(19) United States
(12) Patent Application Publication
(10) Pub. No.: US 2025/0258708 A1
(43) Pub. Date: Aug. 14, 2025

(54) FEDERATED DISTRIBUTED GRAPH-BASED COMPUTING PLATFORM WITH HARDWARE MANAGEMENT

(71) Applicant: QOMPLX LLC, Reston, VA (US)

(72) Inventors: Jason Crabtree, Vienna, VA (US); Richard Kelley, Woodbridge, VA (US); Jason Hopper, Halifax (CA); David Park, Fairfax, VA (US)

(21) Appl. No.: 19/009,889

(22) Filed: Jan. 3, 2025

Related U.S. Application Data
(63) Continuation-in-part of application No. 19/008,636, filed on Jan. 3, 2025.
Application No. 19/008,636 is a continuation-in-part of application No. 18/656,612, filed on May 7, 2024.
(60) Provisional application No. 63/551,328, filed on Feb. 8, 2024.

(51) Int. Cl. G06F 9/50

(52) U.S. Cl. CPC G06F 9/5027

(57) ABSTRACT

A federated distributed AI reasoning and action platform utilizing decentralized, partially observable hierarchical computing for neuro-symbolic reasoning. It features a federated Distributed Computational Graph (DCG) system integrating core components like pipeline orchestration, transformers, and marketplaces. The platform enables privacy-preserving dynamic resource allocation, intelligent task scheduling, and variable information sharing across diverse computing environments. By coordinating with an AI-based operating system and analyzing performance metrics, environmental conditions, and resource availability, the system optimizes efficiency across AI workloads and decision-making processes. This results in an adaptive, power-efficient, and scalable AI-enabled data processing system capable of handling complex tasks while maintaining peak performance under various operating conditions.

### CROSS-REFERENCE TO RELATED APPLICATIONS

Priority is claimed in the application data sheet to the following patents or patent applications, each of which is expressly incorporated herein by reference in its entirety:
Ser. No. 19/008,636
Ser. No. 18/656,612
Ser. No. 63/551,328

### BACKGROUND OF THE INVENTION

### Field of the Art

The present invention is in the field of large-scale cloud and edge computing, on federated distributed graph-based computing, and more particularly on distributed graph-based computing platforms which may be traditional, hierarchically clustered, or federated, which is designed to enhance artificial intelligence based decision-making and automation systems with optional human-machine teaming capabilities including those employing neuro-symbolic reasoning approaches but not limited to large language models (LLMs) and associated services across heterogeneous environments, including cloud infrastructures, managed data centers, edge computing nodes, and wearable/mobile devices and diverse counterparties. The hardware management innovations described herein are applicable across traditional DCG architectures, hierarchical cooperative computing across DCG-enabled clusters, and federated systems with full or partial observability between nodes.

### Discussion of the State of the Art

The recent rapid rise in the capabilities and uses of machine learning, artificial intelligence (AI) and more recently large language models (LLMs) in support of generative artificial intelligence (GenAI or GAI) applications has raised myriad new challenges. New issues such as source data and model provenance, model hallucination and the protection of new threats to intellectual property rights, particularly copyrights and trademarks, against unattributed and unauthorized exploitation by AI models including LLMs, have arisen, while well-known challenges such as user privacy and cybersecurity have become even more difficult to effectively manage and easily understand. Dramatic new opportunities have also arisen as myriad participants rush to adopt more diverse data sources and feed growing machine learning, artificial intelligence and in particular GenAI and LLMs into their existing businesses and even to create entirely new business categories. This is leading to a proliferation of different micro-applications being integrated into computational processes and flows across a wide range of computing applications and modalities.

The most recent AI interest boom has been largely focused on the Transformer and Diffusion models that followed the “Attention is All You Need” paper. Transformer models, particularly in the context of language generation tasks, generate output one token (or “piece”) at a time. Each newly generated token is indeed used as part of the input for generating the next token. This process continues iteratively until the desired output length is achieved or an end-of-sequence token is generated. The popular ChatGPT, Gemini, Bard, LLaMa, and Claude are mainstay examples of models that rely on this core approach, including some variants that reflect on results or engage in basic model blending, consensus or quality control. Closely related are the Diffusion models, which are used primarily to generate new images by beginning with random noise and improving the quality across the entire image until prompts and imagery generate sufficient similarity; DALL-E, Midjourney, and Stable Diffusion are examples of this type of model. Other specific model types such as Mamba (including Vision Mamba), Kolmogrov Arnold, and other variants also essentially follow the same basic principles and utilization considerations.

It is important to note that foundational Large Language Models, like GPT-3 and GPT-4 and their follow-on or competitive variants, are considered to be connectionist AI models rather than symbolic AI. They each have a Connectionist architecture: the currently in-vogue LLMs are a special case of neural network architectures, specifically deep neural networks with millions to billions of parameters. These networks consist of interconnected nodes (neurons) organized in layers. The connections between neurons are weighted, and information flows through these connections during computation. These layers include an input layer, one or more hidden layers, and an output layer. This connectionist architecture is fundamentally different from the symbolic AI approach, which relies on explicit representations of symbols and rules. Further, they typically have a Distributed Representation: LLMs represent information in a distributed manner. Each neuron in the network contributes to the representation of multiple features or concepts simultaneously. In contrast, symbolic AI systems represent knowledge using discrete symbols (e.g. for objects, properties, and relationships) and rules for manipulating these symbols to enable reasoning and problem-solving. LLMs, by distributing information across a vast number of neurons and weights, can capture complex and nuanced patterns in data. These models all use Learning from Data: LLMs are trained through a data-driven approach, where they learn patterns and relationships from massive amounts of data. Large language models like GPT (Generative Pre-trained Transformer) are typically trained on vast amounts of text data. However, there are now emerging advanced models that are being designed to work with different types of data including images, video, audio, tabular/structured, multimodal, code, DNA, proteins, molecules, and computational fluid dynamics often building on top of foundational models trained on large text-dominant corpora and being further enhanced for specific applications with domain-specific tuning, Retrieval-Augmented Generation (RAG) enhancements or knowledge graph enhancements to meet practical performance needs. The base connectionist models do not rely on predefined symbolic representations (e.g., knowledge graphs) or explicit rules. Instead, they adjust their internal connections (weights) through training to improve their ability to predict the next element in a sequence, such as a word in a sentence, or generate coherent content. While most of the approaches noted thus far are effectively Multi-Layer Perceptrons (MLPs) with fixed activation functions on nodes (“neurons”), we also note that Kolmogorov-Arnold Networks (KANs) have emerged as a promising alternative. KANs have learnable activation functions on edges (“weights”) that typically leverage a univariate function parameterized as a spline. KAN-ODEs can further enable ODE-based expression of weightings and support applications not well suited to Physics-Informed Neural Networks (PINNs) or Sparse Identification of Nonlinear Dynamics or Neural ODEs.

Symbolic AI, on the other hand, historically required explicit encoding of knowledge and rules or algorithms for evaluation and in earlier eras this relied heavily on manually curated expert knowledge, often with domain specificity. Further, Connectionist models like LLMs are known for their ability to generalize from the data they have seen during training to generate novel and contextually relevant responses or attempts. They can handle a wide range of tasks and domains by leveraging learned representations that often provide surprisingly convincing or plausible results. Symbolic artificial intelligence (AI) systems often historically struggled with generalization, as they typically require explicit rules for each specific task or domain and may not operate well when observed conditions are not closely correlated to their expected operating conditions. Connectionist models like LLMs lack explicit symbolic reasoning capabilities; that is, they do not have explicit symbols, symbolic representations or rules encoded within them and do not fundamentally understand concepts—they are effectively limited to patterns but can attempt to apply those patterns to any scenario regardless of how tenuous applicability may be. They generate responses based on patterns and associations learned from data utilized in training processes, but in doing so, are largely “black box” systems. In contrast, older symbolic AI systems rely heavily on symbolic representations and rules that were once manually created and maintained and can be explained and traced via essentially rule-based applications of expert knowledge as a result.

Overall, the connectionist nature of many current techniques like LLMs allows them to excel in various natural language understanding tasks and handle complex, context-rich data, making them a powerful tool for many potential AI applications such as content generation, chatbots, language translation, sentiment analysis, text summarization, classification and labeling, question answering and support applications, personalized or contextual recommendations, and comparative analysis. Symbolic AI, on the other hand, is traditionally viewed as being reliant on predefined symbols and rules. This requires formal treatment of data for analysis to enable association between the ontology associated with a given Symbolic application and a data set of interest. This need for highly congruent input and narrow domain framing and brittleness, which can be rigid and less adaptive in the face of real-world data variability, heterogeneity, and uncertainty, can limit its practical applications in many ways. But this common framing of Connectionist versus Symbolic fails to account for broader “systems” level views of practical AI applications which are ultimately of interest to prospective human or robotic agents, owners, and supervisors-who ultimately wish to accomplish something better, cheaper, and/or faster than would otherwise be possible with traditional data analytics, machine learning, or AI systems of either symbolic or connectionist origin.

Within the LLM space, using transformer-based models, word embedding is a technique that assigns words to numerical vectors in a way that connects similar words with vectors that are close in proximity and separates dissimilar words with distant vectors. Similarly, sentence embedding associates a vector with each sentence, gauging the similarity between sentences by allocating large numbers to similar ones and small numbers to dissimilar ones. However, word embeddings have a significant limitation when dealing with words that have multiple meanings. For instance, if a word embedding assigns a vector to the word ‘bear,’ it assigns the same vector to all of its various definitions. This poses a challenge when you want to use the word ‘bear’ in different contexts. This is where the concept of attention comes in. Paragraph-level, document-level, or “chunked” segments or term embedding face many of the same challenges, just with different sampling issues or biases from the source material of interest.

Attention is a mechanism for distinguishing between words when they are used in diverse contexts, transforming word embeddings into contextualized word embeddings. The computer considers all the words in a sentence as context, even including seemingly irrelevant words like “the,” “of,” and “in.” However, it weighs them based on their similarity to the word ‘bear.’ In a well-designed embedding, the similarity between ‘bear’ and words like ‘the’ is nearly zero, indicating their lack of contextual relevance. Consequently, the model learns to ignore these insignificant words and focuses on those with higher similarity to ‘bear.’ Multi-head attention is a method that allows one to modify embeddings to create various attention mechanisms. These modifications can be trained, much as a neural network is trained to more precisely employ weightings reflecting multiple potential contexts-“Bear at the Zoo” is different from “Bear!” during a hiking trip is different from “bear with me” (i.e., be patient with me).

One of the overarching limitations about non-symbolic or Connectionist AI systems like LLMs is that they hallucinate, which can lead to dubious or truly false results. In some cases, LLMs have been known to make up and state facts that are untrue and were never part of their training data. As real-world consequences of making decisions or taking actions based on LLM outputs begin to appear—with concomitant safety and legal risks-connecting the output from a given LLM prompt to a knowledge base imbued with actual semantic meaning is needed. While many LLM companies like OpenAI and Anthropic and Cohere market things like Search Ranking or Semantic Search improvements using LLM overlays on traditional database queries (either user-constructed or constructed as an initial prompt output itself), the results, rankings etc. are not in fact imbued with any “semantic” knowledge or real understanding in the Symbolic sense. Such claims of semantic search are predicated on these kinds of similarity measures which indicate closeness based on contextual indicators derived from the training data—this is distinct from knowledge, comprehension, application, analysis, synthesis, and evaluation in the way used in Bloom's 1956 taxonomy or the 2001 revision which used Remember, Understand, Apply, Analyze, Evaluate, and Create. The effectiveness of meaning representation models or embeddings relies on distance measurement based on a corpora of training data from which vector similarity is determined. Several of the most popular vector similarity functions are Euclidean distance, cosine similarity, and the inner product. The most common linguistic structures in today's natural language tools remain a bag of words (no structure), sequential, constituent, and dependency parsing.

While Connectionist outputs are “made up” they are often nevertheless very compelling artifices which generate believable output that is sometimes correct. Believability may, but does not necessarily, equate to correctness, usefulness, or more broadly fitness for purpose (or optimization) given practical, legal, ethical, moral, and economic considerations and constraints that render a system or its output fit for purpose. This is further complicated by the need to update or evolve data sets and models, computational processes, and the systems of which they are a part, on an ongoing basis whether through continuous learning processes with retraining, reinforcement learning, or techniques like partially neural reinforcement learning which provide frameworks for ongoing verification of neural-network based models within a learning loop inside of continuous state and action spaces.

The growth of increasingly available foundational models alongside specialized data, models, RAGs and tool chains is also driving much more focus on distributed graph-based flow programming of human and agentic workflows. While the core capabilities supporting current kinds of data and process flow programming as complete DCGs for analytical processes and for chaining of models to produce outputs (e.g., in even oriented multi-agent data processor applications like OpenAgents, LangChang, OpenAI Swarm, or Microsoft Magnetic One) have long been disclosed in U.S. patent application Ser. No. 15/931,534 through its pipeline orchestrator architecture providing orchestration of complex workflows, pipeline managers for runtime pipeline management, activity actors for discrete task handling, and service clusters with associated service actors for modular service execution and later enhanced for federated hierarchical cooperative computing (U.S. Pat. No. 10,514,954), security and privacy concerns or regulatory regimes (U.S. patent application Ser. No. 15/489,716), we note that more innovation is required for truly federated orchestration across counterparties where extensive lack of knowledge about aspects of the data/information being processed, the processing systems or networks or devices doing such work, or the counterparties involved is expected, persistent and perhaps even desirable. Highly federated execution of computationally enhanced workflows and transformations of digital and physical assets with deep and diverse and only sometimes declared (or perhaps known) supply chains or data processing support requires more advanced specification and interpretation capabilities with declarative domain-specific language support and the ability for flexible manual or programmatic construction and execution management paired with observability metrics, analytics and simulation modeling. Additionally, current distributed systems remain overly brittle and often struggle with specific challenges associated with distributed computing exemplified by the well-known fallacies of distributed computing: the network is reliable; latency is zero; bandwidth is infinite; the network is secure; topology doesn't change; there is one administrator; transport cost is zero; and the network is homogeneous. Current methodologies for resource pool management and leader election and distributed state machines necessary for coordinated resource pooling and execution remain insufficient for the highly varied, uncertain, dynamic, latency sensitive and increasingly mission critical workflows being injected into applications, chatbots and AI enhanced applications across diverse counterparties with extraordinarily complex digital and physical supply chains.

Current methodologies for resource pool management and leader election and distributed state machines necessary for coordinated resource pooling and execution remain insufficient for the highly varied, uncertain, dynamic, latency sensitive and increasingly mission critical workflows being injected into applications, chatbots and AI enhanced applications across diverse counterparties with extraordinarily complex digital and physical supply chains. What is needed is a federated distributed graph-based computing platform for managing increasingly complex and heterogeneous machine learning, optimizing resource allocation across heterogeneous computing environments while maintaining privacy and security requirements despite numerous counterparties with distinct economic and other incentives (sometimes at odds), support for managing variable and uncertain trustworthiness and artificial intelligence enhanced data processing, that enables more flexible and contextual and declarative use of increasingly heterogeneous computing, transport, and storage technologies and balkanized technology, encryption, and privacy laws and regulations to support new business and technology opportunities to emerge at pace. Such a capability may also enable better responses to the new challenges raised by the dynamic new technology landscape faced by all after the rapid and haphazard introduction of myriad generative AI technologies and platforms, wearables and internet of things devices that are proliferating but require predictable and low-cost integration and collaborative engagement at scale with robust support for multiple interested parties and variable, uncertain, and often partial observability of computational and process flows.

### SUMMARY OF THE INVENTION

Accordingly, the inventor has conceived and reduced to practice, a federated distributed graph-based computing platform for heterogeneous computing environments with multiple organizational, human and AI agent participants. A multi-stakeholder distributed artificial intelligence (AI) reasoning and action and interaction platform that utilizes a cloud-based computing architecture for neuro-symbolic reasoning that can selectively and appropriately blend human action and insight, machine learning, artificial intelligence, statistics, and simulation modeling processes in support of continuous learning from both empirical observations and hypothetical state space explorations of decision spaces—with a particular applicability to decision making under uncertainty in complex adaptive systems but also with applicability for everyday interactions and delegated agentic activities. The platform comprises systems for federated distributed computation declaration, evaluation, distribution, execution and management along with curation, marketplace integration, and context management support human-machine teaming within complicated and complex cyber physical environments that have a wide range of business and decision-making applications over multiple scales, geographies, and timeframes. A federated distributed computational graph (DCG) orchestrates partially observable complex workflows for building and deploying algorithms and models, incorporating expert judgment, domain level expertise and understanding, and utilizing both internal and external data sources to improve a given system's, individual's, group's or organization's outcomes over time and across multiple devices and stakeholders or processes. This is facilitated in part by ongoing analysis of the system of interest to the observer, including with awareness of observer perspective, which is typically (but not necessarily) the beneficiary of the flow-based computing processes enabled by the system, and the evaluation of both experienced and hypothetical (e.g. via simulation or modeling) states over time under different perturbations or shocks from both internal or exogenous factors. A context computing system aggregates contextual data from local or global and internal or external sources or other localized DCG processes in the federated system made known to it (within a given system or as shared or made available from other systems such as via distribute state machine and associated gossip methods and consensus protocols), while a curation system provides curated responses from models (e.g. statistical, machine learning, simulation modeling based, or artificial intelligence including generative approaches like LLMs, deep learning models, or similar).

According to a preferred embodiment of the invention a core distinction of a federated DCG over previously DCGs now widely in use is that it is not necessary for any specific DCG in the federation to have knowledge and/or context of the entire federation of nodes or edges representing dataflows and tasks or processing steps for orchestration, and instead may only focus on the respective jobs and resources assigned for processing. DCGs within a federation may communicate context and state as much or as little as needed to accomplish the job objectives and to enable potential tiers or tessellations of resource pools to compete for processing and task roles and for pipeline definition, context and state updates. Marketplaces offer data (including unstructured, structured, schematized, normalized, and semantified for both real or synthetic), algorithms, models, model components, worlds or artifacts of them, and expert judgment(s) for purchase or integration or inspiration or training of downstream work or algorithms or new synthetic data sets. The platform enables enterprises to construct user-defined workflows and incorporate trained models into their business processes, leveraging enterprise-specific knowledge and for individuals to do effectively the same with temporally, spatially, and experience-based tagging and aggregation of knowledge and experience and exposure over their life. The platform facilitates flexible and scalable integration of statistical, machine learning and artificial intelligence and simulation models into software applications, supported by a dynamic and adaptive federated DCG architecture that supports execution of data flows and orchestration of resources across cloud (e.g. hyperscale), self-managed (e.g. traditional data center) compute clusters, CDNs (e.g. forward content distribution networks that may expand from historical distribution of web content into forward hosting of data sets, models, AI tools, etc . . . ), edge devices, wearables and mobile devices, and individual computers where computational graph specifications may also be communicated between different people, processes, AI agents and collections of logical or hardware resources. This federated DCG architecture not only supports pipeline definition of transformation tasks, especially via a Data Service Layer (DSL) for recipe and template like creation of flows, but enables the express establishment of dependencies and bill of materials from resources, data sets, algorithms, models, and rules/regulations applicable to the data flow being established. This may also optionally include the consideration of both 1st, 3rd, and 4th party compute, transport and storage dependencies with optional declaration of compute transport or storage locality for express, resource-dependent or economically dependent, or allowed locality instruction. The inventions' ability to orchestrate just-in-time, just-in-place, and just-in-context data flow processing across ecosystems, leveraging specific computing and networking constraints—both physical and logical, with multiple stakeholders who may have usage or licensing or economic considerations tied to highly distributed and heterogeneous data processing flows represents a substantial step forward above current cloud based orchestration of data flows and resources (including serverless kinds of architectures like Serverless Flink and schema registries) to provide a much more flexible, comprehensive and manageable means of enabling highly integrated multi-vendor/processor workflows for businesses, organizations, consumers, AI agents and automation engines, and programmers alike. This flexibility is in part enabled by distributed state and job objective management through DCG intercommunication through industry standard communication which may include but is not limited to gossip protocols or gossip-like consensus algorithms, communication protocols (e.g., the Zookeeper Atomic Broadcast (ZAB) protocol at the core of Zookeeper, the Raft consensus algorithm and associated communication model in Kraft, or other protocols or consensus algorithms like Paxos, or serverless implementations like FaasKeeper). This is critical for enabling more advanced kinds of federated and transfer learning at scale and better addressing privacy concerns, data locality regulations/restrictions, and user preferences on top of efficiency in processing, transport and storage of data at massive scale.

According to a preferred embodiment, a computing system for a federated distributed graph-based computing platform with hardware management, the computing system comprising: one or more hardware processors configured for: integrating a hardware management layer with existing system components of a distributed graph-based computing platform; configuring and initializing a thermal management system for optimal thermal control across the platform; establishing real-time monitoring and control of hardware resources distributed throughout the platform; implementing dynamic resource allocation based on workload demands and thermal conditions; coordinating with an operating system for intelligent task scheduling and resource optimization; continuously analyzing platform capabilities and adapting hardware configurations into optimized hardware configurations; and executing AI tasks using the optimized hardware configurations, is disclosed.

According to a preferred embodiment, a computer-implemented method executed on a federated distributed graph-based computing platform with hardware management, the computer-implemented method comprising: integrating a hardware management layer with existing system components of a distributed graph-based computing platform; configuring and initializing a thermal management system for optimal thermal control across the platform; establishing real-time monitoring and control of hardware resources distributed throughout the platform; implementing dynamic resource allocation based on workload demands and thermal conditions; coordinating with an operating system for intelligent task scheduling and resource optimization; continuously analyzing platform capabilities and adapting hardware configurations into optimized hardware configurations; and executing AI tasks using the optimized hardware configurations, is disclosed.

According to a preferred embodiment, A system for a federated distributed graph-based computing platform with an integrated hardware management layer, comprising one or more computers with executable instructions that, when executed, cause the system to: receive a plurality of tasks from a first plurality of federated distributed graph-based systems; forward the plurality of tasks to a centralized distributed graph-based system; analyze and decomposing tasks into a plurality of subtasks with varying levels of visibility, execution flexibility and access requirements; generate a plurality of probabilistic compute graphs that represent the plurality of subtasks and relationships; distribute the plurality of compute graphs to a second plurality of federated distributed graph-based systems which comprises a plurality of resource states, privacy practices and security settings or postures; and execute the subtasks represented by the plurality of probabilistic compute graphs, is disclosed.

According to an aspect of an embodiment, the second plurality of federated distributed graph-based systems are assigned subtasks from the plurality of subtasks based on the second plurality of federated distributed graph-based systems' privacy and security settings.

According to an aspect of an embodiment, the plurality of compute graphs contain various amounts of information, such that some of the second plurality of federated distributed graph-based systems are provided with more information than others.

According to an aspect of an embodiment, the plurality of tasks, subtasks, and compute graphs are received, forwarded, analyzed, and distributed through a data pipeline network that connects the first plurality of federated graph-based systems, the centralized distributed graph-based system, and the second plurality of federated distributed graph-based systems.

According to an aspect of an embodiment, the federated distributed computational graph where computational graphs, in whole or in part, are encoded and communicated across devices alongside other data such as application data or models or data sets or weightings. In a preferred embodiment, federated DCG enables system-wide execution with decentralized and even blind or partially blind execution across tiers and tessellations of computing resources, rendering partially observable collaborative yet decentralized and distributed computing for complex processing and task flows possible with rule, score, weighting, market/bid, or optimization or planning based selection at local, regional or global level. The federation manager facilitates this through resource registry, task analyzer, and matching engine components, enabling dynamic orchestration while maintaining granular privacy and security controls. This architecture allows federated DCGs to communicate state and context information selectively through privacy and security module, with custom compute graphs containing varying levels of visibility tailored to each node's clearance and requirements. The system supports both centralized coordination through DCG and decentralized operation where federated DCGs maintain autonomous control over their resources and processing decisions while participating in the broader federation through secure communication interface.

According to an aspect of an embodiment, the federated DCG system implements a multi-level approach to resource coordination and task distribution through specialized components. The federation manager orchestrates distribution of workloads using resource registry to maintain dynamic inventory of available resources across federated nodes, task analyzer to decompose complex tasks into appropriately-sized subtasks, and matching engine to align tasks with suitable federated DCGs based on their capabilities, current workloads, and security clearances. Communication between federated units occurs through pipeline structures with pipeline managers overseeing different segments of workflow execution. Each federated DCG can interact with corresponding local service clusters and associated Service Actors to execute tasks while maintaining flexible connections to the broader federated network. This architecture enables efficient local processing while preserving the ability to selectively share information and resources across the federation according to established privacy specifications and security requirements. The system supports various operational patterns including peer-to-peer federation where DCGs discover and coordinate directly with each other, hierarchical arrangements where certain DCG's act as regional coordinators, and hybrid approaches that combine aspects of both centralized and decentralized operation.

According to an aspect of an embodiment, the distributed graph-based computing platform is a federated distributed graph-based computing platform.

According to an aspect of an embodiment, dynamically allocating resources comprises adjusting computational resources across hardware components including CPUs, GPUs, and specialized AI hardware such as TPUs.

### BRIEF DESCRIPTION OF THE DRAWING FIGURES

FIG. 1 is a block diagram illustrating an exemplary system architecture for a distributed generative artificial intelligence reasoning and action platform, according to an embodiment.

FIG. 2 is a block diagram illustrating an exemplary aspect of a distributed generative AI reasoning and action platform incorporating various additional contextual data.

FIG. 3 is a diagram illustrating incorporating symbolic reasoning in support of LLM-based generative AI, according to an aspect of a neuro-symbolic generative AI reasoning and action platform.

FIG. 4 is a block diagram illustrating an exemplary architecture for a neuro-symbolic generative AI reasoning and action platform configured for federated learning at a plurality of edge devices, according to an embodiment.

FIG. 5 is a block diagram illustrating an exemplary architecture for a neuro-symbolic generative AI reasoning and action platform configured to utilize a midserver to act as a computing intermediary between a plurality of edge devices and the platform.

FIG. 6 is a block diagram illustrating an exemplary mobile device configured for experience curation using embedded capabilities and functionality provided by a neuro-symbolic generative AI reasoning and action platform, according to an embodiment.

FIG. 7 is a block diagram illustrating an exemplary aspect of a distributed generative artificial intelligence reasoning and action platform, a curation computing system.

FIG. 8 is a block diagram illustrating an exemplary aspect of a distributed generative artificial intelligence reasoning and action platform, a marketplace computing system.

FIG. 9 is a block diagram illustrating a simple example of a distributed computational graph representation for providing neuro-symbolic GenAI capabilities, according to an aspect.

FIG. 10 is a block diagram illustrating an exemplary aspect of an embodiment of a distributed computational graph computing system utilizing an advanced cyber decision platform (ACDP) for external network reconnaissance and contextual data collection.

FIG. 11 is a block diagram illustrating another exemplary aspect of an embodiment of a distributed computational graph computing systems utilizing an advanced cyber decision platform.

FIG. 12 is a diagram of an exemplary architecture for a system for rapid predictive analysis of very large data sets using an actor-driven distributed computational graph, according to one aspect.

FIG. 13 is a diagram of an exemplary architecture for a system for rapid predictive analysis of very large data sets using an actor-driven distributed computational graph, according to one aspect.

FIG. 14 is a diagram of an exemplary architecture for a system for rapid predictive analysis of very large data sets using an actor-driven distributed computational graph, according to one aspect.

FIG. 15 is a block diagram of an architecture for a transformation pipeline within a system for predictive analysis of very large data sets using a distributed computational graph computing system.

FIG. 16 is a process flow diagram of a method for predictive analysis of very large data sets using the distributed computational graph

FIG. 17 is a process flow diagram of a method for an aspect of modeling the transformation pipeline module as a directed graph using graph theory.

FIG. 18 is a flow diagram illustrating an exemplary method for providing experience curation, according to an aspect of an embodiment.

FIG. 19 is a flow diagram illustrating an exemplary method for providing experience curation with using rich contextual data, according to an aspect of an embodiment.

FIG. 20 is a flow diagram illustrating an exemplary method for providing distributed neuro symbolic reasoning and action, according to an aspect of an embodiment.

FIG. 21 is a flow diagram illustrating an exemplary method for using a distributed computation graph system for creating structured representations or knowledge graphs from various data sources, and setting up a pipeline for continuous processing and monitoring of that data, according to an embodiment.

FIG. 22 is a block diagram illustrating an exemplary system architecture for a federated distributed graph-based computing platform.

FIG. 23 is a block diagram illustrating an exemplary system architecture for a federated distributed graph-based computing platform that includes a federation manager.

FIG. 24 is a block diagram illustrating an exemplary component of a federated distributed graph-based computing platform that includes a federation manager, the federation manager.

FIG. 25 is a block diagram illustrating an exemplary system architecture for a federated distributed graph-based computing platform that includes a federation manager where different compute graphs are forward to various federated distributed computation graph systems.

FIG. 26 is a flow diagram illustrating an exemplary method for a federated distributed graph-based computing platform.

FIG. 27 is a flow diagram illustrating an exemplary method for a federated distributed graph-based computing platform that includes a federation manager.

FIG. 28A is a block diagram illustrating an exemplary system architecture for a distributed generative artificial intelligence reasoning and action platform with an integrated hardware management layer.

FIG. 28B is a block diagram illustrating an exemplary subsystems architecture for a hardware management layer.

FIG. 28C is a block diagram illustrating an exemplary subsystem architecture for a component of a distributed generative artificial intelligence reasoning and action platform with an integrated hardware management layer, a through-chip microchannel cooler.

FIG. 29A is a block diagram illustrating an exemplary system architecture for a distributed generative artificial intelligence reasoning and action platform with an integrated hardware aware transformer subsystem.

FIG. 29B is a block diagram illustrating an exemplary subsystem architecture for a component of a distributed generative artificial intelligence reasoning and action platform with an integrated hardware aware transformer subsystem, a hardware aware transformer subsystem.

FIG. 30A is a block diagram illustrating an exemplary system architecture for a component of a distributed generative artificial intelligence reasoning and action platform wherein the LLM services further comprise a convolutional self-attention subsystem.

FIG. 30B is a block diagram illustrating an exemplary subsystem architecture for a distributed generative artificial intelligence reasoning and action platform with an integrated convolutional self-attention subsystem, a convolutional self-attention subsystem.

FIG. 31A is a block diagram illustrating an exemplary system architecture for a distributed generative artificial intelligence reasoning and action platform with an integrated iMTransformer subsystem.

FIG. 31B is a block diagram illustrating an exemplary subsystem architecture for a component of a distributed generative artificial intelligence reasoning and action platform with an integrated iMTransformer subsystem, an iMTransformer subsystem.

FIG. 32A is a block diagram illustrating an exemplary system architecture for a distributed generative artificial intelligence reasoning and action platform with an integrated vector embedding subsystem.

FIG. 32B is a block diagram illustrating an exemplary subsystem architecture for a component of a distributed generative artificial intelligence reasoning and action platform with an integrated vector embedding subsystem, a vector embedding subsystem.

FIG. 33 is a block diagram illustrating an exemplary system architecture for a distributed generative artificial intelligence reasoning and action platform with an integrated neuromorphic processing subsystem.

FIG. 34 is a block diagram illustrating an exemplary subsystem architecture for a component of a distributed generative artificial intelligence reasoning and action platform with an integrated neuromorphic processing subsystem, a neuromorphic processing subsystem.

FIG. 35 is a block diagram illustrating an exemplary system architecture for a distributed generative artificial intelligence reasoning and action platform with an integrated dynamic resource orchestrator.

FIG. 36 is a block diagram illustrating an exemplary subsystem architecture for a component of a distributed generative artificial intelligence reasoning and action platform with an integrated dynamic resource orchestrator, a dynamic resource orchestrator.

FIG. 37 is a block diagram illustrating an exemplary system architecture for a distributed generative artificial intelligence reasoning and action platform with an integrated output validator.

FIG. 38 is a block diagram illustrating an exemplary subsystem architecture for a component of a distributed generative artificial intelligence reasoning and action platform with an integrated output validator, an output validator.

FIG. 39 is a block diagram illustrating an exemplary system architecture for a distributed generative artificial intelligence reasoning and action platform with an integrated mode hardware co-design subsystem.

FIG. 40 is a block diagram illustrating an exemplary subsystem architecture for a component of a distributed generative artificial intelligence reasoning and action platform with an integrated model hardware co-design subsystem, a model hardware co-design subsystem.

FIG. 41 is a block diagram illustrating an exemplary system architecture for a distributed generative artificial intelligence reasoning and action platform with an integrated KAN subsystem.

FIG. 42 is a block diagram illustrating an exemplary subsystem architecture for a component of a distributed generative artificial intelligence reasoning and action platform with an integrated KAN subsystem, a KAN subsystem.

FIG. 43 is a block diagram illustrating an exemplary system architecture for a distributed generative artificial intelligence reasoning and action platform with an integrated neuromodulation controller.

FIG. 44 is a block diagram illustrating an exemplary subsystem architecture for a component of a distributed generative artificial intelligence reasoning and action platform with an integrated neuromodulation controller, a neuromodulation controller.

FIG. 45 is a block diagram illustrating an exemplary system architecture for a distributed generative artificial intelligence reasoning and action platform with an integrated AI-based Operating System (AIOS).

FIG. 46 is a block diagram illustrating an exemplary subsystem architecture for a component of a distributed generative artificial intelligence reasoning and action platform with an integrated AIOS, an AI-based Operating System.

FIG. 47 is a block diagram illustrating an exemplary system architecture for a distributed generative artificial intelligence reasoning and action platform with an integrated liquid circuit subsystem.

FIG. 48 is a block diagram illustrating an exemplary subsystem architecture for a component of a distributed generative artificial intelligence reasoning and action platform with an integrated liquid circuit subsystem, a liquid circuit subsystem.

FIG. 49 is a block diagram illustrating an exemplary system architecture for a distributed generative artificial intelligence reasoning and action platform with an integrated execution path analyzer.

FIG. 50 is a block diagram illustrating an exemplary subsystem architecture for a component of a distributed generative artificial intelligence reasoning and action platform with an integrated execution path analyzer, an execution path analyzer.

FIG. 51 is a flow diagram illustrating an exemplary method for a distributed generative artificial intelligence reasoning and action platform with an integrated hardware management layer.

FIG. 52 is a flow diagram illustrating an exemplary method for a distributed generative artificial intelligence reasoning and action platform with an integrated hardware aware transformer subsystem.

FIG. 53 is a flow diagram illustrating an exemplary method for a distributed generative artificial intelligence reasoning and action platform wherein the LLM services further comprise a convolutional self-attention subsystem.

FIG. 54 is a flow diagram illustrating an exemplary method for a distributed generative artificial intelligence reasoning and action platform with an integrated iMTransformer subsystem.

FIG. 55 is a flow diagram illustrating an exemplary method for a distributed generative artificial intelligence reasoning and action platform with an integrated vector embedding subsystem.

FIG. 56 is a flow diagram illustrating an exemplary method for a distributed generative artificial intelligence reasoning and action platform with an integrated neuromorphic processing subsystem.

FIG. 57 is a flow diagram illustrating an exemplary method for a distributed generative artificial intelligence reasoning and action platform with an integrated dynamic resource orchestrator.

FIG. 58 is a flow diagram illustrating an exemplary method for a distributed generative artificial intelligence reasoning and action platform with an integrated output validator.

FIG. 59 is a flow diagram illustrating an exemplary method for a distributed generative artificial intelligence reasoning and action platform with an integrated mode hardware co-design subsystem.

FIG. 60 is a flow diagram illustrating an exemplary method for a distributed generative artificial intelligence reasoning and action platform with an integrated KAN subsystem.

FIG. 61 is a flow diagram illustrating an exemplary method for a distributed generative artificial intelligence reasoning and action platform with an integrated neuromodulation controller.

FIG. 62 is a flow diagram illustrating an exemplary method for a distributed generative artificial intelligence reasoning and action platform with an integrated AI-based Operating System (AIOS).

FIG. 63 is a flow diagram illustrating an exemplary method for a distributed generative artificial intelligence reasoning and action platform with an integrated liquid circuit subsystem.

FIG. 64 is a flow diagram illustrating an exemplary method for a distributed generative artificial intelligence reasoning and action platform with an integrated execution path analyzer.

FIG. 65 illustrates an exemplary computing environment on which an embodiment described herein may be implemented.

FIG. 66 is a flow diagram illustrating an exemplary method for implementing gossip and consensus flows within and across tiers and tessellations of resource pools in a federated distribution graph-based computing platform.

### DETAILED DESCRIPTION OF THE INVENTION

A federated distributed graph-based computing platform with an integrated hardware management layer for managing and operationalizing artificial intelligence enhanced decision-making and automation systems including large language models and neuro-symbolic reasoning and automation systems. A distributed planning, machine learning, artificial intelligence, modeling simulation and generative artificial intelligence (AI) reasoning and action platform that utilizes a cloud-based computing architecture for operationalizing neuro-symbolic reasoning in real-world applications. The platform comprises systems for distributed computation, curation, marketplace integration, and context management across heterogeneous computing environments across heterogeneous cloud, managed data center, edge, and wearable/mobile devices where entire process graphs, data and models may be moved seamlessly between physical or logical devices for execution on a dynamic basis.

A federated distributed computational graph (DCG) creates, stores, analyzes, orchestrates, and refines complex workflows for building and deploying intelligent decision support, decision making, and automation systems for machine and human machine teamed processes leveraging, statistics, simulation modeling, machine learning, artificial intelligence, automated planning, and generative AI, incorporating expert judgment and internal and external data sources and marketplaces for data, models, algorithms, model weights, experts and third party APIs or services. A just-in-place, just-in-time, and just-in-context computing system aggregates data, while a curation system provides curated responses from selected trained models and resources. Marketplaces offer data, algorithms, databases, model weights and components, models and expert judgment for purchase or integration. The platform enables enterprises to construct user-defined workflows and incorporate trained models into their business processes, leveraging enterprise-specific knowledge. The platform facilitates flexible and scalable integration of machine learning models into software applications, supported by a dynamic and adaptive DCG architecture across heterogeneous resource pools with a declarative language domain-specific language for resource, transformation, and process flows across heterogeneous resource pools with awareness of legal, regulatory, privacy, economic, technology velocity (e.g. Flink or Kafka becoming more or less active).

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “graph” is a representation of information and relationships, where each primary unit of information makes up a “node” or “vertex” of the graph and the relationship between two nodes makes up an edge of the graph. Nodes can be further qualified by the connection of one or more descriptors or “properties” to that node. For example, given the node “James R,” name information for a person, qualifying properties might be “183 cm tall,” “DOB 08/13/1965” and “speaks English”. Similar to the use of properties to further describe the information in a node, a relationship between two nodes that forms an edge can be qualified using a “label”. Thus, given a second node “Thomas G,” an edge between “James R” and “Thomas G” that indicates that the two people know each other might be labeled “knows.” When graph theory notation (Graph=(Vertices, Edges)) is applied this situation, the set of nodes are used as one parameter of the ordered pair, V and the set of 2 element edge endpoints are used as the second parameter of the ordered pair, E. When the order of the edge endpoints within the pairs of E is not significant, for example, the edge James R, Thomas G is equivalent to Thomas G, James R, the graph is designated as “undirected.” Under circumstances when a relationship flows from one node to another in one direction, for example James R is “taller” than Thomas G, the order of the endpoints is significant. Graphs with such edges are designated as “directed.” In the distributed computational graph system, transformations within a transformation pipeline are represented as a directed graph with each transformation comprising a node and the output messages between transformations comprising edges. Distributed computational graph stipulates the potential use of non-linear transformation pipelines which are programmatically linearized. Such linearization can result in exponential growth of resource consumption. The most sensible approach to overcome possibility is to introduce new transformation pipelines just as they are needed, creating only those that are ready to compute. Such method results in transformation graphs which are highly variable in size and node, edge composition as the system processes data streams. Those familiar with the art will realize that a transformation graph may assume many shapes and sizes with a vast topography of edge relationships and node types. It is also important to note that the resource topologies available at a given execution time for a given pipeline may be highly dynamic due to changes in available node or edge types or topologies (e.g. different servers, data centers, devices, network links, etc.) being available, and this is even more so when legal, regulatory, privacy and security considerations are included in a DCG pipeline specification or recipe in the DSL. Since the system can have a range of parameters (e.g. authorized to do transformation x at compute locations of a, b, or c) the just-in-time, just-in-context, just-in-place elements can leverage system state information (about both the processing system and the observed system of interest) and planning or modeling modules to compute at least one parameter set (e.g. execution of pipeline may say based on current conditions use compute location b) at execution time. This may also be done at the highest level or delegated to lower level resources when considering the spectrum from centralized cloud clusters (i.e. higher) to extreme edge (e.g. a wearable, or phone or laptop). The examples given were chosen for illustrative purposes only and represent a small number of the simplest of possibilities. These examples should not be taken to define the possible graphs expected as part of operation of the invention

As used herein, “transformation” is a function performed on zero or more streams of input data which results in a single stream of output which may or may not then be used as input for another transformation. Transformations may comprise any combination of machine, human or machine-human interactions Transformations need not change data that enters them, one example of this type of transformation would be a storage transformation which would receive input and then act as a queue for that data for subsequent transformations. As implied above, a specific transformation may generate output data in the absence of input data. A time stamp serves as an example. In the invention, transformations are placed into pipelines such that the output of one transformation may serve as an input for another. These pipelines can consist of two or more transformations with the number of transformations limited only by the resources of the system. Historically, transformation pipelines have been linear with each transformation in the pipeline receiving input from one antecedent and providing output to one subsequent with no branching or iteration. Other pipeline configurations are possible. The invention is designed to permit several of these configurations including, but not limited to: linear, afferent branch, efferent branch and cyclical.

A “pipeline,” as used herein and interchangeably referred to as a “data pipeline” or a “processing pipeline,” refers to a set of data streaming activities and batch activities. Streaming and batch activities can be connected indiscriminately within a pipeline and compute, transport or storage (including temporary in-memory persistence such as Kafka topics) may be optionally inferred/suggested by the system or may be expressly defined in the pipeline domain specific language. Events will flow through the streaming activity actors in a reactive way. At the junction of a streaming activity to batch activity, there will exist a StreamBatchProtocol data object. This object is responsible for determining when and if the batch process is run. One or more of three possibilities can be used for processing triggers: regular timing interval, every N events, a certain data size or chunk, or optionally an internal (e.g. APM or trace or resource based trigger) or external trigger (e.g. from another user, pipeline, or exogenous service). The events are held in a queue (e.g. Kafka) or similar until processing. Each batch activity may contain a “source” data context (this may be a streaming context if the upstream activities are streaming), and a “destination” data context (which is passed to the next activity). Streaming activities may sometimes have an optional “destination” streaming data context (optional meaning: caching/persistence of events vs. ephemeral). System also contains a database containing all data pipelines as templates, recipes, or as run at execution time to enable post-hoc reconstruction or re-evaluation with a modified topology of the resources (e.g. compute, transport or storage), transformations, or data involved.

### Conceptual Architecture

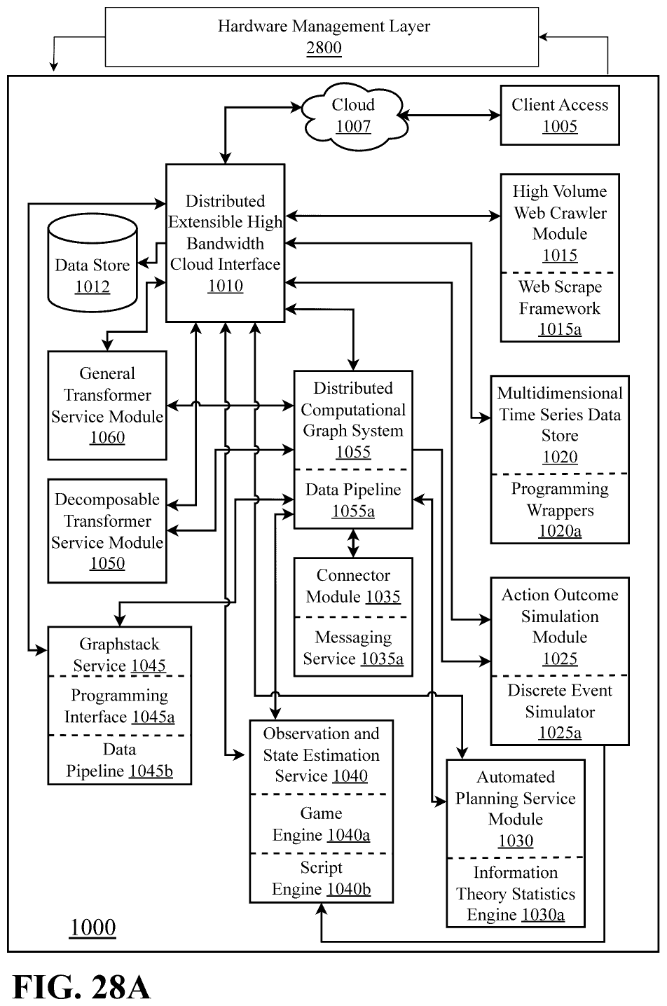

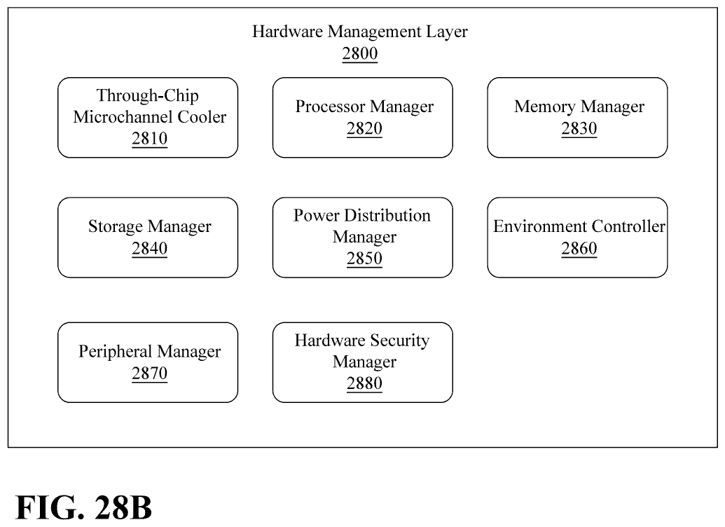

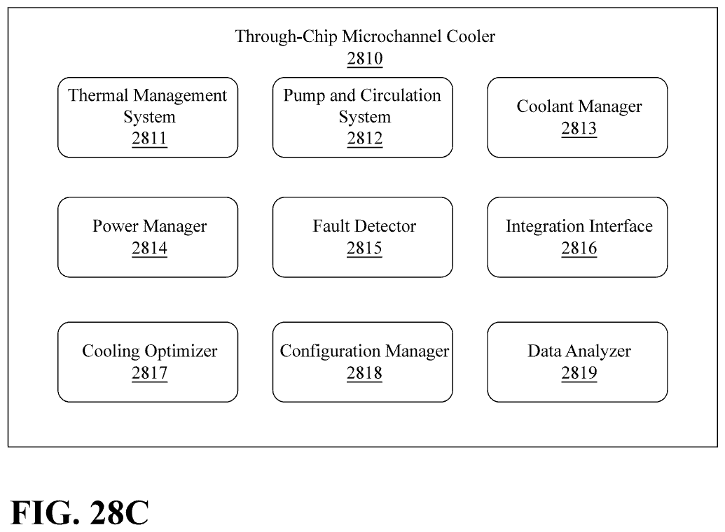

FIG. 28A is a block diagram illustrating an exemplary system architecture for a distributed generative artificial intelligence reasoning and action platform with an integrated hardware management layer. Hardware management layer 2800 can be seamlessly integrated into the existing architecture, interfacing with key components such as distributed computational graph system 1055, general transformer service module 1060, and decomposable transformer service module 1050. This integration allows for dynamic hardware resource allocation and optimization, enhancing the overall performance and efficiency of the system.

A primary function of hardware management layer 2800 is the integration and control of advanced cooling technologies, specifically the through-chip microchannels (TCMCs) for cooling. TCMCs are a solution for thermal management in 3D integrated circuits, allowing for more efficient cooling of densely packed computing components. By incorporating TCMCs, hardware management layer 2800 enables the system to operate at higher clock speeds and with denser computing clusters without the risk of thermal throttling.

For example, in a scenario where distributed computational graph system 1055 is orchestrating a complex AI workflow that requires intensive processing, hardware management layer 2800 can dynamically adjust the cooling parameters of the TCMCs. It might increase the flow rate of coolant through the microchannels in specific areas of the chip where temperature hotspots are detected, ensuring optimal thermal conditions for high-performance operation.

Hardware management layer 2800 also plays a role in implementing hardware-aware AI models. It works along with general transformer service module 1060 and decomposable transformer service module 1050 to optimize the deployment of AI models based on the specific hardware constraints and capabilities. This may be achieved through the integration of Hardware-Aware Transformer (HAT) techniques, which allow the system to automatically adapt AI models to the available hardware resources.

The hardware management layer works in conjunction with the general transformer service module 1060 and decomposable transformer service module 1050 through a mechanism of real-time analysis, adaptation, and deployment. This process begins with the hardware management layer's 2800 continuous monitoring of available hardware resources, creating a detailed profile of the system's computational capabilities. Simultaneously, it analyzes the structure and requirements of the transformer models managed by modules 1060 and 1050.

When a transformer model is scheduled for deployment, the hardware management layer initiates a multi-step optimization process. First, it examines the model's architecture, identifying key components such as attention mechanisms, feed-forward networks, and embedding layers. It then maps these components to the available hardware resources, considering factors such as processing power, memory bandwidth, and specialized accelerators like tensor processing units.

The integration of Hardware-Aware Transformer (HAT) techniques enables dynamic adaptation of model architecture. This adaptation process may involve several strategies. For instance, the system might adjust the number of attention heads or the dimensionality of the feed-forward layers based on the available GPU memory and processing capabilities. In scenarios with heterogeneous hardware, it could distribute different layers of the model across various processing units, assigning computationally intensive operations to high-performance GPUs while routing less demanding tasks to CPUs or specialized AI accelerators.

Furthermore, hardware management layer 2800 may dynamically alter the precision of computations. For example, it might switch from 32-bit to 16-bit floating-point operations on hardware that supports efficient reduced-precision arithmetic, thereby increasing throughput without significantly impacting model accuracy. In cases where the decomposable transformer service module is involved, the system can make even more fine-grained adjustments, potentially breaking down complex transformer operations into smaller, more efficiently distributable components.

This optimization process is not static but continually evolving. The hardware management layer 2800 maintains a feedback loop, monitoring the performance of deployed models and adjusting its optimization strategies in real-time. If it detects changes in hardware availability or shifts in workload patterns, it can trigger re-optimization of the deployed models, ensuring consistent performance even in dynamic computing environments.

By facilitating this intricate relationship between model architecture and hardware capabilities, the hardware management layer 2800 enables modules 1060 and 1050 to deploy transformer models that are uniquely tailored to the specific hardware landscape of the system. This results in optimized performance, improved energy efficiency, and more effective utilization of computational resources across the entire distributed computing platform.

For instance, when deploying a large language model through general transformer service module 1060, hardware management layer 2800 can provide real-time information about the available computational resources, memory bandwidth, and thermal headroom. This information is then used to dynamically adjust the model's architecture, such as the number of attention heads or the depth of the network, to achieve optimal performance within the current hardware constraints.

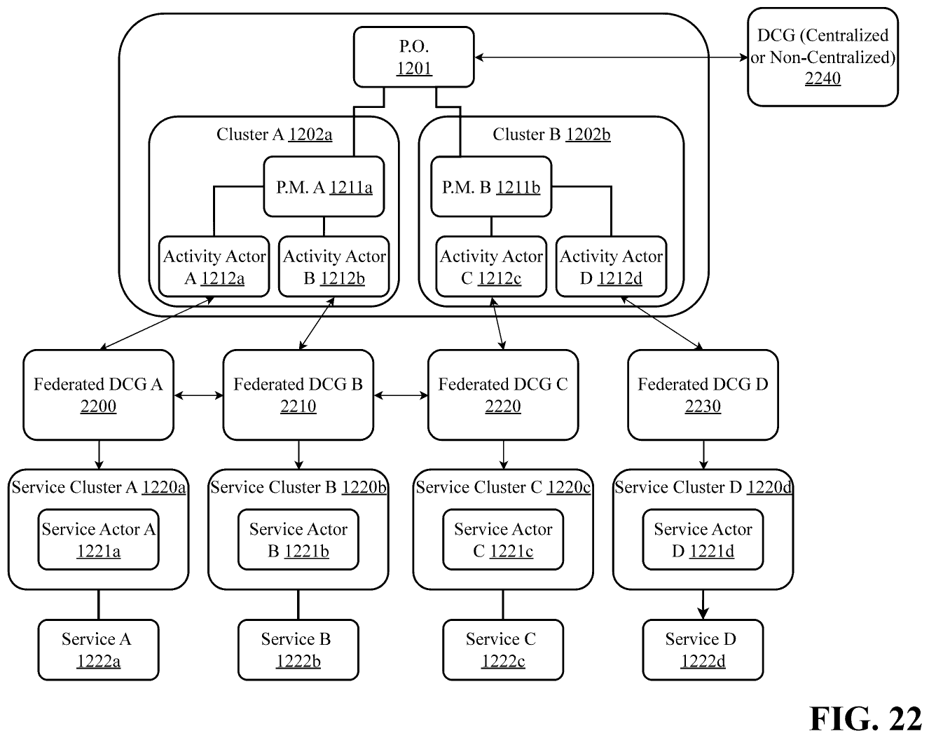

In one embodiment where hardware management layer 2800 operates in a federated system such as one from FIG. 22, the hardware management layer's 2800 operation becomes more complex and distributed, working across multiple semi-autonomous nodes or clusters while respecting privacy and security constraints. The integration with the general transformer service module 1060 and decomposable transformer service module 1050 in this federated context involves a layered approach to optimization and deployment. At the highest level, a federation manager coordinates the overall optimization strategy across the distributed system. This manager maintains a global view of available resources and capabilities, but with limited granularity to respect the privacy and autonomy of individual nodes. It works with aggregated hardware profiles and model performance metrics, rather than detailed, node-specific information.

Within each federated node, a local hardware management layer may operate similarly to the centralized version, but with added responsibilities for maintaining local privacy and adhering to node-specific constraints. These local layers perform detailed hardware profiling and model analysis, but only share abstracted or anonymized data with the federation manager. When deploying transformer models in this federated system, the process begins with the federation manager distributing high-level optimization directives based on its global view. These directives might include general strategies for model partitioning or guidelines for hardware utilization across the federation.

Local hardware management layers then interpret these directives within the context of their specific hardware environments. They apply Hardware-Aware Transformer (HAT) techniques to optimize model deployment for their local resources, which could vary significantly across the federation. This might involve adjusting model architectures, precision levels, or distribution of computation across local heterogeneous hardware. The decomposable transformer service module allows for the transformer model to be split into components that can be distributed across the federation. The local hardware management layers can then optimize these components individually, tailoring them to local hardware capabilities while adhering to the overall model architecture.

Federated learning techniques are employed to train and fine-tune these distributed models without sharing raw data between nodes. The hardware management layer at each node optimizes the local training process, adjusting batch sizes, learning rates, and other hyperparameters based on local hardware capabilities. A federated performance monitoring system may aggregate anonymized performance metrics from across the nodes. This system provides feedback to both the local hardware management layers and the federation manager, enabling continuous refinement of the optimization strategies at both local and global levels. Security and privacy constraints are respected throughout this process. Nodes only share the minimum necessary information for federated optimization, using techniques like differential privacy or secure multi-party computation when exchanging sensitive data or model updates.

This federated approach allows the system to leverage diverse hardware resources across a distributed network while maintaining data privacy and node autonomy. It enables the deployment of large, complex transformer models that can benefit from the collective computational power of the federation, with each component optimized for its specific hardware environment. The result is a highly adaptable, privacy-preserving system capable of efficient AI model deployment across a diverse and distributed computing landscape.

Furthermore, hardware management layer 2800 may facilitate the integration of specialized hardware components through a comprehensive approach that leverages the existing components and systems described in the application. This process involves several key mechanisms working in concert to seamlessly incorporate diverse hardware accelerators and specialized computing elements into the broader distributed computing ecosystem. At the core of this integration process is distributed computational graph system 1055 which provides a flexible framework for representing and orchestrating complex workflows across diverse hardware components. When specialized hardware is introduced, distributed computational graph system 1055 can be dynamically reconfigured to incorporate these new resources, allowing for efficient task distribution and execution.

The hardware management layer may coordinate with a Through-Chip Microchannel Cooler 2810 to ensure optimal thermal management of specialized components. This aids in maintaining stable operation and maximum performance of high-density, high-performance hardware accelerators that may generate significant heat. Leveraging the general transformer service module 1060 and decomposable transformer service module 1050, the hardware management layer 2800 can adapt AI models to take advantage of specialized hardware features. This might involve restructuring transformer architectures or adjusting computational precision to match the capabilities of specific accelerators. The connector module 1035 facilitates communication between specialized hardware and other system components. It manages data transfer and ensures compatibility between different hardware interfaces, allowing for seamless integration of diverse accelerators.

The automated planning service module 1030 is utilized to optimize task allocation across specialized hardware components. It can generate execution plans that efficiently distribute workloads based on the unique capabilities of each hardware accelerator and the current system state. Observation and state estimation service 1040 provides real-time monitoring of specialized hardware performance and health. This information helps make informed decisions about resource allocation and for identifying any potential issues with integrated hardware components.

Through the integration of these existing components and subsystems, the hardware management layer 2800 creates a flexible and robust framework for integrating a wide array of specialized hardware components. This enables the distributed computing platform to leverage cutting-edge hardware innovations, adapt to evolving computational needs, and maintain high performance across diverse and dynamic workloads, all within the context of the systems and processes already described in the application. This enables a distributed computing platform whether fully centralized or federated, to leverage cutting-edge hardware innovations, adapt to evolving computational needs, and maintain high performance across diverse and dynamic workloads. It manages the allocation of tasks to these specialized units, ensuring that each type of computation is performed on the most suitable hardware. In one embodiment, this is achieved through computing context specific dependency graph and compatibility analysis of resources associated with a given hardware, software and DCG execution context, noting that gossiping between tiers and tessellations of the system can aid in ongoing resource declarations and states or that such information may be encoded and communicated alongside a DCG execution graph when prepared by and executed on or sent for distribution by at least one DCG orchestrator within a given federation. It should also be noted that DCG federation members may optionally require end-to-end visibility or resource/compatibility/environmental state assurances or they may delegate authorities for such determinations and dependency graph computations based on user declarations or based on system optimization preferences. This enables different process assurance options for privacy, security and processing flexibility which may be adjusted across different local or global system states, such as primary, alternate, contingent or emergency preferences.

To further enhance adaptability to various operating conditions, the hardware management layer 2800 supports a hybrid cooling architecture integrating multiple advanced cooling technologies. In addition to TCMCs, the system can incorporate liquid immersion cooling for extreme high-density computing environments, two-phase cooling for scenarios requiring rapid heat dissipation, and thermoelectric cooling for localized, precise temperature control. The hardware management layer's sophisticated control algorithms allow for dynamic switching between these cooling modes based on workload characteristics, environmental conditions, and system performance requirements. For example, during periods of moderate load, the system might primarily rely on TCMCs, while transitioning to liquid immersion cooling for sustained high-performance computing tasks, or employing a combination of two-phase cooling and thermoelectric cooling for workloads with rapidly changing thermal profiles. This hybrid approach, orchestrated by the hardware management layer, ensures optimal thermal management across a wide range of operating conditions, from standard data center environments to extreme edge computing scenarios in harsh conditions. By integrating these advanced cooling technologies and employing sophisticated, real-time thermal management strategies, the hardware management layer enables the system to push the boundaries of computing performance while maintaining reliability and efficiency, preventing thermal-induced failures and allowing for more aggressive performance optimization across diverse and demanding workloads.

The federated distributed graph-based computing platform with hardware management demonstrates versatility across various high-stakes scenarios, showcasing its potential to revolutionize complex, data-intensive industries. In healthcare, for instance, the platform enables multiple hospitals, clinics, and research institutions to collaborate on improving diagnostic models for rare diseases while maintaining strict patient data confidentiality. Each healthcare node processes patient data locally, sharing only aggregated model updates or anonymized features with a central hub. This approach allows for the creation of a powerful, global diagnostic model that benefits from diverse datasets without compromising individual patient privacy, adhering to regulations like HIPAA.

In the financial sector, the platform facilitates an approach to fraud detection across competing banks. By leveraging homomorphic encryption and secure multi-party computation, banks can contribute to a shared fraud detection model without exposing sensitive customer transaction data. Each bank maintains local observability of its transactions while participating in a broader, more robust fraud detection network. This collaborative yet secure approach significantly enhances the financial industry's ability to identify and prevent fraudulent activities across institutions.

The platform's capabilities extend to smart city initiatives, where it orchestrates collaboration between various entities such as transportation authorities, environmental monitors, and energy providers. In this context, the system enables cross-domain collaboration without full data visibility. For example, traffic patterns analyzed by transportation agencies can inform air quality predictions made by environmental agencies, all without raw data exchange. This approach allows for comprehensive urban optimization while respecting the privacy constraints of different municipal departments and private companies involved in city management.

In the realm of autonomous vehicles, the platform showcases its ability to handle real-time, safety-critical operations across a network of vehicles from various manufacturers. Each vehicle processes local environmental data, contributing to a global AI model for navigation and safety without sharing raw GPS data or camera feeds. This federated approach allows for rapid improvements in autonomous driving capabilities industry-wide, while maintaining the competitive edge and data privacy of individual manufacturers. The system's ability to dynamically adjust computations based on vehicle hardware capabilities ensures optimal performance across a diverse fleet of autonomous vehicles.

FIG. 28B is a block diagram illustrating an exemplary subsystems architecture for a hardware management layer. Hardware management layer 2800 serves as an interface between the high-level software components of the distributed generative AI reasoning and action platform and its underlying hardware infrastructure.

By leveraging the 2800 hardware management layer, a Through-Chip Microchannel Cooler (TCMC) 2810 fully regulates thermal management. TCMC 2810 may interface directly with distributed computational graph system 1055, allowing for dynamic thermal optimization during complex AI workflows. As the system orchestrates tasks across its network, TCMC 2810 may adjust in real-time, enabling higher performance thresholds that were previously unattainable due to thermal constraints. This capability is advantageous when general transformer service module 1060 or decomposable transformer service module 1050 are handling intensive AI model operations.

Processor manager 2820 and memory manager 2830 work in tandem to create a bridge between the platform's AI models and the available hardware resources. They communicate constantly with general transformer service module 1060, enabling the implementation of hardware-aware transformers (HAT). This allows for on-the-fly adjustments to model architectures based on current hardware capabilities. For instance, during a high-demand period, these processor manager 2820 might reconfigure a large language model to use fewer attention heads, ensuring optimal performance within the available computational constraints.

Simultaneously, memory manager 2830 may support any integrated in-memory computing capabilities inspired by an iMTransformer architecture. It works with multidimensional time series data store 1020 to optimize data placement and access patterns, significantly reducing the data transfer overhead that often bottlenecks AI operations.

Storage manager 2840 extends this data optimization to the broader storage infrastructure. It interfaces with high volume web crawler module 1015 and connector module 1035, ensuring that the vast amounts of data ingested and processed by the system are stored and retrieved efficiently. This becomes particularly important when the system is handling diverse data types for multimodal AI tasks.

Power distribution and environmental control, managed by power distribution manager 2850 and environment controller 2860 respectively, form a feedback loop with TCMC 2810. They work together to maintain an optimal operating environment, dynamically adjusting power allocation and cooling based on the workload demands communicated by distributed computational graph system 1055. This integration ensures that the system can sustain high-performance operations while maintaining energy efficiency.

Peripheral manager 2870 plays a role in expanding the system's capabilities by integrating specialized hardware components. It works in concert with connector module 1035 to incorporate neuromorphic processing units or liquid circuits into the platform's workflow. This allows automated planning service module 1030 to leverage these specialized units for tasks they're best suited for, enhancing the system's ability to handle diverse AI workloads.

Hardware security manager 2880 forms an additional layer of protection that complements the platform's existing security measures. It interfaces with observation and state estimation service 1040 to provide hardware-level security insights. This integration allows for more robust security protocols, combining software-level protections with hardware-based safeguards against potential vulnerabilities.

Through this integration, hardware management layer 2800 creates a dynamic, responsive hardware environment that adapts in real-time to the needs of the AI workloads. It enables the platform to push the boundaries of performance while maintaining efficiency and security, truly embodying the next generation of AI infrastructure.

FIG. 28C is a block diagram illustrating an exemplary subsystem architecture for a component of a distributed generative artificial intelligence reasoning and action platform with an integrated hardware management layer, a through-chip microchannel cooler. Through-Chip Microchannel Cooler (TCMC) 2810 represents a significant advancement in thermal management for high-density computing environments. This subsystem integrates seamlessly with the broader hardware management layer 2800, providing a sophisticated solution to the thermal challenges posed by increasingly powerful and compact AI hardware.

At the core of this subsystem, thermal management system 2811 serves as the central control unit. It interfaces directly with distributed computational graph system 1055, receiving data in real-time or substantially real-time on processing loads and thermal hotspots. In this context, “real-time” encompasses both truly instantaneous data transmission and processing, as well as “substantially real-time” operations. Substantially real-time refers to scenarios where there may be minor, acceptable delays due to system architecture constraints, such as in event-oriented systems where buffering and backpressure modulation can result in variable processing lags. These lags, typically on the order of milliseconds to seconds, are considered acceptable as long as they do not significantly affect the system's ability to respond to thermal events in a timely manner. This definition of real-time allows for dynamic adjustment of cooling strategies based on the current workload distribution across the system's computing units, while acknowledging the practical limitations and variabilities inherent in complex, distributed systems. This interpretation of real-time data collection and response maintains consistency with the system's overall design philosophy and allows for flexibility in implementation across various hardware configurations and operational scenarios.

Pump and circulation system 2812 works in concert with coolant manager 2813 to implement the cooling strategies devised by the thermal management system. These components ensure that coolant is efficiently circulated through the microchannels that permeate the 3D integrated circuits. For instance, when general transformer service module 1060 initiates an intensive AI training task, these systems can increase coolant flow to specific chip areas experiencing higher thermal loads, maintaining optimal operating temperatures.

Power manager 2814 plays a role in balancing cooling performance with energy efficiency. It communicates with the power distribution manager 2850 in the main hardware management layer, ensuring that the cooling system's power consumption is optimized relative to the overall system's energy use. This becomes particularly important during operations that require sustained high performance, such as running complex simulations through action outcome simulation module 1025.

Fault detector 2815 adds a layer of reliability to the cooling system. It continuously monitors the performance of the cooling components, alerting hardware security manager 2880 of any anomalies that could potentially affect system stability. This proactive approach to fault detection helps maintain the integrity of AI operations, particularly during critical tasks managed by automated planning service module 1030.

Integration interface 2816 serves as the primary communication channel between the through-chip microchannel cooler and other components of the hardware management layer. It ensures that cooling operations are coordinated with broader system activities, such as task scheduling by distributed computational graph system 1055 or resource allocation by processor manager 2820.

Cooling optimizer 2817 employs advanced algorithms to continually refine the cooling strategies. It may utilize machine learning techniques to predict thermal patterns based on historical data and current workloads. This predictive capability allows the system to proactively adjust cooling parameters, maintaining optimal thermal conditions even during rapidly changing computational demands.

Configuration manager 2818 allows for flexible adaptation of the cooling system to different hardware configurations. This is particularly valuable when integrating new or specialized hardware components, such as neuromorphic chips or liquid circuits, which may have unique cooling requirements. The configuration manager works closely with peripheral manager 2360 to ensure that these specialized components are adequately cooled without compromising the thermal stability of the overall system.

Data analyzer 2819 processes the vast amount of thermal and performance data generated by the cooling system. It provides valuable insights to observation and state estimation service 1040, contributing to a comprehensive understanding of the system's operational state. This data can be used to inform long-term optimizations of both hardware configurations and AI model architectures.

By integrating these components, TCMC 2810 provides a highly responsive and efficient cooling solution. It enables the distributed generative AI reasoning and action platform to push the boundaries of computational density and performance, supporting advanced AI operations that would be thermally unfeasible with conventional cooling methods. For example, this system could allow for the deployment of highly compact, multi-layered neural network accelerators that operate at clock speeds significantly higher than those achievable with traditional cooling solutions, dramatically enhancing the platform's capability to handle complex, real-time AI tasks.

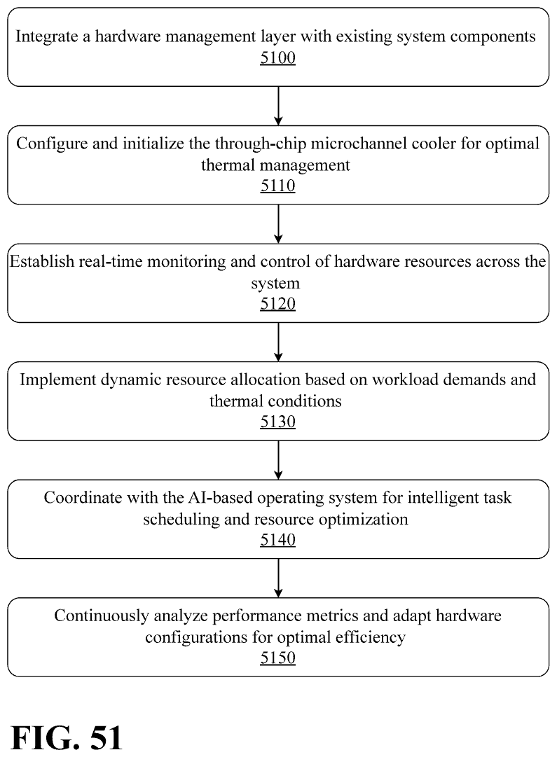

FIG. 51 is a flow diagram illustrating an exemplary method for a distributed generative artificial intelligence reasoning and action platform with an integrated hardware management layer. In a first step 5100, the system integrates a hardware management layer with existing system components of the distributed graph-based computing platform. This integration involves seamlessly incorporating the hardware management layer into the existing architecture, which includes components such as the distributed computational graph system, general transformer service module, and decomposable transformer service module. The hardware management layer acts as an interface between the high-level software components and the underlying hardware infrastructure, enabling more efficient resource utilization and performance optimization.

In a step 5110, the system configures and initializes the through-chip microchannel cooler (TCMC) for optimal thermal management. The TCMC is a critical component of the hardware management layer, designed to address the challenge of cooling high-power electronics in multilayer integrated circuits. It uses microchannels that cross the entire chip perpendicularly to the layers, allowing water to circulate and provide direct cooling to each layer. This step involves setting up the pump and circulation system, configuring the coolant manager, and initializing the thermal management system to ensure efficient heat dissipation across the platform.

In a step 5120, the system establishes real-time monitoring and control of hardware resources across the system. This involves implementing sensors and monitoring tools to track various hardware metrics such as temperature, power consumption, and utilization rates of different components like CPUs, GPUs, and memory units. The hardware management layer uses this real-time data to make informed decisions about resource allocation and thermal management.

In a step 5130, the system implements dynamic resource allocation based on workload demands and thermal conditions. Using the real-time monitoring data, the hardware management layer can dynamically adjust the allocation of computational resources across hardware components. For example, it might redistribute tasks to cooler parts of the system if certain areas are approaching thermal limits, or it could allocate more resources to high-priority tasks while scaling back on less critical operations.

In a step 5140, the system coordinates with the AI-based operating system (AIOS) for intelligent task scheduling and resource optimization. The hardware management layer works in tandem with the AIOS to ensure that tasks are scheduled and resources are allocated in the most efficient manner possible. This coordination takes into account not only the current hardware status but also the specific requirements of AI workloads, such as the needs of large language models or complex simulations.

In a step 5150, the system continuously analyzes performance metrics and adapts hardware configurations for optimal efficiency. This step involves ongoing evaluation of system performance, including factors such as processing speed, energy efficiency, and thermal stability.

Based on this analysis, the hardware management layer can make real-time adjustments to hardware configurations, such as dynamically changing clock speeds, adjusting cooling parameters, or reconfiguring FPGAs for specific tasks. This continuous optimization ensures that the system maintains peak performance and efficiency even as workloads and conditions change over time.

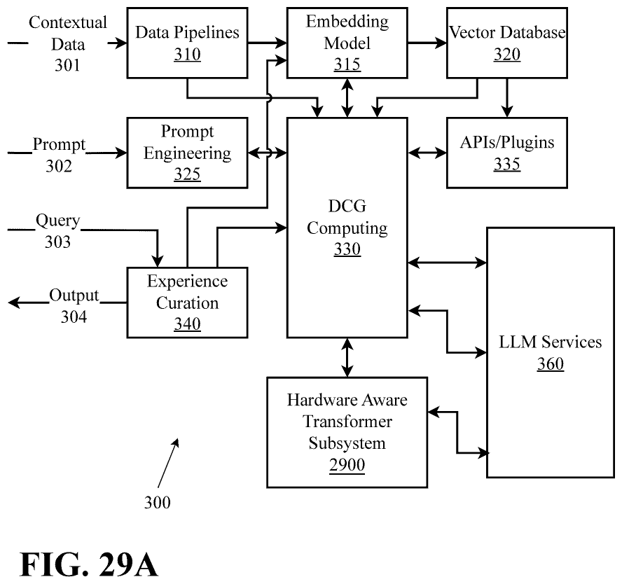

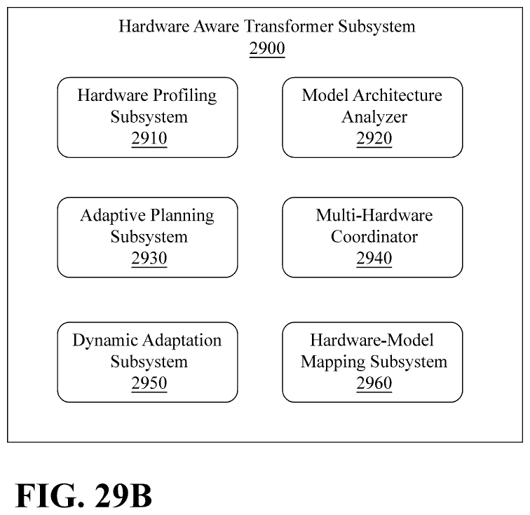

FIG. 29A is a block diagram illustrating an exemplary system architecture for a distributed generative artificial intelligence reasoning and action platform with an integrated hardware aware transformer subsystem. Hardware Aware Transformer (HAT) subsystem 2900 represents a significant advancement in the distributed generative AI reasoning and action platform, seamlessly integrating with existing components to optimize transformer models for specific hardware constraints. This subsystem enhances the platform's ability to adapt AI models to available hardware, improving performance and efficiency across diverse computing environments.

HAT subsystem 2900 interfaces closely with DCG computing 330 component, leveraging the distributed computational graph to orchestrate complex workflows that consider both model architecture and hardware capabilities. This integration allows for dynamic parameter adjustment of transformer models based on real-time hardware availability and performance metrics or model behavior goals (e.g., increasing or decreasing temperature as a simple example). For instance, when the system is operating on edge devices with limited computational resources, HAT subsystem 2900 can automatically adapt the model architecture, reducing the number of attention heads or layers to ensure optimal performance within the given constraints.

HAT subsystem 2900 also interacts intimately with embedding model 315 and vector database 320 components. By understanding the hardware characteristics of these components, it can optimize the embedding process and database queries, ensuring that vectorized representations of contextual data 301 are generated and retrieved in the most hardware-efficient manner. This could involve adjusting the dimensionality of embeddings or the batch size of database operations based on the available memory bandwidth and processing power.

Along with prompt engineering 325 component, HAT subsystem 2900 enables the creation of hardware-aware prompts. These prompts are designed to elicit responses from large language models (LLMs) that are not only contextually relevant but also optimized for the current hardware configuration. For example, when operating on a system with powerful GPUs, the prompts might be engineered to encourage more computationally intensive responses that leverage the available parallel processing capabilities.

HAT subsystem's 2900 integration with experience curation 340 component is particularly noteworthy. It allows for the curation of AI model outputs that are not only contextually appropriate but also optimized for the user's specific hardware environment. This could involve adjusting the length or complexity of generated content based on the processing and display capabilities of the user's device, ensuring a smooth and responsive user experience across a wide range of hardware configurations.

HAT subsystem 2900 works in tandem with APIs/plugins 335 to provide hardware-aware interfaces for external services and tools. This enables the platform to make intelligent decisions about which external resources to leverage based on the current hardware environment, potentially offloading certain tasks to cloud services when local resources are constrained. LLM services 360 benefits significantly from the HAT subsystem's 2900 capabilities. By providing real-time information about hardware constraints and optimizations, the HAT subsystem 2900 enables these services to dynamically adjust their model serving strategies. This could involve techniques such as model quantization, pruning, or even selecting different model variants based on the available hardware resources.

In practice, HAT subsystem 2900 might operate as follows: when a user submits a query 303, the system first analyzes the available hardware resources. Based on this analysis, it selects an appropriate transformer model configuration and optimizes data pipeline 310 for the current hardware environment. As the query is processed through embedding model 315 and vector database 320, the HAT subsystem 2900 continues to monitor and adjust operations for optimal hardware utilization. Finally, when generating output 304, the system ensures that the response is tailored not only to the user's query but also to the capabilities of the user's device.

This holistic integration of the HAT subsystem 2900 across the platform's components enables a new level of hardware-aware AI processing. It allows the system to maintain high performance and efficiency across a diverse range of hardware environments, from resource-constrained edge devices to powerful cloud servers, ultimately providing a more responsive and adaptable AI experience for users.

FIG. 29B is a block diagram illustrating an exemplary subsystem architecture for a component of a distributed generative artificial intelligence reasoning and action platform with an integrated hardware aware transformer subsystem, a hardware aware transformer subsystem. HAT subsystem 2900 acts as a sophisticated intermediary between the platform's AI models and its hardware infrastructure, dynamically optimizing the deployment and execution of transformer models based on available resources. This subsystem interweaves with multiple components of the existing architecture, creating a seamless blend of software intelligence and hardware awareness.

At its foundation, hardware profiling subsystem 2910 establishes a continuous dialogue with hardware management layer 2800. It ingests real-time data on the status and capabilities of various hardware components, from CPUs and GPUs to more specialized units like neuromorphic chips or liquid circuits. This constant stream of hardware intelligence feeds into the broader decision-making processes of the HAT subsystem. Model architecture analyzer 2920 works in concert with general transformer service module 1060 and the decomposable transformer service module 1050. As these modules prepare to deploy transformer models, the analyzer scrutinizes their architectures, identifying potential optimizations. This process is not static but highly dynamic, with the analyzer constantly reassessing model structures in light of the latest hardware profiles provided by the hardware profiling subsystem.

Bridging the gap between hardware capabilities and model requirements, hardware-model mapping subsystem 2960 interfaces closely with distributed computational graph system 1055. It translates the abstract model architectures into concrete execution plans, considering the nuanced capabilities of available hardware. This mapping process informs the construction of the computational graphs, ensuring that each operation is assigned to the most suitable hardware component.

Adaptive planning subsystem 2930 extends this integration, working hand-in-hand with automated planning service module 1030. It incorporates hardware awareness into the broader strategic planning of AI workloads. For instance, when the system anticipates a surge in user queries based on historical data, the adaptive planning subsystem might preemptively reconfigure models to better utilize available hardware, ensuring responsive performance during peak times.

In scenarios involving diverse computing resources, the multi-hardware coordinator 2940 becomes an orchestrator between various components. It collaborates with the connector module 1035, ensuring data flow between heterogeneous hardware components. This coordination extends to the peripheral manager 2870, allowing for the seamless integration of specialized hardware into complex AI workflows. Dynamic adaptation subsystem 2950 serves as the reactive core of HAT subsystem 2900, constantly monitoring and adjusting model deployments. It maintains an ongoing dialogue with observation and state estimation service 1040, using real-time performance data to fine-tune model configurations. This subsystem also interfaces with action outcome simulation module 1025, running rapid simulations to predict the impact of potential adaptations before applying them.

In practice, this integrated system operates as follows: when a user submits a query through experience curation 340 component, it triggers a cascade of interactions within the HAT subsystem 2900. Hardware profiling subsystem 2910 assesses the current state of available resources. Simultaneously, model architecture analyzer 2920 evaluates the transformer models best suited for the query, considering their structural characteristics.

Hardware-model mapping subsystem 2960 then swings into action, determining the optimal way to deploy the chosen model across the available hardware. This mapping is passed to adaptive planning subsystem 2930, which develops a comprehensive execution strategy, considering not just the immediate query but also anticipated future workloads. If the query requires diverse computational resources, multi-hardware coordinator 2940 ensures that operations are distributed efficiently across different types of hardware, from GPUs handling dense matrix operations to neuromorphic chips managing certain sparse computations.

Throughout this process, dynamic adaptation subsystem 2950 stands ready to adjust the deployment in real-time. It might, for instance, dynamically increase the model's complexity if additional GPU resources suddenly become available, or scale back operations if thermal constraints are detected through Through-Chip Microchannel Cooler 2810. This holistic integration allows the HAT subsystem 2900 to create a symbiotic relationship between the platform's AI capabilities and its hardware infrastructure. It enables the system to fluidly adapt its operations to the specific hardware environment, whether it's a resource-constrained edge device or a powerful cloud server. The result is a highly responsive and efficient AI system that can deliver optimal performance across a wide spectrum of hardware configurations, truly embodying the next generation of adaptive AI infrastructure.

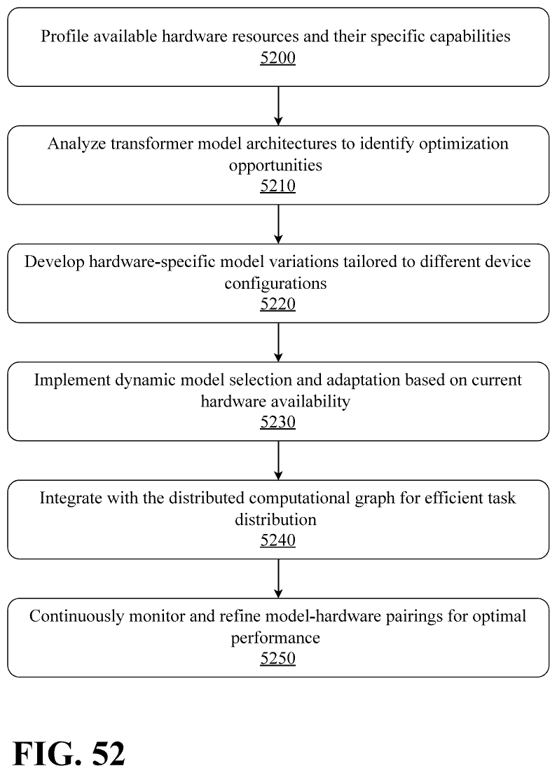

FIG. 52 is a flow diagram illustrating an exemplary method for a distributed generative artificial intelligence reasoning and action platform with an integrated hardware aware transformer subsystem. In a first step 5200, the system profiles available hardware resources and their specific capabilities. This involves a comprehensive assessment of the diverse hardware components within the distributed AI platform, including GPUs, CPUs, specialized AI accelerators, and any neuromorphic processing units. The profiling process captures detailed information about each component's processing power, memory capacity, energy efficiency, and unique features. For example, it might identify the specific capabilities of NVIDIA GPUs like the Blackwell architecture, or custom hardware accelerators optimized for transformer operations.

In a step 5210, the system analyzes transformer model architectures to identify optimization opportunities. This step involves a deep examination of various transformer architectures, considering factors such as model size, attention mechanisms, and computational requirements. The system looks for areas where the model can be optimized to better leverage the specific hardware capabilities identified in the previous step. This might include identifying operations that could be more efficiently executed on certain types of processors or finding opportunities for parallelization.

In a step 5220, the system develops hardware-specific model variations tailored to different device configurations. Based on the analysis from the previous steps, the system creates multiple versions of the transformer models, each optimized for specific hardware setups. This involves a wide range of adjustments and optimizations, far beyond what is typically configured manually by OEMs or enthusiasts. The system can dynamically modify model architecture parameters, such as the number of attention heads, layers, or hidden units. It delves deep into memory-related optimizations, including DRAM timing adjustments like CAS latency, RAS to CAS delay, and row precharge time, which are typically only accessible via BIOS tweaking. CPU-specific settings are also within its purview, allowing for adjustments to cache prefetch policies, branch prediction aggressiveness, or instruction reordering depths. For GPUs, the system can fine-tune core and memory clock speeds, power limits, and cache allocation policies.

The system's capabilities extend to advanced system-level optimizations, such as Nodes Per Socket (NPS) or Sub-NUMA Clustering (SNC) configurations, which can significantly impact performance in multi-chip module processors. It can also manage interconnect-related settings, adjusting parameters like PCIe lane allocation or NVLink bandwidth distribution in multi-GPU setups. What sets this system apart is its ability to perform these optimizations on an ongoing basis, continuously adapt to changing resource requirements and environmental conditions. Unlike manual tuning, which is static and requires expert knowledge, this system can adjust these parameters in real-time based on workload characteristics, thermal conditions, and overall system performance metrics. For instance, it might dynamically adjust DRAM timings to optimize for bandwidth or latency depending on the current phase of model training or inference, or modify SNC configurations to balance between single-thread performance and multi-threaded scalability as the workload changes. This level of dynamic, fine-grained optimization across hardware configurations allows the system to extract maximum performance from the available hardware, adapting to the specific needs of different AI workloads and environmental conditions in ways that far surpass traditional static optimizations or even manual enthusiast-level tuning.

FIG. 22 is a block diagram illustrating an exemplary system architecture for a federated distributed graph-based computing platform. The system comprises a centralized DCG 2240 that coordinates with a plurality of federated DCGs 2200, 2210, 2220, and 2230, each representing a semi-independent computational entity.

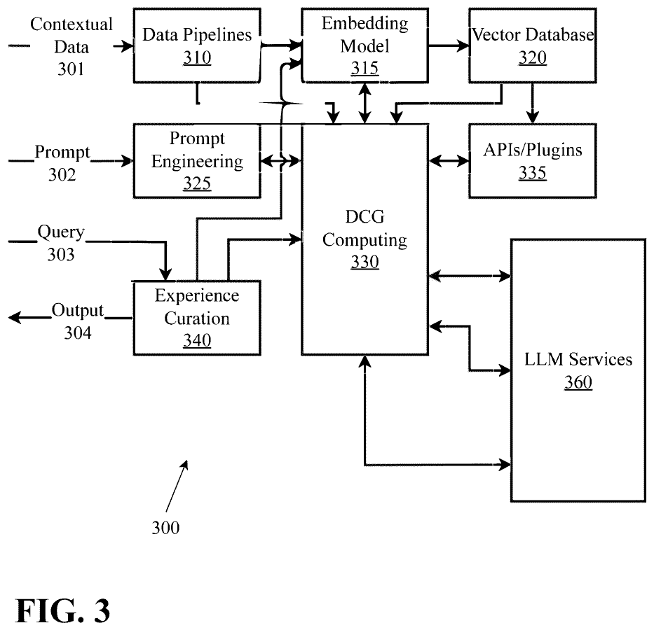

The interaction between federated units in this system represents one of several possible architectural patterns for coordinating distributed computing tasks. The federated architecture supports multiple implementation approaches, with centralized DCG 2240 representing just one possible configuration. In a peer-to-peer federation pattern, DCGs can operate in a fully decentralized manner, discovering and coordinating with each other through gossip protocols, where each DCG advertises its capabilities and available resources to peers, and workloads are distributed through direct DCG-to-DCG communication without central coordination. For bot-to-bot federation scenarios, each DCG can act as an interface to specific user requests or tasks, with DCGs discovering peer capabilities through gossip protocols and matching tasks to capabilities through autonomous selection. This coordination may be implemented through industry standard communication protocols including but not limited to gossip-like consensus algorithms, the Zookeeper Atomic Broadcast (ZAB) protocol, the Raft consensus algorithm and associated communication model in KRaft, or other protocols or consensus algorithms like Paxos, or serverless implementations like FaasKeeper. DCGs within a federation may communicate context and state as much or as little as needed to accomplish job objectives and to enable potential tiers or tessellations of resource pools to compete for processing and task roles and for pipeline definition, context and state updates. This approach supports execution of data flows and orchestration of resources across cloud (e.g., hyperscale), self-managed (e.g., traditional data center) compute clusters, CDNs, edge devices, wearables and mobile devices, and individual computers where computational graph specifications may also be communicated between different people, processes, AI agents and collections of logical or hardware resources. When implemented as a centralized federation, as shown with DCG 2240, it may maintain a high-level view of resources and processes similar to syndication patterns in enterprise architecture, though with limited visibility into internal DCG operations. For instance, in this pattern, task distribution may be facilitated by the centralized DCG 2240, but the fundamental capabilities for autonomous operation remain distributed across the federation, allowing each DCG to maintain independent control over its resources and processing decisions. In one embodiment, centralized DCG 2240 oversees the distribution of workloads across the federated system, maintaining a high-level view of available resources and ongoing processes. In some embodiments, centralized DCG 2240 may not have full visibility or control over the internal operations of each federated DCG. Each DCG system involved in the federated DCG platform may be represented by the system 300 as depicted in FIG. 3.

Each federated DCG (2200, 2210, 2220, 2230) operates as a semi-autonomous unit. These federated DCGs have their own internal structure, similar to the DCG depicted in FIG. 3. In one embodiment, each federated DCG communicates through pipelines that extend across multiple systems, facilitating a flexible and distributed workflow. The pipeline orchestrator P.O. 1201 serves as a conduit for task delegation from the DCG 2240 to the federated DCGs. Each federated DCG (2200, 2210, 2220, 2230) operates as a fully autonomous unit with complete capability to function independently within the federation. These federated DCGs have their own internal structure, similar to the DCG depicted in FIG. 3, and can operate without requiring central coordination. The federated DCGs communicate through pipelines that extend across multiple systems, enabling flexible and distributed workflows through various architectural patterns. In one implementation, DCGs can directly advertise and coordinate tasks with other DCGs in the federation without central mediation, where the pipeline orchestrator P.O. 1201 in each DCG manages task distribution and execution locally while coordinating with peer DCGs through federation protocols. These pipelines may span any number of federated systems, with a plurality of pipeline managers (P.M. A 1211a, P.M. B 1211b, etc.) overseeing different segments or aspects of the workflow based on whether the federation is operating in peer-to-peer, hierarchical, or hybrid patterns. Federated DCGs interact with corresponding local service clusters 1220a-d and associated Service Actors 1221a-d to execute tasks represented by services 1222a-d, allowing for efficient local processing while maintaining flexible connections to the broader federated network through whichever federation pattern best suits the current needs. While a centralized orchestration through DCG 2240 may be implemented in some scenarios, it represents just one possible configuration rather than a requirement of the federation architecture. These pipelines may span any number of federated systems, with a plurality of pipeline managers (P.M. A 1211a, P.M. B 1211b, etc.) overseeing different segments or aspects of the workflow. Federated DCGs interact with corresponding local service clusters 1220a-d and associated Service Actors 1221a-d to execute tasks represented by services 1222a-d, allowing for efficient local processing while maintaining a connection to the broader federated network.

Centralized DCG 2240 may delegate resources and projects to federated DCGs via the pipeline orchestrator P.O. 1201, which then distributes tasks along the pipeline structure. This hierarchical arrangement allows for dynamic resource allocation and task distribution across the federation. Pipelines can be extended or reconfigured to include any number of federated systems, adapting to the complexity and scale of the computational tasks at hand.

Federated DCGs 2200, 2210, 2220, and 2230 may take various forms, representing a diverse array of computing environments. They may exist as cloud-based instances, leveraging the scalability and resources of cloud computing platforms. Edge computing devices can also serve as federated DCGs, bringing computation closer to data sources and reducing latency for time-sensitive operations. Mobile devices, such as smartphones or tablets, can act as federated DCGs, contributing to the network's processing power and providing unique data inputs. Other forms may include on-premises servers, IoT devices, or even specialized hardware like GPUs or TPUs. This heterogeneity allows the federated DCG platform to adapt to various computational needs and take advantage of diverse computing resources, creating a robust and versatile distributed computing environment.

In this federated system, workloads can be distributed across different federated DCGs based on a plurality of factors such as but not limited to resource availability, data locality, privacy requirements, or specialized capabilities of each DCG. Centralized DCG 2240 may assign entire pipelines or portions of workflows to specific federated DCGs, which then manage the execution internally. Communication between centralized DCG 2240 and federated DCGs, as well as among federated DCGs themselves, may occur through the pipeline network which is being overseen by the plurality of pipeline managers and the pipeline orchestrator P.O. 1201.

The interaction between federated units, the centralized unit, and other federated units in this system may be partially governed by privacy specifications, security requirements, and the specific needs of each federated unit. The interaction between federated DCGs in this system is governed by self-enforced privacy specifications, security requirements, and the specific operational needs of each federated unit. Each DCG autonomously manages its privacy and security constraints while participating in the federation. For example, a DCG processing healthcare data can maintain internal mapping tables for data anonymization, transform sensitive data using temporary IDs before sharing, and control data visibility without requiring other DCGs to be aware of the underlying privacy measures. In one embodiment, DCGs advertise their operational requirements to the federation, such as geographic processing restrictions (e.g., EU-only data processing), security clearance requirements, and regulatory compliance certifications. When assigning or accepting tasks, each DCG independently evaluates and enforces its privacy and security controls based on its declared capabilities. For instance, a DCG might autonomously determine whether to process sensitive healthcare data based on its certifications and security measures, without requiring central coordination. While a centralized DCG 2240 may exist in some implementations to facilitate coordination, the fundamental privacy and security controls remain distributed across the federated DCGs, enabling flexible and secure collaboration through self-managed privacy controls and peer-based task distribution. DCG 2240 may manage the overall workflow distribution while respecting privacy and security constraints. In one embodiment, DCG 2240 may be centralized and maintain a high-level view of the system but may have limited insight into the internal operations of each federated DCG. When assigning tasks or pipelines, DCG 2240 may consider the privacy specifications associated with the data and the security clearance of each federated DCG. For instance, it might direct sensitive healthcare data only to federated DCGs with appropriate certifications or security measures in place.

Federated DCGs (2200, 2210, 2220, 2230) may interact with the DCG 2240 and each other based on predefined rules and current needs. A federated DCG might request additional resources or specific datasets from other DCGs 2240, which would then evaluate the request against security protocols before granting access. In cases where direct data sharing between federated DCGs is necessary, DCG 2240 may facilitate this exchange, acting as an intermediary to ensure compliance with privacy regulations. The level of information sharing between federated DCGs can vary. Some units might operate in isolation due to strict privacy requirements, communicating only with DCG 2240. Others might form collaborative clusters, sharing partial results or resources as needed. For example, federated DCG 2200 might share aggregated, anonymized results with federated DCG 2210 for a joint analysis, while keeping raw data confidential.

DCG 2240 may implement a granular access control system, restricting information flow to specific federated DCGs based on the nature of the data and the task at hand. It may employ techniques like differential privacy or secure multi-party computation to enable collaborative computations without exposing sensitive information. In scenarios requiring higher security, DCG 2240 may create temporary, isolated environments where select federated DCGs can work on sensitive tasks without risking data leakage to the broader system. This federated approach allows for a balance between collaboration and privacy, enabling complex, distributed computations while maintaining strict control over sensitive information. The system's flexibility allows it to adapt to varying privacy and security requirements across different domains and use cases, making it suitable for a wide range of applications in heterogeneous computing environments.

In another embodiment, a federated DCG may enable an advanced data analytics platform to support non-experts in machine-aided decision-making and automation processes. Users of this system may bring custom datasets which need to be automatically ingested by the system, represented appropriately in nonvolatile storage, and made available for system-generated analytics to respond to with questions the user(s) want to have answered or decisions requiring recommendations or automation. In this case the DCG orchestration service would create representations of DCG processes that have nodes that each operate on the data to perform various structured extraction tasks, to include schematization, normalization and semantification activities, to develop an understanding of the data content via classification, embedding, chunking, and knowledge base construction and vector representation persistence and structured and unstructured data view generation and persistence, and may also smooth, normalize or reject data as required to meet specified user intent. Users may optionally be asked to provide feedback, e.g. via layperson content and subsequent interpretation by LLM re: the generated tasks or DCG pipelines generated, or in expert or power user modes access or view or modify actual declarative formulations of pipelines or transformation tasks. Based on the outcome of the individual transformation steps and various subgraph pipeline execution and analysis additional data may be added over time or can be accessed from either a centralized data repository, or enriched via ongoing collection from one or more live sources. Data made available to the system can then be tagged and decomposed or separated into multiple sets for training, testing, and validation via pipelines or individual transformation stages. A set of models must then be selected, trained, and evaluated before being presented to the user, which may optionally leverage data and algorithm marketplace functionality. This step of model selection, training, and evaluation can be run many times to identify the optimal combination of input dataset(s), selected fields, dimensionality reduction techniques, model hyper parameters, embeddings, chunking strategies, or blends between use of raw, structured, unstructured, vector and knowledge corpora representations of data for pipelines or individual transformation nodes. The ongoing search and optimization process engaged in by the system may also accept feedback from a user and take new criteria into account such as but not limited to changes in budget that might impact acceptable costs or changes in timeline that may render select techniques or processes infeasible. This may mean system must recommend or select a new group of models, adjusting how training data was selected, or how the model outputs are evaluated or otherwise adjust DCG pipelines or transformation node declarations according to modified objective functions which enable comparative ranking (e.g. via score, model or user feedback or combination) of candidate transformation pipelines with resource and data awareness. The user doesn't need to know the details of how models are selected and trained, but can evaluate the outputs for themselves and view ongoing resource consumption, associated costs and forward forecasts to better understand likely future system states and resource consumption profiles. Based on outputs and costs, they can ask additional questions of the data and have the system adjust pipelines, transformations or parameters (e.g. model fidelity, number of simulation runs, time stepping, etc . . . ) as required in real time for all sorts of models including but not limited to numerical methods, discrete event simulation, machine learning models or generative AI algorithms

According to another embodiment, a federated DCG may enable advanced malware analysis by accepting one or more malware samples. Coordinated by the DCG, the system may engage in running a suite of preliminary analysis tools designed to extract notable or useful features of any particular sample, then using this information to select datasets and pretrained models developed from previously observed samples. The DCG can have a node to select a new model or models to be used on the input sample(s), and using the selected context data and models may train this new model. The output of this new model can be evaluated and trigger adjustments to the input dataset or pretrained models, or it may adjust the hyperparameters of the new model being trained. The DCG may also employ a series of simulations where the malware sample is detonated safely and observed. The data collected may be used in the training of the same or a second new model to better understand attributes of the sample such as its behavior, execution path, targets (e.g., what operating systems, services, networks is it designed to attack), obfuscation techniques, author signatures, or malware family group signatures.

According to an embodiment, a DCG may federate and otherwise interact with one or more other DCG orchestrated distributed computing systems to split model workloads and other tasks across multiple DCG instances according to predefined criteria such as resource utilization, data access restrictions and privacy, compute or transport or storage costs et cetera. It is not necessary for federated DCGs to each contain the entire context of workload and resources available across all federated instances and instead may communicate, through a gossip protocols or gossip-like consensus algorithms, communications protocols (e.g., the Zookeeper Atomic Broadcast (ZAB) protocol at the core of Zookeeper, the Raft consensus algorithm and associated communication model in KRaft, or other protocols or consensus algorithms like Paxos, or serverless implementations like FaasKeeper), to collectively assign resources and parts of the model workload across the entire federation. DCGs within a federation may communicate context and state as much or little as needed to accomplish job objectives and to enable potential tiers or tessellations of resource pools to compete for processing and task roles and for pipeline definition, context and state updates. In this way it is possible for a local private DCG instance to use resources from a cloud based DCG, owned by a third party for example, while only disclosing the parts of the local context (e.g. resources available, DCG state, task and model objective, data classification), as needed. This enables flexible and scalable integration of statistical, machine learning and artificial intelligence and simulation models into software applications, supported by a dynamic and adaptive federated DCG architecture that supports execution of data flows and orchestration of resources across cloud (e.g., hyperscale), self-managed (e.g., traditional data center) compute clusters, CDNs (e.g., forward content distribution networks that may expand from historical distribution of web content into forward hosting of data sets, models, AI tools, etc . . . ), edge devices, wearables and mobile devices, and individual computers. For example, with the rise of edge computing for AI tasks a federated DCG could offload all or parts computationally intensive tasks from a mobile device to cloud compute clusters to more efficiently use and extend battery life for personal, wearable or other edge devices. According to another embodiment, workloads may be split across the federated DCG based on data classification. For example, only process Personally identifiable information (PII) or Protected Health Information (PHI) on private compute resources, but offload other parts of the workload, with less sensitive data, to public compute resources (e.g. those meeting certain security and transparency requirements).

In an embodiment, the federated distributed computational graph (DCG) system enables a sophisticated approach to distributed computing, where computational graphs are encoded and communicated across devices alongside other essential data. This data may include application-specific information, machine learning models, datasets, or model weightings. The system's design enables rapid and low effort or automated integration of diverse computational resources with probabilistic availability, reliability, security, privacy or compliance characteristics.

The federated DCG facilitates system-wide execution with a unique capability for decentralized and partially blind execution across various tiers and tessellations of computing resources. This architecture renders partially observable, collaborative, yet decentralized and distributed computing possible for complex processing and task flows. The system employs a multi-faceted approach to resource allocation and task distribution, utilizing rules, scores, weightings, market/bid mechanisms, or optimization and planning-based selection processes. These selection methods can be applied at local, regional, or global levels within the system, where “global” refers to the entirety of the interconnected federated DCG network, regardless of the physical location or orbital position of its components.

This approach to federated computing allows for unprecedented flexibility and scalability. It can adapt to the unique challenges posed by diverse computing environments, from traditional terrestrial networks to the high-latency, intermittent connections characteristic of space-based systems. The ability to operate with partial blindness and decentralized execution is particularly valuable in scenarios where complete information sharing is impossible or undesirable due to security concerns, bandwidth limitations, or the physical constraints of long-distance space communications.

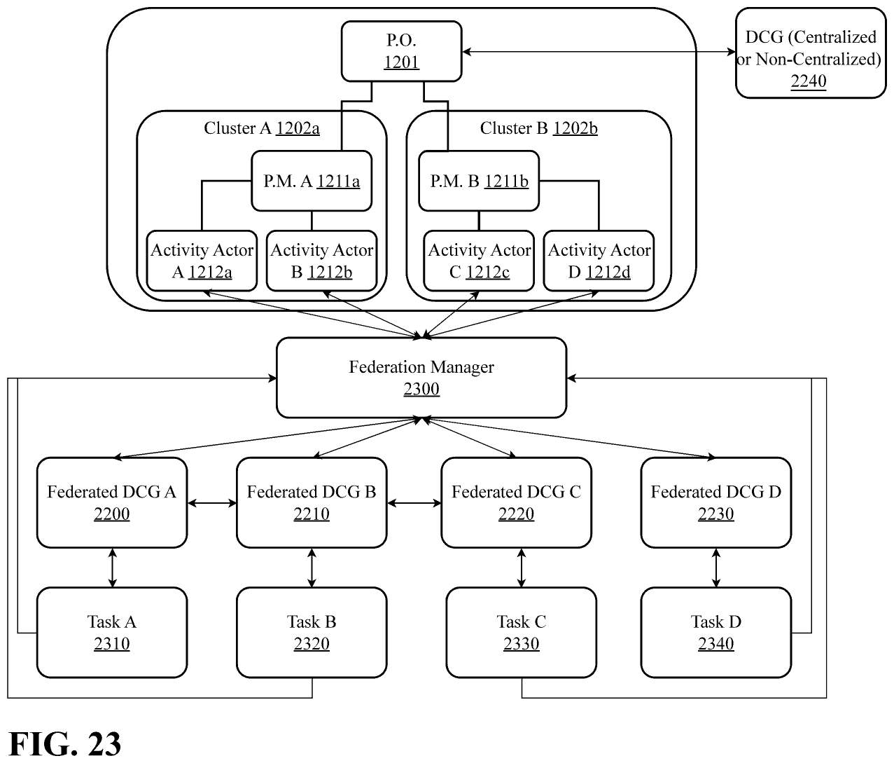

FIG. 23 is a block diagram illustrating an exemplary system architecture for a federated distributed graph-based computing platform that includes a federation manager. In one embodiment, a federation manager 2300 serves as an intermediary between the DCG 2240 and the federated DCGs (2200, 2210, 2220, 2230), providing a more sophisticated mechanism for orchestrating the federated system. It assumes some of the coordination responsibilities previously handled by the centralized DCG, allowing for more nuanced management of resources, tasks, and data flows across the federation. In this structure, DCG 2240 communicates high-level directives and overall system goals to the federation manager 2300. The Federation manager 2300 may be specified or dynamically elected from the participating DCGs. The Federation manager 2300 may be implemented through several different embodiments for leader election and management. In one embodiment, the system uses a gossip-based ring management similar to Riak Core, where participating DCGs form a ring structure and use gossip protocols to maintain and update cluster state information. This approach enables decentralized leader election while also sharing observability data about available resources, including CPU/GPU capabilities.

In another embodiment, the system implements a coordinated leader election mechanism similar to Kubernetes' approach, where election occurs across a tier or tessellation of resources. This implementation includes sharing of resource descriptions and operational metrics during the election process, allowing for informed selection of federation managers based on both node capabilities and current resource states. In another embodiment, the system utilizes a ZooKeeper-style quorum based approach for leader election and state management. This approach maintains consistency through distributed consensus while enabling the sharing of detailed resource descriptions and operational metrics across the federation. Additionally, the system may implement an Elasticsearch-style discovery and voting mechanism, where nodes participate in master election while simultaneously sharing information about their processing capabilities, security clearances, and available resources. This approach combines leader election with dynamic resource discovery and state management. In each embodiment, the gossiping protocol and leader election process, whether process-centric, tier-centric, or tessellation-centric, includes mechanisms for sharing observability data and detailed resource descriptions. This includes but is not limited to information about types of processes nodes can handle, available CPU/GPU resources, memory and storage capabilities, network bandwidth and latency metrics, security standards and privacy certifications, current resource utilization levels, and historical performance metrics. This rich metadata enables more intelligent federation management and resource allocation decisions while maintaining appropriate security and privacy boundaries.

Federation manager 2300 may then translate these directives into specific actions and assignments for each federated DCG, taking into account their individual capabilities, current workloads, and privacy requirements. Additionally, federation manager 2300 may also operate in the reverse direction, aggregating and relaying information from federated DCGs back to DCG 2240. This bi-directional communication allows federation manager 2300 to provide real-time updates on task progress, resource utilization, and any issues or anomalies encountered within the federated network. By consolidating and filtering this information, federation manager 2300 enables centralized DCG 2240 to maintain an up-to-date overview of the entire system's state without being overwhelmed by low-level details. This two-way flow of information facilitates adaptive decision-making at the centralized level while preserving the autonomy and efficiency of individual federated DCGs, ensuring a balanced and responsive federated computing environment

In an embodiment, federation manager 2300 may be connected to a plurality of pipeline manager 1211a and 1211b, which are in turn connected to a pipeline orchestrator 1201. This connection allows for the smooth flow of information between each of the various hierarchies, or tessellations, within the system. Federation manager 2300 may also oversee the distribution and execution of tasks 2310, 2320, 2330, 2340 across the federated DCGs. It can break down complex workflows into subtasks, assigning them to appropriate federated DCGs based on their specializations, available resources, and security clearances. This granular task management allows for more efficient utilization of the federated system's resources while maintaining strict control over sensitive operations.

Federation manager 2300 may allocate tasks and transmit information in accordance with privacy and security protocols. It may act as a gatekeeper, controlling the flow of information between federatAed DCGs and ensuring that data sharing complies with predefined privacy policies. For instance, it could facilitate secure multi-party computations, allowing federated DCGs to collaborate on tasks without directly sharing sensitive data. Federation manager 2300 may also enable more dynamic and adaptive resource allocation. It can monitor the performance and status of each federated DCG in real-time, reallocating tasks or resources as needed to optimize overall system performance. This flexibility allows the system to respond more effectively to changing workloads or unforeseen challenges.

By centralizing federation management functions, this architecture provides a clearer separation of concerns between global coordination (handled by centralized DCG 2240) and local execution (managed by individual federated DCGs). This separation enhances the system's scalability and makes it easier to integrate new federated DCGs or modify existing ones without disrupting the entire federation.

In one embodiment, the federated DCG system can be applied to various real-world scenarios. In healthcare, multiple hospitals and research institutions can collaborate on improving diagnostic models for rare diseases while maintaining patient data confidentiality. Each node (hospital or clinic) processes patient data locally, sharing only aggregated model updates or anonymized features, allowing for the creation of a global diagnostic model without compromising individual patient privacy. In financial fraud detection, competing banks can participate in a collaborative initiative without directly sharing sensitive customer transaction data. The system enables banks to maintain local observability of their transactions while contributing to a shared fraud detection model using techniques like homomorphic encryption or secure multi-party computation. For smart city initiatives, the system allows various entities (e.g., transportation authorities, environmental monitors, energy providers) to collaborate while respecting data privacy. Each entity processes its sensor data locally, with the system orchestrating cross-domain collaboration by enabling cross-institution model learning without full observability of the underlying data.

In one embodiment, the federated DCG system is designed to support partial observability and even blind execution across various tiers and tessellations of computing resources. This architecture enables partially observable, collaborative, yet decentralized and distributed computing for complex processing and task flows. The system can generate custom compute graphs for each federated DCG, specifically constructed to limit information flow. A federated DCG might receive a compute graph representing only a fraction of the overall computation, with placeholders or encrypted sections for parts it should not access directly. This allows for complex, collaborative computations where different parts of the system have varying levels of visibility into the overall task. For instance, a federated DCG in a highly secure environment might perform critical computations without full knowledge of how its output will be used, while another might aggregate results without access to the raw data they're derived from.

In one embodiment, the federated DCG system is designed to seamlessly integrate diverse computational resources, ranging from edge devices to cloud systems. It can adapt to the unique challenges posed by these varied environments, from traditional terrestrial networks to high-latency, intermittent connections characteristic of space-based systems. The system's ability to operate with partial blindness and decentralized execution is particularly valuable in scenarios where complete information sharing is impossible or undesirable due to security concerns, bandwidth limitations, or physical constraints of long-distance communications. This flexibility allows the system to efficiently manage workloads across a spectrum of computing resources, from mobile devices and IoT sensors to edge computing nodes and cloud data centers.

In one embodiment, the system employs a multi-faceted approach to resource allocation and task distribution, utilizing rules, scores, weightings, market/bid mechanisms, or optimization and planning-based selection processes. These selection methods can be applied at local, regional, or global levels within the system. This approach allows the federated DCG to dynamically adjust to varying privacy and security requirements across different domains and use cases. For example, the system can implement tiered observability, where allied entities may have different levels of data-sharing access depending on treaties or bilateral agreements. This enables dynamic privacy management, allowing the system to adapt to changing regulatory landscapes or shifts in data sharing policies among collaborating entities.

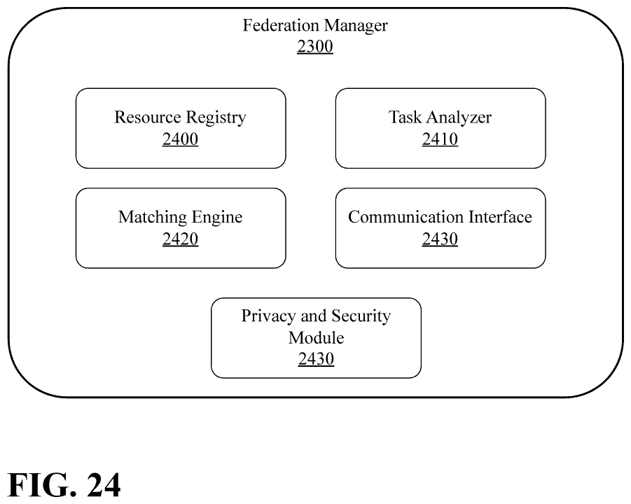

FIG. 24 is a block diagram illustrating an exemplary component of a federated distributed graph-based computing platform that includes a federation manager, the federation manager. In one embodiment, a resource registry 2400 maintains a dynamic inventory of available resources across all federated DCGs. This may be accomplished by periodically polling each federated DCG for updates on their computational capacity, storage availability, and current workload. This information is stored in a structured database, allowing for quick querying and analysis. The registry may use a gossip protocol to efficiently propagate updates across the federation, ensuring that resource information remains current even in large-scale deployments.

A task analyzer 2410 examines incoming tasks from the centralized DCG 2240 or from federated DCGs, breaking them down into subtasks and determining their requirements. It achieves this by parsing task descriptions, which may be encoded in a domain-specific language, and creating a directed acyclic graph (DAG) representing the task's structure and dependencies. The analyzer may also provide estimates regarding resource requirements for each subtask based on historical data and predefined heuristics.

A matching engine 2420 aligns tasks with appropriate federated DCGs by cross-referencing task requirements from task analyzer 2410 with available resources that have been documented by resource registry 2400. In one embodiment, matching engine may employ algorithms such as constraint satisfaction solvers or machine learning models, to optimize task distribution. The engine 2420 considers factors such as but not limited to data locality, processing power requirements, and privacy constraints when making matching decisions. It may use a scoring system to rank potential matches, selecting the highest-scoring options for task assignment.

A communication interface 2430 facilitates secure and efficient information exchange between federation manager 2300, centralized DCG 2240, and federated DCGs. It implements various communication protocols (e.g., gRPC, MQTT) to accommodate different network conditions and security requirements. The interface may encrypt data transfers and may employ techniques like zero-knowledge proofs for sensitive communications, allowing entities to verify information without revealing underlying data.

A privacy and security module 2440 enforces data protection policies across the federation. It achieves this by maintaining a set of rules and permissions for each federated DCG and task. When a task is assigned, this module checks the security clearance of the target federated DCG against the task's requirements. It may implement differential privacy techniques, adding controlled noise to data or results to prevent the extraction of individual information. For collaborative tasks, it could set up secure multi-party computation protocols, enabling federated DCGs to jointly compute results without sharing raw data.

In a decentralized, blind or double blind embodiment, DCG 2240 encodes high-level computational tasks into graphs that can be distributed across the federation. However, unlike traditional distributed systems, these graphs are designed to be partitioned and obscured, allowing for partial or even blind execution. Federation manager 2300 receives computational graphs from DCG 2240, and breaks down the graphs into subtasks which are designed to be executable with limited context. Matching engine 2420 then allocates these subtasks to federated DCGs 2200, 2210, 2220, 2230 based not just on their capabilities, but also on their clearance levels and need-to-know basis.

For each federated DCG, the system may generate a custom compute graph. These graphs are not merely simplified versions of the original, but are specifically constructed to limit information flow. A federated DCG might receive a compute graph that represents only a fraction of the overall computation, with placeholders or encrypted sections representing parts of the computation it should not have direct access to. Communication interface 2430 securely transmits these tailored compute graphs to the federated DCGs through the pipeline structure 1201. This transmission process itself can incorporate encryption and access control mechanisms to maintain the partial blindness of the execution.

Within each federated DCG, the activity actors 1212a-d perform computations based on their received graph, potentially without full knowledge of the overall task they're contributing to. This blind or partially blind execution may be managed by the local pipeline orchestrator 1201, which ensures that each component only accesses the information it's cleared for. The system's ability to operate with partial observability comes into play as computations progress.

Federated DCGs report results back through the pipeline structure, but these results may be encrypted or obfuscated to maintain partial blindness. This architecture allows for complex, collaborative computations where different parts of the system have varying levels of visibility into the overall task. For instance, a federated DCG in a highly secure environment might perform critical computations without full knowledge of how its output will be used, while another federated DCG might aggregate results without access to the raw data they're derived from.

By enabling this decentralized, partially blind execution, the federated DCG system can tackle complex computational tasks that span entire networks, while maintaining strict control over information flow and resource utilization. This approach is particularly valuable for scenarios involving sensitive data, limited communication bandwidth, or the need for compartmentalized computing across vast distances in space.

In one embodiment, the system implements dynamic task allocation based on real-time conditions and changing requirements. As computations progress, each federated DCG reports back through the pipeline structure, providing feedback on task progress, resource utilization, and any issues encountered. The federation manager aggregates this information, providing a high-level overview of the system's state. Based on this real-time feedback, the system can dynamically adjust compute graphs and task allocations. It might modify compute graphs in real-time, reassign tasks to different federated nodes, or adjust resource allocations in response to changing workloads or unforeseen challenges. This adaptive process ensures efficient utilization of resources across the entire federated system, from terrestrial networks to space-based computing nodes, allowing the system to respond effectively to changing conditions and requirements in real-time while maintaining security and efficiency.

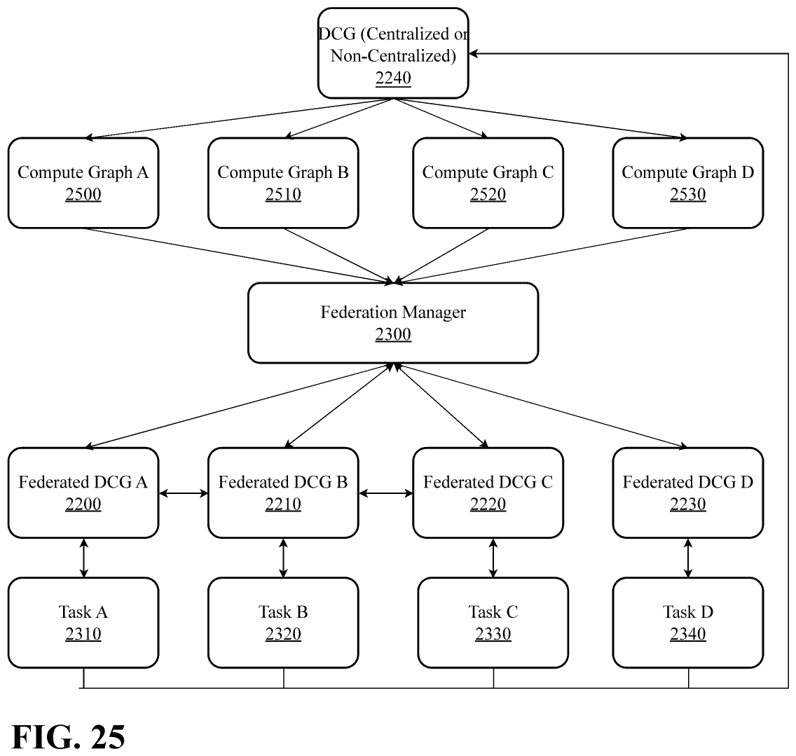

FIG. 25 is a block diagram illustrating an exemplary system architecture for a federated distributed graph-based computing platform that includes a federation manager where different compute graphs are forward to various federated distributed computation graph systems. In one embodiment, DCG 2240 generates a plurality of compute graphs 2500, 2510, 2520, 2530 tailored to each federated DCG's requirements and specifications. This approach allows for fine-grained control over information access and task execution across the federation. DCG 4940 analyzes the overall task requirements and the characteristics of each federated DCG 2200, 2210, 2220, 2230, considering factors such as but not limited to processing capabilities, data access permissions, security clearance levels, and specialized functions. Based on this analysis, it constructs custom compute graphs for each Federated DCG through a multi-step process that involves creating a master compute graph, applying transformations based on each DCG's specifications, and potentially replacing sensitive operations with privacy-preserving alternatives.

Federation manager 2300 may provide the DCG 2240 with up-to-date information about each federated DCG's current status, capabilities, and access rights by leveraging the pipeline infrastructure. This information is used to dynamically adjust the compute graphs as conditions change. When distributing tasks 2310, 2320, 2330, 2340, centralized DCG 2240 sends the corresponding compute graph along with the task, serving as a blueprint for how the federated DCG should execute the task, specifying data access, operations, and handling of intermediate results.

Compute graphs may also be used to facilitate secure collaboration between federated DCGs, potentially including special nodes that define how intermediate results should be shared or combined without revealing sensitive information. As federated DCGs execute their tasks according to their assigned compute graphs, they report progress back to federation manager 2300. Federation manager may then update DCG 2240, which may decide to modify the compute graphs in real-time if necessary, such as when new data requires additional processing steps or if a security policy changes mid-execution.

This dynamic, graph-based approach allows the system to maintain strict control over information flow and task execution while still leveraging the full capabilities of the federated architecture. It provides a flexible framework for handling complex, distributed tasks with varying security and privacy requirements across heterogeneous computing environments, enabling the system to adapt to changing conditions and requirements in real-time while maintaining security and efficiency.

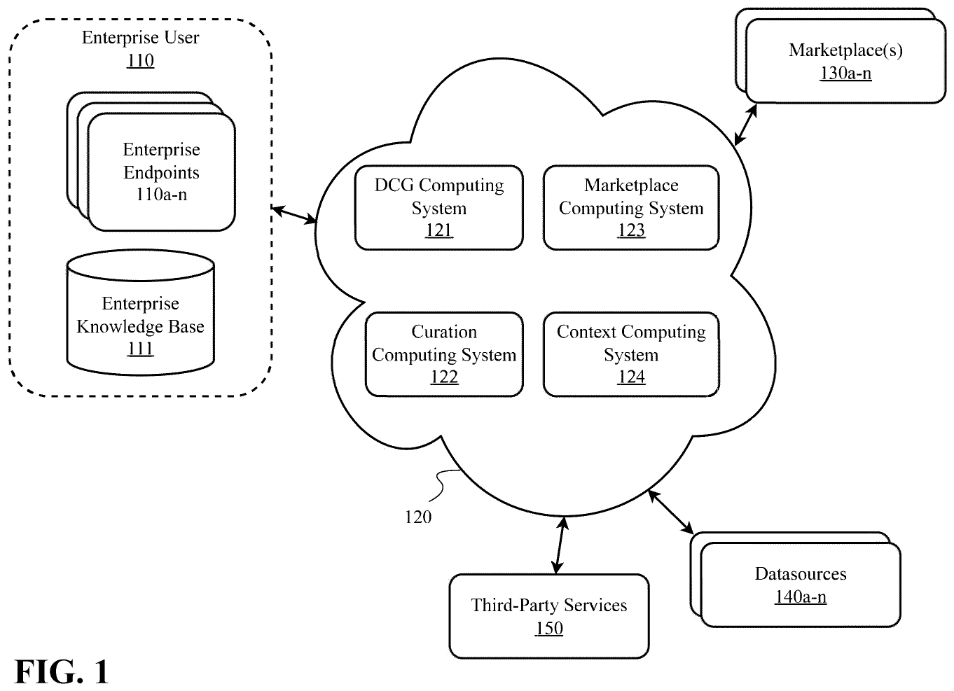

FIG. 1 is a block diagram illustrating an exemplary system architecture for a distributed generative artificial intelligence reasoning and action platform 120, according to an embodiment. According to the embodiment, platform 120 is configured as a cloud-based computing platform comprising various system or sub-system components configured to provide functionality directed to the execution of neuro-symbolic generative AI reasoning and action. Exemplary platform systems can include a distributed computational graph (DCG) computing system 121, a curation computing system 122, a marketplace computing system 123, and a context computing system 124. In some embodiments, systems 121-124 may each be implemented as standalone software applications or as a services/microservices architecture which can be deployed (via platform 120) to perform a specific task or functionality. In such an arrangement, services can communicate with each other over an appropriate network using lightweight protocols such as HTTP, gRPC, or message queues. This allows for asynchronous and decoupled communication between services. Services may be scaled independently based on demand, which allows for better resource utilization and improved performance. Services may be deployed using containerization technologies such as Docker and orchestrated using container orchestration platforms like Kubernetes. This allows for easier deployment and management of services.

The distributed generative AI reasoning and action platform 120 can enable a more flexible approach to incorporating machine learning (ML) models into the future of the Internet and software applications; all facilitated by a DCG architecture capable of dynamically selecting, creating, and incorporating trained models with external data sources and marketplaces for data and algorithms.

According to the embodiment, DCG computing system 121 provides orchestration of complex, user-defined workflows built upon a declarative framework which can allow an enterprise user 110 to construct such workflows using modular components which can be arranged to suit the use case of the enterprise user. As a simple example, an enterprise user 110 can create a workflow such that platform 120 can extract, transform, and load enterprise-specific data to be used as contextual data for creating and training a ML or AI model. The DCG functionality can be extended such that an enterprise user can create a complex workflow directed to the creation, deployment, and ongoing refinement of a trained model (e.g., LLM). For example, in some embodiments, an enterprise user 110 can select an algorithm from which to create the trained model, and what type of data and from what source they wish to use as training data. DCG computing system 121 can take this information and automatically create the workflow, with all the requisite data pipelines, to enable the retrieval of the appropriate data from the appropriate data sources, the processing/preprocessing of the obtained data to be used as inputs into the selected algorithm(s), the training loop to iteratively train the selected algorithms including model validation and testing steps, deploying the trained model, and finally continuously refining the model over time to improve performance.

A context computing system 124 is present and configured to receive, retrieve, or otherwise obtain a plurality of context data from various sources including, but not limited to, enterprise users 110, marketplaces 130a-n, third-party sources 150, and other data sources 140a-n. Context computing system 124 may be configured to store obtained contextual data in a data store. For example, context data obtained from various enterprise endpoints 110a-n of a first enterprise may be stored separately from the context data obtained from the endpoints of a second enterprise. In some embodiments, context data may be aggregated from multiple enterprises within the same industry and stored as a single corpus of contextual data. In such embodiments, contextual data may be transformed prior to processing and storage so as to protect any potential private information or enterprise-specific secret knowledge that the enterprise does not wish to share.

A curation computing system 122 is present and configured to provide curated (or not) responses from a trained model (e.g., LLM) to received user queries. A curated response may indicate that it has been filtered, such as to remove personal identifying information or to remove extraneous information from the response, or it may indicate that the response has been augmented with additional context or information relevant to the user. In some embodiments, multiple trained models (e.g., LLMs) may each produce a response to a given prompt, which may include additional contextual data/elements, and a curation step may include selecting a single response of the multiple responses to send to a user, or the curation may involve curating the multiple responses into a single response. The curation of a response may be based on rules or policies that can set an individual user level, an enterprise level, or at a department level for enterprises with multiple departments (e.g., sales, marketing, research, product development, etc.).

According to the embodiment, an enterprise user 110 may refer to a business organization or company. An enterprise may wish to incorporate a trained ML model into their business processes. An enterprise may comprise a plurality of enterprise endpoints 110a-n which can include, but are not limited to, mobile devices, workstations, laptops, personal computers, servers, switches, routers, industrial equipment, gateways, smart wearables, Internet-of-Things (IoT) devices, sensors, and/or the like. An enterprise may engage with platform 120 to create a trained model to integrate with its business processes via one or more enterprise endpoints. To facilitate the creation of purpose-built, trained models, enterprise user 110 can provide a plurality of enterprise knowledge 111 which can be leveraged to build enterprise specific (or even specific to certain departments within the enterprise) ML/AI models. Enterprise knowledge 111 may refer to documents or other information important for the operation and success of an enterprise. Data from internal systems and databases, such as customer relationship management (CRM) systems, enterprise resource planning (ERP) systems, rules and policies databases, and transactional databases, can provide information about the operational context of an enterprise. For example, product knowledge, market knowledge, industry trends, regulatory knowledge, business processes, customer knowledge, technology knowledge, financial knowledge, organization knowledge, and risk management knowledge may be included in enterprise knowledge base 111.

According to the embodiment, platform 120 is configured to retrieve, receive, or otherwise obtain a plurality of data from various sources. A plurality of marketplaces 130a-n may be present and configured to provide centralized repositories for data, algorithms, and expert judgment, which can be purchased, sold, or traded on an open marketplace. External data sourced from various marketplaces 130a-n can be used as a training data source for creating trained models for a particular use case. A marketplace computing system 123 is present and configured to develop and integrate various marketplaces 130a-n. Marketplace computing system 123 can provide functionality directed to the registration of experts or entities. An expert may be someone who has a deep understanding and knowledge of a specific industry, including its trends, challenges, technologies, regulations, and best practices. Industry experts often have many years of industry experience and have developed a reputation for their expertise and insights. Examples of experts can include, but are not limited to, consultants, analysts, researchers, academics, or professionals working in the industry. In some embodiments, experts and/or entities can register with platform 120 so that they may become verified experts/entities. In such an embodiment, an expert/entity profile may be created which can provide information about expert judgment, scored data and algorithms, and comparisons/statistics about the expert's/entity's scores and judgment with respect to other expert/entities. Marketplace computing system 123 may further provide functionality directed to the management of the various marketplaces and the data/algorithms provided therein.

According to some embodiments, platform 120 can communicate with and obtain data from various third-party services 150. For example, third-party services can include LLM services such as APIs and LLM hosting platforms, which platform 120 can interface with to obtain algorithms or models to use as starting points for training a neuro-symbolic generative AI reasoning and action model to be deployed at the enterprise or individual level. As another example, social media platforms can provide data about trends, events, and public sentiment, which can be useful for understanding the social context of a situation. Exemplary data sources 140a-n can include, but are not limited to, sensors, web data, environmental data, and survey and interviews.

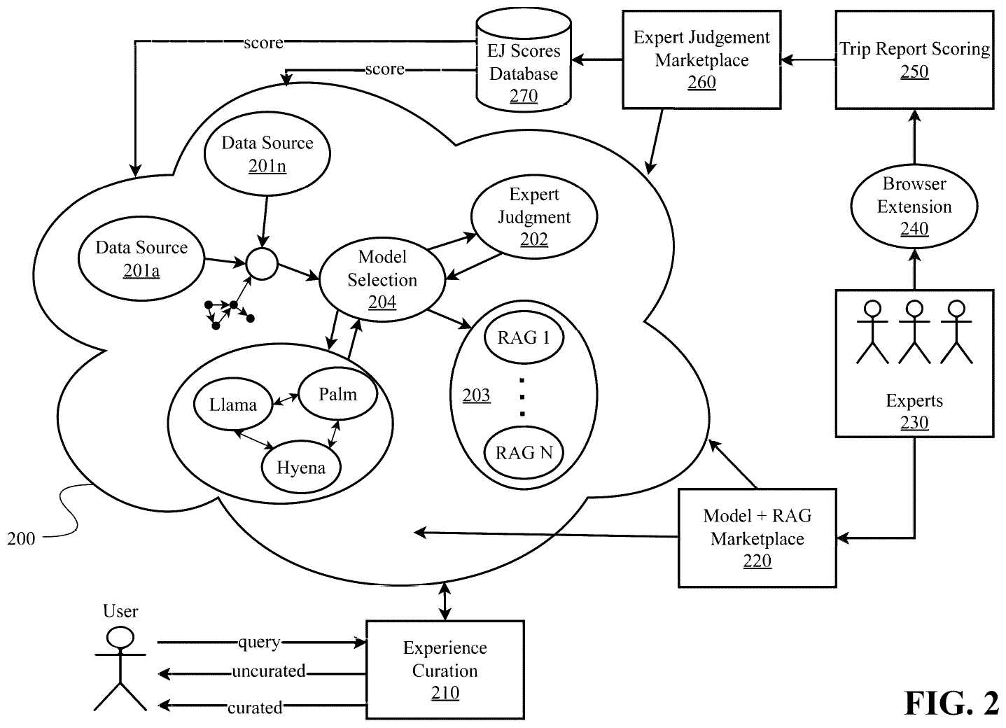

FIG. 2 is a block diagram illustrating an exemplary aspect of a distributed generative AI reasoning and action platform incorporating various additional contextual data. According to the aspect, a plurality of contextual data from various data sources may be integrated into platform 120. A simple exemplary directed computational graph 200 is illustrated within the cloud and utilizes the plurality of contextual data to create and train a model. Various marketplaces 130a-n are shown which can provide contextual data to platform 120 including an expert judgment marketplace 260 and a model and retrieval augmented generation (RAG) marketplace 220. According to the aspect, DCG 200 orchestrates model (and model weight) selection 204, including multi-model usage in series or parallel (i.e., feed output of one model into another, or compare and choose outputs across multiple models), based on multiple data sources (both trained and external), input from crowdsourced expert judgment, training or tuning data set corpora, and RAG libraries.

Expert judgment will become increasingly important in the world of proprietary or otherwise blackbox ML or AI models where hallucinations and training data quality may produce misleading or otherwise incorrect results. The expert judgment marketplace 260 provides a way for experts 230 to weigh-in on the correctness of data whether that is training data or model output, and can be facilitated by a browser extension 240, for example, to score things like data sources during their daily “trip around web”. This trip report scoring 250 concept allows experts to score data sources. In an implementation, a browser extension 240 is developed with an accuracy score input where the user can rank a news article they are reading as they consume it. Expert judgment marketplace 260 allows for consumers to pick and rank “experts” based on how well their judgment helps or hinders their overall consumption of model output. For example, experts that routinely highly rank data sources, like news sites, that are known to spread false information should likewise be less trusted over time compared to their peers, and any models trained on that data similarly less trusted. Ultimately a database 270 of data sources and schemas scored by algorithms or experts could be used as input into the DCG 200 for more accurate and real-time inference based on ongoing rating of preferred data set and data format combinations (e.g. the same data might be purchased in unstructured, structured, schematized, normalized, or semantified formats) which may introduce different types of bias or impacts on performance, results, or processing costs.

Accordingly, a RAG marketplace 220 may be implemented to further refine model output. RAG input information may be included as additional context which can be supplied to a GenAI model in addition to a prompt (engineered, or otherwise). Marketplace 220 may be global or local to a given device or system since they might cache resources locally for on demand purchase or execution. This is especially important where companies may want to sell access to their proprietary dataset through the form of input to a RAG. For example, a medical research company may have valuable information they could sell to other institutions in the form of the output of their dataset fed to a RAG to augment related research without specifically providing access to the raw training data. Retrieval-augmented generation is a framework that combines elements of retrieval-based and generative models to improve the performance of natural language processing tasks. In RAG, a retriever component is used to select relevant information from a large corpus, and a generator component is used to produce a final output based on both the retrieved information and the input query. RAG marketplace 220 may be scored by experts for accuracy and effectiveness across domains. The owner of these datasets may also further protect raw data access while also increasing retrieval accuracy by developing a set of models trained for each AI model that can allow retrieved data to be projected into a latent space capable of being fed into a specific AI model. This approach may leverage techniques such as autoencoders, Variational Autoencoders (VAEs), or adversarial training to create lower-dimensional representations that capture essential features while obscuring raw data. These latent representations can be tailored to specific AI tasks, providing just enough information for the model to perform effectively without exposing unnecessary details. This latent representation of data would prevent the user from reversing it back to raw data, while also being designed to efficiently inform the selected AI model. Furthermore, by applying dimensionality reduction techniques like t-SNE or UMAP, and incorporating differential privacy methods, the system can offer formal privacy guarantees while maintaining data utility. This strategy allows for a balance between protecting sensitive information and enabling high-performance AI applications, as each latent space can be optimized for its intended use case while minimizing the risk of data reconstruction.

According to the aspect, a user experience curation engine 210 is needed that is able to curate output whether that is in the form of filtering out sensitive data or simply customizing results in a way the user prefers (which may be based on user-/entity-defined rules or policies). A user can submit a query to experience curation engine 210 which can send the query to the DCG trained model to obtain a response. Experience curation 210 may then process the received response to curate it (or not) to meet the preferences of the user.

As illustrated, DCG 200 shows a simple example of a directed computational graph which can be used to create a complex workflow to create and train an MI/AI model (e.g., variations of or standard transformer architecture). As shown, the DCG comprises multiple sources of information for training the selected models(s) including multiple data sources 201a-n which may or may not be scored by experts, expert judgment 202, and one or more RAGs 203 which may be obtained from RAG marketplace 220 or may be obtained directly from enterprise knowledge. DCG may have access to stored models or variants thereof. In the illustration, LLAMA (Learned Layer-wise Attention Metric for Transformers), PALM (Permuted Adaptive Lateral Modulation), and HYENA (Hyperbolic Encoder for Efficient Attention) are shown as possible examples of the types of models which can be selected by the DCG to create and train a GenAI model. Furthermore, the “model parameters” and mathematical techniques or assumptions used in each model may be cataloged and included in a model-specific template which may be stored in cloud-based storage on platform 120. In some embodiments, platform 120 may store a hierarchical representation of transformer models (e.g., as a graph), which may represent a lineage of the evolution of transformer models. In an implementation, model selection or exploration involves selections based on the evolutionary tree of one or more model types and use said tree (e.g., graph) for selections in heuristic search for best algorithm/data combinations, licensing costs/explorations, etc. It should be appreciated that certain aspects of the invention may be tailored based on what kind of mathematical approach underpins a specific model.

In operation, DCG 200 obtains the various contextual data from the connected data sources, creates training, validation, and test datasets from the obtained data, and uses the various datasets to train, validate, and test the model as it undergoes a model training loop that iteratively trains the model to generate responses based on the plurality of contextual data.

FIG. 3 is a diagram illustrating incorporating symbolic reasoning in support of LLM-based generative AI, according to an aspect of a neuro-symbolic generative AI reasoning and action platform. According to the aspect, platform 120 can incorporate symbolic reasoning and in-context learning to create and train off the shelf models (e.g., an LLM foundational model or narrow model) through clever prompting and conditioning on private data or very situation specific “contextual” data. Platform 120 can obtain contextual data 301 and preprocess the data for storage. Contextual data 301 may refer to data obtained from marketplaces 130a-n, third-party services 150, and enterprise knowledge 111, as well as other types of contextual data that may be obtained from other sources. DCG 330 is responsible for orchestrating the entire process and can create data pipelines 310 as needed to facilitate the ingestion of contextual data 301. Contextual data can include text documents, PDFs, and even structure formats like CSV (comma-separated values) or SQL tables or other common generic data formats like OWL or RDF or domain specific content such as the Financial Industry Business Ontology (FIBO) or Open Graph of Information Technology (OGIT). This stage involves storing private data (e.g., context data) to be retrieved later.

Typically, the context data 301 is broken into chunks, passed through and embedding model 315, then stored in a specialized database called a vector database 320. Embedding models are a class of models used in many tasks such as natural language processing (NLP) to convert words, phrases, or documents into numerical representations (embeddings) that capture similarity which often correlates semantic meaning. Exemplary embedding models can include, but are not limited to, text-embedding-ada-002 model (i.e., OpenAI API), bidirectional encoder representations form transformers, Word2Vec, FastText, transformer-based models, and/or the like. The vector database 315 is responsible for efficiently storing, comparing, and retrieving a large plurality of embeddings (i.e., vectors). Vector database 315 may be any suitable vector database system known to those with skill in the art including, but not limited to, open source systems like Pinecone, Weaviate, Vespa, and Qdrant. According to the embodiment, embedding model 315 may also receive a user query from experience curation 340 and vectorize it where it may be stored in vector database 320. This provides another useful datapoint to provide deeper context when comparing received queries against stored query embeddings.

A user may submit a query 303 to an experience curation engine 340 which starts the prompt construction and retrieval process. The query is sent to DCG 330 which can send the query to various components such as prompt engineering 325 and embedding model 315. Embedding model 315 receives the query and vectorizes it and stores it in vector database 320. The vector database 320 can send contextual data (via vectors) to DCG 330 and to various APIs/plugins 335. Prompt engineering 325 can receive prompts 302 from developers to train the model on. These can include some sample outputs such as in few-shot prompting. The addition of prompts via prompt engineering 325 is designed to ground model responses in some source of known input or knowledge and provide external context the model wasn't trained on to improve likelihood of a useful response. Other examples of prompt engineering that may be implemented in various embodiments include, but are not limited to, chain-of-thought, self-consistency, generated knowledge, tree of thoughts, directional stimulus, and/or the like.

During a prompt execution process, experience curation 340 can send user query to DCG 330 which can orchestrate the retrieval of context and a response. Using its declarative roots, DCG 330 can abstract away many of the details of prompt chaining; interfacing with external APIs 335 (including determining when an API call is needed); retrieving contextual data from vector databases 330; and maintaining memory across multiple LLM calls. The DCG output may be a prompt, or series of prompts, to submit to a language model via LLM services 360 (which may be potentially prompt tuned). In turn, the LLM processes the prompts, contextual data, and user query to generate a contextually aware response which can be sent to experience curation 340 where the response may be curated, or not, and returned to the user as output 304.

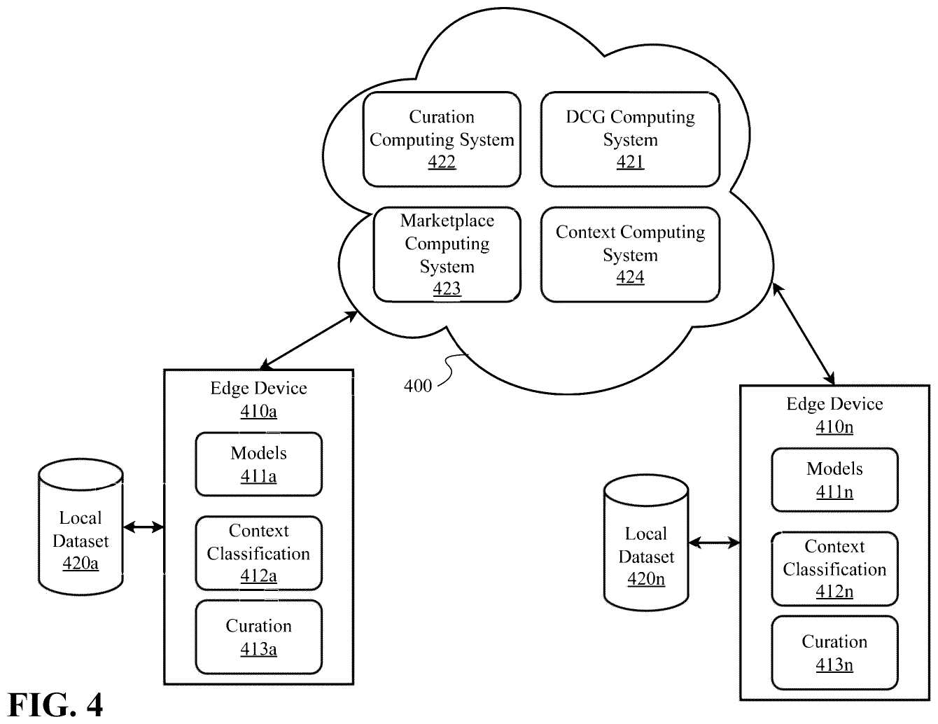

FIG. 4 is a block diagram illustrating an exemplary architecture for a neuro-symbolic generative AI reasoning and action platform 400 configured for federated learning at a plurality of edge devices 410a-n, according to an embodiment. According to the embodiment, platform 400 comprises DCH computing system 421, curation computing system 422, marketplace computing system 423, and context computing system 424. According to an embodiment, edge devices 410a-n may represent various enterprise endpoints. In other embodiments, edge devices 410a-n may represent various endpoints from two or more separate enterprises. In an embodiment, an edge device 410a-n may be a computing device associated with a platform user, such as someone who engages with the platform for experience curation or an expert who provides expert judgment scores to platform 400 via, for example, expert judgment marketplace 260 or some other mechanism.

As shown, each edge device 410a-n may comprise instances of local models 411a-n, context classification processes 412-n, and experience curation processes 413a operating on the device. Each edge device may have access to a local data or knowledge base 420a-n and which is only accessible by its associated edge device. Edge devices 410a-n may utilize these components to perform various computations wherein the processing of data and execution of algorithms happens locally on the device, rather than relying on the systems and services provided by platform 400. In some embodiments, a plurality of edge devices 410a-n may be implemented as individual computing nodes in a decentralized federated system, wherein tasks and data may be distributed across multiple nodes, allowing for parallel processing and potentially faster computation. Federated systems are often used in scenarios where data privacy and security are important, as data can remain on local nodes and only aggregated or processed results are shared more widely.

In some implementations, the platform 400 may leverage federated learning, where machine learning models 411a-n are trained across multiple decentralized edge devices 410a-n, with the models' updates being aggregated centrally. This approach allows for the training of models without the need to centrally store sensitive data from individual devices. For example, each edge device 410a-n could train local instances of neuro-symbolic GenAI reasoning and action models and local instances of context classification models 412a-n. According to an embodiment, context classification models 412a-n may be configured to select relevant passages from a knowledge base 420a-n or corpus given a query. This can be done using various techniques such as BM25, TF-IDF, or neural retrieval models like dense passage retrieval. The retrieved passages serve as context or input to a generator (e.g., a transformer-based model).

Federated learning can occur at the edge device wherein the context classification model 412a is trained locally. Periodically, (e.g., hourly, daily, weekly, etc.) platform 400 may collect (e.g., aggregate) model parameters, encrypted data, and/or the like from all of, or a subset of, edge devices 410a-n and apply the aggregated model parameters as an update to a master or global model (e.g., context classification, neuro-symbolic GenAI model, etc.). The updated global model or just its parameters, may be transmitted to all of, or a subset of, the edge devices 410a-n where they may be applied to the local models operating thereon. Similarly, platform 400 can aggregate obtained training data, which may or may not be encrypted, and apply the training data to global models. These updated models may be transmitted to edge devices as described above.

As shown, edge devices 410a-n may further comprise a curation application 413a-n operating on the device. Curation application 413a may be configured to act as an intermediary between a user who can submit a query and models 411a which receive the query and generate a response back. Curation 413a-n may receive a response from a locally stored model and curate the response based on user (or entity) defined rules or preferences. For example, a response may first be filtered of any personal information by curation 413a prior to the being relayed back to the user. As another example, curation 413a may transform the response into specific format, style, or language based on user defined preferences. This allows the edge device 410a user to have their experience with the local models curated to fit any criteria they deem important.

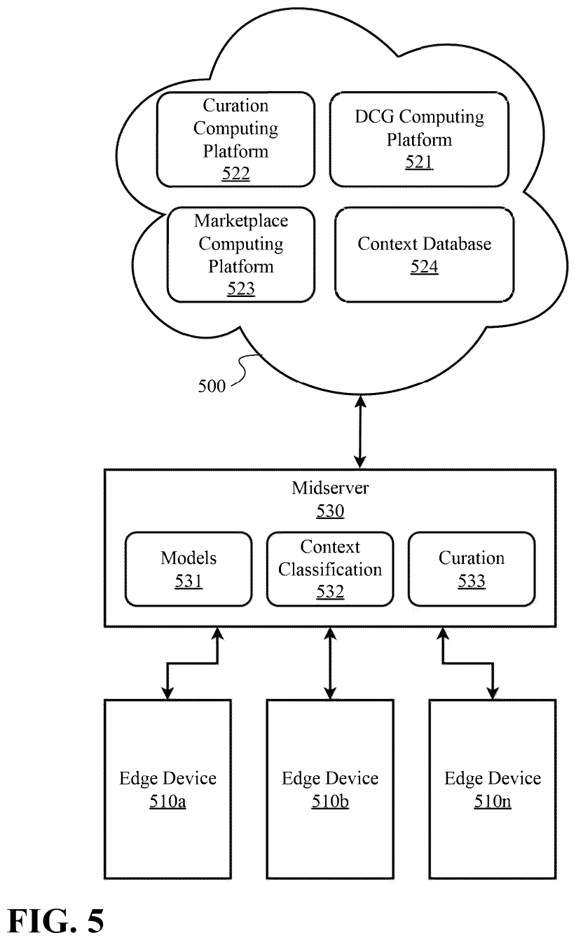

FIG. 5 is a block diagram illustrating an exemplary architecture for a neuro-symbolic generative AI reasoning and action platform 500 configured to utilize a midserver 530 to act as a computing intermediary between a plurality of edge devices 510a-n and the platform. According to the embodiment, midserver 530 facilitates communication between edge devices 510a-n and the backend systems 521, 522, 523, 524 provided by platform 500. The system supports any number of midservers, CDNs, or resource pools that can dynamically join and rejoin the network through gossip protocols across resource pools.

According to the embodiment, midserver 530 may have stored and operating on it one or more neuro-symbolic GenAI reasoning and action models 531, context classification processes 532, and curation processes 533. Each resource pool, including midserver 530, performs local forecasting of its future availability and reliability based on local information, advertising these predictions on both a real-time and forward-looking basis. This probabilistic forecasting at the resource pool level operates distinctly from the pool's reception of probabilistic information from other resource pools, enabling it to compute probabilistic representations of potential compute paths with partial observability to share back through the network.

Midserver 530 can be configured to periodically receive data (e.g., context data) and state information from each of the connected edge devices 510a-n. Each resource pool may independently validate the accuracy and authenticity of other pools' advertised resources and capabilities, implementing security measures similar to MANRS (Mutually Agreed Norms for Routing Security) to protect against spoofing, false advertisements, and other security threats across resource pool advertisements within or across counterparties, regardless of whether they share public, private, or hybrid data access patterns. Additionally, midserver 530 can be configured to receive user-submitted queries or data submissions or messages from edge devices via curation 533, obtain relevant context associated with the received query or message via context classification 532, and use a neuro-symbolic GenAI model 531 to process the query and context data to generate a response to the user. The generated response may be curated (or not) and transmitted back to the user of the edge device.

This functionality can be extended to support “reverse edge” computing scenarios, similar to Private Compute Cloud (PCC) concepts. For example, midserver 530 could be implemented as a hyperconverged appliance or software package deployed on-premises, akin to Azure Stack or AWS Outposts. In this configuration, it would act as a local, private cloud environment, hosting content curation systems and AI models closer to the data source. This approach allows for data processing, AI inferencing, and content curation to occur within the organization's own infrastructure, addressing data sovereignty, latency, and privacy concerns while still leveraging cloud-like capabilities. Edge devices and midservers may also receive or transmit entire DCG instruction sets which may be optionally bundled with models, RAG, weight adjustments, synthetic data sets, data, or logic. Edge devices and midservers may also receive or transmit entire DCG instruction sets which may be optionally bundled with models, RAG, weight adjustments, synthetic data sets, data, or logic.

In some implementations, edge devices 510a-n may have stored upon them local models as described in FIG. 4, and midserver 530 may store global models or even mid-tier models associated with the local models. In such an implementation, midserver can aggregate model parameters and update the global/mid-tier models accordingly.

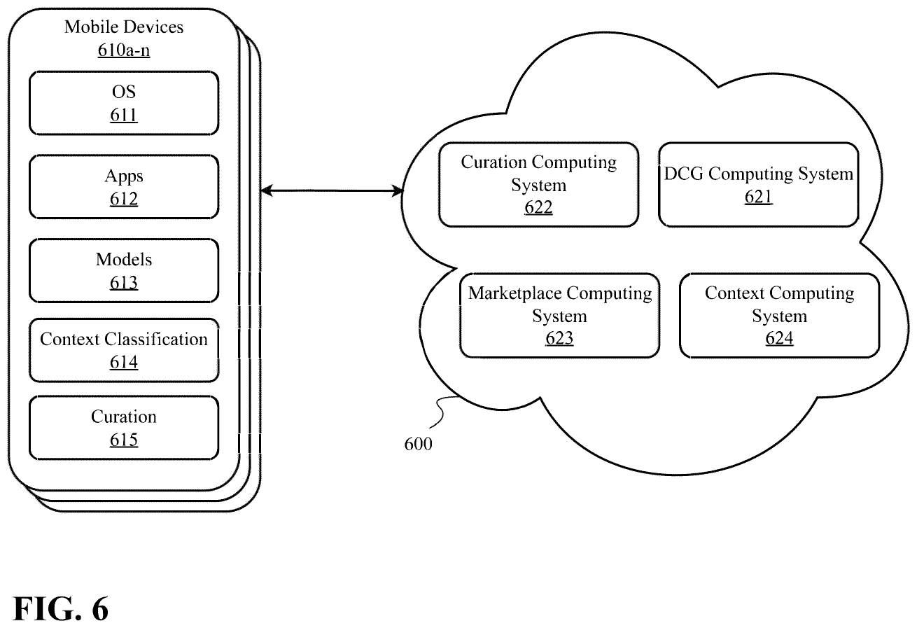

FIG. 6 is a block diagram illustrating an exemplary mobile device 610a-n configured for experience curation using embedded capabilities and functionality provided by a neuro-symbolic generative AI reasoning and action platform 600, according to an embodiment. According to the embodiment, a mobile device 610a may comprise an operating system 611, various software applications 612 (e.g., text messaging application, social media application, mobile games, music streaming applications, etc.), a local instance of a neuro-symbolic GenAI model 613, a context classification model 614, and an experience curation application 615. Mobile devices 610a-n may further comprise a processor, memory, sensors, storage, wireless communication modules, a display, audio components, and various other components to enable the functionality of a mobile computing device. Mobile devices 610a-n may connect to platform 600 via a suitable communication network such as the Internet. In some embodiments, mobile devices may utilize the systems and services 621, 622, 623, 624 provided by platform to facilitate query-response interactions with a neuro-symbolic GenAI model.

According to the embodiment, mobile device 610a stores and operates local models 613, 614 and a curation application 615 which can be leveraged during instances when mobile device 610a is unable to connect with platform 600 or otherwise has an intermittent connection thereby making data transmission difficult, slow, or impossible. In such situations, mobile device 610a can leverage the local components to perform computation at the edge. A user of mobile device 610a can use curation application 615 to submit a query to the local neuro-symbolic GenAI model 613, along with any aggregated context retrieved via context classification 614. The model 613 can generate a response and send it to curation application 615 where it may be curated (or not) based on the mobile device user's preferences or rules.

In some embodiments, when there is only an intermittent connection to platform 600, such as when a mobile device is in an area with poor network coverage, various strategies may be implemented to provide functionality to the mobile device user. For example, data (e.g., a user submitted query or prompt) can be temporarily stored in a buffer on the device until a connection to platform 600 is available. Once the connection is restored, the buffered data can be transmitted. Likewise, frequently accessed data or recently transmitted data can be cached on the device. This allows the device to access the data locally when a connection to platform 600 is not available. In some implementations, data can be compressed before transmission to reduce the amount of data that needs to be transmitted. This can help to minimize the impact of intermittent connections on data transmission. In some embodiments, mobile device 610a-n may use protocols that are designed to handle intermittent connections, such as MQTT (Message Queuing Telemetry Transport) or CoAP (Constrained Application Protocol), can help to ensure that data is successfully transmitted even in challenging network conditions. Finally, some use cases may implement an offline mode that allows users to continue using the application (or local instances) and storing data locally until a connection to platform 600 is available again.

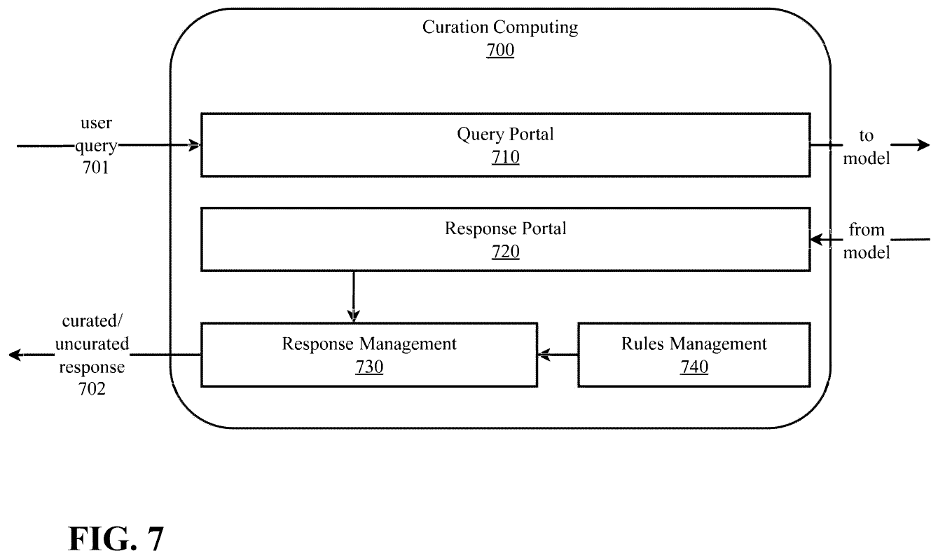

FIG. 7 is a block diagram illustrating an exemplary aspect of a distributed generative artificial intelligence reasoning and action platform, a curation computing system 700. According to the aspect, curation computing system 700 is configured to provide curated (or not) responses from a trained model (e.g., transformer-based model) to received user queries. A curated response may indicate that the response has been filtered, such as to remove personal identifying information or to remove extraneous information from the response, or it may indicate that the response has been augmented with additional context or information relevant to the user. The curation of a response may be based on rules or policies that can be set at an individual user level, an enterprise level, or at a department level for enterprises with multiple departments (e.g., sales, marketing, research, product development, etc.). User/entity rules and/or preferences may be stored in a data storage system of platform 120 and retrieved by a rules management component 740 during experience curation processes.

In operation, curation computing 700 receives a user query 701 directed to a neuro-symbolic GenAI model. A query portal 710 may be present and configured to receive a query 701 and prepare it for processing by a GenAI model. For example, a query may be split into tokens, (e.g., words or sub words) which are basic units of the language model. As another example, a text-based query may undergo normalization (e.g., converting to lowercase, removing punctuation, handling special characters, etc.) to ensure consistency and improve model performance. As yet another example, for models that use attention mechanisms, an attention mask may be applied to the input to indicate which tokens should be attended to and which should be ignored. In some implementations, a query portal 710 may be configured to send received queries to an embedding model which can vectorize the received query and store it in a vector database. In such embodiments, stored query embeddings may be used as a form of contextual data which may be retrieved and transmitted with the query to a GenAI model which generates a response based on the received query and contextual data.

According to the aspect, a response portal 720 is present and configured to receive a response from one a GenAI model and a response management system 730 determines if the received response needs to be curated or not. If the response does not need to be curated, then it may be sent as an uncrated response 702 to the user who submitted the query. Response management 730 can determine if there are any user/entity defined rules or preferences available such as stored in a user/entity profile in a data storage system of platform 120. Rules management 740 can retrieve said rules and response management can curate or otherwise augment the received response based on the user/entity rules or preferences. The result is a curated response 702 which can be transmitted back to the user who submitted the query.

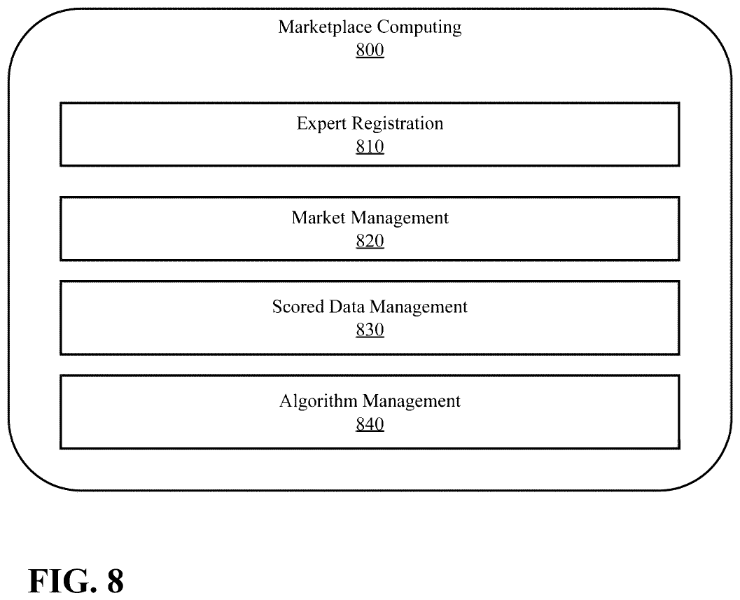

FIG. 8 is a block diagram illustrating an exemplary aspect of a distributed generative artificial intelligence reasoning and action platform, a marketplace computing system 800. According to the aspect, marketplace computing system 800 is present and configured to develop and integrate various marketplaces 130a-n for data, algorithms, and RAGs into platform 120. Marketplace computing system 800 can provide functionality directed to the registration of experts 810 or entities. An expert may be someone who has a deep understanding and knowledge of a specific industry, including its trends, challenges, technologies, regulations, and best practices. Industry experts often have many years of experience working in the industry and have developed a reputation for their expertise and insights. An expert may be registered by providing proof of identity and qualifications, and creating an expert profile which can store a variety of information about the expert such as their name, industry, credentials, scores (e.g., scores that the expert has assigned to data sources, models/algorithms, model outputs, and/or the like), and reputation. For example, a university professor who specializes in transformer-based algorithms can register as an expert in the realm of generative algorithms. As another example, a virologist could register as an expert and provide scores for academic papers which disclose a new methodology for viral spread modeling. Marketplace computing system 800 may further comprise a market management component 820 which can interface with a plurality of markets 130a-n to integrate information contained therein. A scored data management component 830 may be configured to interface with a browser extension 240 or expert judgment marketplace 260 to retrieve expert scores and store them in an expert judgment score database 270. According to the aspect, an algorithm management component 840 is present and configured to acquire algorithms from algorithm marketplaces to be used in the construction and configuration of neuro-symbolic GenAI models.

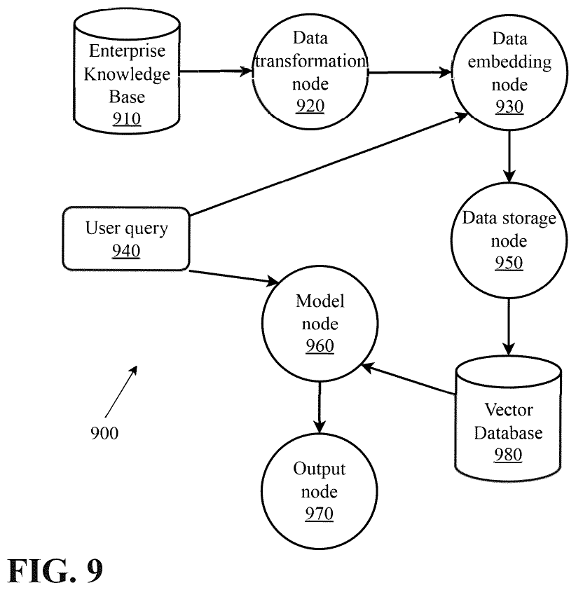

FIG. 9 is a block diagram illustrating a simple example of a distributed computational graph 900 representation for providing neuro-symbolic GenAI capabilities, according to an aspect. According to the aspect, the DCG may be represented as a series of nodes which represent discrete computational or data processing functions, and a series of edges connecting the nodes which represent information or data messages being sent between processing nodes. A DCG can be used to acquire a plurality of context data in the form of an enterprise knowledge base 910. A data transformation node 920 is created to handle the ingestion and transformation of acquired context data. Obtained data may then be sent to a data embedding node 930 which can vectorize the received context data. The vectorized data may flow from the embedding node 930 to a data storage node 950. Data storage node 950 may select the appropriate vector database 980 in which to store the vectorized context data. An input node 940 may allow for a user to submit a query to the workflow. The user query can be sent to data embedding node 930 where it may be vectorized and sent to data storage node 950 for storage in the vector database. The user query can also be sent to a model node 960 which contains the selected model(s) which will process the user query along with any relevant context data obtained from data storage node vector database 980. Model node 960 then processes this information to generate a response which can be sent to output node 970. In some instances, output node 970 may output the response directly to the user. In other instances, output node 970 may be configured to transform the response into a curated response based on user/entity defined rules or preferences.

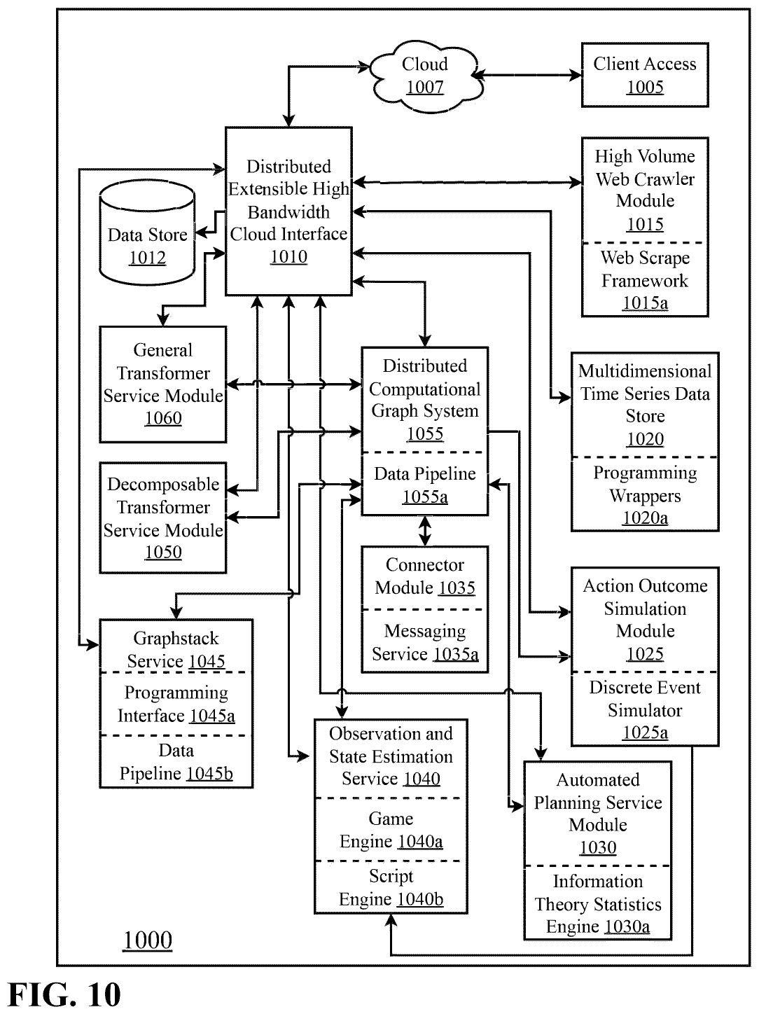

FIGS. 10-14 illustrate various exemplary aspects of system architectures of distributed computational graph computing environments. For more detailed information regarding the operation of the various components and aspects described herein with respect to FIGS. 10-14, please refer to U.S. patent application Ser. No. 15/931,534 which is incorporated herein by reference.

FIG. 10 is a block diagram illustrating an exemplary aspect of an embodiment of a distributed computational graph computing system utilizing an advanced cyber decision platform (ACDP) for external network reconnaissance and contextual data collection. Client access to the system 1005 for specific data entry, system control and for interaction with system output such as automated predictive decision making and planning and alternate pathway simulations, occurs through the system's distributed, extensible high bandwidth cloud interface 1010 which uses a versatile, robust web application driven interface for both input and display of client-facing information via network 1007 and operates a data store 1012 such as, but not limited to MONGODB™, COUCHDB™, CASSANDRA™ or REDIS™ according to various arrangements. Much of the enterprise knowledge/context data analyzed by the system both from sources within the confines of the enterprise business, and from cloud based sources, also enter the system through the cloud interface 1010, data being passed to the connector module 1035 which may possess the API routines 1035a needed to accept and convert the external data and then pass the normalized information to other analysis and transformation components of the system, the directed computational graph module 1055, high volume web crawler module 1015, multidimensional time series database (MDTSDB) 1020 and the graph stack service 1045. The directed computational graph module 1055 retrieves one or more streams of data from a plurality of sources, which includes, but is in no way not limited to, enterprise knowledge, RAGs, expert judgment/scores, a plurality of physical sensors, network service providers, web based questionnaires and surveys, monitoring of electronic infrastructure, crowdsourcing campaigns, and human input device information. Within the directed computational graph module 1055, data may be split into two identical streams in a specialized pre-programmed data pipeline 1055a, wherein one sub-stream may be sent for batch processing and storage while the other sub-stream may be reformatted for transformation pipeline analysis. The data is then transferred to the general transformer service module 1060 for linear data transformation as part of analysis or the decomposable transformer service module 1050 for branching or iterative transformations that are part of analysis. The directed computational graph module 1055 can represent all data as directed graphs where the transformations are nodes and the result messages between transformations edges of the graph. The high volume web crawling module 1015 uses multiple server hosted preprogrammed web spiders, which while autonomously configured are deployed within a web scraping framework 1015a of which SCRAPY™ and scripted headless browser variants are examples, to identify and retrieve data of interest from web based sources that are not well tagged by conventional web crawling technology. Data persistence stores such as the multiple dimension time series data store module 1020 may receive streaming data from a large plurality of sensors that may be of several different types. The multiple dimension time series data store module may also store any time series data encountered by the system such as but not limited to enterprise network usage data, component and system logs, environmental context, edge device state information, performance data, network service information captures such as, but not limited to news and financial feeds, and sales and service related customer data. The module is designed to accommodate irregular and high volume surges by dynamically allocating network bandwidth and server processing channels to process the incoming data. Inclusion of programming wrappers 1020a for languages examples of which are, but not limited to C++, PERL, PYTHON, Rust, GoLang, and ERLANG™ allows sophisticated programming logic to be added to the default function of the multidimensional time series database 1020 without intimate knowledge of the core programming, greatly extending breadth of function. Data retrieved by various data stores such as SQL, graph, key-value, or the multidimensional time series database (MDTSDB) 1020 and the high volume web crawling module 1015 may be further analyzed and transformed into task optimized results by the directed computational graph 1055 and associated general transformer service 1050 and decomposable transformer service 1060 modules. Alternately, data from the multidimensional time series database and high volume web crawling modules may be sent, often with scripted cuing information determining important vertexes 1045a, to the graph stack service module 1045 which, employing standardized protocols for converting streams of information into graph representations of that data, for example, open graph internet technology although the invention is not reliant on any one standard. Through the steps, the graph stack service module 1045 represents data in graphical form influenced by any predetermined scripted modifications 1045a and stores it in a graph-based data store 1045b such as GIRAPH™ or a key value pair type data store REDIS™, or RIAK™, among others, all of which are suitable for storing graph-based information.

Results of the transformative analysis process may then be combined with further client directives, and additional business rules and practices relevant to the analysis and situational information external to the already available data in the automated planning service module 1030 which also runs powerful information theory 1030a based predictive statistics functions and machine learning algorithms to allow future trends and outcomes to be rapidly forecast based upon the current system derived results and choosing each a plurality of possible business decisions. Using all available data, the automated planning service module 1030 may propose business decisions most likely to result is the most favorable business outcome with a usably high level of certainty. Closely related to the automated planning service module in the use of system derived results in conjunction with possible externally supplied additional information (i.e., context) in the assistance of end user business decision making, the action outcome simulation module 1025 with its discrete event simulator programming module 1025a coupled with the end user facing observation and state estimation service 1040 which is highly scriptable 1040b as circumstances require and has a game engine 1040a to more realistically stage possible outcomes of business decisions under consideration, allows business decision makers to investigate the probable outcomes of choosing one pending course of action over another based upon analysis of the current available data.

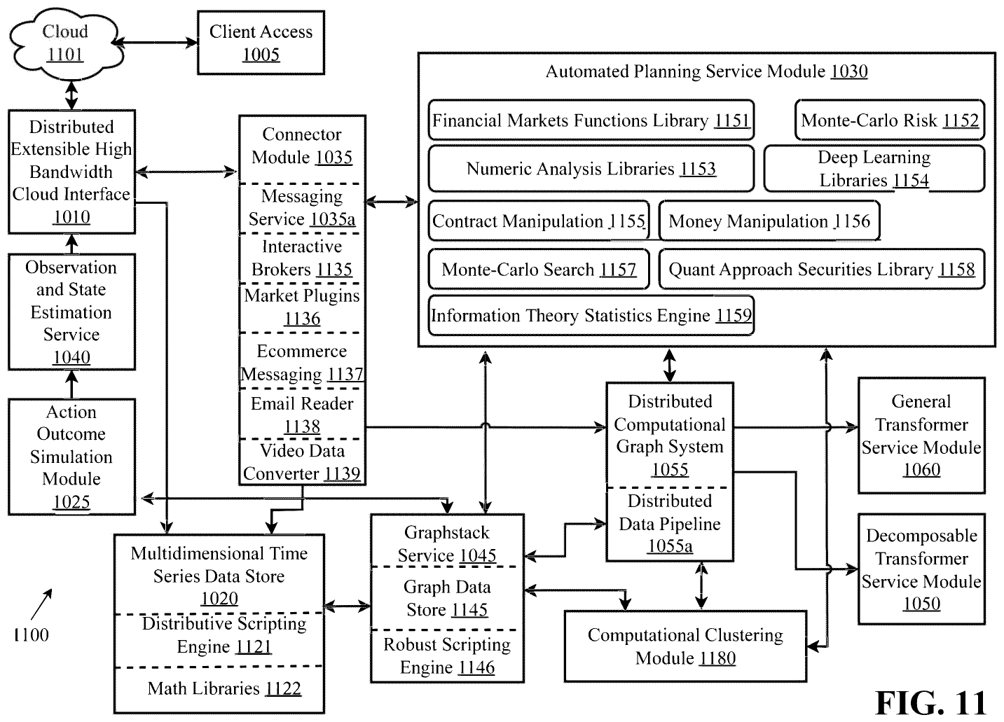

FIG. 11 is a block diagram illustrating another exemplary aspect of an embodiment 1100 of a distributed computational graph computing systems utilizing an advanced cyber decision platform. According to the aspect the integrated platform 1100, is very well suited to perform advanced predictive analytics and predictive simulations to produce investment predictions. Much of the trading specific programming functions are added to the automated planning service module 1030 of the modified advanced cyber decision platform 1100 to specialize it to perform trading analytics. Specialized purpose libraries may include but are not limited to financial markets functions libraries 1151, Monte-Carlo risk routines 1152, numeric analysis libraries 1153, deep learning libraries 1154, contract manipulation functions 1155, money handling functions 1156, Monte-Carlo search libraries 1157, and quant approach securities routines 1158. Pre-existing deep learning routines including information theory statistics engine 1159 may also be used. The invention may also make use of other libraries and capabilities that are known to those skilled in the art as instrumental in the regulated trade of items of worth. Data from a plurality of sources used in trade analysis are retrieved, much of it from remote, cloud resident 1101 servers through the system's distributed, extensible high bandwidth cloud interface 110 using the system's connector module 135 which is specifically designed to accept data from a number of information services both public and private through interfaces to those service's applications using its messaging service 135a routines, due to ease of programming, are augmented with interactive broker functions 1135, market data source plugins 1136, e-commerce messaging interpreters 1137, business-practice aware email reader 1138 and programming libraries to extract information from video data sources 1139.

Other modules that make up the advanced cyber decision platform may also perform significant analytical transformations on trade related data. These may include the multidimensional time series data store 1020 with its robust scripting features which may include a distributive friendly, fault-tolerant, real-time, continuous run prioritizing, programming platform such as, but not limited to Erlang/OTP 1121 and a compatible but comprehensive and proven library of math functions of which the C⁺⁺ math libraries are an example 1122, data formalization and ability to capture time series data including irregularly transmitted, burst data; the GraphStack service 145 which transforms data into graphical representations for relational analysis and may use packages for graph format data storage such as Titan, Janusgraph, Neo4j, or Neptune that may implement open standards such as Tinkerpop which can support both OLAP and OLTP use cases 1145 or the like and a highly interface accessible programming interface an example of which may be Akka/Spray, although other, similar, combinations may equally serve the same purpose in this role 1146 to facilitate optimal data handling; the directed computational graph module 155 and its distributed data pipeline 155a supplying related general transformer service module 160 and decomposable transformer module 150 which may efficiently carry out linear, branched, and recursive transformation pipelines during trading data analysis may be programmed with multiple trade related functions involved in predictive analytics of the received trade data. Both possibly during and following predictive analyses carried out by the system, results must be presented to clients 1005 in formats best suited to convey both important results for analysts to make highly informed decisions and, when needed, interim or final data in summary and potentially raw for direct human analysis. Simulations which may use data from a plurality of field spanning sources to predict future system or decision-making conditions are accomplished within the action outcome simulation module 1025. Data and simulation formatting may be completed or performed by the observation and state estimation service 1040 using its ease of scripting and gaming engine to produce optimal presentation results.

In cases where there are both large amounts of data to be ingested, schematized, normalized, semantified or otherwise cleansed, enriched or formalized and then intricate transformations such as those that may be associated with deep machine learning, predictive analytics and predictive simulations, distribution of computer resources to a plurality of systems may be routinely required to accomplish these tasks due to the volume of data being handled and acted upon. The advanced cyber decision platform employs a distributed architecture that is highly extensible to meet these needs. A number of the tasks carried out by the system are extremely processor intensive and for these, the highly integrated process of hardware clustering of systems, possibly of a specific hardware architecture particularly suited to the calculations inherent in the task, is desirable, if not required for timely completion. The system includes a computational clustering module 1180 to enable the configuration and management of such clusters during application of the advanced cyber decision platform. While the computational clustering module is drawn directly connected to specific co-modules of the advanced cyber decision platform these connections, while logical, are for ease of illustration and those skilled in the art will realize that the functions attributed to specific modules of an embodiment may require clustered computing under one use case and not under others. Similarly, the functions designated to a clustered configuration may be role, if not run, dictated. Further, not all use cases or data runs may use clustering.

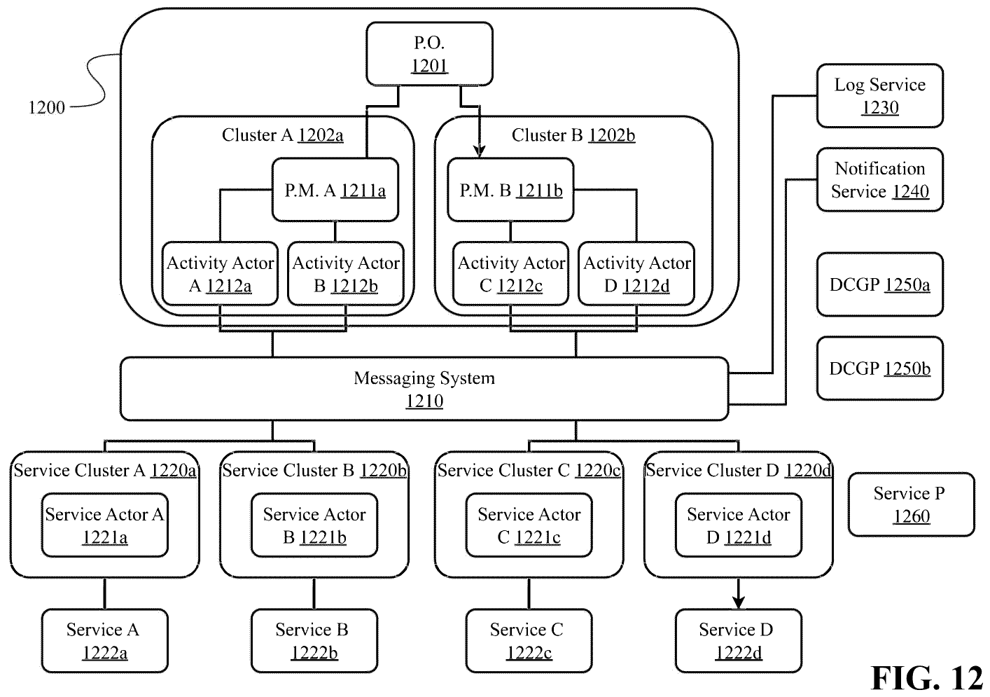

FIG. 12 is a diagram of an exemplary architecture for a system for rapid predictive analysis of very large data sets using an actor-driven distributed computational graph 1200, according to one aspect. According to the aspect, a DCG 1200 may comprise a pipeline orchestrator 1201 that may be used to perform a variety of data transformation functions on data within a processing pipeline, and may be used with a messaging system 1210 that enables communication with any number of various services and protocols, relaying messages and translating them as needed into protocol-specific API system calls for interoperability with external systems (rather than requiring a particular protocol or service to be integrated into a DCG 1200).

Pipeline orchestrator 1201 may spawn a plurality of child pipeline clusters 1202a-b, which may be used as dedicated workers for streamlining parallel processing. In some arrangements, an entire data processing pipeline may be passed to a child cluster 1202a for handling, rather than individual processing tasks, enabling each child cluster 1202a-b to handle an entire data pipeline in a dedicated fashion to maintain isolated processing of different pipelines using different cluster nodes 1202a-b. Pipeline orchestrator 1201 may provide a software API for starting, stopping, submitting, or saving pipelines. When a pipeline is started, pipeline orchestrator 1201 may send the pipeline information to an available worker node 1202a-b, for example using AKKA™ clustering. For each pipeline initialized by pipeline orchestrator 1201, a reporting object with status information may be maintained. Streaming activities may report the last time an event was processed, and the number of events processed. Batch activities may report status messages as they occur. Pipeline orchestrator 1201 may perform batch caching using, for example, an IGFS™ caching filesystem. This allows activities 1212a-d within a pipeline 1202a-b to pass data contexts to one another, with any necessary parameter configurations.

A pipeline manager 1211a-b may be spawned for every new running pipeline, and may be used to send activity, status, lifecycle, and event count information to the pipeline orchestrator 1201. Within a particular pipeline, a plurality of activity actors 1212a-d may be created by a pipeline manager 1211a-b to handle individual tasks, and provide output to data services 1222a-d. Data models used in a given pipeline may be determined by the specific pipeline and activities, as directed by a pipeline manager 1211a-b. Each pipeline manager 1211a-b controls and directs the operation of any activity actors 1212a-d spawned by it. A pipeline process may need to coordinate streaming data between tasks. For this, a pipeline manager 1211a-b may spawn service connectors to dynamically create TCP connections between activity instances 1212a-d. Data contexts may be maintained for each individual activity 1212a-d, and may be cached for provision to other activities 1212a-d as needed. A data context defines how an activity accesses information, and an activity 1212a-d may process data or simply forward it to a next step. Forwarding data between pipeline steps may route data through a streaming context or batch context.

A client service cluster 1230 may operate a plurality of service actors 1221a-d to serve the requests of activity actors 1212a-d, ideally maintaining enough service actors 1221a-d to support each activity per the service type. These may also be arranged within service clusters 1220a-d, in a manner similar to the logical organization of activity actors 1212a-d within clusters 1202a-b in a data pipeline. A logging service 1230 may be used to log and sample DCG requests and messages during operation while notification service 1240 may be used to receive alerts and other notifications during operation (for example to alert on errors, which may then be diagnosed by reviewing records from logging service 1230), and by being connected externally to messaging system 1210, logging and notification services can be added, removed, or modified during operation without impacting DCG 1200. A plurality of DCG protocols 1250a-b may be used to provide structured messaging between a DCG 1200 and messaging system 1210, or to enable messaging system 1210 to distribute DCG messages across service clusters 1220a-d as shown. A service protocol 1260 may be used to define service interactions so that a DCG 1200 may be modified without impacting service implementations. In this manner it can be appreciated that the overall structure of a system using an actor driven DCG 1200 operates in a modular fashion, enabling modification and substitution of various components without impacting other operations or requiring additional reconfiguration.

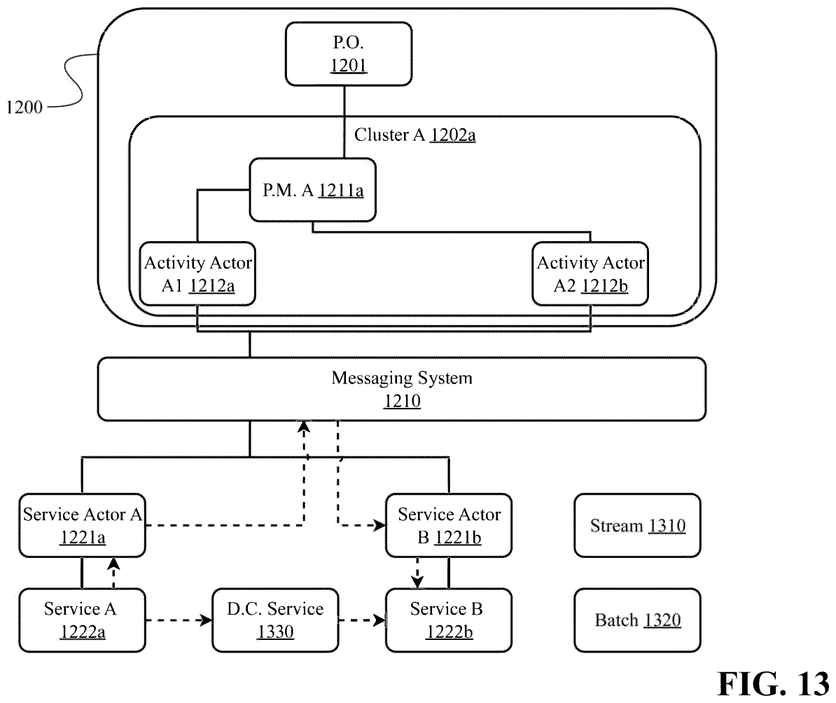

FIG. 13 is a diagram of an exemplary architecture for a system for rapid predictive analysis of very large data sets using an actor-driven distributed computational graph 1200, according to one aspect. According to the aspect, a variant messaging arrangement may utilize messaging system 1210 as a messaging broker using a streaming protocol 1310, transmitting and receiving messages immediately using messaging system 1210 as a message broker to bridge communication between service actors 1221a-b as needed. Alternately, individual services 1222a-b may communicate directly in a batch context 1320, using a data context service 1330 as a broker to batch-process and relay messages between services 1222a-b.

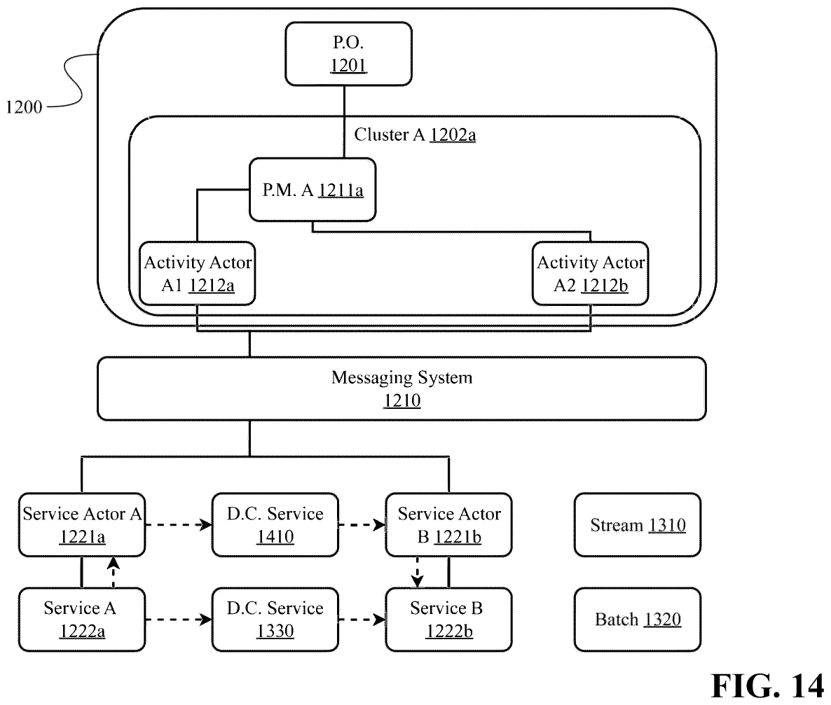

FIG. 14 is a diagram of an exemplary architecture for a system for rapid predictive analysis of very large data sets using an actor-driven distributed computational graph 1200, according to one aspect. According to the aspect, a variant messaging arrangement may utilize a service connector 1410 as a central message broker between a plurality of service actors 1221a-b, bridging messages in a streaming context 1310 while a data context service 1330 continues to provide direct peer-to-peer messaging between individual services 1222a-b in a batch context 1320.

It should be appreciated that various combinations and arrangements of the system variants described above (referring to FIGS. 10-14) may be possible, for example using one particular messaging arrangement for one data pipeline directed by a pipeline manager 1211a-b, while another pipeline may utilize a different messaging arrangement (or may not utilize messaging at all). In this manner, a single DCG 1200 and pipeline orchestrator 1201 may operate individual pipelines in the manner that is most suited to their particular needs, with dynamic arrangements being made possible through design modularity as described above in FIG. 12.

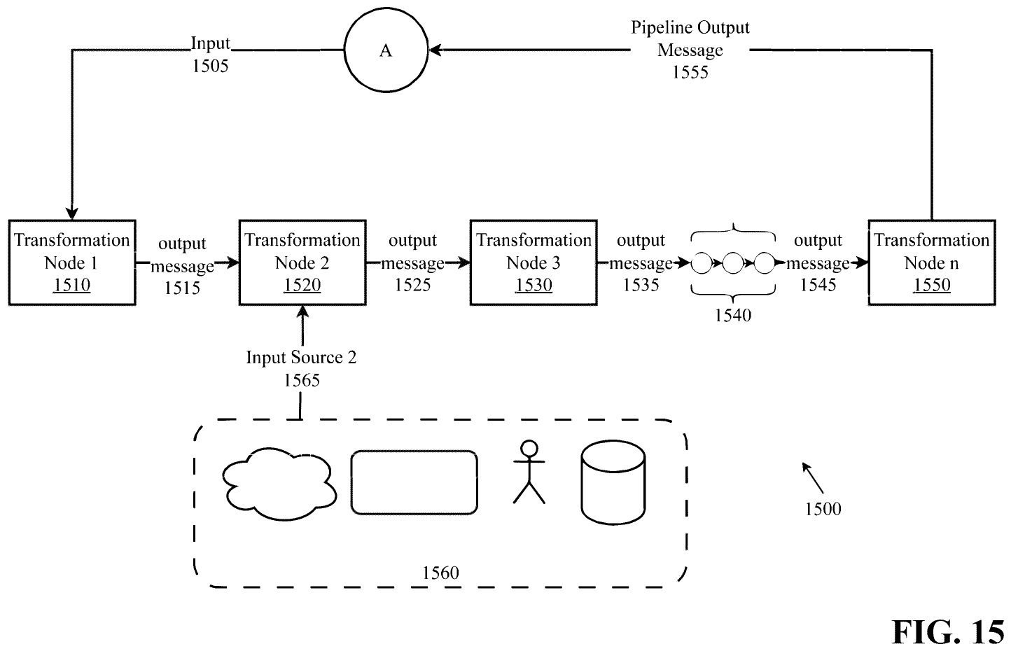

FIGS. 15-17 illustrate various exemplary aspects of system architectures and methods of distributed computational graph computing environments. For more detailed information regarding the operation of the various components and aspects described herein with respect to FIGS. 15-17, please refer to U.S. patent application Ser. No. 15/616,427 which is incorporated herein by reference.

FIG. 15 is a block diagram of an architecture for a transformation pipeline within a system for predictive analysis of very large data sets using distributed computational graph computing system 1500. According to the aspect, streaming input from a data filter software module, 1505 serves as input to the first transformation node 1510 of the transformation pipeline. Each transformation node's function 1510, 1520, 1530, 1540, 1550 is performed on input data stream and transformed output message 1515, 1525, 1535, 1545, 1555, 1565 is sent to the next step. In this aspect, transformation node 2 1520 has a second input stream 1560. The specific source of this input is inconsequential to the operation of the invention and could be another transformation pipeline software module, a data store, human interaction, physical sensors, monitoring equipment for other electronic systems or a stream from the internet as from a crowdsourcing campaign, just to name a few possibilities 1560. For example, a first input stream may comprise enterprise knowledge and a second input stream may comprise RAG data from a RAG marketplace. Functional integration of a second input stream into one transformation node requires the two input stream events be serialized. The illustrated system can perform this serialization using a decomposable transformation software module. While transformation nodes are described according to various aspects as uniform shape, such uniformity is used for presentation simplicity and clarity and does not reflect necessary operational similarity between transformations within the pipeline. It should be appreciated that one knowledgeable in the field will realize that certain transformations in a pipeline may be entirely self-contained; certain transformations may involve direct human interaction, such as selection via dial or dials, positioning of switch or switches, or parameters set on control display, all of which may change during analysis; other transformations may require external aggregation or correlation services or may rely on remote procedure calls to synchronous or asynchronous analysis engines as might occur in simulations among a plurality of other possibilities. For example, engines may be singletons (composed of a single activity or transformation). Furthermore, leveraging the architecture in this way allows for versioning and functional decomposition (i.e. embedding entire saved workflows as single nodes in other workflows). Further according to this aspect, individual transformation nodes in one pipeline may represent the function of another transformation pipeline. It should be appreciated that the node length of transformation pipelines depicted in no way confines the transformation pipelines employed by the invention to an arbitrary maximum length 1510, 1520, 1530, 1540, 1550, as, being distributed, the number of transformations would be limited by the resources made available to each implementation of the invention. It should be further appreciated that there need be no limits on transform pipeline length. Output of the last transformation node and by extension, the transform pipeline, 1550 may be sent back to messaging software module 562 for pre-decided action.

### Detailed Description of Exemplary Aspects

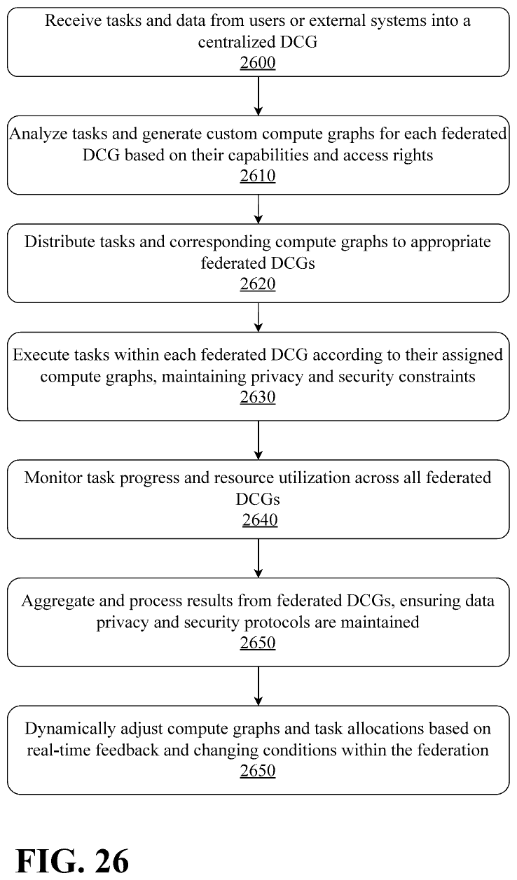

FIG. 26 is a flow diagram illustrating an exemplary method for a federated distributed graph-based computing platform. In a step 2600, the system receives tasks and data from users or external systems. This step initiates the federated computing process, where complex computational tasks are encoded into high-level computational graphs. These graphs represent the overall structure and dependencies of the required computations, and may include additional data such as application-specific information, machine learning models, datasets, or model weightings.

In a step 2610, the system analyzes the tasks and generates custom compute graphs for each federated node based on their capabilities and access rights. This involves examining each task to determine its specific requirements, such as computational power, data access needs, and security constraints. The system then creates tailored versions of the original computational graph, modified to fit the specific capabilities and access rights of each federated node. In a step 2620, the system distributes tasks and corresponding compute graphs to appropriate federated nodes. This involves securely transmitting these custom compute graphs to the respective federated nodes, along with any necessary data or models. This transmission occurs through a structured pipeline, ensuring efficient and secure distribution of tasks across the federation.

In a step 2630, tasks are executed within each federated node according to their assigned compute graphs, maintaining privacy and security constraints. The received compute graph is further broken down and distributed among internal components of each federated node. This step enables partial or blind execution, where some federated nodes may process only a portion of the overall computation, with limited visibility into the broader task. In a step 2640, the system monitors task progress and resource utilization across all federated nodes. As computations progress, each federated node reports back through the pipeline structure. This feedback includes task progress, resource utilization, and any issues encountered. The system aggregates this information, providing a high-level overview of the system's state.

In a step 2650, results from federated nodes are aggregated and processed, ensuring data privacy and security protocols are maintained. The system pieces together the final output from potentially encrypted or obfuscated results, maintaining the partial blindness of the execution where necessary. In a step 2660, the system dynamically adjusts compute graphs and task allocations based on real-time feedback and changing conditions within the federation. Based on the aggregated feedback, the system may decide to reallocate tasks or resources. It might modify compute graphs in real-time, reassign tasks to different federated nodes, or adjust resource allocations.

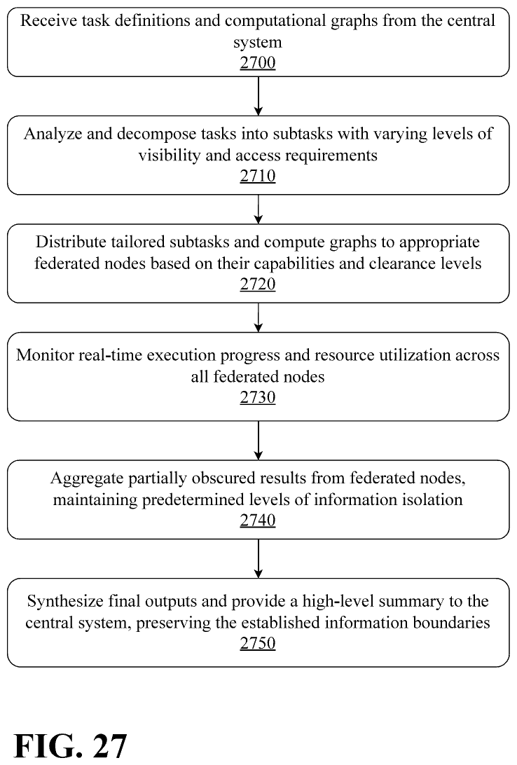

FIG. 27 is a flow diagram illustrating an exemplary method for a federated distributed graph-based computing platform that includes a federation manager. In a step 2700, the system receives task definitions and computational graphs from the central system. This initiates the process of distributed computing, where complex tasks are represented as computational graphs that can be broken down and distributed across the federation. These graphs encapsulate the structure, dependencies, and data requirements of the overall computational task.

In a step 2710, the system analyzes and decomposes tasks into subtasks with varying levels of visibility and access requirements. This step involves breaking down the received computational graphs into smaller, manageable components. Each subtask is assigned specific visibility and access levels, enabling the system to implement partial or blind execution strategies. This decomposition allows for fine-grained control over information flow within the federated network. In a step 2720, the system distributes tailored subtasks and compute graphs to appropriate federated nodes based on their capabilities and clearance levels. This distribution process takes into account the specific attributes of each federated node, including its computational resources, security clearance, and current workload. The system ensures that each node receives only the information and tasks it is authorized to process, maintaining the integrity of the partial blindness approach.

In a step 2730, the system monitors real-time execution progress and resource utilization across all federated nodes. This ongoing monitoring process allows the system to track the progress of distributed tasks, assess the performance of individual nodes, and identify any bottlenecks or issues in real-time. The system collects data on task completion rates, resource usage, and any anomalies encountered during execution. In a step 2740, the system aggregates partially obscured results from federated nodes, maintaining predetermined levels of information isolation. As federated nodes complete their assigned subtasks, they return results that may be intentionally obscured or encrypted to maintain the partial blindness of the execution. The system collects these results, ensuring that the predetermined levels of information isolation are preserved throughout the aggregation process.

In a step 2750, the system synthesizes final outputs and provides a high-level summary to the central system, preserving the established information boundaries. This final step involves combining the partially obscured results into a coherent output that addresses the original task requirements. The system generates a high-level summary that encapsulates the results of the distributed computation while carefully maintaining the information boundaries established earlier in the process. This summary is then provided to the central system, completing the federated computation cycle while preserving the security and privacy constraints of the distributed network.

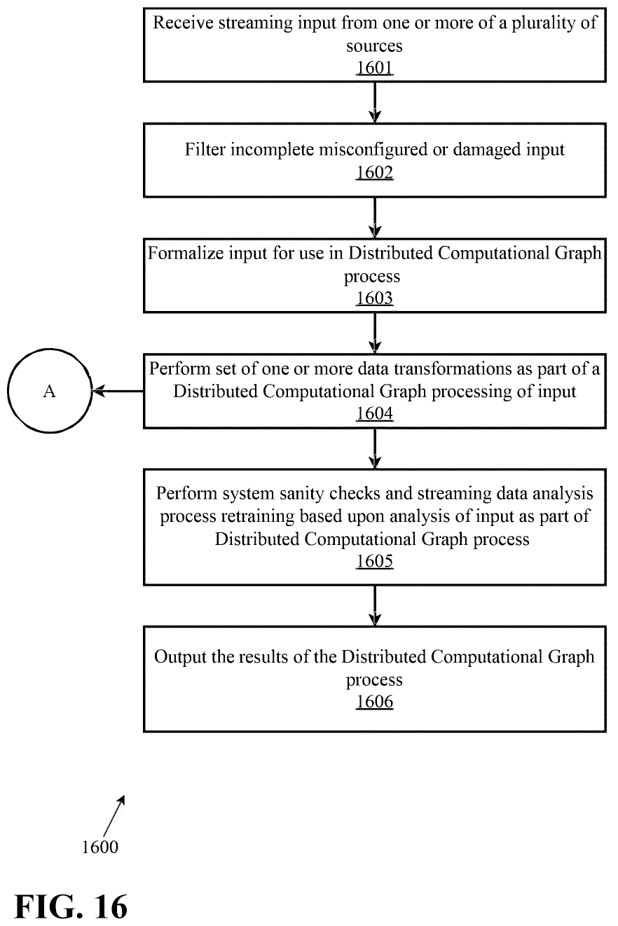

FIG. 16 is a process flow diagram of a method 1600 for predictive analysis of very large data sets using the distributed computational graph. One or more streams of data from a plurality of sources, which includes, but is in no way not limited to, a number of physical sensors, web-based questionnaires and surveys, monitoring of electronic infrastructure, crowd sourcing campaigns, and direct human interaction, may be received by system 1601. The received stream is filtered 1602 to exclude data that has been corrupted, data that is incomplete or misconfigured and therefore unusable, data that may be intact but nonsensical within the context of the analyses being run, as well as a plurality of predetermined analysis related and unrelated criteria set by the authors. Filtered data may be split into two identical streams at this point (second stream not depicted for simplicity), wherein one substream may be sent for batch processing 1600 while another substream may be formalized 1603 for transformation pipeline analysis 1604, 1500, and retraining 1605. Data formalization for transformation pipeline analysis acts to reformat the stream data for optimal, reliable use during analysis. Reformatting might entail, but is not limited to: setting data field order, standardizing measurement units if choices are given, splitting complex information into multiple simpler fields, and stripping unwanted characters, again, just to name a few simple examples. The formalized data stream may be subjected to one or more transformations. Each transformation acts as a function on the data and may or may not change the data. Within the invention, transformations working on the same data stream where the output of one transformation acts as the input to the next are represented as transformation pipelines. While the great majority of transformations in transformation pipelines receive a single stream of input, modify the data within the stream in some way and then pass the modified data as output to the next transformation in the pipeline, the invention does not require these characteristics. According to the aspect, individual transformations can receive input of expected form from more than one source or receive no input at all as would a transformation acting as a timestamp. According to the aspect, individual transformations may not modify the data as would be encountered with a data store acting as a queue for downstream transformations. According to the aspect, individual transformations may provide output to more than one downstream transformations. This ability lends itself to simulations where multiple possible choices might be made at a single step of a procedure all of which need to be analyzed. While only a single, simple use case has been offered for each example, in each case, that example was chosen for simplicity of description from a plurality of possibilities, the examples given should not be considered to limit the invention to only simplistic applications. Last, according to the invention, transformations in a transformation pipeline backbone may form a linear, a quasi-linear arrangement or may be cyclical, where the output of one of the internal transformations serves as the input of one of its antecedents allowing recursive analysis to be run. The result of transformation pipeline analysis may then be modified by results from batch analysis of the data stream and output 1606 in format predesigned by the authors of the analysis with could be human readable summary printout, human readable instruction printout, human-readable raw printout, data store, or machine encoded information of any format known to the art to be used in further automated analysis or action schema.

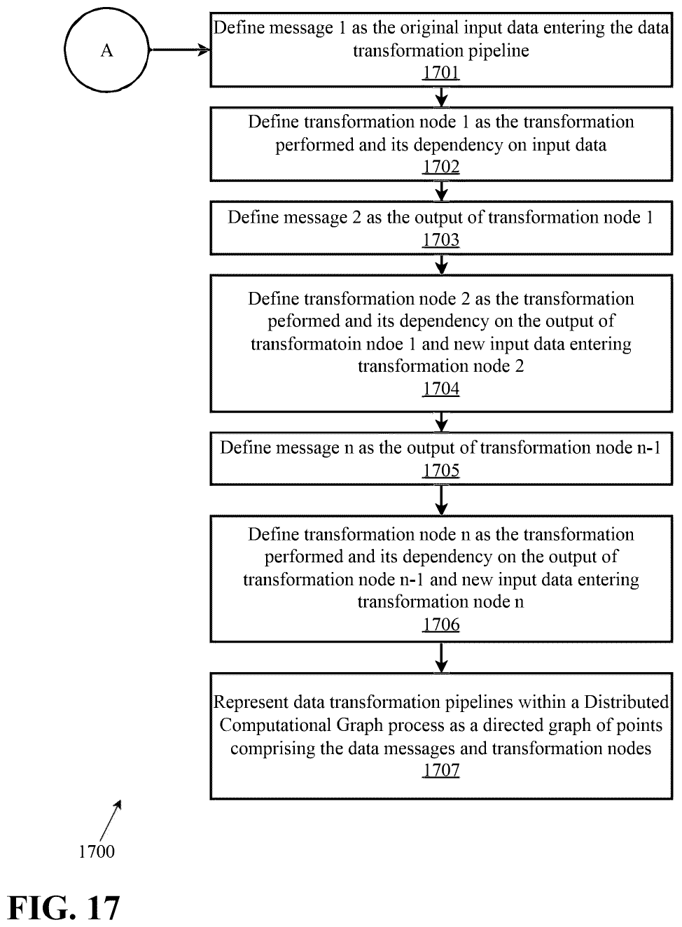

FIG. 17 is a process flow diagram of a method 1700 for an aspect of modeling the transformation pipeline module as a directed graph using graph theory. According to the aspect, the individual transformations 1702, 1704, 1706 of the transformation pipeline t₁ . . . tₙ such that each tᵢ T are represented as graph nodes. Transformations belonging to T are discrete transformations over individual datasets dᵢ, consistent with classical functions. As such, each individual transformation tⱼ, receives a set of inputs and produces a single output. The input of an individual transformation tᵢ is defined with the function in: tᵢ d₁ . . . dₖ such that in(tᵢ)={d₁ . . . dₖ) and describes a transformation with k inputs. Similarly, the output of an individual transformation is defined as the function out: tᵢ[ld₁] to describe transformations that produce a single output (usable by other transformations). A dependency function can now be defined such that dep(tₐ,t_{b}) out(tₐ)in(t_{b})The messages carrying the data stream through the transformation pipeline 1701,1703, 1705 make up the graph edges. Using the above definitions, then, a transformation pipeline within the invention can be defined as G=(V,E) where message(t₁,t₂ . . . t(ₙ₋₁),tₙ)V and all transformations t₁.·tₙ and all dependencies dep(tᵢ,tⱼ)E 1707.

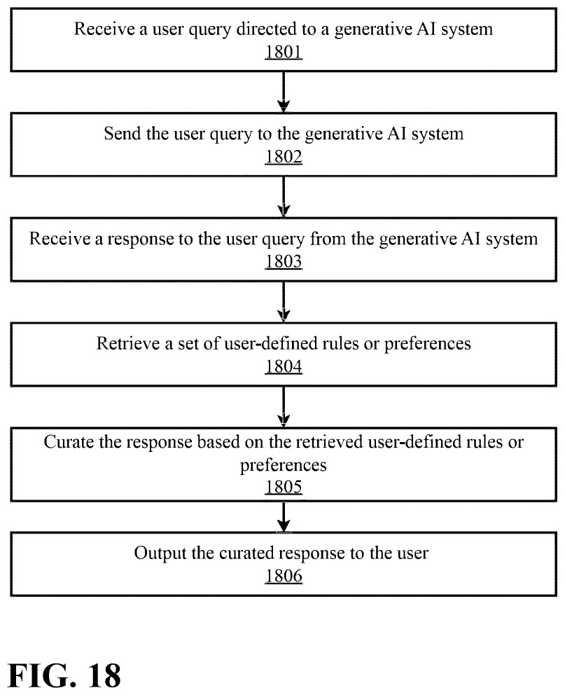

FIG. 18 is a flow diagram illustrating an exemplary method for providing experience curation, according to an aspect of an embodiment. According to the aspect, the process begins at step 1801 when a distributed generative AI reasoning and action platform receives a user query directed to a generative AI system. The query may comprise a request for information, a summary, a request for a document, or some other action. The user may submit their query to the platform via an experience curation portal such as through a web app or website accessed via an Internet browser operating on a computer (e.g., personal computer, laptop), or through an associated curation application which can be operated on a mobile computing device (e.g., smart phone, tablet, smart wearable, IoT device, etc.). In some implementations, the received user query may be sent to a data embedding system which can vectorize the query and store it in a vector database where it may be retrieved to be used as contextual data included in a query/prompt sent to a generative AI system.

At step 1802 the query is sent to the generative AI system which processes the query and returns a generated response which is received by the platform at step 1803. At step 1804 curation system locates and retrieves any available user-defined rules or preferences. In some embodiments, the user-defined rules/preferences may be defined by an entity (e.g., a company). Exemplary rules or preferences can include, but are not limited to, conditional generation preferences, formatting rules, language rules, style rules, geographic rules, environmental rules, and timing rules. As for conditional generation rules, the model can be conditioned on specific input data related to the individual, such as preferences, behavior, and characteristics. For example, in text generation, the model could be conditioned on a user's previous messages or writing style to generate more personalized responses. Formatting, style, and language rules are closely related and may be used to curate a response in a specific format (e.g., bullet points, paragraph, single sentence, numbered outline, CSV, etc.), response style (e.g., formal, informal, academic, accessible, abstract, casual, etc.), and the language in which a response is translated, respectively. At step 1805 curation system can curate the response based on the retrieved user-defined rules or preferences. For example, the system may filter out extraneous data, or personal information. As a last step 1806, curation system returns the curated response to the user, thereby providing experience curation to a platform user.

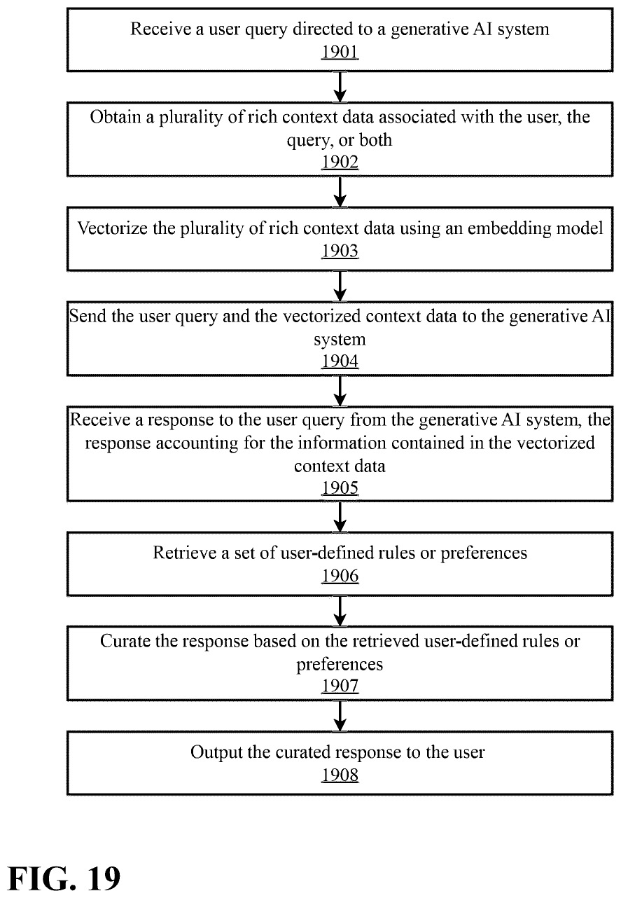

FIG. 19 is a flow diagram illustrating an exemplary method for providing experience curation with using rich contextual data, according to an aspect of an embodiment. According to the aspect, the process begins at step 1901 when a distributed generative AI reasoning and action platform receives a user query directed to a generative AI system. The query may comprise a request for information, a summary, a request for a document, or some other action. The user may submit their query to the platform via an experience curation portal such as through a web app or website accessed via an Internet browser operating on a computer (e.g., personal computer, laptop), or through an associated curation application which can be operated on a mobile computing device (e.g., smart phone, tablet, smart wearable, IoT device, etc.). In some implementations, the received user query may be sent to a data embedding system which can vectorize the query and store it in a vector database where it may be retrieved to be used as contextual data included in a query/prompt sent to an ML, AI, generative AI, planning, or automation/action orchestration system.

A DCG orchestrated model which employs a hierarchical classification and model selection regime for content (either in whole or in part) can enable much more accurate ultimate semantic performance. For example, a query/prompt can be submitted to the generative AI system with additional metadata associated with the context of the prompt itself as well as additional broader information about the user and the user's ongoing behavior and/or activities. At step 1902 the system obtains a plurality of rich context data associated with the user, the query, or both. A subset of the plurality of context data information may be obtained from a vector database, the vector database comprising a plurality of embedded contextual data. Embedded contextual data can comprise (but is not limited to) information obtained from an enterprise knowledge base and embedded queries/prompts. Context data associated with the user may comprise information obtained from or related to one or more of a computing device on which the user is accessing the curation system/platform, the geographic location the user is located, an action the user is performing during interaction with the curation system/platform, and timing data associated with the user, and/or the like. A subset of the plurality of obtained context data may be obtained from one or more marketplaces such as a data marketplace and/or an expert judgment marketplace. In some embodiments, the selection of context data may be based on one or more expert judgment scores assigned to an information source or dataset.

As an example, if a user is asking a generative AI enhanced search engine for “the best pizza” on her cell phone while driving at 55 mph on the road and not near her home (e.g. on vacation) this is massively different from the user being at home, on her couch, connected on her laptop, from her normal IP address, having just ran a series of searches for airline tickets to Italy and Neapolitan Pizza recipes. The additional device, user, recent behavior, etc. content can be used by a classifier alongside a prompt to help focus results on things that are not only relevant (e.g. pizza places near the user that are open now) but likely to be consistent with her broader needs/persona (e.g. if available, the suggestions could be looked at based on other budget, dining, etc. preferences like outdoor seating and meals below $20 per person). The same principle applies to more complicated and complex topics like medicine or finance or law.

At step 1903 the obtained plurality of context data may be processed into vectors by an embedding model and stored in the vector database.

At step 1904 the user query and the vectorized context data is sent to the generative AI system which processes the query and returns a generated response which accounts for the information contained in the vectorized context data and which is received by the platform at step 1905. At step 1906 curation system locates and retrieves any available user-defined rules or preferences. In some embodiments, the user-defined rules/preferences may be defined by an entity (e.g., a company). Exemplary rules or preferences can include, but are not limited to, conditional generation preferences, formatting rules, language rules, style rules, geographic rules, environmental rules, and timing rules. With respect to conditional generation rules, the model can be conditioned on specific input data related to the individual, such as preferences, behavior, and characteristics. For example, in text generation, the model could be conditioned on a user's previous messages or writing style to generate more personalized responses. Formatting, style, and language rules are closely related and may be used to curate a response in a specific format (e.g., bullet points, paragraph, single sentence, numbered outline, CSV, etc.), response style (e.g., formal, informal, academic, accessible, abstract, casual, etc.), and the language in which a response is translated, respectively. At step 1907 curation system can curate the response based on the retrieved user-defined rules or preferences. For example, the system may filter out extraneous data, or personal information. As a last step 1908, curation system returns the curated response to the user, thereby providing experience curation to a platform user.

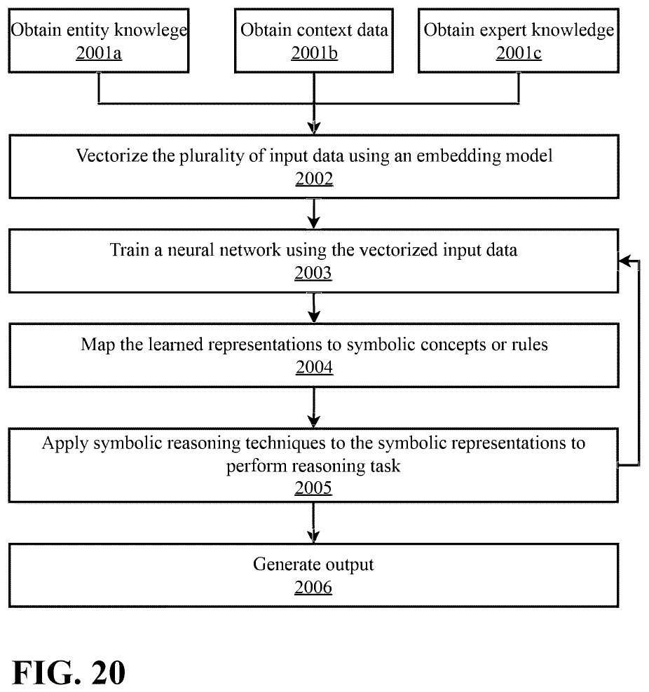

FIG. 20 is a flow diagram illustrating an exemplary method for providing distributed neuro-symbolic reasoning and action model, according to an aspect of an embodiment. A neuro-symbolic model combines neural network-based approaches with symbolic reasoning to enable a more flexible and powerful reasoning system. In neuro-symbolic reasoning, neural networks are used to learn representations of data, similar to how they are used in deep learning. These learned representations can then be combined with symbolic representations and rules to perform reasoning tasks. This combination allows for the strengths of both approaches to be leveraged: the ability of neural networks to learn complex patterns from data, and the ability of symbolic reasoning to represent and manipulate abstract concepts and rules.

According to the aspect, the process begins at step 2001a-c wherein a plurality of input data is obtained from various sources. Examples of input data can include entity knowledge 2001a, context data 2001b, and expert knowledge 2001c. Other types of data may be obtained and may be dependent upon the embodiment and the particular use case. Data may be obtained from third-party services, entity databases/data warehouses/knowledge base and/or the like, and various marketplaces for data, algorithms, RAGs, and/or expert judgment. At step 2002 the obtained plurality of input data is vectorized using an embedding model and stored in a vector database. Vectorizing the data allows it to be used as input for processing by a neural network. At step 2003 platform 120 can train the neural network using the input data to learn patterns and relationships in the data. In some embodiments, this step may involve using labeled examples and supervised learning. A recurrent neural network or some other transformer-based model may be used as the basis for the neural network. At step 2004 the system maps the learned representations to symbolic concepts or rules. At this step, the system learns to represent the learned features or representations from the neural network in symbolic form. At step 2005 the system applies reasoning techniques to the symbolic representations to perform reasoning tasks. Examples of reasoning techniques that may be implemented can include, but are not limited to, logic rules or inference engines. This step may involve combining the learned representations with existing knowledge or rules to derive new conclusions. At this point in the process a feedback loop is created wherein feedback from the symbolic reasoning step is incorporated back into the neural network to refine the learned representations. This feedback loop helps improve system performance over time. As a last step 2006, the trained, distributed GenAI reasoning and action model can generate output of the reasoning process, which could be a decision, a prediction, or an action based on the input data and the reasoning process. In some embodiment, the input data may further include a query/prompt and metadata comprising various contextual information about the user and/or prompt.

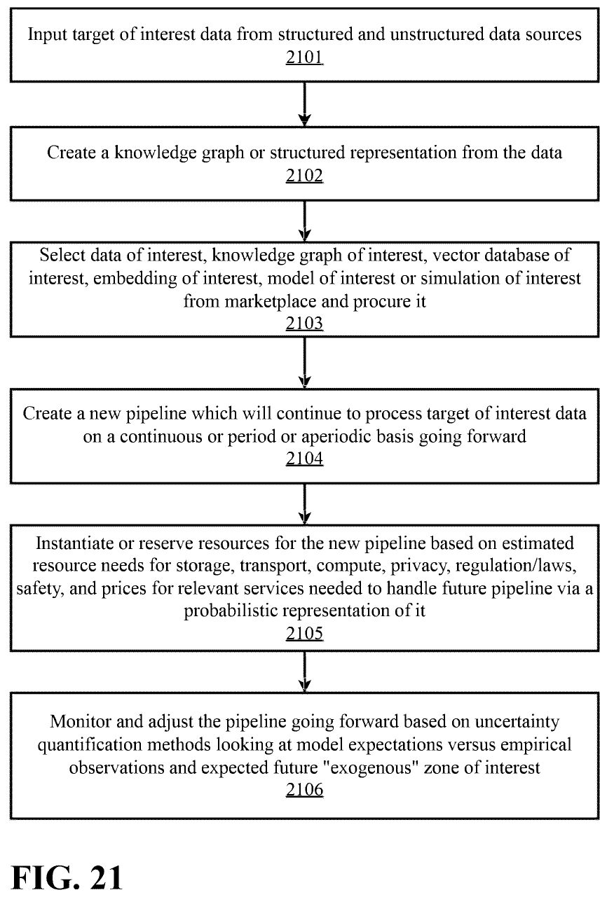

FIG. 21 is a flow diagram illustrating an exemplary method for using a distributed computation graph system for creating structured representations or knowledge graphs from various data sources, and setting up a pipeline for continuous processing and monitoring of that data, according to an embodiment. According to the embodiment, the process begins at step 2101 when the platform receives a plurality of input data of interest from structured (e.g., databases, spreadsheets, etc.) and unstructured (e.g., documents, websites, social media, etc.) data sources. Data may be obtained using data extraction techniques such as, for example, web scraping, APIs, natural language processing, etc.). Additionally, or alternatively, the data may be obtained from a data marketplace (e.g., expert judgment, RAGs, models, datasets, etc.). At step 2102 platform creates a knowledge graph or structured representation from data of interest. This may comprise applying information extraction methods (e.g., named entity recognition, relation extraction, etc.) to extract entities and relationships from unstructured data and integrating the extracted information with structured data sources. Further, a knowledge graph representation can be built by creating nodes for entities and edges for relationships. Optionally, platform can be configured to create vector representations of entities/relationships using techniques like word embeddings.

At step 2103, platform selects data of interest, knowledge graph of interest, vector database of interest, embedding of interest, model of interest or simulation of interest from marketplace and procures it. Platform can search/browse a marketplace or repository for relevant data sources, knowledge graphs, vector databases, models, simulations, etc., and evaluate the potential options based on factors like relevance, quality, and cost. This step may further include purchasing or licensing selected assets for use in a pipeline. As a next step 2104, platform creates a new pipeline which will continue to process target of interest data on a continuous or periodic or aperiodic basis going forward. The pipeline may be designed (e.g., batch, streaming, etc.) based on the processing needs and can integrate components for data ingestion, knowledge graph updates, model execution and/or the like.

At step 2105, platform can instantiate or reserve resources for the new pipeline based on estimated resource needs for storage, transport, compute, privacy, regulation/laws, safety, and prices for relevant services needed to handle future pipeline via a probabilistic representation of it. Platform may estimate pipeline resource requirements (storage, compute, networking, etc.) and also consider privacy, regulatory, and safety constraints that impact resource needs. Platform may use probabilistic modeling to forecast future resource demands. This step may further comprise provisioning cloud/on-premise resources (e.g., virtual machines, containers, databases, etc.) accordingly. As a last step 2106, platform monitors and adjusts the pipeline going forward based on uncertainty quantification methods looking at model expectations versus empirical observations and expected future “exogenous” zone of interest. A pipeline may be monitored for performance, data drift, model accuracy, etc. and by tracking metrics like data volumes, processing times, error rates, and model accuracies. Platform may use techniques such as, for example, Bayesian modeling to quantify uncertainties in model parameters and propagate input/parameter uncertainties through the model(s) to get prediction uncertainties. Techniques such as bootstrap, cross-validation can also quantify model uncertainties. Platform can identify external variables (e.g., new regulations, market shifts, technology changes, etc.) that may impact the “zone of interest” and quantify potential impacts on pipeline performance/relevance. As an example, platform could implement monitoring for these variables using web scraping, news feeds, etc.

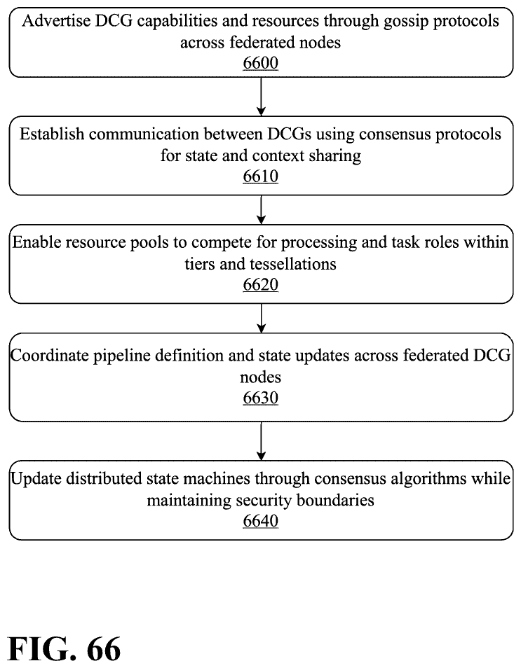

FIG. 66 is a flow diagram illustrating an exemplary method for implementing gossip and consensus flows within and across tiers/tessellations of resource pools in a federated distributed graph-based computing platform. In step 6600, each DCG advertises its capabilities and available resources to peers through gossip protocols. This enables DCGs to operate in a fully decentralized manner, with workloads distributed through direct DCG-to-DCG communication without requiring central coordination.

In a step 6610, the system establishes communication between DCGs using industry-standard consensus protocols. This may include but is not limited to the Zookeeper Atomic Broadcast (ZAB) protocol, the Raft consensus algorithm and associated communication model in KRaft, or other protocols and consensus algorithms like Paxos, or serverless implementations like FaasKeeper. These protocols enable distributed state and job objective management through DCG intercommunication. This flexibility in protocol selection and implementation is critical for enabling more advanced kinds of federated and transfer learning at scale and better addressing privacy concerns, data locality regulations/restrictions, and user preferences on top of efficiency in processing, transport and storage of data at massive scale.

In a step 6620, the system enables resource pools to compete for processing and task roles within tiers and tessellations. DCGs within a federation communicate context and state as needed to accomplish job objectives. This enables potential tiers or tessellations of resource pools to compete for both processing and task roles, while also supporting pipeline definition and state updates. This competition and coordination can occur in a fully decentralized manner, where DCGs discover and coordinate with each other through gossip protocols, enabling workloads to be distributed through direct DCG-to-DCG communication without requiring central coordination.

In a step 6630, the system coordinates pipeline definition and state updates across federated DCG nodes. This implements the federation capabilities, where DCGs coordinate pipeline definition and context and state updates across the federation. The system supports execution of data flows and orchestration of resources across cloud (e.g., hyperscale), self-managed (e.g., traditional data center) computer clusters, CDNs (e.g., forward content distribution networks that may expand from historical distribution of web content into forward hosting of data sets, models, AI tools, etc . . . ), edge devices, wearables and mobile devices, and individual computers. This enables computational graph specifications to be communicated between different people, processes, AI agents and collections of logical or hardware resources.

In a step 6640, the system updates distributed state machines through consensus algorithms while maintaining security boundaries. This enables sharing and availability of information across systems via distributed state machine and associated gossip methods and consensus protocols. The system aggregates contextual data from local or global and internal or external sources or other localized DCG processes in the federated system made known to it, whether within a given system or as shared or made available from other systems. This approach supports continuous learning from both empirical observations and hypothetical state space explorations of decision spaces, particularly applicable to decision making under uncertainty in complex adaptive systems but also with applicability for everyday interactions and delegated agentic activities.

According to an aspect, the process enables multi-stakeholder distributed artificial intelligence reasoning and action through a cloud-based computing architecture. The system maintains flexibility through distributed state and job objective management, critical for enabling advanced kinds of federated and transfer learning at scale while addressing privacy concerns, data locality regulations/restrictions, and user preferences. This is facilitated by ongoing analysis of the system of interest to the observer, including awareness of observer perspective, which is typically (but not necessarily) the beneficiary of the flow-based computing enabled by the system. The system supports both empirical observations and hypothetical state space explorations of decision spaces, making it particularly applicable to decision making under uncertainty in complex adaptive systems while also supporting everyday interactions and delegated agentic activities across multiple scales, geographies, and timeframes.

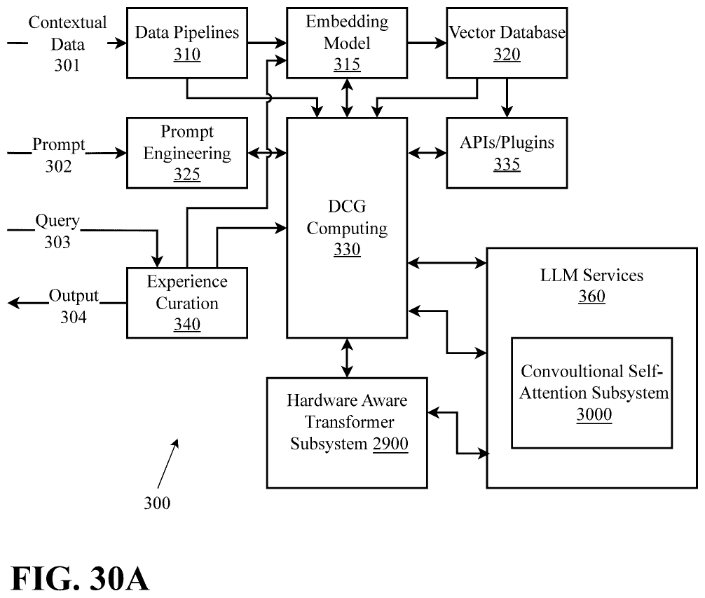

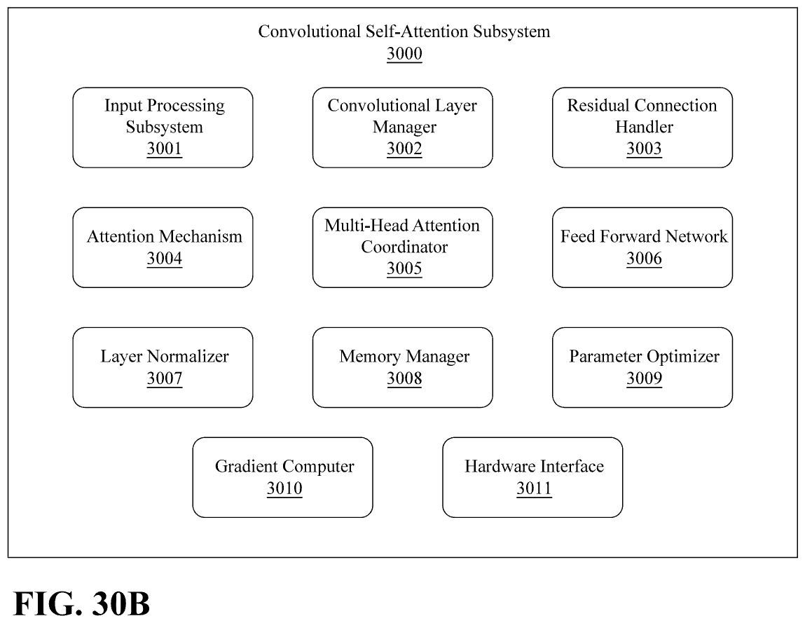

FIG. 30A is a block diagram illustrating an exemplary system architecture for a component of a distributed generative artificial intelligence reasoning and action platform wherein the LLM services further comprise a convolutional self-attention subsystem. Convolutional Self-Attention (CSA) subsystem 3000 represents a significant advancement in the distributed generative AI reasoning and action platform, seamlessly integrating with existing components to enhance the efficiency and performance of transformer models. This subsystem replaces traditional attention mechanisms with convolutional operations, offering substantial benefits in terms of computational efficiency and scalability.

CSA subsystem 3000 operates in close conjunction with DCG computing 330 component, leveraging the distributed computational graph to orchestrate complex workflows that incorporate convolutional self-attention mechanisms. This integration allows for more efficient processing of input sequences, particularly beneficial for tasks involving long-range dependencies or high-resolution inputs. For instance, when processing lengthy documents or high-resolution images, the CSA subsystem 3000 can maintain global receptive fields while utilizing local convolution kernel windows, significantly reducing computational complexity.

In its interaction with embedding model 315 and vector database 320, CSA subsystem 3000 enhances the platform's ability to handle and process large-scale data efficiently. By employing convolutional operations, it can generate more compact and efficient representations of input data, potentially reducing the dimensionality of embeddings without sacrificing contextual information. This optimization cascades through the system, allowing for more efficient storage and retrieval of vectorized data in the vector database.

CSA subsystem 3000 works in tandem with prompt engineering 325 component to enable more efficient processing of prompts and generation of responses. By leveraging convolutional operations, it can capture local and global context more efficiently, potentially allowing for more nuanced and context-aware prompt engineering strategies. This could lead to more precise and relevant outputs, especially in scenarios requiring understanding of long-range dependencies or complex spatial relationships in the input data. In an embodiment, prompt engineering component evaluates system prompt, user prompt, background information and prompt specific content insertions for each model submission and makes recommendations (or may automatically) construct an alternative prompt or prompt sequence. For example, a prompt with insufficient context may be improved by selective use of RAG or database for vector db chunks or recent general or user-specific model interactions or some combination thereof. The system may leverage a user provided, system provided, or dynamically generated input quality metric or objective function before submitting a given query to an LLM (or other model). This may be particularly useful for cost, access, and efficiency considerations on advanced models (which are routinely restricted upon initial release by Anthropic, OpenAI, and other providers). One example is decomposing a given prompt and data context into subordinate Transformations which may be expressed as an LLM specific DCG in the form of a directed acyclic graph of a directed graph. In certain implementations, cycles, particularly in cases where LLM output fails to meet intent, can be immensely valuable to users or machine generated DCG specified processes or flows as long as exit criteria through computed linearization of a finite DAG at execution time by system are provided. The system may optionally be configured to simultaneously submit a user prompt, or some decomposed element, to more than one model (e.g., some on premise or local LLM like Ollama alongside remote API calls to services like AWS Bedrock, Anthropic Claude, or OpenAI ChatGPT). This enables a multitude of model consensus, model debate, model blend, or basic neuro-symbolic reasoning approaches, such as using datalog enabled deductive reasoning on structured data returned from an LLM enabled series of database queries from SQL, NoSQL, KG, or even vector databases to compare deductive symbolic reasoning from an expert rule set against LLM outputs.

The localized LLM prompt optimizer in the system is designed to maximize utilization of the available context window for each submission by creating a prioritized understanding of relevant tokens. This involves dynamically extracting and ranking tokens from a cache of prior conversations, current conversations, or active processes related to a given submission. By selectively pulling in the most pertinent context, the system ensures that the maximum amount of relevant information is included in the prompt provided to the LLM.

The system implements a dynamic context window optimization framework through several integrated components. A context scoring a prioritization engine performs token relevance scoring using multiple configurable methods including: semantic similarity analysis using models such as all-MiniLM-L6-v2 with configurable thresholds and weights; temporal decay calculations with adjustable half-life periods; causal chain analysis with configurable maximum depths; and interaction importance metrics tracking user explicit references and system dependencies.

Context block management is implemented with configurable parameters including: minimum block sizes of 50 tokens, maximum block sizes of 512 tokens, overlap buffers of 25 tokens; compression ratios of 0.8, and preservation rules for maintaining semantic completeness, code block integrity, and definition pair relationships.

The window composition strategy implements dynamic allocation across multiple components such as system prompts (150-500 tokens with 0.9 priority), current queries (100-1000 tokens with 1.0 priority), historical context (dynamic allocation based on remaining space with 0.7 priority), and working memory (100-300 tokens with 0.8 priority).

The system employs a sophisticated memory management architecture with multiple storage layers: active memory utilizing a sliding window retention policy with real-time updates; short-term cache supporting up to 50,000 tokens with LRU retention and compression, long-term storage implemented in vector databases using HNSW indexing, and retrieval metrics incorporating semantic relevance, temporal proximity, usage frequency, and causal importance.

The context assembly pipeline implements a multi-stage process including pre-processing with deduplication using semantic clustering (0.92 threshold), compression maintaining semantic preservation (0.8 ratio), normalization across Unicode, whitespace, special tokens, historical assembly of core, and supporting context layers.

Additionally, the system implements a conversion decomposition engine with sophisticated analysis parameters including semantic boundary detection using transformer attention mechanisms, topic clustering using hierarchical DBSCAN, dependency tracking with directed weighted graphs, and reconstruction rules maintaining references and variable scope.

The system further enhances security through implementation of a dynamic prompt security and audit framework. This framework leverages Graph-level anomaly detection via Hierarchical Memory Networks (HimNet) to enhance security measures against potential jailbreak attempts on LLMs. By adapting HimNet for anomaly detection within localized LLM prompt sequence directed acyclic graphs (DAGs), the system achieves robust detection of anomalies at both local and global levels. The security framework implements hierarchical memory modules for prompt DAGs including: node memory module for capturing fine-grained deviations in prompt-token relationships; and graph memory module for identifying holistic anomalies across execution sequences. The system maintains a multi-layer audit pipeline with: pre-execution analysis performing static analysis of token patterns; runtime monitoring implementing dynamic pattern recognition; and post-execution validation ensuring response content and behavior consistency. An anomaly scoring framework evaluates: structural anomaly through graph topology deviation analysis; semantic anomaly using content similarity measures; and behavioral anomaly based on execution pattern analysis. Protection mechanisms include immediate response actions such as: query modification through token santization; execution control including path termination; pattern learning for attack signature updates; and model protection implementing boundary enforcement. The system implements real-time monitoring and reporting capabilities including: metrics collection for performance indicators; alert generation based on threshold triggers; trend analysis tracking pattern evolution; and report generation for security status and compliance. This integrated approach enables efficient processing of prompts while maintaining robust security measures and optimal resource utilization across the system.

Integration with experience curation 340 component allows the CSA subsystem 3000 to contribute to more efficient and effective curation of AI-generated content. The computational efficiency gained through convolutional self-attention can be leveraged to process and analyze larger volumes of generated content, potentially enabling more sophisticated curation strategies that consider broader context and nuanced relationships within the data. CSA subsystem 3000 also enhances the capabilities of LLM services 360 component. By providing a more efficient alternative to traditional self-attention mechanisms, it allows for the deployment of larger and more powerful language models within the same computational constraints. This could enable the platform to handle more complex language tasks or operate with improved performance on resource-constrained devices.

In one embodiment, CSA subsystem 3000 may work in harmony with Hardware Aware Transformer (HAT) subsystem 2900, creating a powerful synergy between hardware-aware optimization and efficient attention mechanisms. The HAT subsystem 2900 can leverage the computational characteristics of convolutional self-attention to make more informed decisions about model deployment and resource allocation. For example, on devices with limited memory bandwidth, CSA subsystem's 3000 enables efficient use of local computations that may be preferentially utilized to maintain model performance while reducing memory access requirements.

In practice, when a user submits a query 303, the system leverages the CSA subsystem 3000 to process the input more efficiently. The convolutional operations allows for parallel or even distributed processing of the input sequence, capturing both local and global dependencies. This processed information is then passed through the embedding model and vector database, where the efficient representations generated by the CSA subsystem 3000 enable faster retrieval of relevant contextual information. As the query is processed through LLM services 360, CSA subsystem's 3000 efficient attention mechanism allows for handling of longer sequences or more complex relationships within the same computational budget. HAT subsystem 2900 simultaneously optimizes the deployment of these models based on the current hardware environment, leveraging CSA subsystem's 3000 computational characteristics. When generating output 304, the system utilizes CSA subsystem 3000 to efficiently process and generate the response, potentially allowing for more coherent long-form outputs or handling of more complex, multi-modal inputs.

This holistic integration of CSA subsystem 3000 across the platform's components enables a new level of efficiency in AI processing. It allows the system to handle larger inputs, process information more efficiently, and potentially improve the quality of outputs across a diverse range of hardware environments. The result is a more responsive, scalable, and capable AI system that can deliver enhanced performance across a wide range of applications and deployment scenarios.

FIG. 30B is a block diagram illustrating an exemplary subsystem architecture for a distributed generative artificial intelligence reasoning and action platform with an integrated convolutional self-attention subsystem, a convolutional self-attention subsystem. At its core, input processing subsystem 3001 serves as the initial point of contact for incoming data, closely interfacing with data pipelines 310 of the main architecture. It prepares the input for convolutional processing, potentially reshaping or padding the data as needed. This preprocessing step is for maintaining the spatial or sequential relationships within the input, whether it's text, images, or other modalities.

Convolutional layer manager 3002 works in tandem with embedding model 315, applying convolutional operations to the input representations. This process captures local patterns efficiently, providing a strong foundation for subsequent attention mechanisms. By leveraging convolutional operations, the system can process larger input sizes more efficiently than traditional self-attention alone, which is particularly beneficial for tasks involving high-resolution images or long sequences of text.

Residual connection handler 3003 maintains the flow of information through the network, working closely with DCG computing 330 component to manage the complex data flows within the model. These residual connections allow the model to learn incremental representations, which is for maintaining performance in very deep networks.

Central to CSA subsystem 3000, attention mechanism 3004 and multi-head attention coordinator 3005 work in concert to capture both local and global dependencies in the input. These components interface with general transformer service module 1060 and decomposable transformer service module 1050, providing an efficient alternative to traditional self-attention. By operating on the output of convolutional layers, this attention mechanism can maintain a global receptive field while leveraging the efficiency of local convolutional operations. Feed forward network 3006 and layer normalizer 3007 work together to process the attended representations, interfacing with hardware-aware transformer subsystem 2900 to ensure optimal utilization of available computational resources. Feed forward network 3006 applies non-linear transformations to the attended representations, while layer normalizer 3007 helps stabilize the learning process and accelerate training.

In one embodiment, memory manager 3008 plays a role in optimizing the use of computational resources, working closely with hardware management layer 2800 to efficiently allocate and manage memory for the convolutional and attention operations. This is particularly important when processing large inputs or deploying models on memory-constrained devices. Parameter optimizer 3009 and gradient computer 3010 form the learning core of the CSA subsystem 3000, interfacing with automated planning service module 1030 to continuously refine the model's parameters based on performance feedback. These components ensure that the convolutional self-attention mechanism adapts to the specific characteristics of the tasks and data it encounters.

Hardware interface 3011 serves as a link between CSA subsystem 3000 and hardware-aware transformer subsystem 2900. It provides detailed information about the computational characteristics of convolutional self-attention operations, allowing for more informed decisions about model deployment and resource allocation.

This holistic integration allows CSA subsystem 3000 to provide a powerful and efficient attention mechanism that scales well to large inputs and complex tasks. It enables the system to process information more efficiently across a wide range of hardware environments, from resource-constrained edge devices to powerful cloud servers. The result is a highly adaptable and efficient AI system that can deliver enhanced performance across diverse applications and deployment scenarios, truly embodying the next generation of AI infrastructure.

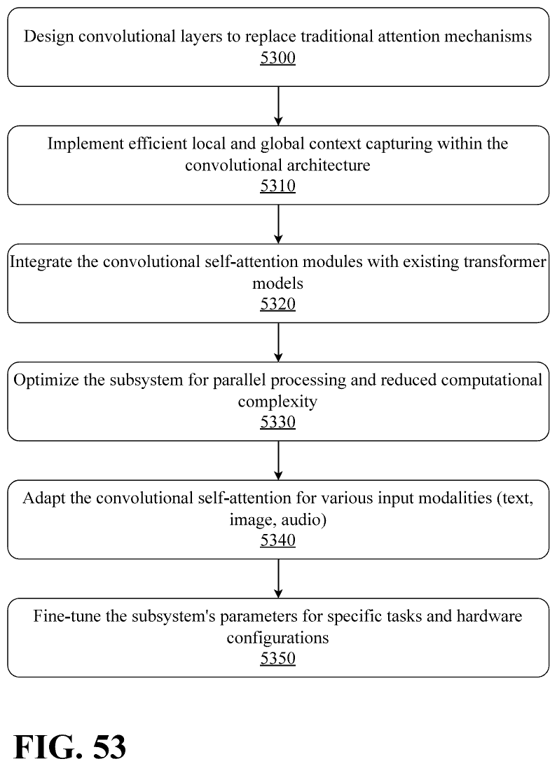

FIG. 53 is a flow diagram illustrating an exemplary method for a distributed generative artificial intelligence reasoning and action platform wherein the LLM services further comprise a convolutional self-attention subsystem. In a first step 5300, the system designs convolutional layers to replace traditional attention mechanisms. This step involves creating specialized convolutional neural network (CNN) architectures that can effectively capture the same types of relationships and dependencies that traditional self-attention mechanisms do in transformer models. The design takes into account the need for both local and global context processing, which is for maintaining the power of self-attention while leveraging the efficiency of CNNs. This approach is inspired by research showing that CNNs can emulate attention mechanisms while being more computationally efficient.

In a step 5310, the system implements efficient local and global context capturing within the convolutional architecture. This step focuses on ensuring that the convolutional layers can effectively process both short-range and long-range dependencies in the input data. For local context, the system might use standard convolutional operations with small kernel sizes. For global context, it could implement dilated convolutions or pooling operations that increase the receptive field of the network. The goal is to achieve a balance that allows the model to understand both fine-grained details and overarching structures in the input, similar to how traditional self-attention operates.

In a step 5320, the system integrates the convolutional self-attention modules with existing transformer models. This involves carefully replacing the traditional self-attention layers in transformer architectures with the newly designed convolutional modules. The integration process ensures that the convolutional self-attention can seamlessly interact with other components of the transformer, such as feed-forward networks and layer normalization. This step may also involve adjusting the model's overall architecture to best leverage the strengths of the convolutional approach.

In a step 5330, the system optimizes the subsystem for parallel processing and reduced computational complexity. Convolutional operations are inherently more parallelizable than traditional attention mechanisms, and this step focuses on maximizing this advantage. The system implements optimizations such as grouped convolutions or depthwise separable convolutions to further reduce computational complexity. It also ensures that the convolutional operations are structured to take full advantage of GPU architectures, enabling efficient parallel processing across multiple cores.

In a step 5340, the system adapts the convolutional self-attention for various input modalities (text, image, audio). While originally designed for text processing, the convolutional self-attention approach can be extended to handle different types of data. For text, the system might implement 1D convolutions over token embeddings. For images, 2D convolutions can be used to process spatial relationships. For audio, the system could use 1D convolutions over time or 2D convolutions over time-frequency representations. This flexibility allows the convolutional self-attention subsystem to be used across a wide range of AI tasks and applications.

In a step 5350, the system fine-tunes the subsystem's parameters for specific tasks and hardware configurations. This final step involves adjusting the hyperparameters of the convolutional self-attention modules to optimize performance for particular use cases and hardware setups. The fine-tuning process might involve adjusting the number and size of convolutional layers, tweaking learning rates, or modifying regularization techniques. The system may use techniques like neural architecture search or Bayesian optimization to find the best configurations. Additionally, the fine-tuning takes into account the specific capabilities of the available hardware, such as the number of GPU cores or the memory bandwidth, to ensure optimal performance on the given infrastructure.

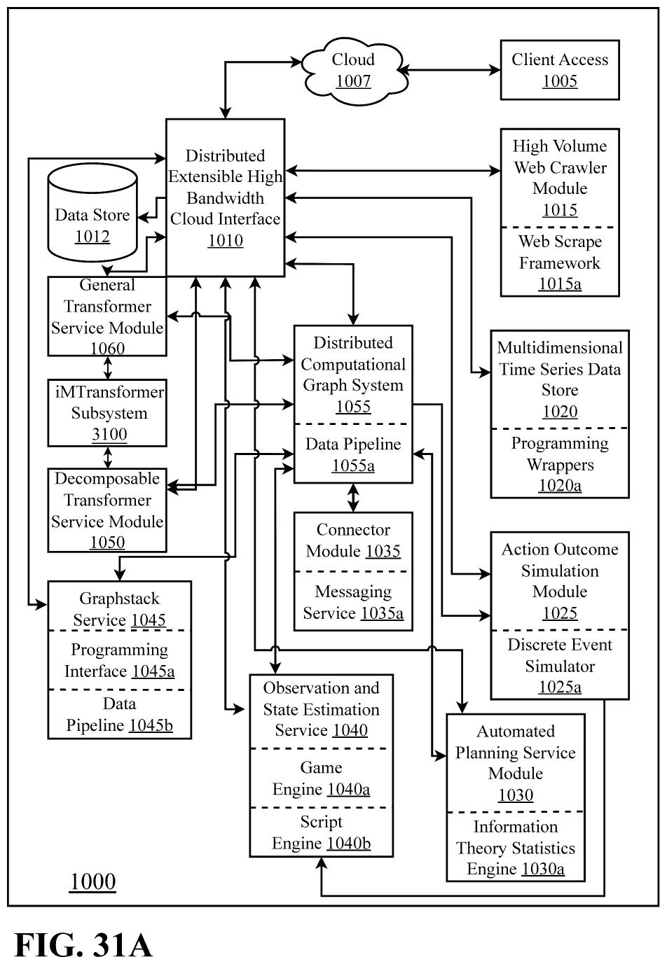

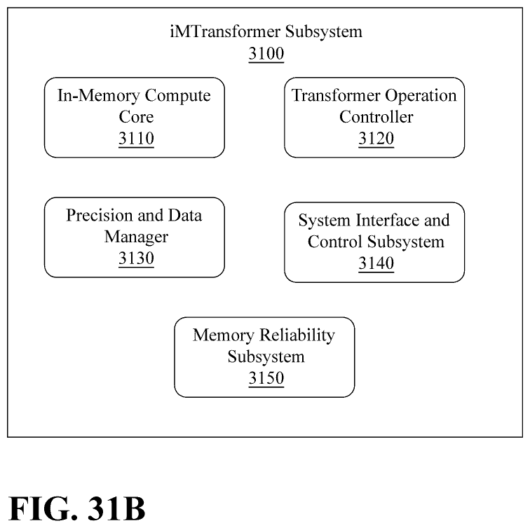

FIG. 31A is a block diagram illustrating an exemplary system architecture for a distributed generative artificial intelligence reasoning and action platform with an integrated iMTransformer subsystem. IMTransformer subsystem 3100 represents a significant advancement in the distributed generative AI reasoning and action platform, integrating in-memory computing techniques to enhance the efficiency and performance of transformer models. This subsystem seamlessly interweaves with multiple components of the existing architecture, creating a symbiotic relationship between memory and computation that dramatically reduces data transfer overhead and improves overall system performance.

At its core, iMTransformer subsystem 3100 works in close concert with distributed computational graph system 1055, revolutionizing how data flows through the AI pipeline. By integrating memory and computation units, it allows for processing to occur directly where data is stored, significantly reducing the need for data movement between separate processing and memory units. This is particularly beneficial when handling large-scale AI workloads, such as training and inference on massive language models or processing high-dimensional data.

IMTransformer subsystem 3100 establishes a deep connection with general transformer service module 1060 and decomposable transformer service module 1050, enhancing their capabilities by providing a more efficient computational substrate. For instance, when these modules are orchestrating complex transformer operations, iMTransformer subsystem 3100 can execute certain computations directly within memory, reducing latency and energy consumption associated with data movement. Interacting closely with multidimensional time series data store 1020, the iMTransformer subsystem 3100 enables more efficient processing of temporal data. It can perform rapid in-memory computations on time series data, accelerating tasks such as pattern recognition, anomaly detection, and predictive modeling. This is particularly valuable in scenarios requiring real-time analysis of streaming data, such as financial modeling or IoT sensor data processing.

IMTransformer subsystem 2100 also enhances the capabilities of the action outcome simulation module 1025 by providing rapid in-memory computation for simulation scenarios. This allows for more complex and detailed simulations to be run in real-time, improving the accuracy and responsiveness of predictive modeling and decision-making processes. In its interaction with automated planning service module 1030, iMTransformer subsystem 2900 enables more efficient execution of planning algorithms. By performing key computations in-memory, it can accelerate the evaluation of different planning scenarios, allowing for more thorough exploration of potential outcomes within given time constraints.

In one embodiment, iMTransformer subsystem 2900 may work synergistically with hardware management layer 2800, particularly interfacing with components like Through-Chip Microchannel Cooler 2810. This integration allows for optimized thermal management of the in-memory computing units, ensuring stable and efficient operation even under high computational loads. In practice, when a client accesses the system through distributed extensible high bandwidth cloud interface 1010, iMTransformer subsystem 3100 is activated. As data flows through data pipeline 1055a, iMTransformer subsystem 3100 enables rapid in-memory processing at various stages. For instance, when high volume web crawler module 1015 ingests large amounts of data, iMTransformer subsystem 3100 can perform initial processing and feature extraction directly in memory, significantly reducing the data transfer overhead to other processing units.

As the data progresses through the AI pipeline, iMTransformer subsystem 3100 continues to optimize operations. During transformer model computations orchestrated by general transformer service module 1060, it enables efficient execution of attention mechanisms and feed-forward operations directly within memory. This not only accelerates the computation but also reduces energy consumption, allowing for more sustainable operation of large-scale AI models.

IMTransformer subsystem 3100 also enhances observation and state estimation service 1040 by enabling rapid in-memory processing of state information. This allows for more responsive and accurate state estimation, for applications requiring real-time decision making or control. By integrating the iMTransformer subsystem 3100, the platform achieves a new level of efficiency in AI processing. It allows for handling larger models and datasets within the same computational constraints, potentially enabling more complex AI tasks or improving performance on resource-constrained devices. The result is a more responsive, energy-efficient, and capable AI system that can deliver enhanced performance across a wide range of applications and deployment scenarios, from edge computing to large-scale cloud infrastructures.

FIG. 31b is a block diagram illustrating an exemplary subsystem architecture for a component of a distributed generative artificial intelligence reasoning and action platform with an integrated iMTransformer subsystem, an iMTransformer subsystem. At the heart of the iMTransformer subsystem 3100 lies an in-memory computer core 3110, which serves as the nexus of computation and storage. In-memory computer core 3110 interfaces directly with distributed computational graph system 1055, enabling the execution of complex AI operations directly where data resides. For instance, when processing large language models, matrix multiplications and attention computations can be performed within the memory itself, drastically reducing the data movement that typically bottlenecks AI workloads. This tight integration allows for unprecedented efficiency in handling the massive datasets and models that modern AI tasks demand.

Working in concert with the in-memory computer core 3110, transformer operation controller 3120 orchestrates the execution of transformer-specific operations. It communicates closely with general transformer service module 1060 and decomposable transformer service module 1050, translating high-level transformer architectures into optimized in-memory operations. This controller ensures that operations like self-attention and feed-forward networks are executed efficiently within the memory substrate, maximizing the benefits of the in-memory computing paradigm.

Precision and data manager 3130 plays a role in optimizing the use of the in-memory computer 3000 resources. In one embodiment, the precision and data manager 3130 interfaces with hardware-aware transformer subsystem 2900, dynamically adjusting the precision of computations based on the requirements of the task and the available resources. For example, it might use lower precision for initial layers of a deep network and higher precision for later layers, balancing accuracy and computational efficiency. This component also manages data flow within the memory, ensuring that frequently accessed data is kept in fast-access regions, further enhancing performance.

System interface and control subsystem 3140 serves as the primary communication channel between the iMTransformer subsystem 310 and the broader platform architecture. It interfaces with connector module 1035, facilitating the seamless integration of in-memory computing capabilities into the platform's data pipelines. This subsystem may also work closely with hardware management layer 2800, providing real-time information about the state and capabilities of the in-memory compute resources. This integration allows for dynamic allocation of tasks between traditional computing units and the in-memory compute core, optimizing overall system performance.

Memory reliability subsystem 3150 ensures the integrity and consistency of data within the in-memory compute environment. It works in tandem with the observation and state estimation service 1040, constantly monitoring the state of the in-memory computations and detecting any anomalies or errors. This subsystem implements error correction mechanisms and redundancy strategies to maintain the reliability of computations, which is when dealing with the complex and often probabilistic nature of AI workloads.

In one embodiment, iMTransformer subsystem 3100 operates as follows: When a complex AI task is initiated through client access 1005, distributed computational graph system 1055 decomposes it into a series of operations. Transformer operation controller 3120 then maps these operations onto in-memory computer core 3110, where they are executed with minimal data movement. Throughout this process, precision and data manager 3130 optimizes the use of memory resources, adjusting precision and data placement as needed.

System interface and control subsystem 3140 continuously communicates with the broader platform, ensuring that the in-memory computations are coordinated with other system components. For instance, it might work with action outcome simulation module 1025 to rapidly execute simulation scenarios in memory, or with automated planning service module 1030 to accelerate the evaluation of planning alternatives. Meanwhile, memory reliability subsystem 3040 constantly monitors the computations, ensuring their integrity and correcting any errors that may arise due to the complexities of in-memory computing. This robust error management allows iMTransformer subsystem 3100 to maintain high reliability even when pushing the boundaries of computational efficiency.

By integrating these components, iMTransformer subsystem 3100 enables a new paradigm of AI computation within the platform. It allows for the handling of larger models and datasets with significantly reduced energy consumption and latency. This capability opens up new possibilities for AI applications, from more responsive real-time systems to more complex and nuanced language models, all while potentially reducing the hardware footprint required for advanced AI tasks. The result is a more powerful, efficient, and adaptable AI system that can deliver enhanced performance across a wide range of applications and deployment scenarios.

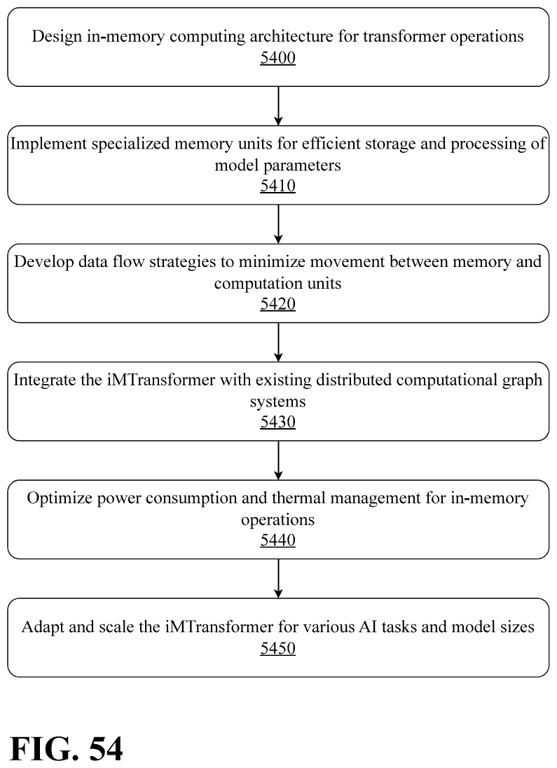

FIG. 54 is a flow diagram illustrating an exemplary method for a distributed generative artificial intelligence reasoning and action platform with an integrated iMTransformer subsystem. In a first step 5400, the system designs an in-memory computing architecture for transformer operations. This step involves creating a specialized hardware architecture that allows for transformer computations to be performed directly within memory units, rather than shuttling data back and forth between separate memory and processing units. The design takes into account the specific computational needs of transformer models, such as matrix multiplications and attention mechanisms. This approach is inspired by the concept of processing-in-memory (PIM) and aims to significantly reduce the energy consumption and latency associated with data movement in traditional von Neumann architectures.

In a step 5410, the system implements specialized memory units for efficient storage and processing of model parameters. This involves developing custom memory structures that can not only store the transformer model's weights and activations but also perform computations on this data. These units might use emerging memory technologies such as resistive random-access memory (ReRAM) or magnetoresistive RAM (MRAM), which can perform analog computations directly in the memory array. The implementation ensures that these memory units can handle the precision requirements of transformer models while maximizing computational efficiency.

In a step 5420, the system develops data flow strategies to minimize movement between memory and computation units. This step focuses on optimizing how data moves within the iMTransformer architecture. It involves designing efficient data routing mechanisms and scheduling algorithms that maximize in-memory computations and minimize any necessary data transfers. The system might implement techniques such as data reuse and operator fusion to further reduce data movement. This step is for realizing the full potential of the in-memory computing approach and achieving significant improvements in energy efficiency and processing speed.

In a step 5430, the system integrates the iMTransformer with existing distributed computational graph systems. This involves ensuring that the iMTransformer can seamlessly work within the broader AI platform, particularly with the distributed computational graph system. The integration allows the platform to dynamically decide when to utilize the iMTransformer for specific tasks within a larger AI workflow. It also involves developing interfaces that allow the iMTransformer to efficiently receive inputs from and send outputs to other components of the system, ensuring that the in-memory processing capabilities can be leveraged across a wide range of AI applications.

In a step 5440, the system optimizes power consumption and thermal management for in-memory operations. While in-memory computing can significantly reduce overall power consumption, it also presents unique thermal challenges due to the concentration of both storage and computation in the same units. This step involves implementing advanced power management techniques, such as dynamic voltage and frequency scaling, specifically tailored for the iMTransformer architecture. It also includes developing thermal management strategies, possibly leveraging technologies like the through-chip microchannel cooler (TCMC) mentioned in earlier disclosures, to ensure stable and efficient operation of the in-memory computing units.

In a step 5450, the system adapts and scales the iMTransformer for various AI tasks and model sizes. This final step involves ensuring that the iMTransformer architecture is flexible enough to handle a wide range of transformer-based models and AI tasks. It includes developing techniques to efficiently partition and distribute large models across multiple iMTransformer units for scalability. The system also implements methods to dynamically adjust the precision and computational resources based on the specific requirements of different AI tasks, ensuring optimal performance and efficiency across various applications, from natural language processing to computer vision.

This method diagram outlines a comprehensive approach to implementing an iMTransformer subsystem, which leverages in-memory computing to significantly enhance the efficiency and performance of transformer models. By minimizing data movement and optimizing for specific hardware capabilities, the iMTransformer has the potential to dramatically improve the speed and energy efficiency of AI computations across a wide range of applications and model sizes.

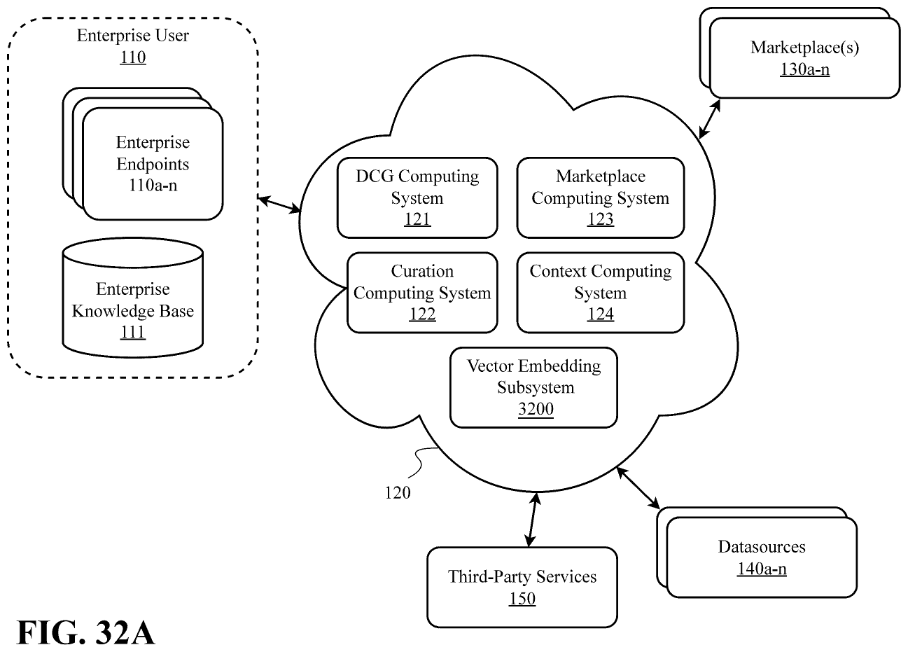

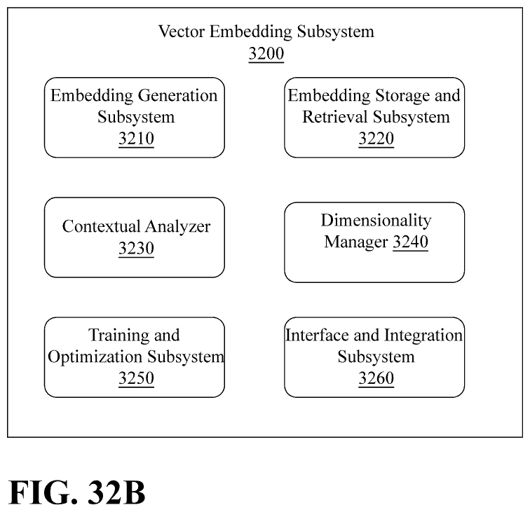

FIG. 32A is a block diagram illustrating an exemplary system architecture for a distributed generative artificial intelligence reasoning and action platform with an integrated vector embedding subsystem. Vector embedding subsystem 3200 represents an enhancement to the distributed generative AT reasoning and action platform, seamlessly integrating advanced techniques for knowledge representation and processing. This subsystem interweaves with multiple components of the existing architecture, fundamentally transforming how the platform handles, analyzes, and leverages complex data structures and knowledge.

Vector embedding subsystem 3200 establishes a deep connection with context computing system 124, revolutionizing how contextual data is processed and utilized throughout the platform. By transforming diverse data types-including but not limited to text, images, and structured data-into high-dimensional vector representations, it enables more nuanced and efficient processing of contextual information. For instance, when the system encounters complex enterprise knowledge from enterprise knowledge base 111, vector embedding subsystem 3200 can convert this information into dense vector representations that capture semantic relationships and contextual nuances far more effectively than traditional symbolic representations.

Vector embedding subsystem 3200 works in close concert with DCG computing system 121, enhancing the platform's ability to process and reason over complex knowledge structures.

As DCG computing system 121 orchestrates complex workflows, the vector embeddings provide a rich, continuous representation space that allows for more sophisticated operations, such as semantic similarity computations or analogical reasoning. This is particularly valuable when dealing with tasks that require understanding of complex relationships or nuanced contextual information.

Interacting closely with marketplace computing system 123, vector embedding subsystem 3200 enables more efficient and effective utilization of external data sources and algorithms. It can generate vector representations of marketplace offerings, allowing for more precise matching between user needs and available resources. For example, when an enterprise user seeks specific data or algorithms from marketplaces 130a-n, the vector embeddings can facilitate more accurate and context-aware recommendations.

Vector embedding subsystem 3200 also significantly enhances the capabilities of curation computing system 122. By leveraging vector representations, the curation process can consider deeper semantic relationships and contextual relevance when selecting and organizing information for users. This results in more personalized and contextually appropriate curation of AI outputs, improving the overall user experience. In its interaction with enterprise endpoints 110a-n, vector embedding subsystem 3200 enables more sophisticated processing of enterprise-specific data and queries. It can generate vector representations of user inputs, allowing for more nuanced understanding of user intent and context. This is particularly valuable in scenarios requiring deep understanding of domain-specific terminology or complex business processes.

Vector embedding subsystem 3200 also interfaces with third-party services 150, enabling more effective integration of external capabilities. By converting inputs and outputs to and from vector representations, it allows for seamless interaction between the platform and various external services, enhancing the system's overall flexibility and capability.

In an embodiment, when an enterprise user 110 interacts with the system, vector embedding subsystem 3200 works in tandem with other components to process and understand the user's input. For instance, if a user submits a complex query involving multiple data sources and domain-specific concepts, the subsystem generates vector representations that capture the query's semantic content. These embeddings are then used by the DCG computing system 121 to orchestrate a workflow that leverages the most relevant data sources and algorithms. As the query is processed, vector embedding subsystem 3200 continues to play a role. It enables more effective retrieval of relevant information from enterprise knowledge base 111 and external data sources 140a-n by allowing for semantic similarity searches in the vector space. This results in more contextually relevant and comprehensive responses to user queries.

Throughout the process, vector embedding subsystem 3200 works closely with the context computing system 124 to maintain and update a rich contextual understanding of the ongoing interaction. This allows for more coherent and contextually appropriate responses, even in complex, multi-turn interactions.

By integrating vector embedding subsystem 3200, the platform achieves a new level of sophistication in handling complex knowledge structures and contextual information. It allows for more nuanced understanding and processing of diverse data types, enhancing the system's ability to perform complex reasoning tasks and generate more contextually appropriate responses. The result is a more intelligent, adaptable, and context-aware AI system that can deliver enhanced performance across a wide range of applications and domains, from enterprise decision-making support to advanced data analysis and knowledge discovery.

FIG. 32B is a block diagram illustrating an exemplary subsystem architecture for a component of a distributed generative artificial intelligence reasoning and action platform with an integrated vector embedding subsystem, a vector embedding subsystem. Vector embedding subsystem 3200 serves as a sophisticated nexus for knowledge representation and processing within the distributed generative AI reasoning and action platform. This subsystem integrates seamlessly with multiple components of the existing architecture, fundamentally enhancing the platform's ability to understand, process, and leverage complex data structures and contextual information.

At the heart of this subsystem, embedding generation subsystem 3210 works in close concert with the context computing system 124 and the DCG computing system 121. It transforms diverse inputs—from user queries to enterprise knowledge-into high-dimensional vector representations. For instance, when processing complex enterprise data from enterprise knowledge base 111, it generates dense vector embeddings that capture intricate semantic relationships and domain-specific nuances. These embeddings serve as the foundation for more sophisticated reasoning and analysis throughout the platform.

Embedding storage and retrieval subsystem 3220 interfaces closely with multidimensional time series data store 1020 and data store 1012, providing a specialized infrastructure for efficiently managing vector representations. This component enables rapid storage and retrieval of embeddings, for real-time processing of user queries and large-scale data analysis. For example, when action outcome simulation module 1025 requires quick access to relevant contextual information for a simulation scenario, this subsystem can swiftly retrieve the most pertinent vector representations.

Working in tandem with these components, contextual analyzer 3230 enriches the platform's contextual understanding capabilities. It interfaces with observation and state estimation service 1040, continuously analyzing incoming data and updating contextual representations. This dynamic process allows the system to maintain a nuanced understanding of evolving contexts, for applications like real-time decision support or adaptive user interfaces. Dimensionality manager 3240 plays a critical role in optimizing the efficiency and effectiveness of the vector representations. It may work closely with Hardware-Aware Transformer Subsystem 2900 and iMTransformer subsystem 3000 to dynamically adjust the dimensionality of embeddings based on task requirements and available computational resources. This adaptive approach ensures optimal performance across various hardware configurations, from resource-constrained edge devices to powerful cloud servers.

Training and optimization subsystem 3250 is deeply integrated with the automated planning service module 1030 and general transformer service module 1060. It continuously refines the embedding models based on new data and performance feedback. For instance, when the system encounters novel domain-specific terminology in enterprise queries, this subsystem can adapt the embedding model to better capture these new concepts, enhancing the overall accuracy and relevance of the system's responses. Interface and integration subsystem 3260 serves as the primary communication channel between vector embedding subsystem 3100 and other platform components. It works closely with connector module 1035 and APIs/Plugins 335 to ensure seamless integration of vector embeddings into various workflows. This component enables diverse platform features—from the marketplace computing system 123 to third-party services 150—to leverage the power of vector representations in their operations.

In an embodiment, vector embedding subsystem 3200 operates as a cohesive unit, enhancing numerous platform processes. When an enterprise user 110 submits a complex query, embedding generation subsystem 3210 immediately converts it into a vector representation. Contextual analyzer 3230 then enriches this representation with relevant contextual information, drawing from the user's history and current system state. As the query is processed, embedding storage and retrieval subsystem 3220 rapidly fetches relevant vector representations from the enterprise knowledge base and external data sources. Dimensionality manager 3240 ensures these operations are optimized for the current hardware configuration, dynamically adjusting embedding dimensions if necessary.

Throughout this process, training and optimization subsystem 3250 monitors performance, fine-tuning the embedding models to better capture the nuances of the specific enterprise domain. Meanwhile, interface and integration subsystem 3260 facilitates smooth interaction between the vector operations and other platform components, ensuring that the enriched, vectorized information is effectively utilized by modules like DCG computing system 121 or curation computing system 122.

This intricate interplay of components within vector embedding subsystem 3200 enables the platform to achieve a new level of sophistication in handling complex knowledge structures and contextual information. It allows for more nuanced understanding and processing of diverse data types, enhancing the system's ability to perform complex reasoning tasks and generate more contextually appropriate responses. The result is a more intelligent, adaptable, and context-aware AI system that can deliver enhanced performance across a wide range of applications and domains, from enterprise decision-making support to advanced data analysis and knowledge discovery.

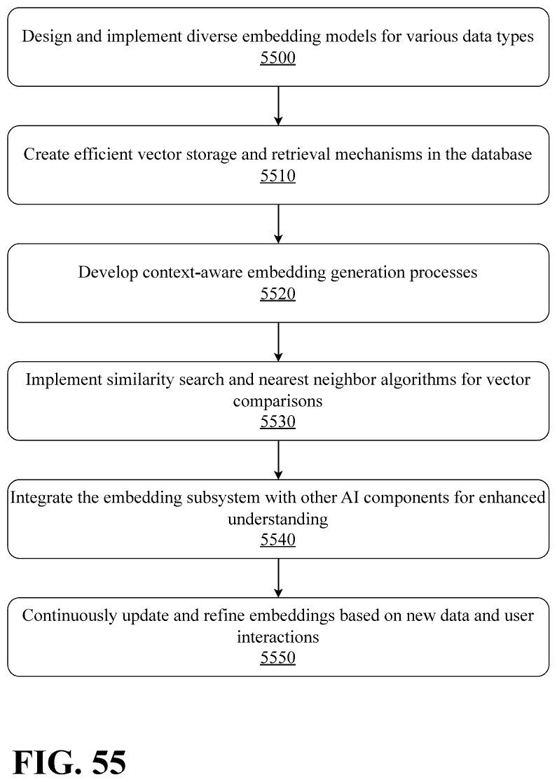

FIG. 55 is a flow diagram illustrating an exemplary method for a distributed generative artificial intelligence reasoning and action platform with an integrated vector embedding subsystem. In a first step 5500, the system designs and implements diverse embedding models for various data types. This step involves creating or adapting a range of embedding models capable of handling different types of data, such as text, images, audio, and structured data. For text, this might include models like Word2Vec, FastText, or BERT-based embeddings. For images, the system could implement models based on convolutional neural networks (CNNs) or vision transformers. The goal is to have a versatile set of embedding models that can effectively capture semantic relationships and contextual information across different modalities.

In a step 5510, the system creates efficient vector storage and retrieval mechanisms in the database. This involves implementing a specialized vector database or adapting existing database systems to efficiently store and query high-dimensional vector embeddings. The system might use techniques like locality-sensitive hashing (LSH) or hierarchical navigable small world (HNSW) graphs to enable fast approximate nearest neighbor search. This step ensures that the embedded vectors can be quickly stored, retrieved, and compared, which is for real-time AI applications.

In a step 5520, the system develops context-aware embedding generation processes. This step focuses on creating embedding models that can take into account the broader context in which data appears. For text, this might involve using transformer-based models that consider the entire sequence when generating embeddings. For images or audio, it could include incorporating metadata or surrounding content. The system might also implement techniques for dynamic or contextualized embeddings that can adapt based on the specific task or query at hand. This context-awareness enhances the quality and relevance of the generated embeddings.

In a step 5530, the system implements similarity search and nearest neighbor algorithms for vector comparisons. This involves developing efficient algorithms to compare vector embeddings and find the most similar items in the vector space. The system might implement techniques like cosine similarity for measuring vector distances, or more advanced methods like approximate nearest neighbor search algorithms. This step is for enabling fast and accurate retrieval of relevant information based on semantic similarity rather than just keyword matching.

In a step 5540, the system integrates the embedding subsystem with other AI components for enhanced understanding. This step involves connecting the vector embedding subsystem with other parts of the AI platform, such as the distributed computational graph system, the curation system, and various AI models. The integration allows for seamless use of embeddings in tasks like semantic search, recommendation systems, and content understanding. It might also involve developing interfaces that allow AI models to dynamically request and utilize embeddings as part of their processing pipelines.

In a step 5550, the system continuously updates and refines embeddings based on new data and user interactions. This final step implements a feedback loop that allows the embedding models to evolve and improve over time. The system might use techniques like online learning or periodic retraining to incorporate new data and adapt to changing language or content patterns. It could also leverage user interactions and feedback to fine-tune embeddings for specific domains or applications. This continuous refinement ensures that the embeddings remain relevant and effective as the underlying data and usage patterns change.

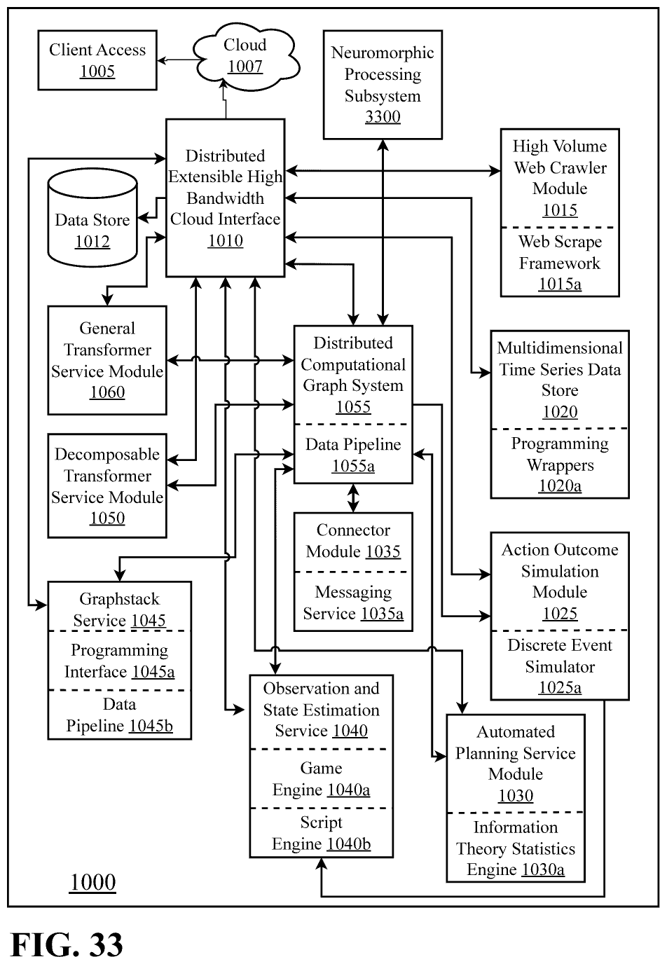

FIG. 33 is a block diagram illustrating an exemplary system architecture for a distributed generative artificial intelligence reasoning and action platform with an integrated neuromorphic processing subsystem. Neuromorphic processing subsystem 3300 represents an addition to the distributed generative AI reasoning and action platform, integrating brain-inspired computing principles to enhance the system's efficiency, adaptability, and capability to handle complex AI tasks. This subsystem interweaves seamlessly with multiple components of the existing architecture, fundamentally altering how certain AI operations are executed and optimized.

Neuromorphic processing subsystem 3300 establishes a deep connection with distributed computational graph system 1055, enabling the platform to leverage spike-based processing for certain AI workloads. This integration allows for more efficient handling of tasks that involve temporal data or require adaptive learning. For instance, when processing time-series data from multidimensional time series data store 1020, neuromorphic processing subsystem 3300 can employ a spike-based computation to detect temporal patterns more efficiently than traditional computing approaches.

Neuromorphic processing subsystem 3300 works in close concert with general transformer service module 1060 and decomposable transformer service module 1050, enhancing their capabilities by providing a neuromorphic substrate for certain operations. This is particularly beneficial for tasks that require online learning or adaptation to new data streams. For example, when handling a continuous stream of data from high volume web crawler module 1015, neuromorphic processing subsystem 3300 can adapt its processing in real-time, potentially identifying new patterns or relationships that traditional static models might miss.

Interacting closely with action outcome simulation module 1025, neuromorphic processing subsystem 3300 enables more efficient and adaptive simulation scenarios. Its ability to process information in a highly parallel and event-driven manner aligns well with discrete event simulator 1025a, allowing for more complex and realistic simulations of dynamic systems. This could be particularly valuable in scenarios requiring real-time decision making based on rapidly changing environmental conditions. Neuromorphic processing subsystem 3300 also enhances capabilities of automated planning service module 1030 by providing a platform for implementing neuromorphic planning algorithms. These algorithms, inspired by the brain's ability to plan and make decisions in complex, uncertain environments, can potentially offer more robust and adaptive planning solutions for scenarios with high degrees of uncertainty or dynamism.

In its interaction with observation and state estimation service 1040, neuromorphic processing subsystem 3300 enables more efficient processing of sensory data and state information. Its event-driven, parallel processing capabilities are well-suited for tasks like real-time sensor fusion or anomaly detection in complex data streams. Additionally, neuromorphic processing subsystem 3300 works synergistically with hardware management layer 2800, interfacing with components like Through-Chip Microchannel Cooler 2810 to ensure efficient thermal management. This integration is given the unique thermal characteristics of neuromorphic hardware, which often allows for more dense computing configurations.

In an embodiment, when a client accesses the system through distributed extensible high bandwidth cloud interface 1010, neuromorphic processing subsystem 3300 can be engaged for suitable tasks. For instance, if a user submits a query requiring real-time processing of a high-dimensional, temporal data stream, distributed computational graph system 1055 might route this task to neuromorphic processing subsystem 3300. Here, the spike-based processing can efficiently extract relevant temporal features, potentially identifying complex patterns that might be computationally expensive to detect using traditional methods. As the data flows through the AI pipeline, neuromorphic processing subsystem 3300 continues to optimize operations where appropriate. During transformer model computations orchestrated by general transformer service module 1060, certain adaptive or temporal aspects of the processing might be offloaded to the neuromorphic hardware, leveraging its efficient handling of time-dependent data.

Neuromorphic processing subsystem 3300 also enhances the platform's ability to handle uncertain or noisy data, a common challenge in real-world AI applications. Its brain-inspired processing principles allow for more robust performance in the face of imperfect input data, potentially improving the reliability of AI outputs in challenging real-world scenarios. By integrating neuromorphic processing subsystem 3300, the platform achieves a new level of efficiency and adaptability in AI processing. It allows for handling certain types of AI workloads more efficiently, potentially enabling more complex AI tasks or improving performance on resource-constrained devices. The result is a more versatile, energy-efficient, and adaptive AI system that can deliver enhanced performance across a wide range of applications, from real-time sensor processing to adaptive learning in dynamic environments.

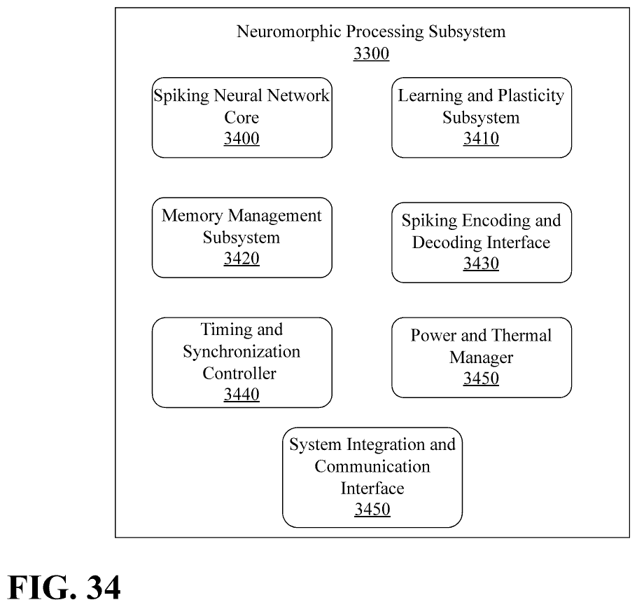

FIG. 34 is a block diagram illustrating an exemplary subsystem architecture for a component of a distributed generative artificial intelligence reasoning and action platform with an integrated neuromorphic processing subsystem, a neuromorphic processing subsystem. Central to neuromorphic processing subsystem 3300 lies spiking neural network core 3400, which serves as the primary computational engine for neuromorphic processing. This core interfaces directly with distributed computational graph system 1055, enabling the execution of spike-based computations that are particularly efficient for temporal and event-driven data processing. For instance, when handling streaming data from the high volume web crawler module 1015, spiking neural network core 3400 can efficiently process and identify temporal patterns in real-time, potentially uncovering insights that might be missed by traditional computing approaches.

Working in concert with spiking neural network core 3400, learning and plasticity subsystem 3410 enables continuous adaptation and learning within the neuromorphic hardware. It communicates closely with automated planning service module 1030 and general transformer service module 1060, allowing for the dynamic adjustment of network parameters based on incoming data and task requirements. This capability is particularly valuable in scenarios requiring online learning or adaptation to novel patterns, such as in real-time anomaly detection or adaptive control systems.

Memory management subsystem 3420 plays a role in optimizing the use of the neuromorphic hardware's unique memory architecture. It interfaces with multidimensional time series data store 1020 and the data store 1012, efficiently managing the flow of data to and from spiking neural network core 3400. This component ensures that relevant information is readily available for spike-based processing, while also managing the storage of learned patterns and network states. Spiking encoding and decoding interface 3430 serves as a bridge between the traditional data representations used in other parts of the platform and the spike-based representations used in the neuromorphic hardware. It works closely with connector module 1035 and messaging service 1035a, facilitating seamless integration of neuromorphic processing into the platform's diverse workflows. For example, when processing sensory data for observation and state estimation service 1040, this interface efficiently converts incoming data streams into spike trains for neuromorphic processing, and then translates the results back into a format suitable for further analysis by other platform components.

Timing and synchronization controller 3440 ensures precise temporal coordination within the neuromorphic hardware and synchronization with other platform components. It interfaces with discrete event simulator 1025a and the information theory statistics engine 1030a, enabling accurate simulation of time-dependent neuromorphic processes and facilitating the integration of neuromorphic computations into broader simulation and statistical analysis workflows. Power and thermal manager 3450 works in tandem with hardware management layer 2800 and Through-Chip Microchannel Cooler 2810 to optimize the energy efficiency and thermal characteristics of the neuromorphic hardware. This is for maintaining stable operation and maximizing the performance benefits of neuromorphic computing, especially in scenarios involving intensive, continuous processing.

System integration and communication interface 3460 serves as the primary link between the neuromorphic processing subsystem and the rest of the platform. It facilitates bidirectional communication with various platform components, ensuring that neuromorphic processing capabilities are seamlessly integrated into the platform's diverse workflows. This interface works closely with graphstack service 1045 and its programming interface 1045a, allowing for the incorporation of neuromorphic processing into complex, graph-based computational workflows.

By integrating these components, the neuromorphic processing subsystem 3300 enables a new paradigm of AI computation within the platform. It allows for efficient handling of temporal and event-driven data, continuous learning and adaptation, and potentially lower power consumption for certain types of AI workloads. This capability opens up new possibilities for AI applications, from more responsive real-time systems to more adaptive and energy-efficient edge computing solutions. The result is a more versatile, efficient, and biologically-inspired AI system that can deliver enhanced performance across a wide range of applications and deployment scenarios.

The neuro-symbolic AI capabilities of the system demonstrate adaptability in edge AI environments, showcasing the platform's versatility across diverse hardware configurations. For instance, in the context of autonomous drones, the hardware-aware AI models dynamically adjust their computational complexity based on the drone's specific hardware capabilities and current operational constraints. During a long-range mission, the system might initially deploy a full-scale object detection model. However, as battery levels decrease, it transitions to a more lightweight model, sacrificing some accuracy for extended operational time. This adaptive approach ensures continuous functionality while optimizing resource utilization.

In medical devices, the system's multi-hardware orchestration capabilities come to the fore, coordinating between specialized neuromorphic processors and conventional GPUs. For example, in a portable medical imaging device, the system might employ neuromorphic processors for rapid, energy-efficient preliminary image analysis, while reserving GPU resources for more complex diagnostic algorithms when higher accuracy is required. This heterogeneous approach allows for optimal performance across varying computational demands, balancing speed, accuracy, and energy efficiency.

The platform's marketplace for data, models, and algorithms further enhances its capabilities, offering users access to a wide range of resources to augment their AI systems. In a practical scenario, an AI researcher working on smart city traffic flow management might purchase a specialized congestion prediction algorithm from the marketplace. This algorithm, trained on diverse urban datasets, could significantly enhance the researcher's existing model, improving its ability to predict and mitigate traffic bottlenecks in real-time. The marketplace also provides model testing environments, allowing users to benchmark purchased models or algorithms on their specific hardware configurations before finalizing the purchase. This feature ensures compatibility and performance, reducing the risk associated with integrating new components into existing systems.

Advanced security mechanisms are integral to the platform, providing robust protection at the hardware level. In a real-time scenario, if the system detects a potential security breach in a specific hardware component, it immediately initiates a series of protective measures. This might involve real-time task reallocation, shifting sensitive computations away from the compromised component to secure hardware modules. Simultaneously, it could trigger hardware-level encryption processes to protect sensitive data in transit or at rest, ensuring data integrity even during active workflows. It may also cause the system to report that it is unavailable to the controlling DCG or change the federated DCGs current or future advertised state (optionally probabilistically) to other resource clusters or processes.

In an embodiment, the platform implements comprehensive hardware-level security mechanisms through a multi-layered approach to protect system integrity and data security. At the foundation of this approach is a real-time security monitoring and detection system that continuously monitors hardware components using embedded sensors and monitoring circuits. This monitoring system collects and analyzes a comprehensive set of performance metrics including power consumption patterns, thermal signatures, timing variations, memory access patterns, and I/O request patterns. The system implements sophisticated anomaly detection using statistical analysis and machine learning models, performing real-time comparison of behavioral patterns against known attack signatures. Additionally, the system maintains continuous monitoring of hardware-level integrity checks including secure boot measurements, runtime attestation values, hardware root of trust readings, and Trusted Platform Module (TPM) state verification.

When suspicious activity is detected, the system activates immediate response mechanisms through automated triggering of isolation protocols. These protocols encompass logical isolation of compromised components, physical deactivation of suspicious hardware modules, network segment isolation, and memory region quarantine. The system implements a sophisticated dynamic resource reallocation process that first identifies critical workloads running on potentially compromised hardware, then performs priority-based task migration to secure hardware modules. This process includes verification of secure hardware availability, establishment of secure communication channels for migration, and careful handling of atomic operations during the transition phase to maintain system integrity.

The platform implements robust hardware-level encryption protection through immediate encryption protocols. These protocols include on-the-fly encryption of data in transit using dedicated hardware encryption engines, activation of memory encryption for data at rest, dynamic key generation and management, and secure key storage in hardware security modules (HSM). The encryption mechanisms utilize AES-256 encryption for data at rest and implement ChaCha20-Poly1305 for data in transit, leveraging hardware-accelerated encryption through dedicated security processors. The system maintains sophisticated key rotation mechanisms and implements Perfect Forward Secrecy (PFS) to ensure long-term data security.

Federation state management is implemented through dynamic updates that provide immediate state change notification to the controlling DCG while maintaining system security. This includes generation of probabilistic future state advertisements, implementation of gradual state transition to avoid detection, and maintenance of plausible deniability in state changes. Resource availability management encompasses dynamic adjustment of advertised capabilities, probabilistic resource availability reporting, implementation of randomized response delays, and generation of synthetic load patterns to mask actual system behavior.

The system implements a comprehensive secure recovery process through protocols that verify hardware component isolation, perform secure state restoration from trusted backups, verify integrity of restored components, and implement gradual reintegration of recovered components. The recovery validation process implements multi-factor authentication for component reactivation, performs staged testing of recovered components, verifies security posture before full reintegration, and maintains an enhanced monitoring period post-recovery to ensure system stability and security.

Audit and reporting mechanisms maintain comprehensive logs of all security-relevant events including hardware-level activity logs, component state changes, resource reallocation events, and encryption operation records. The system ensures secure audit trail maintenance through tamper-evident logging, distributed log storage, cryptographic log signing, and secure timestamp implementation to maintain the integrity of security records.

Integration with federated DCG operations is achieved through sophisticated coordination with federation management, including synchronization of security states across the federation, propagation of threat intelligence, coordinated response actions, and resource reallocation across the federation. Federation-wide security measures implement distributed security policies, coordinated incident response protocols, shared threat detection patterns, and collective security posture management to maintain overall system security in the distributed environment.

Next the invention extends and enhances the secure enclave model through distributed security architecture and hardware-level protection mechanisms. The system implements distributed secure processing domains across different hardware components, where each domain maintains dedicated secure memory regions with hardware encryption, an isolated execution environment with its own security monitor, independent cryptographic keys and security parameters, and dedicated power/clock domains for side-channel protection. Real-time domain health monitoring is implemented through continuous integrity verification of the execution environment, power analysis detection circuits, timing anomaly detection, temperature sensors for thermal analysis, and voltage glitch detection systems.

The system implements a dynamic domain migration system with hardware-level support for secure computation migration between domains. This includes dedicated migration channels with point-to-point encryption, atomic state transfer protocols to prevent partial migrations, hardware-accelerated state encryption during transit, and secure key migration protocols between domains. Migration is triggered by various conditions including detection of hardware tampering attempts, thermal anomalies indicating potential attacks, power analysis detection alerts, timing anomalies suggesting side-channel attempts, and integrity verification failures.

An enhanced encryption is implemented through hardware security modules in each domain, providing real-time memory encryption/decryption, on-the-fly key generation for migrated processes, secure key storage and management, and hardware-accelerated cryptographic operations. Memory protection features include page-level encryption with unique keys, anti-replay protection with hardware counters, integrity verification with MAC, and secure DMA channels between domains.

Secure resource management is achieved through hardware resource isolation, implementing dedicated memory controllers per domain, independent cache hierarchies, separate power delivery networks, and isolated clock generation. The system provides dynamic resource allocation through hardware-enforced resource partitioning, real-time resource reallocation based on security needs, secure migration of resources between domains, and hardware-level accounting and quota enforcement.

The platform implements an advanced monitoring and response system through continuous security monitoring using hardware performance counters, power consumption monitors, temperature sensors, timing analyzers, and voltage monitors. Automated response mechanisms include instant domain isolation on threat detection, secure process migration triggering, hardware-level encryption activation, power/clock manipulation for side-channel prevention, and resource reallocation for compromise mitigation.

A hardware-software integration layer provides a secure API for domain management, including domain creation/destruction, process migration requests, resource allocation controls, and security policy enforcement. This layer implements a hardware abstraction layer providing a unified interface for security features, hardware capability discovery, resource management primitives, and security event notifications.

Enhanced boot and attestation capabilities are implemented through a secure boot chain with hardware-based root of trust per domain, independent measurement and verification, secure configuration loading, and runtime attestation capabilities. Remote attestation features include hardware-backed identity per domain, secure channel establishment, configuration reporting, and security state verification.

The system implements comprehensive emergency response capabilities through hardware-level emergency responses including instant encryption of sensitive data, secure erasure of cryptographic material, power state manipulation, clock frequency adjustments, and resource quarantine. A coordinated response system provides cross-domain security event correlation, synchronized defensive actions, graceful service migration, and hardware-enforced isolation, ensuring robust protection against sophisticated security threats.

The system further introduces several enhancements building upon secure enclave and TPM concepts, extending beyond current implementations including Microsoft's Pluton system. The system implements distributed security domain management through multiple coordinated security domains, where each domain incorporates dedicated security monitoring circuits, hardware-enforced memory protection mechanisms, independent cryptographic operation units, dedicated clock and power management, and cross-domain secure communication channels. Enhanced isolation is achieved through physical isolation of security domain components, electromagnetic interference protection, power domain separation, thermal monitoring and management, and hardware-level access control enforcement.

The platform implements an adaptive hardware security response system through active security monitoring, incorporating real-time performance signature analysis, power consumption pattern monitoring, temperature distribution tracking, voltage glitch detection, clock anomaly identification, and memory access pattern analysis. Hardware-level response mechanisms include dynamic resource reallocation on threat detection, automatic domain isolation triggering, power state modification capabilities, clock frequency adjustment, memory access pattern randomization, cache flush operations, and hardware-enforced execution restrictions.

An enhances secure boot architecture is implemented through a multi-phase secure boot process incorporating hardware root of trust verification, ROM-based initial boot loader, signature verification at each stage, hardware-enforced code integrity checks, and runtime attestation capabilities. Boot integrity protection is maintained through hardware-based key storage, secure parameter validation, boot sequence integrity monitoring, configuration state verification, and sophisticated tamper detection and response mechanisms.

The system implements hardware-based workload migration enabling secure computation transfer between domains through hardware-encrypted state transfer, atomic operation guarantees, key migration protocols, and state verification mechanisms. Migration security features include point-to-point encryption, hardware-level authentication, integrity verification, anti-replay protection, and state reconstruction validation to ensure secure transfer of operations.

Dynamic resource protection is achieved through hardware resource management incorporating real-time resource allocation tracking, usage pattern analysis, access control enforcement, and resource isolation verification. Protection mechanisms include hardware-level access control, resource usage monitoring, anomaly detection, usage pattern verification, and resource allocation enforcement to maintain secure operation boundaries.

The platform implements comprehensive hardware security telemetry through dedicated security sensors, usage pattern trackers, performance counters, power monitors, and thermal sensors. Telemetry processing is performed through hardware-based anomaly detection, pattern matching engines, statistical analysis units, machine learning acceleration, and real-time correlation analysis to identify potential security threats.

Cross-platform security coordination is implemented through secure inter-platform communication utilizing hardware-based authentication, encrypted channel establishment, state synchronization protocols, and resource sharing controls. Coordination features include security policy synchronization, threat intelligence sharing, resource allocation optimization, and workload distribution management across the platform.

Enhanced recovery mechanisms are implemented through hardware-based recovery systems incorporating secure state backup, fast state restoration, configuration recovery, and key material regeneration capabilities. Recovery features include atomic recovery operations, state verification during recovery, partial recovery capabilities, recovery authentication, and recovery auditing to maintain system integrity during and after recovery events. These enhancements collectively provide a more robust and sophisticated security architecture that addresses limitations in current TPM and secure enclave implementations.

In a further embodiment, the system implements sophisticated hardware-level mechanisms to detect potential security breaches through dedicated monitoring circuits that perform continuous analysis of multiple physical characteristics. These monitoring circuits analyze power consumption patterns, electromagnetic emissions, thermal signatures, and timing variations to identify potential security threats. The system maintains independent operation of these security mechanisms separate from potentially compromised software components while ensuring service availability through secure migration capabilities.

Upon detection of suspicious activity, the system initiates a multi-stage hardware-based response protocol. First, the system implements immediate isolation of the potentially infected domain through dedicated hardware mechanisms, creating a secure boundary around the compromised components. Simultaneously, the system initiates secure migration of critical computations to verified secure domains using hardware-encrypted channels, ensuring continuity of essential operations. During this process, cryptographic keys and sensitive state information are protected through hardware-based encryption mechanisms operating independently of the compromised domain.

The system maintains system state preservation through secure backup mechanisms that operate at the hardware level, ensuring that critical system state information can be recovered if needed. Recovery procedures are then initiated through hardware-based secure protocols that operate independently of potentially compromised software systems. This creates a resilient security architecture with multiple independent layers of hardware security protection that can maintain system integrity and service availability even in the presence of sophisticated security threats.

In another embodiment, the architecture integrates with existing TPM capabilities and builds upon secure enclave concepts while implementing distributed security domains, enhanced isolation, proactive monitoring, and secure recovery features directly in hardware. The system implements comprehensive hardware security metrics across multiple categories to enable complete system monitoring and analysis.

The system implements sophisticated power analysis metrics including instantaneous power consumption per component, power consumption patterns, power spikes and anomalies, voltage fluctuations, current draw variations, power state transitions, sleep state metrics, power domain isolation status, cross-domain power correlations, and battery metrics for mobile and portable systems. Thermal telemetry is maintained through component temperature readings, thermal gradients, cooling system performance measurements, thermal throttling event monitoring, temperature pattern analysis, thermal zone status tracking, heat dissipation metrics, thermal anomaly detection, cross-component thermal correlation, and ambient temperature impact analysis.

Performance monitoring is implemented through comprehensive performance counters tracking CPU utilization patterns, memory access patterns, cache hit/miss rates, bus utilization metrics, I/O operation patterns, DMA transfer statistics, instruction execution patterns, branch prediction statistics, pipeline stall events, and speculative execution metrics. Security event metrics are maintained through monitoring of access control violations, authentication failures, integrity check failures, encryption operation metrics, key usage statistics, security domain transitions, trust boundary crossings, security policy violations, attestation events, and secure boot measurements.

The system implements cross-domain correlation through multiple parameter sets. Temporal correlation is maintained through high-precision timestamps, event sequence ordering, causality chains, time synchronization status, temporal pattern analysis, event frequency metrics, duration measurements, delay statistics, response time analysis, and time drift measurements. Spatial correlation is implemented through analysis of component relationships, resource dependencies, data flow patterns, physical proximity impacts, domain interaction patterns, resource sharing metrics, cross-domain communication, topology mapping, location-based analysis, and proximity-based correlation. Resource correlation is tracked through shared resource usage, resource contention patterns, allocation conflicts, usage dependencies, resource state transitions, capacity utilization, resource health metrics, availability statistics, performance impact analysis, and resource isolation verification.

OpenTelemetry integration is implemented across multiple points including metric collection, trace context, and log integration. Metric collection encompasses custom security metric types, hardware counter integration, resource attribute definitions, security context propagation, sampling configurations, aggregation rules, unit standardization, metadata enrichment, batch processing parameters, and collection frequency settings. Trace context maintains hardware operation spans, security event spans, cross-domain trace context, error propagation paths, resource dependencies, performance bottlenecks, causal relationships, span attributes, link definitions, and context propagation rules.

The system implements predictive analysis through multiple parameter sets including historical pattern analysis, failure prediction factors, and maintenance optimization parameters. This enables comprehensive monitoring of performance trends, error patterns, resource utilization trends, security event patterns, usage patterns, wear indicators, aging factors, environmental impacts, seasonal variations, and workload correlations.

A response automation framework is implemented through sophisticated trigger conditions, response categories, and impact assessment capabilities. Trigger conditions include threshold violations, pattern recognition, anomaly detection, prediction-based triggers, multi-factor conditions, compound events, time-based triggers, state transitions, resource exhaustion, and security violations. The system maintains comprehensive security visualization capabilities through real-time monitoring, historical analysis, and interactive analysis features, enabling detailed system visibility and analysis capabilities.

This integrated telemetry specification enables complete visibility into hardware security operations, provides early warning system capabilities for potential failures, enables optimized maintenance scheduling, allows automated response to security events, maintains detailed audit trails, enables predictive analysis and optimization, facilitates cross-domain security correlation, and identifies resource optimization opportunities across the system.

In a further embodiment, the specification supports integration with existing security and operations tools while providing detailed hardware-specific telemetry capabilities through a comprehensive multi-layer authentication framework. At the physical hardware layer, the system implements authentication through hardware root of trust components including TPM/Secure Enclave direct measurements, hardware serial attestation, component-level cryptographic identity, physical security sensor status, hardware configuration state, firmware version verification, boot sequence measurements, hardware security module status, physical tamper detection, and environmental condition validation. Direct hardware communication is secured through PCIe bus authentication, DMA transfer verification, memory controller authentication, I/O controller verification, bus encryption status, hardware interrupt validation, direct memory access patterns, physical port security, hardware accelerator authentication, and peripheral device validation.

The system implements bare metal operation system authentication through OS-hardware interface security mechanisms including kernel driver authentication, hardware abstraction layer verification, device driver signatures, system call authentication, memory management verification, I/O subsystem validation, power management authentication, resource allocation verification, hardware event handling, and interrupt management validation. OS security measures include kernel integrity verification, system file signatures, security policy enforcement, resource access control, process isolation verification, memory protection status, execution permission enforcement, system call filtering, security module status, and access control list validation.

Hypervisor layer security is implemented across both Type 1 (bare metal) and Type 2 (hosted) hypervisors. Type 1 hypervisor security includes direct hardware access verification, resource partitioning validation, VM isolation enforcement, memory page table verification, I/O device assignment validation, virtual device authentication, resource scheduler verification, hardware virtualization status, hypervisor integrity checks, and security boundary enforcement. Type 2 hypervisor security encompasses host OS interaction validation, resource sharing verification, host security policy compliance, device passthrough validation, host resource allocation, virtual network security, storage access verification, memory sharing validation, host system call validation, and performance isolation verification.

Virtual machine authentication is implemented through VM-hypervisor authentication and inter-VM communication security. VM-hypervisor authentication includes VM boot attestation, virtual device authentication, memory allocation verification, virtual CPU validation, virtual network interface security, storage access authentication, resource quota verification, VM migration security, snapshot integrity validation, and configuration verification. Inter-VM communication security encompasses VM-to-VM authentication, virtual network security, shared resource validation, cross-VM isolation, resource access control, traffic encryption verification, virtual switch security, load balancer authentication, service mesh integration, and network policy enforcement.

The system implements container platform security through Kubernetes cluster authentication and container runtime security mechanisms. Kubernetes security includes node authentication, pod security policies, container runtime security, network policy enforcement, service account validation, RBAC policy verification, secret management, volume mount authentication, admission controller validation, and resource quota enforcement. Container runtime security implements image signature verification, container isolation validation, runtime privilege enforcement, resource limit validation, storage driver authentication, network namespace security, control group enforcement, capability restrictions, seccomp profile validation, and AppArmor/SELinux enforcement.

Cross-layer authentication flows are maintained through both vertical and horizontal authentication chains. Vertical authentication encompasses hardware-to-OS validation, OS-to-hypervisor authentication, hypervisor-to-VM validation, VM-to-container platform, container-to-application, end-to-end chain verification, layer transition security, authentication propagation, context preservation, and security boundary maintenance. Horizontal authentication implements node-to-node validation, cluster-wide authentication, cross-datacenter validation, geographic distribution security, multi-cloud authentication, federation validation, cross-platform security, hybrid cloud authentication, edge node validation, and inter-cluster security.

Authentication data flows are managed through security context propagation and cross-layer monitoring capabilities. Security context propagation includes identity propagation rules, authentication token flow, security attribute preservation, context enrichment, authorization propagation, policy enforcement points, trust boundary definitions, credential management, session management, and access control inheritance. Cross-layer monitoring implements authentication event correlation, security violation detection, performance impact tracking, resource usage validation, compliance verification, audit trail maintenance, security metric collection, anomaly detection, pattern analysis, and predictive security measures.

Platform-specific considerations are implemented for major virtualization platforms including Nutanix, VMware, and Proxmox, with each maintaining its own comprehensive security framework. This enables secure multi-layer authentication across physical and virtual infrastructure, clear security boundaries between layers, end-to-end authentication chains, platform-specific security considerations, cross-platform authentication flows, detailed audit capabilities, security monitoring and validation, and resource access control enforcement. The framework supports both traditional and cloud-native deployments while maintaining security across all layers of the infrastructure stack.

In another embodiment, the system implements a comprehensive framework for HPC-based enhancements to hardware root of trust components, detailing necessary parameters, processes, and evaluation criteria while maintaining practical implementation considerations. The key innovations include multi-layered detection using correlated HPC metrics, real-time behavioral analysis of trust components, adaptive baseline management, comprehensive evaluation frameworks, and practical deployment considerations.

The system implements a core component monitoring framework through sophisticated hardware performance counter selection across multiple security domains. Core TPM counters monitor L1 cache misses and refills, bus access frequency, instruction retirement rate, branch prediction accuracy, exception handling frequency, and memory access patterns. Secure enclave counters track cache access patterns, execution path divergence, memory barrier frequency, DMA transaction rates, interrupt handling patterns, and context switch frequency. Cryptographic engine counters monitor arithmetic operation density, memory access locality, pipeline stall frequency, cache coherency events, bus utilization patterns, and power consumption variations.

Sampling parameters are implemented across both temporal and spatial resolutions. Temporal resolution maintains a base sampling interval of 5 ms, aggregation window of 1000 ms, analysis interval of 30 s, and baseline update frequency of 24 h. Spatial resolution implements per-core granularity, per-component isolation, cross-component correlation, and system-wide aggregation. The feature extraction process encompasses raw counter collection through direct register sampling, hardware timestamp correlation, counter overflow handling, and multi-core synchronization.

The system implements a sophisticated detection framework through multi-layer analysis across component, cross-component, and system levels. Component-level analysis includes individual counter thresholds, component-specific patterns, local behavior consistency, and resource utilization profiles. Cross-component analysis monitors interaction patterns, resource contention detection, communication profiles, and system state consistency. System-level analysis tracks global behavior patterns, resource allocation balance, performance characteristic stability, and security state coherence.

Detection parameters are maintained through statistical thresholds and pattern recognition metrics. Statistical thresholds implement base deviation tolerance of 2.5σ, minimum confidence level of 99.9%, false positive target below 0.01%, and detection latency target under 100 ms. Pattern recognition parameters include minimum pattern length of 5 samples, pattern similarity threshold of 85%, maximum acceptable drift of 5%, and temporal correlation window of 1 second.

The evaluation framework implements comprehensive performance metrics across detection effectiveness, system impact, and reliability metrics. Detection effectiveness targets include true positive rate above 99%, false positive rate below 0.1%, detection latency under 100 ms, and recovery time under 1 second. System impact parameters maintain CPU overhead target below 1%, memory footprint under 5 MB, storage requirements under 100 MB/day, and network bandwidth under 1 KB/s. Reliability metrics target 99.999% availability, MTBF above 10,000 hours, recovery success rate above 99.9%, and 100% state persistence accuracy.

Implementation requirements span hardware, software, and integration domains. Hardware requirements include processors with HPC support, dedicated secure storage, isolated execution environment, trusted execution capability, real-time clock source, and secure boot mechanism. Software requirements encompass minimal OS footprint, secure communication channels, cryptographic service access, logging infrastructure, state management capability, and recovery mechanisms. Integration requirements implement hardware abstraction layer, security policy enforcement, audit trail maintenance, alert mechanism, management interface, and recovery procedures.

Operational considerations are maintained through comprehensive deployment processes, maintenance requirements, and incident response procedures. The deployment process includes initial setup and calibration, baseline profile establishment, detection parameter tuning, integration validation, security verification, and production deployment. Maintenance requirements encompass regular baseline updates, detection accuracy monitoring, performance impact assessment, security state verification, component health monitoring, and system integrity validation. Incident response procedures implement compromise detection, impact assessment, containment measures, recovery initiation, root cause analysis, and security posture restoration.

In a further embodiment, the system implements enhanced hardware performance counter (HPC) based anomaly detection using concepts from Qubes OS's security architecture to create a more robust and compartmentalized monitoring system. The system implements domain separation through core security domains including an HPC Monitor Domain (HPC-dom), Analysis Domain (Analysis-dom), and Alert Domain (Alert-dom).

The HPC Monitor Domain operates as a dedicated unprivileged domain for HPC data collection with direct access to CPU performance counters via VT-d, implementing no network access or other privileges, and maintaining a minimal attack surface through a stripped-down OS. This domain communicates only with the Analysis Domain through strictly defined channels. The Analysis Domain processes raw HPC data from the HPC Monitor Domain, runs anomaly detection algorithms, maintains no direct access to hardware, remains network isolated, and cannot directly affect monitored domains. The Alert Domain handles alert generation and response actions, maintains network access for sending alerts, implements read-only access to analysis results, and cannot affect monitoring or analysis operations.

Inter-domain communication is implemented through secure data flows and domain interaction control. The HPC data collection path maintains one-way data flow from HPC-dom to Analysis-dom through secure channels, implementing fixed message formats, rate limiting, and cryptographically signed measurements. The analysis results path similarly maintains one-way alert flow from Analysis-dom to Alert-dom through secure channels with structured alert formats and no feedback capability to analysis. Domain interaction control is implemented through explicit permission models for all inter-domain communication, mandatory access control between domains, no direct domain-to-domain networking, and all communication via controlled channels.

The system implements comprehensive security enhancements through hardware-level isolation and software-level protection. Hardware-level isolation utilizes VT-d for direct but contained hardware access, IOMMU protection of domain memory, CPU core isolation options, and memory controller access controls. Software-level protection implements domain hardening through minimal OS installations, no unnecessary services, stripped down kernels, and read-only root filesystems. Communication security is maintained through signed messages between domains, version controlled interfaces, rate limiting on all channels, and protocol verification.

The system implements Pluton-enhanced HPC security through a sophisticated measurement collection chain. Protected counter access processes include counter initialization through Pluton-generated unique counter access tokens, hardware-level counter binding to Pluton security context, counter access permissions mapped to measurement operations, and measurement cycle initialization with Pluton attestation. Collection parameters implement adjustable sampling frequency from 1-1000 Hz, batch sizes from 16-1024 measurements, validation windows of 10-100 ms, attestation freshness under 5 ms, various counter types, and multiple collection modes.

A secure transport chain is implemented through measurement packaging and protection mechanisms. Measurement data structures include counter ID, raw value, timestamp, configuration hash, hardware state, collection context, and validation metadata. Protection mechanisms implement hardware-level encryption, measurement batch signing, secure timestamp inclusion, configuration binding, chain-of-custody validation, and replay attack prevention.

The system maintains a protected analysis environment with defined environment parameters and analysis workflow. Environment parameters include hardware-enforced isolation level, encrypted page memory protection, Pluton-verified execution context, dedicated secure memory resource allocation, continuous state validation, and defined recovery procedures. The analysis workflow implements measurement validation process, baseline comparison procedure, anomaly detection sequence, alert generation protocol, response action framework, and audit trail creation.

The comprehensive architecture enables robust detection capabilities while maintaining strict security boundaries between components. The key innovation lies in the direct hardware-level protection of the entire measurement and analysis pipeline while maintaining efficient processing and strong security guarantees. The system supports secure updates, recovery procedures, and operational monitoring while preserving isolation between critical security domains.

The platform may also implement a distributed hardware-based authentication mechanism, which continuously verifies the integrity of hardware components across cloud and edge nodes. Before any node can participate in the computation process, it must pass this rigorous authentication, ensuring that only trusted, uncompromised hardware is utilized in the distributed computing environment.

The distributed graph-based computing structure of the platform excels in managing complex, high-stakes environments. For instance, in the context of collaborative autonomous vehicle fleets, the system efficiently handles cross-industry data sharing and decision-making processes. It might coordinate real-time data from multiple vehicles, traffic infrastructure, and weather systems, using the distributed graph to optimize routing decisions across the entire fleet while ensuring individual vehicle safety.

Furthermore, the system's ability to dynamically reconfigure itself in response to changing data privacy regulations or user preferences showcases its adaptability and compliance capabilities. By integrating differential privacy techniques into the graph computations, the system can adjust the level of data anonymization in real-time. For example, if a user opts out of sharing certain types of data, or if regulations in a particular region change, the system can immediately alter its data handling processes, ensuring continued compliance without disrupting overall functionality. This dynamic reconfiguration capability ensures that the platform remains flexible and responsive to evolving privacy landscapes, making it suitable for deployment across diverse regulatory environments.

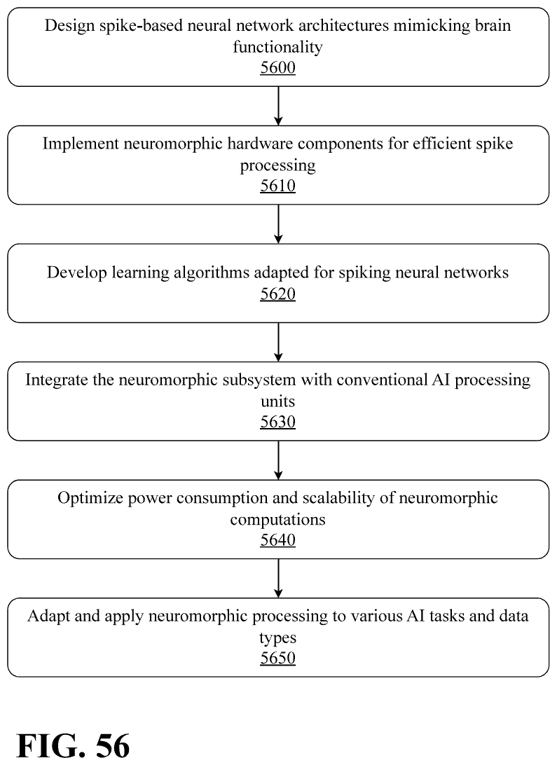

FIG. 56 is a flow diagram illustrating an exemplary method for a distributed generative artificial intelligence reasoning and action platform with an integrated neuromorphic processing subsystem. In a first step 5600, the system designs spike-based neural network architectures mimicking brain functionality. This step involves creating artificial neural network models that operate on principles similar to biological neurons, using discrete spikes for information processing and transmission. The design takes inspiration from neuroscience research, incorporating elements such as temporal coding, sparse activation, and event-driven computation. These architectures might include spiking neural networks (SNNs) with various neuron models (e.g., leaky integrate-and-fire, Izhikevich model) and synaptic plasticity mechanisms inspired by biological processes like spike-timing-dependent plasticity (STDP).

In a step 5610, the system implements neuromorphic hardware components for efficient spike processing. This involves developing or integrating specialized hardware that can efficiently process spike-based information. This could include neuromorphic chips like Intel's Loihi, or custom designs using emerging technologies such as memristors or photonic computing elements. The hardware is optimized for parallel, asynchronous, and event-driven computation, aligning closely with the spike-based nature of the neural architectures. This step may also involve implementing liquid circuits, as mentioned in previous disclosures, which can perform logical operations with extreme energy efficiency by mimicking synaptic operations.

In a step 5620, the system develops learning algorithms adapted for spiking neural networks. Traditional deep learning algorithms often don't translate directly to spike-based systems, so this step focuses on creating or adapting learning algorithms specifically for neuromorphic architectures. This might include spike-based versions of backpropagation, reinforcement learning algorithms optimized for sparse, temporal data, or novel learning approaches inspired by biological neural plasticity. The goal is to enable efficient training and adaptation of the neuromorphic networks for various AI tasks.

In a step 5630, the system integrates the neuromorphic subsystem with conventional AI processing units. This step involves creating interfaces and coordination mechanisms that allow the neuromorphic components to work seamlessly with traditional AI hardware like GPUs and CPUs. The integration enables hybrid processing pipelines where certain tasks can be offloaded to the neuromorphic subsystem for more efficient processing, while others remain on conventional hardware. This might involve developing data conversion mechanisms between spike-based and traditional representations, as well as scheduling algorithms to optimize workload distribution across different processing units.

In a step 5640, the system optimizes power consumption and scalability of neuromorphic computations. Neuromorphic systems have the potential for extremely low power consumption, and this step focuses on realizing that potential while ensuring scalability to larger, more complex tasks. This involves implementing fine-grained power management techniques, optimizing spike encoding and transmission, and developing efficient interconnect strategies for large-scale neuromorphic systems. The step may also leverage advanced cooling technologies like the through-chip microchannel cooler (TCMC) to manage thermal issues in densely packed neuromorphic components.

In a step 5650, the system adapts and applies neuromorphic processing to various AI tasks and data types. This final step involves expanding the applicability of the neuromorphic subsystem beyond traditional use cases. It includes developing spike-based processing techniques for different types of data (e.g., converting images or audio into spike trains), and adapting neuromorphic approaches to a wide range of AI tasks such as pattern recognition, anomaly detection, and real-time control systems. This step also involves creating libraries and APIs that allow developers to easily leverage neuromorphic processing in diverse applications, potentially opening up new possibilities in areas like robotics, IoT, and edge computing.

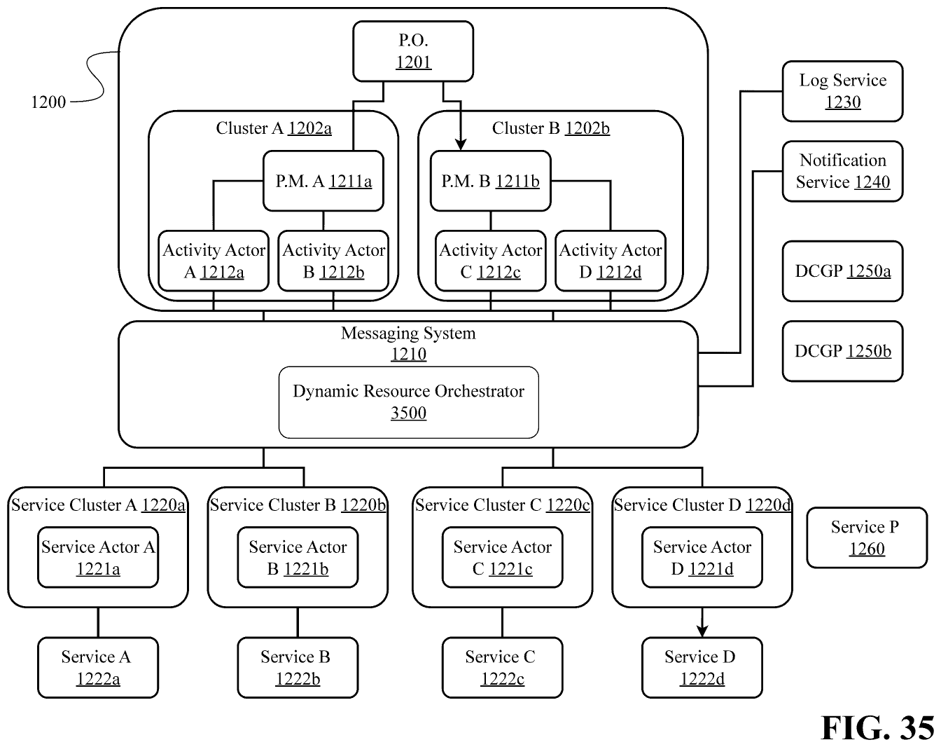

FIG. 35 is a block diagram illustrating an exemplary system architecture for a distributed generative artificial intelligence reasoning and action platform with an integrated dynamic resource orchestrator. Dynamic resource orchestrator 3500 represents an enhancement to the distributed generative AI reasoning and action platform, seamlessly integrating with the existing distributed computational graph architecture to optimize resource allocation and utilization across the system. This orchestrator works in concert with multiple components of the existing architecture, fundamentally improving the platform's ability to handle complex, dynamic workloads efficiently.

Dynamic resource orchestrator 3500 interfaces closely with pipeline orchestrator 1201, enhancing its ability to manage and distribute tasks across the system. As the pipeline orchestrator spawns child pipeline clusters 1202a-b, the dynamic resource orchestrator continuously monitors and analyzes resource utilization, making real-time decisions about task allocation and resource distribution. For instance, when a computationally intensive AI model is being deployed through the general transformer service module, the dynamic resource orchestrator can dynamically adjust the allocation of processing power, memory, and other resources to ensure optimal performance.

Dynamic resource orchestrator 3500 establishes a deep connection with pipeline managers 1211a and 1211b within each cluster. It enhances their ability to manage activity actors 1212a-d by providing real-time insights into resource availability and performance metrics. This allows for more intelligent task scheduling and load balancing within and across clusters. For example, if one cluster is experiencing high load due to a complex AI workflow, the dynamic resource orchestrator can seamlessly redistribute tasks to other, less burdened clusters, ensuring consistent performance across the system.

Interacting closely with service clusters 1220a-d and their respective service actors 1221a-d, dynamic resource orchestrator 3500 optimizes the allocation of specialized services. It works in tandem with the hardware-aware transformer subsystem to ensure that tasks are assigned to the most suitable hardware resources. For instance, when dealing with tasks that could benefit from neuromorphic processing, the orchestrator can prioritize the allocation of these tasks to clusters with available neuromorphic hardware. Dynamic resource orchestrator 3500 also enhances the functionality of messaging system 1210, optimizing the flow of data and control messages across the platform. By continuously analyzing message patterns and system state, it can dynamically adjust communication pathways to reduce latency and improve overall system responsiveness. This is particularly valuable in scenarios involving real-time AI processing or complex, multi-step workflows.

In its interaction with log service 1230 and notification service 1240, dynamic resource orchestrator 3500 enables more sophisticated monitoring and alerting capabilities. It can analyze log data in real-time to identify potential resource bottlenecks or inefficiencies, triggering notifications or automated responses as needed. This proactive approach to resource management helps maintain optimal system performance even under varying workload conditions. Dynamic resource orchestrator 3500 works synergistically with DCG protocols 1250a-b, enhancing their ability to distribute workloads across the system. By providing real-time information about resource availability and performance, it allows for more intelligent and efficient routing of tasks through the distributed computational graph.

In an embodiment, as the pipeline orchestrator begins to distribute tasks across clusters, dynamic resource orchestrator 3500 continuously monitors resource utilization and performance metrics. It might, for example, detect that a particular cluster is approaching its memory limits due to a large language model being loaded. In response, it could dynamically reallocate memory resources from less utilized clusters or initiate the provisioning of additional memory resources if available.

Throughout the execution of the workflow, dynamic resource orchestrator 3500 continues to optimize resource allocation. It might detect that certain tasks are particularly well-suited for neuromorphic processing and dynamically route these tasks to clusters with available neuromorphic hardware. Simultaneously, it could identify opportunities for parallel processing and distribute tasks across multiple clusters to maximize throughput. Dynamic resource orchestrator 3500 also plays a role in managing the system's response to unexpected events or changing conditions. For instance, if a hardware failure is detected in one cluster, dynamic resource orchestrator 3500 can quickly redistribute tasks to other clusters, ensuring minimal disruption to ongoing processes. Similarly, if there's a sudden spike in user requests, the orchestrator can dynamically scale resources to meet the increased demand, potentially leveraging cloud resources if needed.

By integrating dynamic resource orchestrator 3500, the platform achieves a new level of efficiency and adaptability in resource management. It allows for more intelligent and responsive allocation of computing resources, enabling the system to handle more complex and varied workloads while maintaining optimal performance. The result is a more resilient, scalable, and efficient AI system that can deliver consistent performance across a wide range of scenarios, from edge computing to large-scale cloud deployments.

The system's adaptability extends to predictive resource allocation, leveraging AI to anticipate potential network congestion or hardware failures. By analyzing historical data patterns, current network traffic, and hardware health metrics, the AI can forecast potential issues and proactively adjust resource distribution. This might involve rerouting critical tasks away from hardware components showing early signs of degradation or preemptively scaling up resources in anticipation of a predicted spike in demand. The AI-driven resource optimization continuously learns and improves over time, refining its predictive models based on observed outcomes, energy consumption patterns, and long-term hardware performance trends. This learning process extends to user-level analysis, incorporating User and Entity Behavior Analytics (UEBA) to optimize resource allocation based on individual user patterns. For example, the system might preemptively allocate more resources to users known to run resource-intensive simulations, like climate scientists, while maintaining a leaner resource profile for users typically engaged in less demanding tasks. While this user-based approach may not always be optimal for short-term task allocation, it provides valuable insights for long-term capacity planning and resource provisioning at a macro level, enabling the system to anticipate and prepare for diverse workload patterns across its user base. This comprehensive approach to dynamic resource allocation ensures not only immediate performance optimization but also long-term efficiency and adaptability of the entire computational ecosystem.

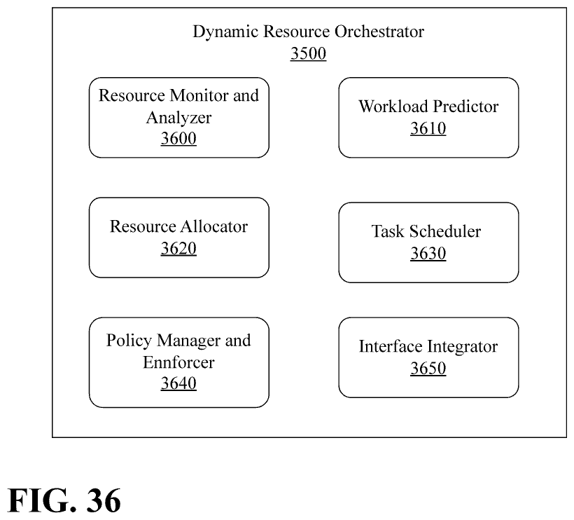

FIG. 36 is a block diagram illustrating an exemplary subsystem architecture for a component of a distributed generative artificial intelligence reasoning and action platform with an integrated dynamic resource orchestrator, a dynamic resource orchestrator. Central to dynamic resource orchestrator 3500, resource monitor and analyzer 3600 serves as the vigilant observer of the entire system. It interfaces closely with pipeline orchestrator 1201 and individual pipeline managers 1211a-b, continuously collecting and analyzing data on resource utilization across all clusters. This component might, for instance, detect that a particular cluster is approaching memory capacity due to a large language model being processed by general transformer service module 1060. This real-time insight forms the foundation for intelligent resource management decisions.

Working in concert with resource monitor and analyzer 3600, workload predictor 3610 leverages advanced machine learning techniques to anticipate future resource needs. It communicates with automated planning service module 1030 and action outcome simulation module 1025 to incorporate broader system goals and simulated outcomes into its predictions.

For example, if the workload predictor anticipates a spike in natural language processing tasks based on historical patterns, it can proactively suggest resource allocations to handle the expected increase in demand.

Resource allocator 3620 acts as the decision-making core of the orchestrator. It takes inputs from both the resource monitor and analyzer and the workload predictor to make informed decisions about resource distribution. This component works closely with Hardware-Aware Transformer subsystem 2800 to ensure that resources are allocated in a manner that aligns with the specific hardware capabilities of different clusters. For instance, it might prioritize allocating tasks that benefit from neuromorphic processing to clusters equipped with neuromorphic processing subsystem 3300.

Task scheduler 3630 translates the high-level resource allocation decisions into concrete task assignments. It interfaces directly with distributed computational graph system 1055 and the service clusters 1220a-d to optimize the distribution of workloads across the available resources. This component might, for example, decide to split a complex AI workflow across multiple clusters to maximize parallel processing capabilities, dynamically adjusting the schedule based on real-time performance metrics.

Policy manager and enforcer 3640 ensures that all resource allocation and task scheduling decisions adhere to predefined policies and constraints. It works in tandem with observation and state estimation service 1040 to maintain a holistic view of the system state and enforce operational boundaries. This might involve ensuring that critical tasks always have access to a minimum level of resources, or that certain data-sensitive operations are only executed on specific, secure clusters. Interface integrator 3650 serves as the primary communication channel between dynamic resource orchestrator 3500 and other platform components. It works closely with connector module 1035 and the messaging system 1210 to ensure seamless integration of the orchestrator's decisions into the broader system workflow. This component enables the orchestrator to communicate resource allocation decisions to various parts of the system, from individual service actors 1221a-d to high-level management interfaces.

By integrating these components, dynamic resource orchestrator 3500 enables a new level of efficiency and adaptability in resource management. It allows the platform to handle complex, varying workloads with grace, dynamically adjusting to changing demands and system conditions. This results in a more resilient, scalable, and efficient AI system that can maintain optimal performance across a wide range of scenarios, from edge computing applications to large-scale cloud deployments.

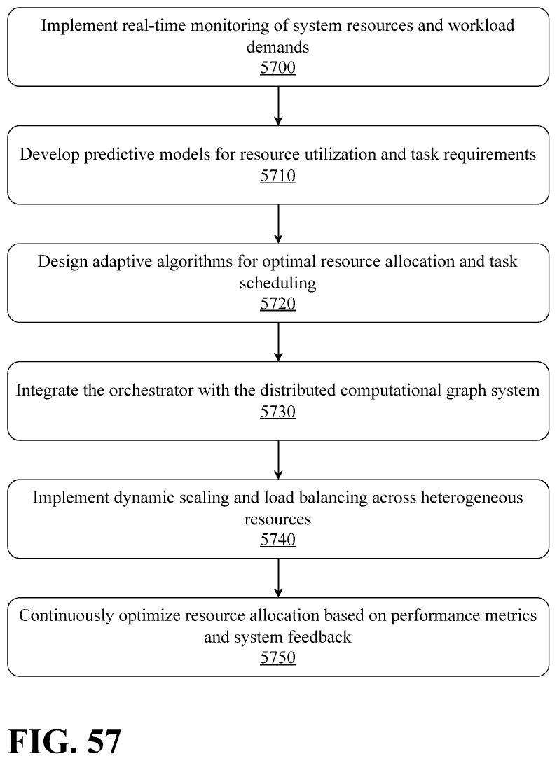

FIG. 57 is a flow diagram illustrating an exemplary method for a distributed generative artificial intelligence reasoning and action platform with an integrated dynamic resource orchestrator. In a first step 5700, the system implements real-time monitoring of system resources and workload demands. This involves setting up a comprehensive monitoring infrastructure that tracks the utilization and performance of various hardware components across the distributed AI platform. The monitoring covers aspects such as CPU and GPU usage, memory allocation, network bandwidth, and storage I/O. It also involves tracking incoming workloads and their specific resource requirements. This real-time data collection forms the foundation for dynamic resource management decisions.

In a step 5710, the system develops predictive models for resource utilization and task requirements. Using the data collected from the monitoring system, machine learning models are created to forecast future resource needs and workload patterns. These models might employ techniques such as time series analysis, reinforcement learning, or deep learning to accurately predict resource utilization trends and upcoming task requirements. The predictive capabilities enable proactive resource allocation and help prevent bottlenecks or resource contention.

In a step 5720, the system designs adaptive algorithms for optimal resource allocation and task scheduling. This step involves creating sophisticated algorithms that can dynamically adjust resource allocation based on current system state, predicted future needs, and overall performance goals. These algorithms might incorporate techniques from operations research, such as constraint optimization or genetic algorithms, as well as AI methods like Deep Q-Networks for decision making. The algorithms are designed to handle complex trade-offs between performance, energy efficiency, and resource availability across heterogeneous hardware components.

In a step 5730, the system integrates the orchestrator with the distributed computational graph system. This integration ensures that the resource orchestrator can efficiently manage the execution of complex AI workflows represented as computational graphs. The orchestrator works closely with the graph system to dynamically allocate resources for different parts of the graph, potentially splitting or merging computational nodes based on available resources. This tight integration allows for fine-grained control over resource utilization and enables efficient execution of large-scale, distributed AI tasks.

In a step 5740, the system implements dynamic scaling and load balancing across heterogeneous resources. This step involves developing mechanisms to automatically scale resources up or down based on demand, as well as balancing workloads across different types of hardware (e.g., CPUs, GPUs, TPUs, neuromorphic processors). The system might employ techniques like containerization or serverless computing to enable rapid deployment and scaling of AI tasks. Load balancing algorithms are implemented to ensure optimal utilization of resources and prevent any single component from becoming a bottleneck.

In a step 5750, the system continuously optimizes resource allocation based on performance metrics and system feedback. This final step implements a feedback loop that allows the orchestrator to learn and improve its allocation strategies over time. The system collects detailed performance metrics and compares them against expected outcomes. Machine learning techniques, possibly including reinforcement learning, are used to refine the resource allocation algorithms based on this feedback. This continuous optimization ensures that the system adapts to changing workloads, hardware configurations, and performance requirements, maintaining optimal efficiency and performance over time.

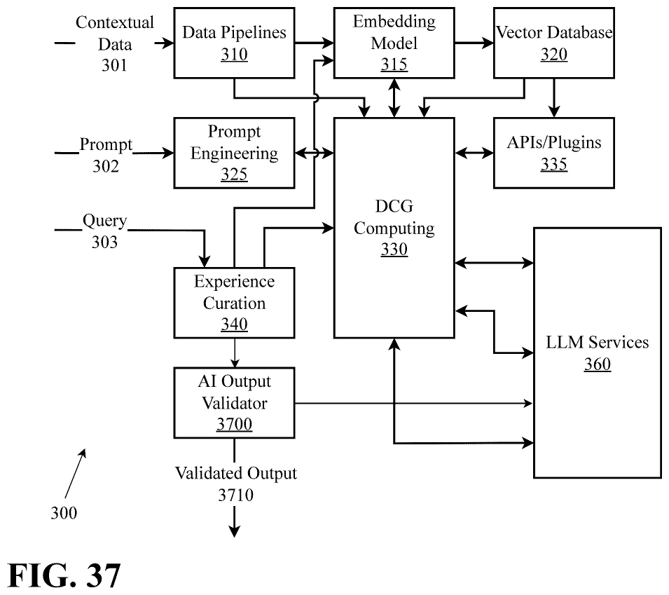

FIG. 37 is a block diagram illustrating an exemplary system architecture for a distributed generative artificial intelligence reasoning and action platform with an integrated output validator. AI output validator 3700 is an enhancement to the distributed generative AI reasoning and action platform, integrating seamlessly to ensure the reliability, accuracy, and safety of AI-generated outputs. AI output validator 3700 interweaves with multiple components of the existing architecture, fundamentally improving the platform's ability to produce trustworthy and contextually appropriate responses.

AI output validator 3700 establishes a connection with DCG computing 330 component, intercepting and analyzing the outputs generated by various AI models before they are returned to the user. This integration allows for a comprehensive evaluation of AI-generated content, checking for potential errors, inconsistencies, or hallucinations that might occur in large language models or other AI systems. For instance, when processing a complex query that requires multi-step reasoning, the validator might cross-reference the generated output against known facts or logical constraints to ensure coherence and accuracy.

AI output validator 3700 works in close concert with embedding model 315 and vector database 320, leveraging these components to perform semantic similarity checks and fact verification. By comparing the embeddings of the AI-generated output with those of trusted information sources stored in the vector database, the validator can identify potential discrepancies or misalignments. This is particularly valuable when dealing with domain-specific queries that require high levels of accuracy, such as in medical or legal applications.

Interacting with the prompt engineering 325 component, AI output validator 3700 enhances the system's ability to generate appropriate and safe responses. It can analyze the relationship between the input prompt and the generated output, ensuring that the response adheres to specified guidelines or constraints. For example, in scenarios involving content generation for different age groups, the validator could ensure that the output maintains an appropriate tone and content level for the target audience.

AI output validator 3700 also establishes a link with experience curation 340 component, working to ensure that the curated AI experiences meet predefined quality and safety standards. By validating outputs before they reach the curation stage, it helps maintain the integrity and reliability of the user experience. This could involve checking for potential biases, ensuring factual accuracy, or verifying that the output aligns with user preferences and system policies. In its interaction with LLM services 360, AI output validator 3700 plays a role in managing the outputs from various large language models. It can compare outputs from multiple models, identify discrepancies, and select or synthesize the most reliable response. This multi-model validation approach can significantly enhance the robustness of the system's outputs, particularly in scenarios where high stakes decisions are involved.

AI output validator 3700 also interfaces with APIs/plugins 335, enabling the integration of external validation tools or domain-specific knowledge bases. This allows for specialized validation processes that can be tailored to specific use cases or industries. For instance, in a financial application, the AI output validator 3700 might interface with regulatory compliance APIs to ensure that AI-generated financial advice adheres to current regulations.

In an embodiment, when a user submits a query 303 through the system, AI output validator 3700 begins functioning action as soon as the AI models generate a response. It begins by analyzing the semantic content of the output, leveraging embedding model 315 to create a vector representation of the generated text. This representation is then compared against relevant information in vector database 320 to check for factual accuracy and contextual appropriateness. Simultaneously, AI output validator 3700 might employ rule-based checks to ensure that the output adheres to predefined safety and quality guidelines. For complex queries, it might break down the response into sub-components, validating each part individually before assessing the coherence of the whole. If any issues are detected, AI output validator 3700 can trigger various actions. It might flag the output for human review, automatically correct minor issues, or in cases of significant discrepancies, request a regeneration of the response from the AI models. The validator might also provide confidence scores or explanations for its validation decisions, which can be used by experience curation 340 component to further refine the user experience.

Throughout this process, AI output validator 3700 maintains a feedback loop with other system components. It can inform prompt engineering 325 component about patterns in problematic outputs, helping to refine prompt strategies. It also provides valuable data to DCG computing 330 component, which can use this information to optimize its computational graphs for improved accuracy and reliability.

By integrating AI output validator 3700, the platform achieves a new level of trustworthiness and reliability in its AI-generated outputs. It allows for more confident deployment of AI models in critical applications, reducing the risk of misinformation or inappropriate content. The result is a more responsible and dependable AI system that can deliver high-quality, validated outputs 3710 across a wide range of applications and domains, from general-purpose chatbots to specialized decision-support systems in regulated industries.

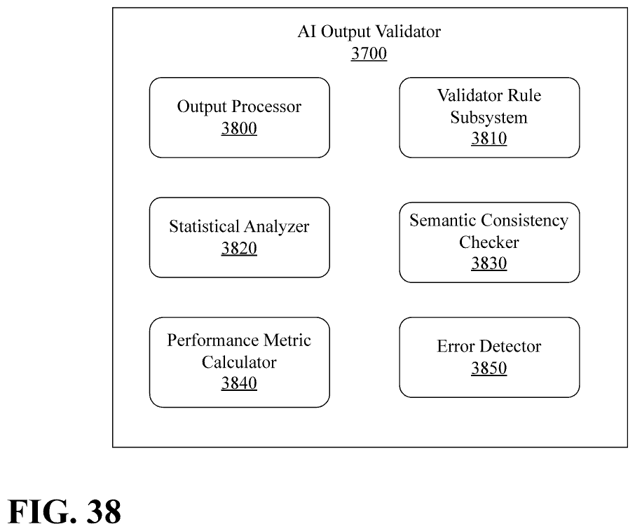

FIG. 38 is a block diagram illustrating an exemplary subsystem architecture for a component of a distributed generative artificial intelligence reasoning and action platform with an integrated output validator, an output validator. Output processor 3800 serves as the initial point of contact for AI-generated content. It interfaces closely with DCG computing 330 and LLM services 360, intercepting outputs from various AI models before they reach the user. This component might, for instance, receive a complex response generated by a large language model and prepare it for multi-faceted validation. The output processor also works in tandem with experience curation 340 component, ensuring that the validation process aligns with overall user experience goals.

Working in concert with the output processor, validator rule subsystem 3810 applies a set of predefined rules and constraints to the AI-generated content. It communicates with prompt engineering 325 component to understand the context and requirements of the original query, ensuring that the output adheres to specified guidelines. For example, in a scenario where the system is generating medical information, this subsystem might enforce rules about citing reputable sources or flagging speculative statements.

Statistical analyzer 3820 employs advanced statistical techniques to evaluate the reliability of the AI output. It interfaces with information theory statistics engine 1030a to perform in-depth analysis of the generated content. This might involve assessing the probability distribution of certain phrases or comparing the statistical properties of the output to those of known reliable sources. In a financial forecasting scenario, for instance, the statistical analyzer could check if the predicted values fall within historically observed ranges. Semantic consistency checker 3830 plays a role in ensuring the logical coherence and contextual appropriateness of the AI output. It works closely with embedding model 315 and vector database 320 to perform semantic similarity checks and fact verification. This component might, for example, compare the embeddings of key concepts in the output against those in the vector database to detect any semantic drift or inconsistencies. In a legal document generation task, it could ensure that the terminology used is consistent with the relevant jurisdiction and case law.

Performance metric calculator 3840 quantifies various aspects of the AI output's quality and relevance. It interfaces with observation and state estimation service 1040 to incorporate broader system performance data into its calculations. This component might compute metrics such as relevance scores, coherence indices, or domain-specific quality indicators. For instance, in a customer service application, it could calculate metrics related to empathy, problem-solving effectiveness, and adherence to company policies. Error detector 3850 serves as the last line of defense, identifying potential mistakes, hallucinations, or inappropriate content in the AI output. It works in tandem with automated planning service module 1030 to anticipate and preemptively address potential error scenarios. This component might employ techniques like anomaly detection or cross-referencing with multiple knowledge sources to flag suspicious content. In a critical infrastructure management scenario, for example, it could detect if the AI system suggests actions that violate safety protocols or operational constraints.

By integrating these components, the AI output validator 3700 enables a new level of reliability and trustworthiness in AI-generated content. It allows the platform to confidently deploy AI models in critical applications, significantly reducing the risk of misinformation, inconsistencies, or inappropriate outputs. The result is a more responsible and dependable AI system that can deliver high-quality, thoroughly validated outputs across a wide range of applications, from general-purpose content generation to specialized decision-support systems in highly regulated industries.

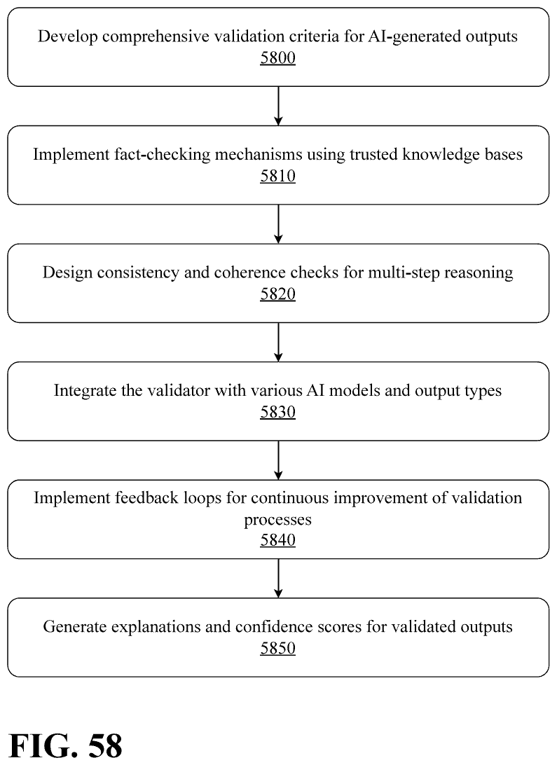

FIG. 58 is a flow diagram illustrating an exemplary method for a distributed generative artificial intelligence reasoning and action platform with an integrated output validator. In a first step 5800, the system develops comprehensive validation criteria for AI-generated outputs. This step involves defining a wide range of criteria to assess the quality, accuracy, and reliability of outputs from various AI models. These criteria might include factual correctness, logical consistency, relevance to the input query, adherence to ethical guidelines, and appropriateness for the intended audience. The validation criteria are designed to be flexible and adaptable to different types of AI tasks, such as natural language generation, image creation, or decision-making processes.

In a step 5810, the system implements fact-checking mechanisms using trusted knowledge bases. This involves integrating the validator with reliable, up-to-date knowledge sources, which could include curated databases, academic repositories, or verified public datasets. The system develops algorithms to efficiently query these knowledge bases and cross-reference AI-generated content against established facts. This step might also involve implementing natural language processing techniques to understand and compare semantic content, ensuring that the fact-checking goes beyond simple keyword matching.

In a step 5820, the system designs consistency and coherence checks for multi-step reasoning. This step focuses on validating the logical flow and consistency of AI outputs, especially for tasks involving complex reasoning or multi-step processes. The system implements algorithms to track logical dependencies, identify contradictions, and ensure that conclusions follow from premises. This might involve techniques from formal logic, causal reasoning, or probabilistic inference. For language models, it could include analyzing coreference resolution and maintaining consistent entity attributes throughout a generated text.

In a step 5830, the system integrates the validator with various AI models and output types. This involves creating flexible interfaces that allow the validator to work with different types of AI models (e.g., language models, image generators, decision-making systems) and handle various output formats (text, images, structured data). The integration ensures that the validation process can be seamlessly applied across the platform's diverse AI capabilities. This step might also involve developing model-specific validation techniques that leverage the unique characteristics of each AI model.

In a step 5840, the system implements feedback loops for continuous improvement of validation processes. This step creates mechanisms to learn from validation results and user feedback, allowing the validator to improve its performance over time. The system might employ machine learning techniques to identify patterns in validation errors and refine its checking algorithms. It could also incorporate active learning approaches to efficiently gather human feedback on edge cases or ambiguous outputs, using this information to enhance its validation capabilities.

In a step 5850, the system generates explanations and confidence scores for validated outputs. This final step focuses on providing transparency and interpretability for the validation process. For each validated output, the system generates human-readable explanations of why it passed or failed certain validation criteria. It also computes confidence scores that indicate the degree of certainty in the validation results. These explanations and scores help users understand the reliability of the AI-generated content and make informed decisions about its use. The system might employ techniques from explainable AI (XAI) to generate these insights in a clear and accessible manner.

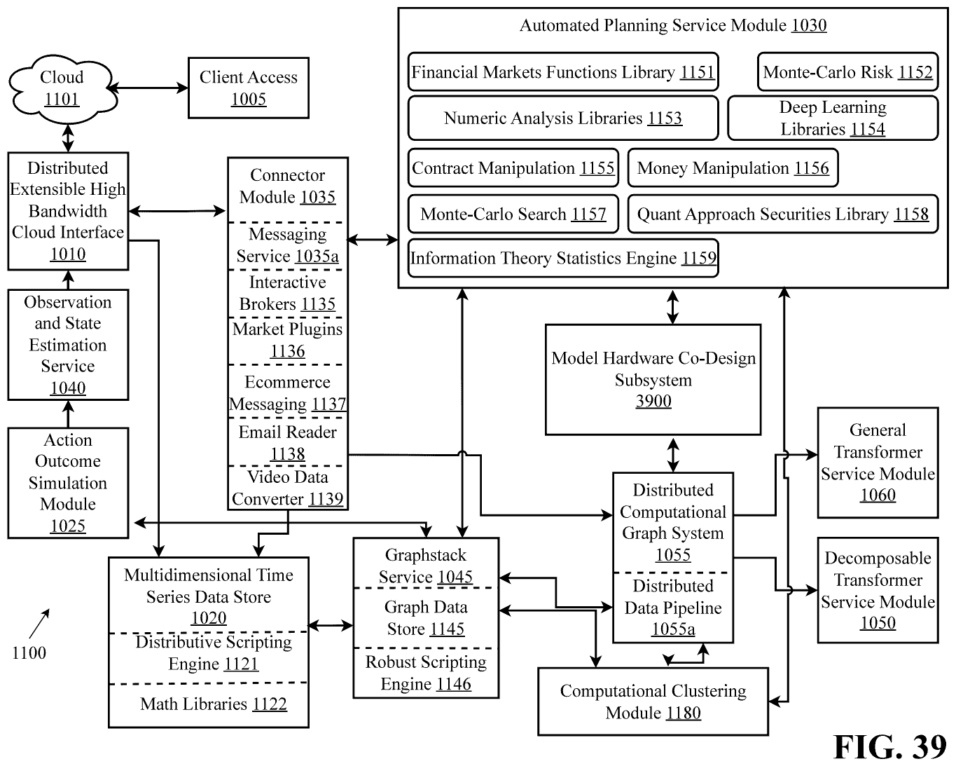

FIG. 39 is a block diagram illustrating an exemplary system architecture for a distributed generative artificial intelligence reasoning and action platform with an integrated mode hardware co-design subsystem. Model hardware co-design subsystem 3900 represents a significant advancement in the distributed generative AI reasoning and action platform, seamlessly integrating the processes of AI model development and hardware optimization. This subsystem creates a symbiotic relationship between software and hardware design, fundamentally enhancing the platform's ability to create highly efficient and specialized AI solutions.

At its core, model hardware co-design subsystem 3900 establishes a connection with distributed computational graph system 1055 and its distributed data pipeline 1055a. This integration allows for the simultaneous optimization of AI model architectures and hardware configurations, enabling the platform to create purpose-built solutions that maximize performance and efficiency. For instance, when developing a complex AI model for financial market analysis, the subsystem might iteratively adjust both the model's architecture and the underlying hardware specifications to achieve optimal performance for specific types of financial computations.

Model hardware co-design subsystem 3900 works in close concert with general transformer service module 1060 and decomposable transformer service module 1050, enhancing their capabilities by tailoring hardware configurations to the specific needs of transformer-based models. This could involve, for example, designing specialized processing units optimized for attention mechanisms or developing memory architectures that efficiently handle the large parameter sets typical of transformer models. Interacting closely with automated planning service module 1030 and its associated libraries 1151-1159, model hardware co-design subsystem 3900 enables the creation of highly specialized AI solutions for specific domains. It can leverage domain-specific knowledge encoded in these libraries to inform both model architecture decisions and hardware design choices. For instance, when developing an AI system for quantitative finance, the subsystem might use insights from quant approach securities library 1158 to design both a tailored neural network architecture and specialized hardware accelerators optimized for financial calculations.

Model hardware co-design subsystem also establishes a link with the computational clustering module 1180, enabling the design of AI models and hardware configurations that can efficiently scale across distributed computing environments. This could involve, for example, developing models that can be efficiently partitioned across multiple specialized processing units, along with the hardware interconnects necessary to support high-speed communication between these units. In its interaction with observation and state estimation service 1040, model hardware co-design subsystem 3900 can incorporate real-world performance data and operational constraints into the design process. This allows for the creation of AI models and hardware configurations that are not just theoretically optimal, but also well-suited to practical deployment scenarios. For example, it might adjust model complexity and hardware power requirements based on observed energy constraints in edge computing environments.

Model hardware co-design subsystem 3900 also interfaces with the connector module 1035 and its various plugins 1135-1139, ensuring that the co-designed models and hardware can efficiently handle diverse data inputs and integrate with external systems. This might involve, for instance, designing specialized hardware interfaces for high-speed market data ingestion when developing AI systems for algorithmic trading.

In an embodiment, when a new AI solution is being developed, model hardware co-design subsystem 3900 orchestrates a complex, iterative process. It might begin by analyzing the requirements of the task, drawing on domain-specific knowledge from relevant libraries. The subsystem then initiates parallel processes of model architecture search and hardware configuration optimization. As potential model architectures are evaluated using distributed computational graph system 1055, the hardware design is simultaneously refined. This could involve simulating different hardware configurations, testing various memory hierarchies, or exploring novel processing unit designs. The subsystem continuously assesses the performance of these model-hardware pairings, using metrics relevant to the specific application domain.

Throughout this process, model hardware co-design subsystem 3900 maintains a feedback loop with other system components. It might, for example, leverage action outcome simulation module 1025 to predict the real-world performance of different model-hardware combinations. It could also interface with multidimensional time series data store 1020 to incorporate historical performance data into its design decisions. By integrating model hardware co-design subsystem 3900, the platform achieves a new level of efficiency and specialization in AI system development. It allows for the creation of highly optimized, purpose-built AI solutions that maximize performance within given constraints. This capability opens up new possibilities for AI applications, from ultra-efficient edge computing solutions to highly specialized AI accelerators for complex scientific computations. The result is a more powerful, efficient, and adaptable AI development platform that can deliver tailored solutions across a wide range of applications and deployment scenarios.

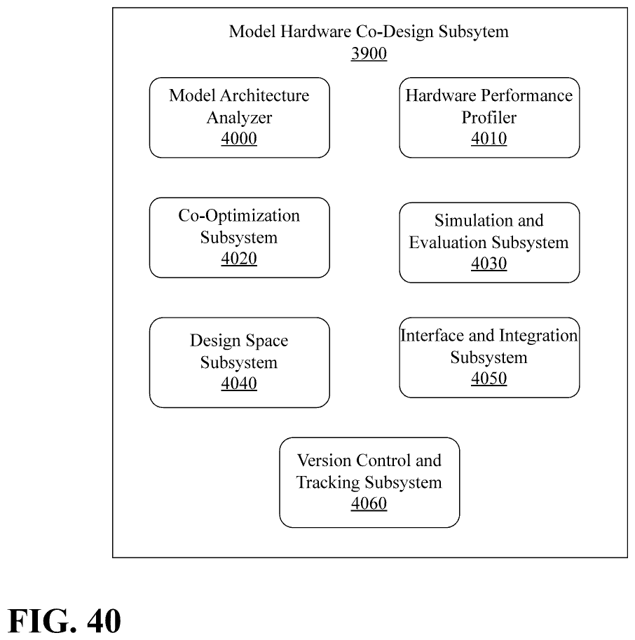

FIG. 40 is a block diagram illustrating an exemplary subsystem architecture for a component of a distributed generative artificial intelligence reasoning and action platform with an integrated model hardware co-design subsystem, a model hardware co-design subsystem. Model architecture analyzer 4000 works with general transformer service module 1060 and decomposable transformer service module 1050. It continuously analyzes and evaluates different model architectures, considering factors such as computational complexity, memory requirements, and potential for parallelization. For instance, when developing a large language model for real-time translation, this component might explore variations in attention mechanism designs or experiment with different model depths and widths to find the most efficient architecture for the given task.

Hardware performance profiler 4010 establishes a connection with computational clustering module 1180 and distributed computational graph system 1055. It gathers detailed performance data on various hardware configurations, considering factors like processing speed, memory bandwidth, and energy efficiency. This component might, for example, profile the performance of different GPU architectures or specialized AI accelerators when executing specific types of neural network operations, providing data for the co-optimization process.

Working in tandem with these components, co-optimization subsystem 4020 serves as the decision-making core of the model hardware co-design process. It leverages advanced optimization techniques, potentially incorporating ideas from Monte-Carlo search library 1157 and deep learning libraries 1154, to navigate the complex design space of model architectures and hardware configurations. This subsystem might employ techniques similar to neural architecture search, but extended to include hardware parameters, iteratively refining both the model and hardware design to achieve optimal performance for specific tasks.

Simulation and evaluation subsystem 4030 plays a role in assessing the potential performance of different model-hardware pairings. It interfaces with action outcome simulation module 1025 and leverages information theory statistics engine 1159 to predict and evaluate the real-world performance of proposed designs. For instance, when developing an AI system for financial risk assessment, this subsystem might simulate its performance using historical market data, evaluating both accuracy and computational efficiency.

Design space exploration subsystem 4040 works closely with automated planning service module 1030 to systematically explore the vast space of possible model architectures and hardware configurations. It might employ techniques like evolutionary algorithms or Bayesian optimization to efficiently navigate this complex design space. For example, when developing an AI system for edge computing, this subsystem could explore trade-offs between model complexity, energy efficiency, and inference speed, considering a range of potential hardware platforms from low-power microcontrollers to more capable edge GPUs. Interface and integration subsystem 4050 serves as the primary link between model hardware co-design subsystem 3900 and other platform components. It works closely with connector module 1035 and its various plugins 1135-1139 to ensure that the co-designed models and hardware can efficiently integrate with diverse data sources and external systems. This subsystem might, for instance, design specialized hardware interfaces for high-speed video data ingestion when developing AI models for real-time video analysis, leveraging the video data converter 1139 for efficient data preprocessing.

Version control and tracking subsystem 4060 maintains a comprehensive record of the co-design process, interfacing with multidimensional time series data store 1020 to log the evolution of model architectures and hardware configurations over time. This enables the platform to track performance improvements, rollback to previous versions if needed, and provide insights into the co-design process for future projects.

By integrating these components, model hardware co-design subsystem 3900 enables a new paradigm in AI system development. It allows for the creation of highly optimized, purpose-built AI solutions that maximize performance within given constraints. This capability opens up new possibilities for AI applications, from ultra-efficient edge computing solutions to highly specialized AI accelerators for complex scientific computations. The result is a more powerful, efficient, and adaptable AI development platform that can deliver tailored solutions across a wide range of applications and deployment scenarios.

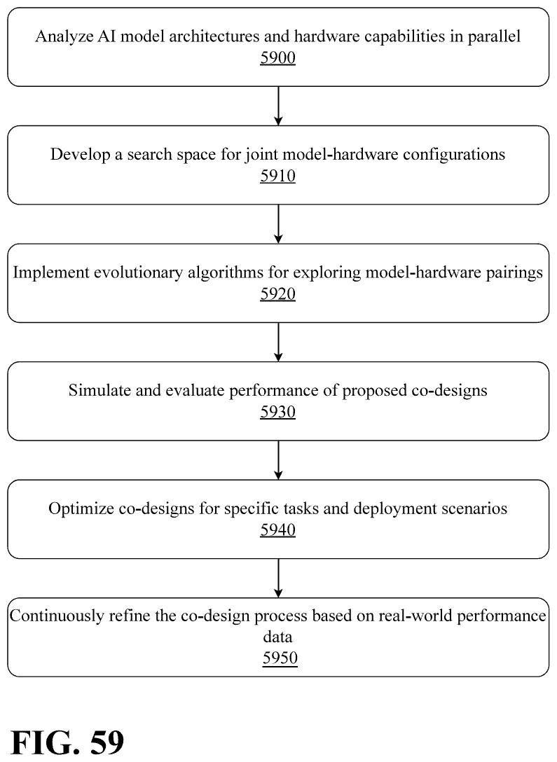

FIG. 59 is a flow diagram illustrating an exemplary method for a distributed generative artificial intelligence reasoning and action platform with an integrated model hardware co-design subsystem. In a first step 5900, the system analyzes AI model architectures and hardware capabilities in parallel. This step involves a comprehensive assessment of both the AI model structures (such as various transformer architectures, convolutional neural networks, or neuromorphic designs) and the available hardware resources (including CPUs, GPUs, TPUs, FPGAs, and specialized AI accelerators). The analysis considers factors like computational requirements, memory access patterns, and parallelization potential for the models, as well as processing power, memory bandwidth, and energy efficiency for the hardware. This parallel analysis sets the foundation for finding optimal pairings between models and hardware.

In a step 5910, the system develops a search space for joint model-hardware configurations. Using the insights from the previous step, this stage involves defining a multidimensional space that represents all possible combinations of model architectures and hardware configurations. This search space might include variables such as model size, layer types, attention mechanisms, hardware types, memory configurations, and interconnect topologies. The system also defines constraints and objectives within this space, such as performance targets, energy efficiency goals, and hardware resource limitations.

In a step 5920, the system implements evolutionary algorithms for exploring model-hardware pairings. This step involves developing and applying advanced search algorithms, such as genetic algorithms or evolutionary strategies, to efficiently explore the vast search space defined in the previous step. These algorithms iteratively generate and evaluate potential model-hardware pairings, mimicking natural selection to converge on optimal configurations. The system might implement techniques like neural architecture search (NAS) combined with hardware-aware optimization to simultaneously evolve both the model architecture and the hardware configuration.

In a step 5930, the system simulates and evaluates performance of proposed co-designs. For each candidate model-hardware pairing generated by the evolutionary algorithms, the system performs detailed simulations to assess its performance. This involves using hardware simulation tools to model the execution of the AI models on the proposed hardware configurations. The evaluation considers metrics such as inference speed, training time, energy consumption, and accuracy. The system might leverage techniques like hardware-in-the-loop simulation or digital twins of hardware components to ensure accurate performance predictions.

In a step 5940, the system optimizes co-designs for specific tasks and deployment scenarios. This step focuses on fine-tuning the model-hardware pairings for particular use cases or deployment environments. It involves adjusting model hyperparameters, hardware settings, and even low-level implementation details to maximize performance for specific AI tasks (e.g., natural language processing, computer vision, or reinforcement learning). The optimization process might use techniques like Bayesian optimization or gradient-based methods to efficiently navigate the refined search space for each specific scenario.

In a step 5950, the system continuously refines the co-design process based on real-world performance data. This final step implements a feedback loop that allows the co-design system to learn and improve from actual deployments. The system collects performance data from real-world usage of the co-designed models and hardware, comparing it against the simulated predictions. Machine learning techniques are then used to update and refine the simulation models, search algorithms, and optimization strategies based on this empirical data. This continuous refinement ensures that the co-design process becomes increasingly accurate and effective over time, adapting to new hardware innovations and evolving AI model architectures.

This method diagram outlines a comprehensive approach to implementing a model hardware co-design subsystem, which aims to achieve unprecedented levels of performance and efficiency in AI systems. By simultaneously optimizing both the AI model architecture and the underlying hardware configuration, this subsystem enables the creation of highly specialized and efficient AI solutions tailored to specific tasks and deployment scenarios. This co-design approach represents a significant advancement over traditional methods that optimize models and hardware separately, potentially leading to breakthroughs in AI performance and energy efficiency.

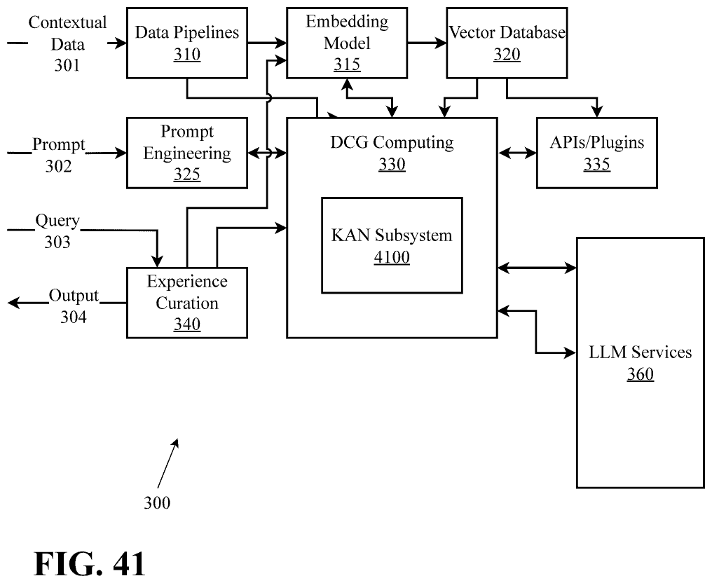

FIG. 41 is a block diagram illustrating an exemplary system architecture for a distributed generative artificial intelligence reasoning and action platform with an integrated KAN subsystem. Kolmogorov-Arnold Network (KAN) subsystem 4100 represents an advancement in the distributed generative AI reasoning and action platform, introducing a novel approach to neural network design based on the Kolmogorov-Arnold representation theorem. This subsystem seamlessly integrates with existing components, enhancing the platform's capability to handle complex, multivariate functions and improving its overall efficiency and adaptability.

At its core, the KAN subsystem 4100 establishes a deep connection with DCG computing 330 component, offering an alternative neural network architecture that complements traditional approaches. This integration allows the platform to leverage KANs for tasks that benefit from their unique ability to represent complex multivariate functions as superpositions of simpler, univariate functions. For instance, when dealing with high-dimensional data in financial modeling or scientific simulations, KAN subsystem 4100 can provide more efficient and accurate representations compared to traditional neural network architectures.

KAN subsystem 4100 works in close concert with embedding model 315 and vector database 320, enhancing the platform's ability to process and represent complex, high-dimensional data. By leveraging the Kolmogorov-Arnold representation, KAN subsystem 4100 can create more compact and interpretable embeddings for certain types of data, improving both storage efficiency and retrieval accuracy in the vector database.

Interacting closely with prompt engineering 325 component, KAN subsystem 4100 enables more sophisticated handling of complex, multivariate queries. It can decompose intricate prompts into simpler, more manageable components, aligning with the KAN's approach of representing complex functions as compositions of simpler ones. This capability is particularly valuable in scenarios requiring nuanced understanding of multifaceted user inputs, such as in advanced natural language processing tasks or complex decision-making systems.

KAN subsystem 4100 also enhances the capabilities of LLM services 360 by providing an alternative architectural approach for certain language modeling tasks. While traditional transformer-based models excel in many NLP tasks, the KAN architecture might offer advantages in scenarios requiring precise handling of multivariate relationships within language, such as in specialized scientific or technical domains.

In its interaction with experience curation 340 component, KAN subsystem 4100 contributes to more nuanced and efficient curation of AI-generated content. Its ability to represent complex functions compactly can lead to more precise and interpretable content selection and organization, potentially improving the overall quality and relevance of curated AI experiences.

KAN subsystem 4100 also interfaces with APIs/plugins 335, enabling the integration of KAN-based models with external tools and services. This allows for specialized processing pipelines that can leverage the unique strengths of KANs in conjunction with other AI and data processing tools. In an embodiment, when a user submits a query 303 that involves complex, multivariate relationships, KAN subsystem 4100 can be engaged to process this input. It might work in parallel with traditional neural network approaches, with DCG computing 330 component orchestrating the flow of information between different processing paradigms.

For example, in a scenario involving complex scientific data analysis, KAN subsystem 4100 might be used to model intricate relationships between multiple variables. Embedding model 315 could leverage the KAN architecture to create more efficient representations of this multidimensional data, which are then stored in the vector database 320. When processing related queries, the system can utilize these KAN-based embeddings to retrieve and analyze relevant information more effectively. Throughout the query processing pipeline, KAN subsystem 4100 continues to interact with other components. It might inform prompt engineering 325 process, suggesting decompositions of complex queries that align well with the KAN architecture. LLM services 360 might selectively employ KAN-based models for specific subtasks that benefit from their strengths in handling multivariate relationships.

Experience curation 340 can leverage the KAN subsystem's 4100 outputs to create more nuanced and precise content selections, potentially offering users a richer and more accurately tailored AI experience. By integrating KAN subsystem 4100, the platform achieves a new level of versatility in handling complex, multivariate problems. It allows for more efficient representation and processing of certain types of data and relationships, potentially opening up new possibilities in areas such as scientific computing, financial modeling, and advanced natural language processing. The result is a more powerful and flexible AI system that can adapt its architectural approach based on the specific requirements of each task, delivering enhanced performance across a wide range of complex, real-world applications.

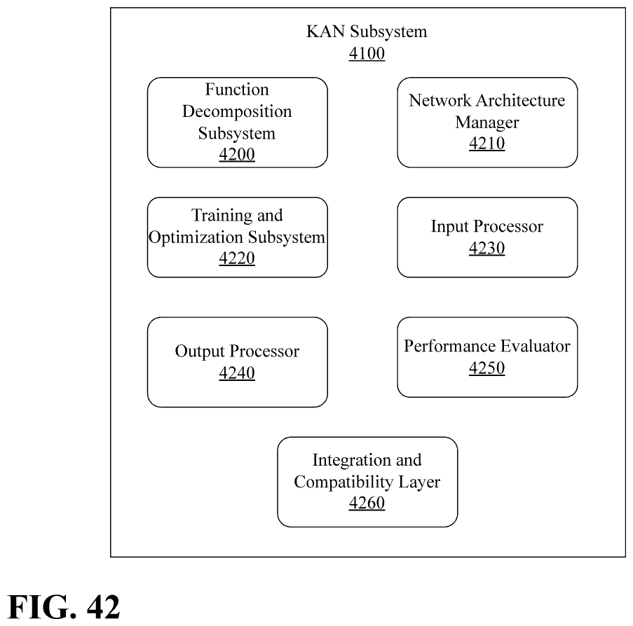

FIG. 42 is a block diagram illustrating an exemplary subsystem architecture for a component of a distributed generative artificial intelligence reasoning and action platform with an integrated KAN subsystem, a KAN subsystem. At the heart of KAN subsystem 4100, a function decomposition subsystem 4200 works in close concert with DCG computing 330 and prompt engineering 325 components. It analyzes complex, multivariate functions or inputs and decomposes them into simpler, univariate components as per the Kolmogorov-Arnold theorem. For instance, when processing a complex query involving multiple interrelated variables in a scientific computing task, this component might break down the problem into a set of simpler, more manageable sub-functions. This decomposition not only aligns with the mathematical principles underpinning KANs but also facilitates more efficient processing and parallelization of tasks.

Network architecture manager 4210 establishes a connection with general transformer service module 1060 and the decomposable transformer service module 1050. It designs and manages the specific architecture of the KAN, determining how the decomposed functions should be represented and connected within the network. This component might, for example, dynamically adjust the network's structure based on the complexity of the input, ensuring optimal representation of the decomposed functions while maintaining computational efficiency.

Working in tandem with these components, training and optimization subsystem 4220 leverages advanced machine learning techniques to train and refine KAN subsystem 4100. It interfaces with automated planning service module 1030 and its associated libraries, particularly the deep learning libraries 1154, to implement efficient training strategies tailored to the unique structure of KANs. This subsystem might employ specialized optimization algorithms that take advantage of the KAN's decomposed structure, potentially leading to faster convergence and better generalization for certain types of problems.

Input processor 4230 plays a role in preparing data for processing by the KAN. It works closely with embedding model 315 to transform input data into a format suitable for the KAN's unique architecture. For instance, when dealing with high-dimensional financial data, the input processor might apply specific transformations that align with the KAN's function decomposition approach, facilitating more efficient processing of complex financial models. Similarly, output processor 4240 interprets and formats the KAN's outputs for use by other system components. It interfaces with experience curation 340 component and LLM services 360, ensuring that the KAN's outputs can be seamlessly integrated into the platform's broader workflows. This might involve translating the KAN's function-based outputs into formats more readily usable by traditional neural network architectures or human-readable formats.

Performance evaluator 4250 continuously assesses the KAN's performance, interfacing with observation and state estimation service 1040 to gather performance metrics and operational data. This component might compare the KAN's performance against traditional neural network approaches for various tasks, providing valuable insights that inform the platform's decision-making about when and how to employ KAN-based processing.

Integration and compatibility layer 4260 serves as the primary interface between KAN subsystem 4100 and other platform components. It works closely with connector module 1035 and APIs/plugins 335 to ensure smooth integration of KAN-based processing into diverse workflows. This layer might, for example, provide translation mechanisms that allow KAN outputs to be used as inputs for other AI models or external tools, and vice versa.

By integrating these components, KAN subsystem 4100 enables a new paradigm in neural network processing within the platform. It allows for more efficient handling of certain types of complex, multivariate problems, potentially opening up new possibilities in areas such as scientific computing, financial modeling, and advanced data analysis. The result is a more versatile and powerful AI system that can adapt its processing approach based on the specific requirements of each task, delivering enhanced performance across a wide range of complex, real-world applications.

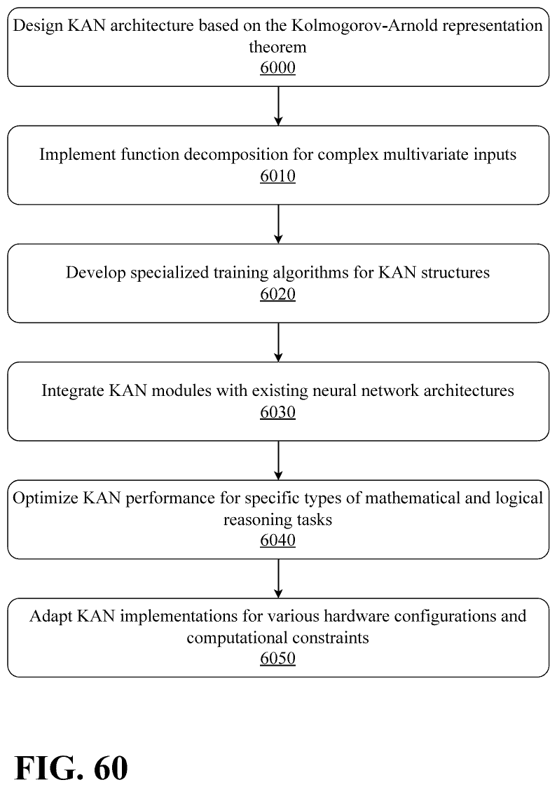

FIG. 60 is a flow diagram illustrating an exemplary method for a distributed generative artificial intelligence reasoning and action platform with an integrated KAN subsystem. In a first step 6000, the system designs KAN architecture based on the Kolmogorov-Arnold representation theorem. This step involves creating a neural network structure that leverages the principle that any continuous multivariate function can be represented as a superposition of continuous functions of one variable. The KAN architecture is designed to efficiently implement this representation, potentially using a hierarchical structure with layers dedicated to single-variable functions and their combinations. This design aims to capture complex, high-dimensional relationships more efficiently than traditional neural network architectures.

In a step 6010, the system implements function decomposition for complex multivariate inputs. This step involves developing algorithms to break down complex input functions or data into simpler, single-variable components that can be processed by the KAN. The decomposition process might use techniques from functional analysis, dimensionality reduction, or advanced signal processing. The goal is to transform high-dimensional input spaces into a format that aligns with the KAN's architecture, enabling more efficient processing and representation of complex relationships.

In a step 6020, the system develops specialized training algorithms for KAN structures. Traditional backpropagation algorithms may not be optimal for the unique architecture of KANs, so this step focuses on creating new or adapted training methods. These might include variations of gradient descent optimized for the KAN structure, evolutionary algorithms tailored to the KAN's hierarchical nature, or novel learning approaches that leverage the mathematical properties of the Kolmogorov-Arnold representation. The training algorithms are designed to efficiently learn both the single-variable functions and their composition within the KAN.

In a step 6030, the system integrates KAN modules with existing neural network architectures. This step involves developing interfaces and methods to incorporate KAN components into broader AI systems. It might include creating hybrid architectures that combine KAN layers with traditional neural network layers, or developing ways to use KANs as specialized processing units within larger models. This integration allows the system to leverage the strengths of KANs (such as efficient representation of complex functions) while still benefiting from the capabilities of other neural network types.

In a step 6040, the system optimizes KAN performance for specific types of mathematical and logical reasoning tasks. This step focuses on tailoring the KAN architecture and training processes for particular classes of problems where its unique structure might offer advantages. This could include optimization problems, certain types of differential equations, or specific logical reasoning tasks. The optimization might involve adjusting the network's structure, fine-tuning hyperparameters, or developing task-specific loss functions that leverage the KAN's properties.

In a step 6050, the system adapts KAN implementations for various hardware configurations and computational constraints. This final step ensures that KANs can be efficiently deployed across a range of hardware platforms, from high-performance servers to resource-constrained edge devices. It involves optimizing the KAN's computations for different types of processors (e.g., CPUs, GPUs, or specialized AI hardware), potentially leveraging hardware-specific features to accelerate KAN operations. This step might also include developing compressed or quantized versions of KANs for deployment in environments with limited computational resources, ensuring that the benefits of the KAN architecture can be realized across diverse computing environments.

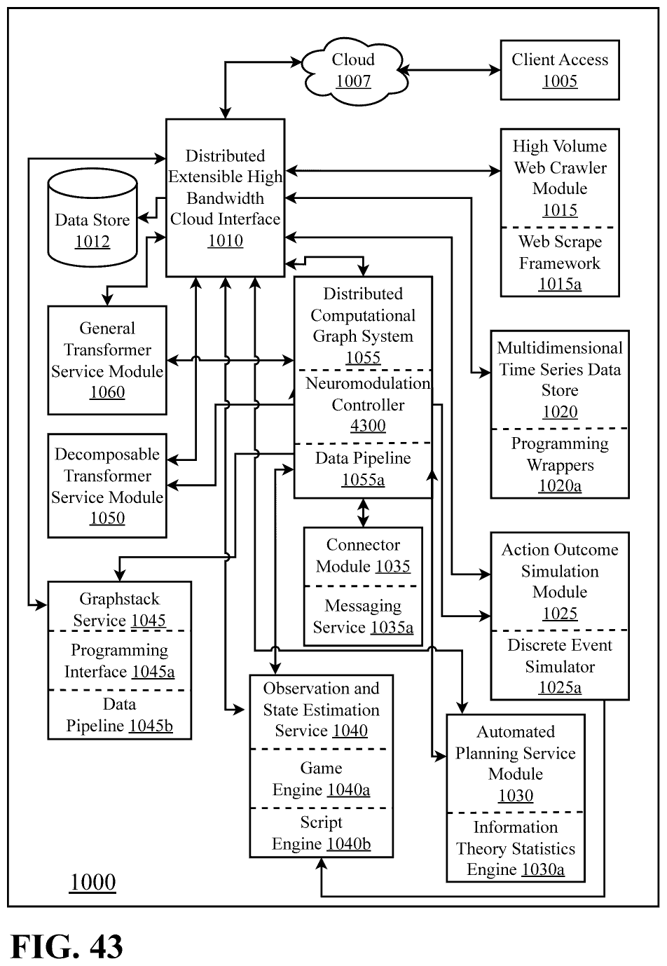

FIG. 43 is a block diagram illustrating an exemplary system architecture for a distributed generative artificial intelligence reasoning and action platform with an integrated neuromodulation controller. A neuromodulation controller 4300 represents an advancement in the distributed generative AI reasoning and action platform, introducing brain-inspired adaptive control mechanisms to enhance the system's flexibility and efficiency. This controller seamlessly integrates with multiple components of the existing architecture, fundamentally improving the platform's ability to dynamically adjust its processing based on context and task demands.

At its core, neuromodulation controller 4300 establishes a connection with the distributed computational graph system 1055, enabling dynamic modulation of computational processes across the platform. Inspired by the role of neuromodulators in biological brains, this controller can adjust the “neural” activity levels within the system, effectively increasing or decreasing data flow and processing intensity between different components based on real-time requirements and conditions. For instance, when the system encounters a computationally intensive task, the neuromodulation controller might enhance connectivity and resource allocation to specific nodes in the computational graph, mimicking the way dopamine modulates neural activity in biological systems.

Neuromodulation controller 4300 works with general transformer service module 1060 and decomposable transformer service module 1050, enhancing their adaptability and efficiency. By dynamically modulating the attention mechanisms and feed-forward processes within these transformer models, the controller can optimize their performance for different types of tasks or input data. This might involve adjusting the intensity of attention in certain parts of the model or modifying the balance between different processing streams, similar to how neuromodulators in the brain can enhance or suppress specific neural pathways.

Interacting with action outcome simulation module 1025 and its discrete event simulator 1025a, neuromodulation controller 4300 enables more adaptive and context-sensitive simulations. It can modulate the simulation parameters and processing intensity based on the importance or urgency of different simulated events, potentially leading to more efficient and focused simulations. This is particularly valuable in scenarios requiring real-time decision making or adaptive planning in complex, dynamic environments.

Neuromodulation controller 4300 also enhances the capabilities of the automated planning service module 1030 by providing a mechanism for dynamic adjustment of planning strategies. It can modulate the planning process based on factors such as time constraints, resource availability, or the criticality of the decision, potentially leading to more efficient and context-appropriate planning outcomes.

In its interaction with observation and state estimation service 1040, neuromodulation controller 4300 plays a role in dynamically adjusting the system's sensitivity to different types of input or state information. This could involve enhancing the processing of certain types of sensory data in response to detected anomalies or shifting the balance between different state estimation strategies based on the current operational context.

Neuromodulation controller 4300 also interfaces with high volume web crawler module 1015 and multidimensional time series data store 1020, enabling more adaptive and efficient data collection and storage processes. It might modulate the crawler's behavior based on the relevance or novelty of discovered information, or adjust the granularity and frequency of data storage in the time series database based on the detected importance or volatility of the data.

In an embodiment, when the system is processing a complex query or task, neuromodulation controller 4300 continuously monitors the system's state and performance through its connections with various components. It might detect, for example, that a particular part of the computational graph is becoming overburdened with a complex language processing task. In response, it could enhance the “neural” activity in that region by increasing resource allocation and strengthening connections to supporting components, while potentially dampening activity in less critical areas to maintain overall system efficiency.

Throughout the processing pipeline, neuromodulation controller 4300 continues to make dynamic adjustments. It might modulate the attention mechanisms in the transformer modules to focus more intensely on certain aspects of the input data, or adjust the planning strategies to become more exploratory or exploitative based on the current context and goals. By integrating neuromodulation controller 4300, the platform achieves a new level of adaptability and efficiency in its AI processing. It allows for dynamic, context-sensitive adjustment of computational processes, potentially enabling more robust performance across a wide range of tasks and operational conditions. This brain-inspired approach to system control opens up new possibilities for creating more flexible, efficient, and context-aware AI systems, capable of adapting their processing strategies in real-time to meet the demands of complex, dynamic environments.

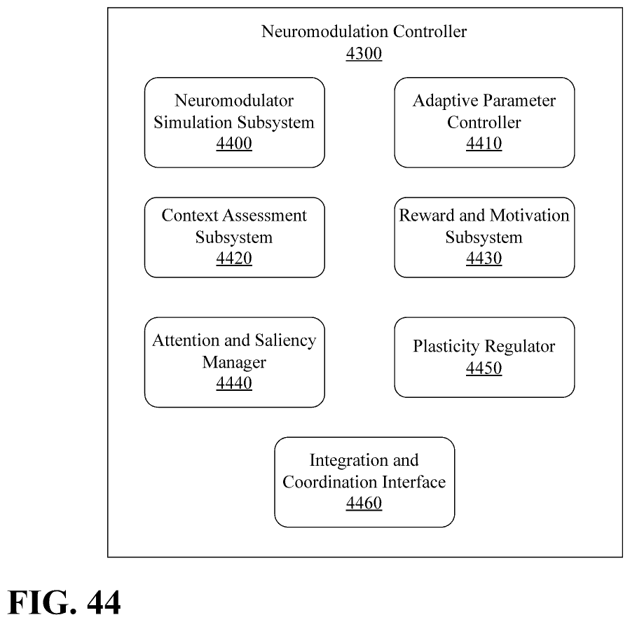

FIG. 44 is a block diagram illustrating an exemplary subsystem architecture for a component of a distributed generative artificial intelligence reasoning and action platform with an integrated neuromodulation controller, a neuromodulation controller. Neuromodulation controller 4300 represents a sophisticated system for dynamically adjusting the behavior and processing capabilities of the distributed generative AI reasoning and action platform, inspired by the neuromodulatory systems in biological brains. This controller creates a synergistic relationship between its components and the broader architecture, fundamentally enhancing the platform's ability to adapt to varying tasks and contexts.

Central to this this controller, neuromodulator simulation subsystem 4400 works with distributed computational graph system 1055 and general transformer service module 1060. It simulates the effects of various neuromodulators, such as dopamine, serotonin, and norepinephrine, on the system's processing. For instance, when the platform is engaged in a task requiring heightened attention and quick responses, this subsystem might simulate an increase in “dopamine-like” activity, enhancing the connectivity and responsiveness of relevant computational nodes, much like dopamine modulates neural activity in biological systems.

Adaptive parameter controller 4410 establishes a deep connection with decomposable transformer service module 1050 and automated planning service module 1030. It dynamically adjusts various parameters across the system based on the simulated neuromodulatory states. This might involve tweaking learning rates, attention weights, or decision thresholds in real-time. For example, during a complex problem-solving task, it could modulate the exploration-exploitation balance in the planning algorithms, mimicking how neuromodulators influence decision-making processes in the brain.

Working in tandem with these components, context assessment subsystem 4420 continuously analyzes the current operational context, interfacing with observation and state estimation service 1040 and action outcome simulation module 1025. It evaluates factors such as task complexity, time constraints, and environmental conditions to inform the neuromodulatory responses. This subsystem might, for instance, detect a shift to a high-stakes decision-making scenario and trigger a system-wide increase in “norepinephrine-like” activity to enhance focus and information processing.

Reward and motivation subsystem 4430 plays a role in guiding the system's behavior towards desirable outcomes. It interfaces with information theory statistics engine 1030a and game engine 1040a to assess the system's performance and generate internal reward signals. These signals influence the neuromodulatory state, potentially increasing “dopamine-like” activity in response to successful outcomes or unexpected positive results, thereby reinforcing effective processing pathways.

Attention and saliency manager 4440 works closely with high volume web crawler module 1015 and multidimensional time series data store 1020 to modulate the system's focus on different information streams. It can enhance or suppress the processing of certain data types or sources based on their current relevance or importance. For example, when monitoring financial markets, it might heighten the system's sensitivity to specific economic indicators during times of market volatility.

Plasticity regulator 4450 interfaces with the learning components across the platform, including the transformer modules and the automated planning service. It modulates the system's capacity for learning and adaptation based on the current neuromodulatory state. During periods of high “acetylcholine-like” activity, for instance, it might increase the plasticity of certain model components, allowing for more rapid learning and adaptation to new information or task requirements.

Integration and coordination interface 4460 serves as the primary communication channel between the neuromodulation controller and other platform components. It works closely with connector module 1035 and messaging service 1035a to ensure that the neuromodulatory effects are consistently applied across the entire system. This interface enables the neuromodulation controller to influence diverse aspects of the platform's operation, from data processing and model execution to resource allocation and output generation.

By integrating these components, neuromodulation controller 4300 enables a new level of adaptability and context-sensitivity in AI processing. It allows the platform to dynamically adjust its behavior and processing characteristics based on task demands, environmental conditions, and internal states. This results in a more flexible, efficient, and responsive AI system that can adapt its processing strategies in real-time, mimicking the adaptive capabilities of biological brains and potentially leading to more robust and versatile AI applications across a wide range of domains.

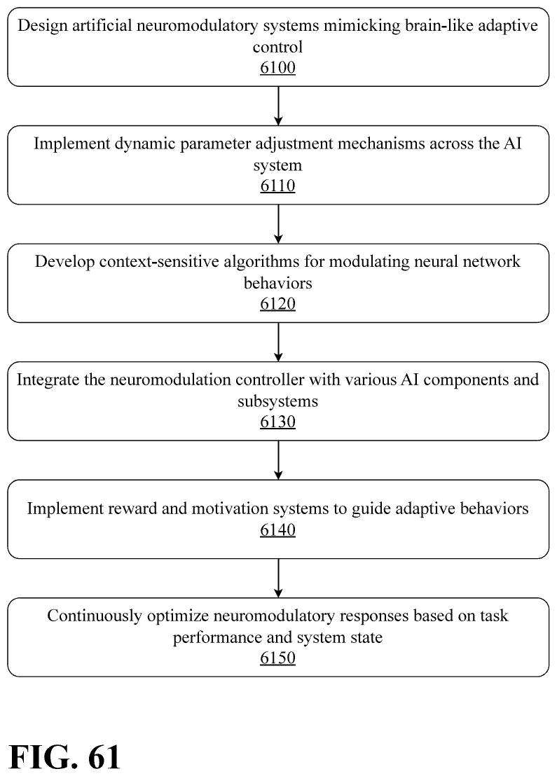

FIG. 61 is a flow diagram illustrating an exemplary method for a distributed generative artificial intelligence reasoning and action platform with an integrated neuromodulation controller. In a first step 6100, the system designs artificial neuromodulatory systems mimicking brain-like adaptive control. This step involves creating a framework that emulates the function of neuromodulators in the brain, such as dopamine, serotonin, and norepinephrine. The design incorporates mechanisms for global regulation of neural network activities, influencing aspects like learning rate, attention, and signal-to-noise ratio. This artificial neuromodulatory system aims to provide the AI platform with more flexible, context-sensitive control over its operations, similar to how neuromodulators regulate brain function.

In a step 6110, the system implements dynamic parameter adjustment mechanisms across the AI system. This involves developing algorithms that can modify key parameters of various AI components in real-time. These adjustments might include altering learning rates, attention weights, or activation thresholds in neural networks, or modifying decision-making thresholds in planning algorithms. The implementation ensures that these adjustments can be made quickly and efficiently across the distributed AI platform, allowing for rapid adaptation to changing conditions or task requirements.

In a step 6120, the system develops context-sensitive algorithms for modulating neural network behaviors. This step focuses on creating algorithms that can interpret the current context of the AI system's operation and adjust network behaviors accordingly. These algorithms might analyze factors such as input data characteristics, task complexity, or environmental conditions to determine appropriate modulation strategies. For example, the system might increase attention focus in high-stakes decision-making scenarios or boost exploration in novel environments. The goal is to enable more nuanced and adaptive behavior across different operational contexts.

In a step 6130, the system integrates the neuromodulation controller with various AI components and subsystems. This involves creating interfaces and communication channels that allow the neuromodulation controller to interact with and influence different parts of the AI platform. Integration points might include the distributed computational graph system, the hardware-aware transformer subsystem, and the neuromorphic processing components. The integration ensures that neuromodulatory signals can be effectively transmitted and acted upon throughout the system, enabling coordinated adaptive responses.

In a step 6140, the system implements reward and motivation systems to guide adaptive behaviors. This step involves developing mechanisms that generate internal reward signals based on task performance, goal achievement, or novel discoveries. These reward systems, inspired by dopaminergic pathways in the brain, help guide the AI system's learning and decision-making processes. The implementation might include techniques from reinforcement learning, intrinsic motivation algorithms, or curiosity-driven exploration methods. These systems work in tandem with the neuromodulatory mechanisms to shape the AI's behavior towards more effective and adaptive strategies.

In a step 6150, the system continuously optimizes neuromodulatory responses based on task performance and system state. This final step implements a feedback loop that allows the neuromodulation controller to refine its strategies over time. The system collects data on how different neuromodulatory actions affect task performance and overall system efficiency. Machine learning techniques, possibly including meta-learning or evolutionary algorithms, are then used to optimize the neuromodulation strategies. This continuous optimization ensures that the neuromodulatory responses become increasingly effective at enhancing the AI system's performance across various tasks and conditions.

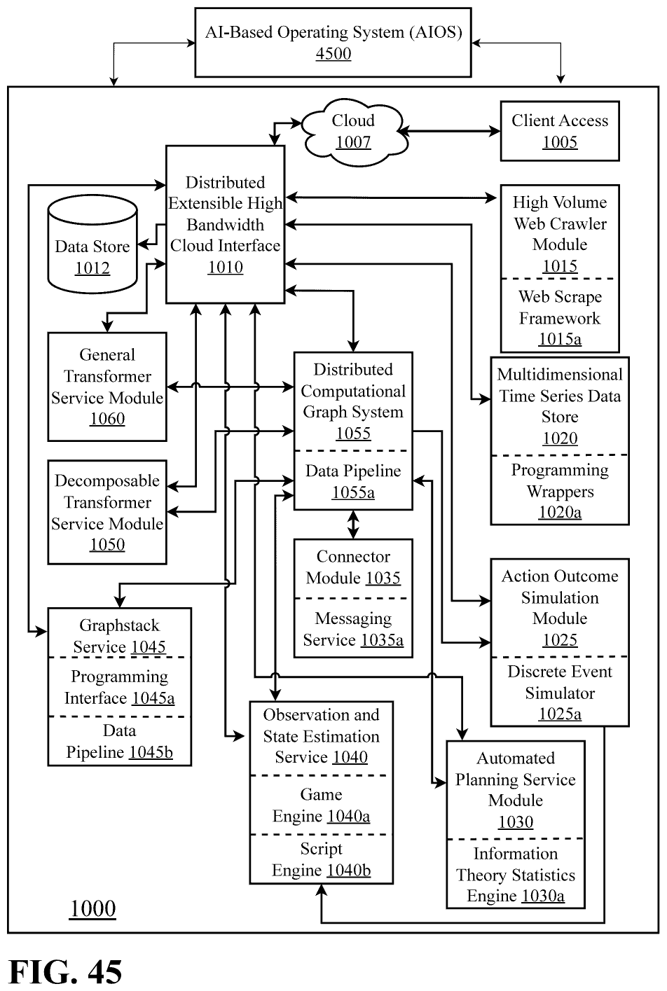

FIG. 45 is a block diagram illustrating an exemplary system architecture for a distributed generative artificial intelligence reasoning and action platform with an integrated AI-based Operating System (AIOS). The AI-Based Operating System (AIOS) 4500 represents an advancement in the distributed generative AI reasoning and action platform, fundamentally transforming the way the system manages resources, schedules tasks, and optimizes performance. This AIOS seamlessly integrates with and enhances multiple components of the existing architecture, creating a more intelligent, adaptive, and efficient foundation for AI operations.

AIOS 4500 establishes a deep connection with distributed computational graph system 1055, reimagining how computational resources are allocated and tasks are scheduled. Unlike traditional operating systems, AIOS 4500 uses AI-driven techniques to dynamically optimize resource allocation based on real-time analysis of task requirements, system state, and performance metrics. For instance, when processing a complex AI workflow, AIOS 4500 might intelligently distribute subtasks across available hardware resources, considering factors like processing power, memory availability, and data locality to maximize efficiency.

AIOS 4500 works in close concert with general transformer service module 1060 and decomposable transformer service module 1050, enhancing their performance by providing a more intelligent and adaptive execution environment. It can dynamically adjust system-level parameters, such as memory allocation or process priorities, based on the specific needs of different transformer models or the current phase of model execution. This might involve, for example, prioritizing certain types of computations during the attention mechanism calculations or optimizing memory access patterns for specific transformer architectures.

Interacting closely with action outcome simulation module 1025 and its discrete event simulator 1025a, AIOS 4500 enables more sophisticated and efficient simulation capabilities. It can intelligently manage the allocation of computational resources for simulations, potentially running multiple simulations in parallel or adjusting the granularity of simulations based on their importance or the current system load. This enhanced simulation capability could be particularly valuable in scenarios requiring real-time decision making or complex planning under uncertainty.

AIOS 4500 also significantly enhances the capabilities of automated planning service module 1030 by providing a more intelligent and flexible substrate for planning operations. It can dynamically adjust the resources allocated to planning tasks based on their complexity and urgency, and even parallelize planning operations across multiple hardware units when beneficial. This could lead to more efficient and adaptive planning processes, for applications in areas like autonomous systems or complex logistics optimization.

In its interaction with observation and state estimation service 1040, AIOS 4500 plays a role in managing and optimizing the flow of data through the system. It can intelligently prioritize the processing of certain types of inputs or state information based on their current relevance or importance to ongoing tasks. For example, in a real-time monitoring scenario, AIOS 4500 might dynamically adjust system resources to ensure rapid processing of critical sensor data while temporarily de-prioritizing less urgent background tasks.

AIOS 4500 also interfaces with high volume web crawler module 1015 and multidimensional time series data store 1020, providing more intelligent management of data ingestion and storage processes. It might dynamically adjust the resources allocated to web crawling based on the discovered data's relevance or novelty, or optimize the storage and retrieval of time series data based on usage patterns and current system priorities.

In an embodiment, when a client accesses the system through distributed extensible high bandwidth cloud interface 1010, AIOS 4500 springs into action, orchestrating a complex dance of resource allocation and task scheduling. It might, for instance, dynamically configure the system to optimally handle the incoming request, adjusting parameters across various components to ensure efficient processing. As data flows through the AI pipeline, AIOS 4500 continuously monitors and optimizes operations. During transformer model computations orchestrated by general transformer service module 1060, it might dynamically adjust memory allocation or CPU/GPU utilization to match the specific needs of different processing stages.

When automated planning service module 1030 engages in complex planning tasks, AIOS 4500 could intelligently distribute subtasks across available hardware, potentially leveraging specialized AI accelerators for certain types of computations. Throughout these processes, AIOS 4500 maintains a holistic view of the system's state and performance, making ongoing adjustments to optimize efficiency and responsiveness. It might, for example, dynamically migrate processes between different hardware units to balance load or adjust I/O priorities to ensure smooth data flow for critical operations.

By integrating AIOS 4500, the platform achieves a new level of intelligence and adaptability in its core operations. It allows for more efficient utilization of hardware resources, more responsive handling of diverse AI workloads, and greater flexibility in adapting to changing operational requirements. This AI-driven approach to system management opens up new possibilities for creating more powerful, efficient, and scalable AI systems, capable of handling increasingly complex and diverse tasks across a wide range of applications and deployment scenarios.

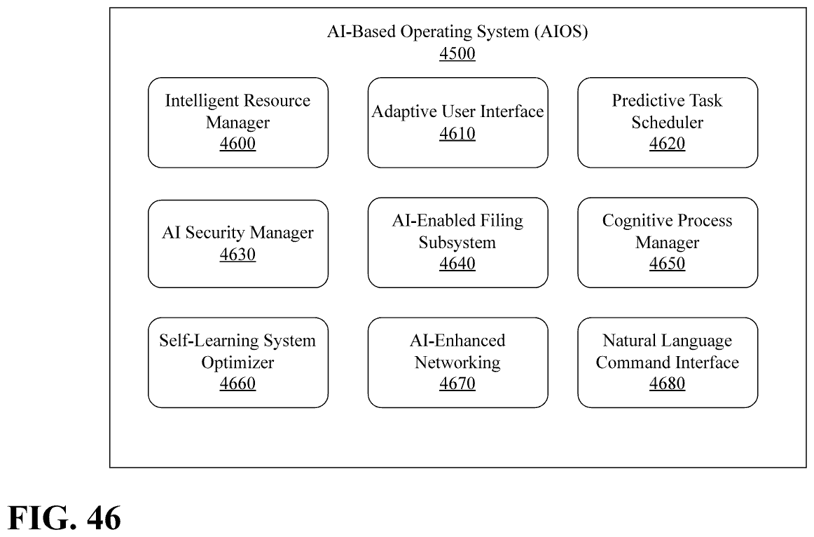

FIG. 46 is a block diagram illustrating an exemplary subsystem architecture for a component of a distributed generative artificial intelligence reasoning and action platform with an integrated AIOS, an AI-based Operating System. AI-Based Operating System (AIOS) 4500 represents a pioneering approach to system management, integrating advanced AI techniques into the core functionalities of an operating system. This AIOS creates a synergistic relationship between its components and the broader architecture of the distributed generative AI reasoning and action platform, fundamentally enhancing the system's efficiency, adaptability, and user interaction capabilities.

At the heart of AIOS 4500, intelligent resource manager 4600 works in close concert with distributed computational graph system 1055 and hardware management layer 2800. It employs AI algorithms to dynamically allocate and optimize system resources based on real-time demands and predictive analytics. For instance, when dealing with complex AI workloads, it might intelligently distribute tasks across CPUs, GPUs, and specialized hardware like neuromorphic processing subsystem 3300, considering factors such as processing requirements, energy efficiency, and thermal management through Through-Chip Microchannel Cooler 2810.

Adaptive user interface 4610 establishes a deep connection with experience curation 340 component, providing a dynamically adjusting interface that evolves based on user behavior, preferences, and the current context of operations. This might involve reorganizing menu structures, adjusting visualization parameters, or even modifying the complexity of presented information based on the user's expertise level and current task requirements.

Working in tandem with these components, predictive task scheduler 4620 interfaces with automated planning service module 1030 and action outcome simulation module 1025 to anticipate future system needs and preemptively allocate resources. It might, for example, predict an upcoming surge in natural language processing tasks based on historical patterns and user behavior, prompting the system to prepare relevant models and allocate appropriate computational resources in advance.

AI security manager 4630 plays a role in maintaining system integrity and data protection. It works closely with AI output validator 3700 and observation and state estimation service 1040 to continuously monitor for potential security threats, employing advanced anomaly detection and predictive analytics to identify and mitigate risks before they escalate. This could involve dynamically adjusting firewall rules, isolating suspicious processes, or even initiating self-healing procedures in response to detected vulnerabilities.

AI-enabled filing subsystem 4640 modernizes data management within the platform. It interfaces with vector embedding subsystem 3100 and multidimensional time series data store 1020 to create an intelligent, context-aware filing system. This subsystem might automatically categorize and tag incoming data, create semantic links between related pieces of information, and even predict future data access patterns to optimize storage and retrieval processes.

Cognitive process manager 4650 enhances the platform's ability to handle complex, multi-step AI workflows. It interacts with general transformer service module 1060, KAN subsystem 4100, and other AI processing components to orchestrate sophisticated cognitive tasks. For instance, it might dynamically compose a workflow that combines natural language processing, image analysis, and logical reasoning to solve a complex problem, adjusting the process in real-time based on intermediate results and resource availability.

Self-learning system optimizer 4660 continuously refines AIOS's 4500 performance based on operational data and outcomes. It works with neuromodulation controller 4300 and model hardware co-design subsystem 3900 to evolve the system's behaviors and configurations over time. This might involve fine-tuning resource allocation strategies, adjusting scheduling algorithms, or even proposing architectural changes to better match observed usage patterns and performance requirements.

AI-enhanced networking 4670 component optimizes data flow and communication within the system and with external entities. It interfaces with connector module 1035 and the messaging service 1035a to intelligently route data, prioritize network traffic, and dynamically adjust communication protocols based on current needs and network conditions. This could lead to more efficient data transfer for distributed AI tasks, improved responsiveness for real-time applications, and better utilization of available network resources.

Natural language command interface 4680 provides an intuitive way for users and administrators to interact with the AIGS 4500. It leverages the platform's advanced natural language processing capabilities, working with LLM services 360 and prompt engineering 325 components to interpret and execute complex commands expressed in natural language. This allows for more flexible and user-friendly system management, enabling users to perform complex operations or queries using conversational language.

By integrating these advanced AI-driven components, AIGS 4500 creates a new paradigm in operating system design. It enables a level of efficiency, adaptability, and intelligence in system management that goes far beyond traditional operating systems. This results in a more powerful, user-friendly, and self-optimizing platform capable of handling the most demanding and complex AI workloads while continuously evolving to meet changing needs and technological advancements.

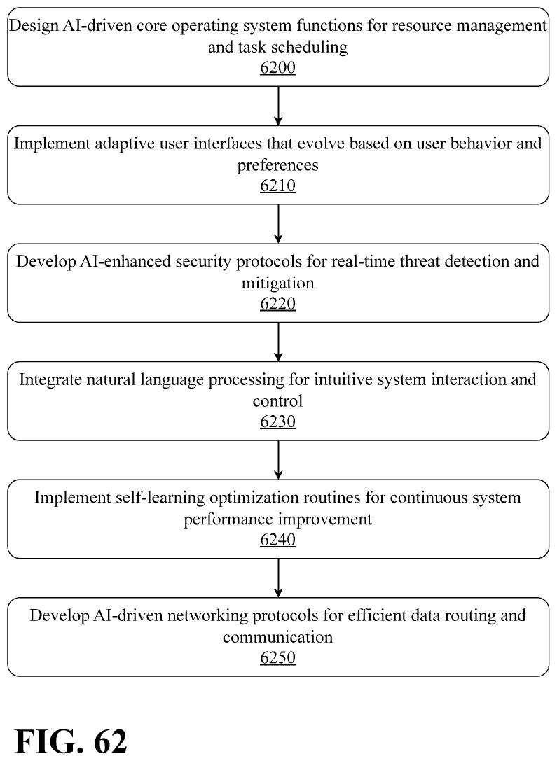

FIG. 62 is a flow diagram illustrating an exemplary method for a distributed generative artificial intelligence reasoning and action platform with an integrated AI-based Operating System (AIGS). In a first step 6200, the system designs AI-driven core operating system functions for resource management and task scheduling. This involves reimagining traditional OS functions through the lens of AI capabilities. The system develops intelligent algorithms that can dynamically allocate computational resources (CPU, GPU, memory, storage) based on real-time demands and predictive analysis of upcoming tasks. These AI-driven functions might use techniques like reinforcement learning or neural networks to optimize resource utilization across diverse workloads, potentially leveraging insights from the dynamic resource orchestrator mentioned in earlier disclosures.

In a step 6210, the system implements adaptive user interfaces that evolve based on user behavior and preferences. This step focuses on creating UI components that can dynamically adjust their layout, functionality, and presentation based on individual user interactions and patterns. The system might employ machine learning techniques to analyze user behavior, predict user needs, and automatically customize the interface. This could include reorganizing menu structures, adjusting information density, or even modifying interaction modalities (e.g., switching between touch, voice, and gesture controls) to best suit the user's current context and preferences.

In a step 6220, the system develops AI-enhanced security protocols for real-time threat detection and mitigation. This involves creating advanced security measures that leverage AI to identify and respond to potential threats in real-time. The system might use anomaly detection algorithms to spot unusual system behaviors, employ natural language processing to analyze network traffic for potential threats, or use machine learning models to predict and prevent security vulnerabilities. These AI-driven security protocols would work proactively to maintain system integrity, potentially integrating with the hardware security manager mentioned in earlier hardware management layer discussions.

In a step 6230, the system integrates natural language processing for intuitive system interaction and control. This step involves developing sophisticated NLP capabilities that allow users to interact with the operating system using natural language commands and queries. The system might leverage large language models or specialized NLP algorithms to interpret user intent, execute complex commands, and provide conversational responses. This natural language interface would extend across all aspects of the OS, from file management to system configuration, offering a more intuitive and accessible way for users to control and interact with their computing environment.

In a step 6240, the system implements self-learning optimization routines for continuous system performance improvement. This involves creating AI algorithms that continuously monitor system performance, identify bottlenecks or inefficiencies, and automatically implement optimizations. These routines might use techniques like Bayesian optimization or evolutionary algorithms to explore different system configurations and parameter settings. The system could learn from its own operational history and user feedback to progressively enhance its performance, stability, and energy efficiency over time.

In a step 6250, the system develops AI-driven networking protocols for efficient data routing and communication. This final step focuses on optimizing network operations using AI techniques. The system might implement machine learning algorithms to predict network traffic patterns and dynamically adjust routing strategies. It could use reinforcement learning to optimize data packet transmission in complex network environments. Additionally, the system might develop intelligent caching mechanisms that anticipate data needs and preemptively position data for faster access. These AI-driven networking protocols would aim to reduce latency, improve bandwidth utilization, and enhance overall system responsiveness.

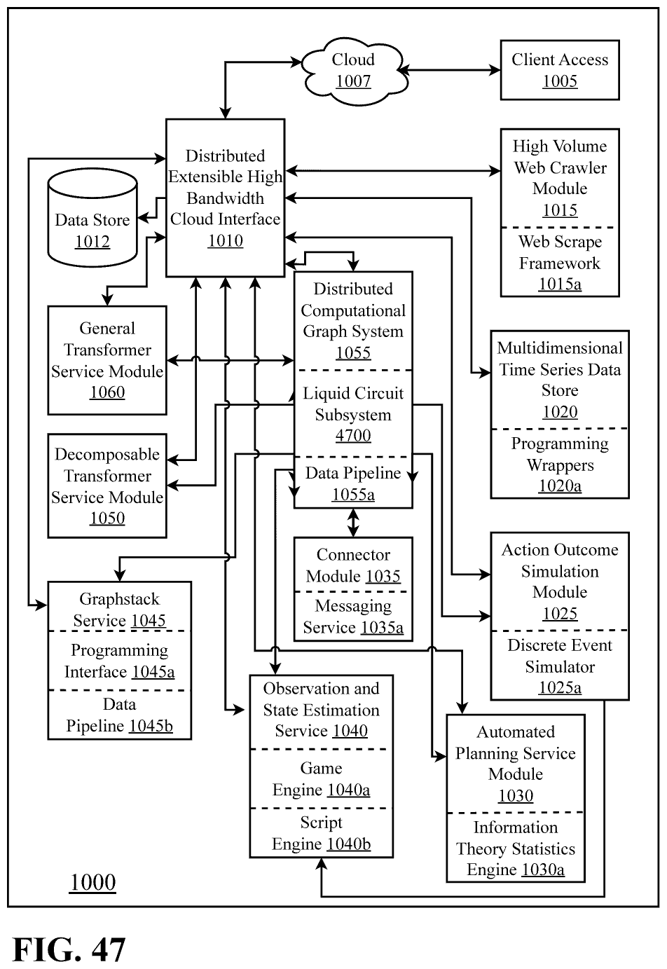

FIG. 47 is a block diagram illustrating an exemplary system architecture for a distributed generative artificial intelligence reasoning and action platform with an integrated liquid circuit subsystem. Liquid circuit subsystem 4700 is an advancement in the distributed generative AI reasoning and action platform, incorporating cutting-edge neuromorphic computing principles inspired by the brain's synaptic operations. This subsystem seamlessly integrates with multiple components of the existing architecture, fundamentally enhancing the platform's ability to perform efficient and adaptive computations.

Liquid circuit subsystem 4700 establishes a connection with distributed computational graph 1055, enabling the execution of certain AI operations with unprecedented energy efficiency and speed. By leveraging fluidic memristors and ion-based computations, this subsystem can perform complex matrix operations and neural network computations at power levels significantly lower than traditional electronic circuits. For instance, when processing large-scale language models through general transformer service module 1060, the liquid circuit subsystem might handle certain matrix multiplications or attention mechanisms, dramatically reducing energy consumption while maintaining or even improving computational speed.

Liquid circuit subsystem works in close concert with the hardware management layer 2800, particularly interfacing with Through-Chip Microchannel Cooler 23810. This integration allows for efficient thermal management of the liquid circuits, ensuring stable operation even under high computational loads. The unique properties of liquid circuits, which combine computation and memory storage within the same device, align well with the platform's goals of reducing data movement and enhancing overall system efficiency. Interacting closely with neuromorphic processing subsystem 3300, liquid circuit subsystem 4700 enables a more brain-like approach to certain computations. It can emulate synaptic plasticity and adaptive learning directly in hardware, potentially enhancing the platform's ability to perform online learning and adaptation. This capability could be particularly valuable in scenarios requiring real-time learning from streaming data or rapid adaptation to new patterns, such as in advanced robotics or adaptive control systems.

Liquid circuit subsystem 4700 also enhances the capabilities of the action outcome simulation module 1025 by providing a substrate for efficient, parallel processing of complex simulations. Its ability to perform rapid, low-power computations could enable more detailed and extensive simulations within given time and energy constraints, potentially improving the accuracy and scope of predictive modeling and decision-making processes. In its interaction with observation and state estimation service 1040, the liquid circuit subsystem 4700 can offer rapid, energy-efficient processing of sensory data and state information. Its parallel processing capabilities and adaptive nature make it well-suited for tasks like real-time sensor fusion or anomaly detection in complex data streams, potentially enabling more responsive and accurate state estimation in dynamic environments.

Liquid circuit subsystem 4700 may also interface with model hardware co-design subsystem 3900, opening up new possibilities for specialized AI hardware designs. The unique properties of liquid circuits, such as their ability to shuffle ions for dynamic circuit reconfiguration, could lead to highly adaptable hardware designs that can be optimized in real-time for different types of AI workloads.

In an embodiment, when the platform encounters a computationally intensive task, such as training a large language model or performing complex simulations, liquid circuit subsystem 4700 can be engaged to handle specific portions of the computation. For example, it might perform the matrix operations involved in the attention mechanisms of transformer models, leveraging its energy-efficient, parallel processing capabilities to accelerate these computations while significantly reducing power consumption. Throughout the AI pipeline, liquid circuit subsystem 4700 continues to optimize operations where appropriate. During complex simulations orchestrated by action outcome simulation module 1025, it might handle the parallel processing of multiple simulation scenarios, enabling more comprehensive exploration of possible outcomes within given computational constraints.

Liquid circuit subsystem 4700 also enhances the platform's ability to handle uncertainty and noise in data processing. Its brain-inspired processing principles allow for more robust performance in the face of imperfect input data, potentially improving the reliability of AI outputs in challenging real-world scenarios. By integrating liquid circuit subsystem 4700, the platform achieves a new level of efficiency and adaptability in AI processing. It allows for handling certain types of AI workloads with dramatically lower energy consumption, potentially enabling more complex AI tasks on resource-constrained devices or improving the scalability of large-scale AI operations. The result is a more versatile, energy-efficient, and brain-like AI system that can deliver enhanced performance across a wide range of applications, from edge computing devices to large-scale data centers, opening up new possibilities for AI applications that require high performance within strict energy constraints.

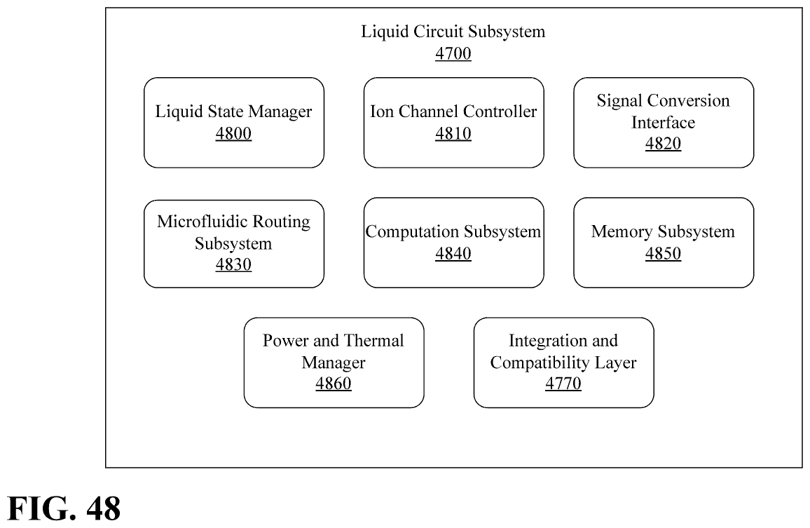

FIG. 48 is a block diagram illustrating an exemplary subsystem architecture for a component of a distributed generative artificial intelligence reasoning and action platform with an integrated liquid circuit subsystem, a liquid circuit subsystem. Liquid circuit subsystem 4700 represents a cutting-edge approach to neuromorphic computing within the distributed generative AI reasoning and action platform. This subsystem creates a synergistic relationship between its components and the broader architecture, fundamentally enhancing the platform's ability to perform efficient, adaptive, and brain-like computations.

Central to this subsystem, liquid state manager 4800 works in close concert with distributed computational graph system 1055 and hardware management layer 2800. It continuously monitors and adjusts the state of the liquid circuits, ensuring optimal conditions for computation. For instance, when processing complex AI workloads, it might dynamically adjust the ionic concentrations or fluid dynamics within the circuits to optimize their computational properties for specific types of operations, such as the attention mechanisms in transformer models or the parallel processing required for large-scale simulations.

Ion channel controller 4810 establishes a connection with the neuromorphic processing subsystem 3300 and the general transformer service module 1060. It regulates the flow of ions through the liquid circuits, effectively controlling the strength of connections between different computational elements. This mimics the function of synapses in biological brains, allowing for adaptive and plastic computations. For example, during a learning task, the ion channel controller might strengthen certain ionic pathways to reinforce important connections, similar to how synaptic plasticity works in biological neural networks. Working in tandem with these components, signal conversion interface 4820 plays a role in bridging the gap between traditional electronic signals and the ionic signals used in liquid circuits. It interfaces with various platform components, such as connector module 1035 and messaging service 1035a, ensuring seamless integration of liquid circuit computations into the broader AI workflows. This interface might, for instance, convert incoming electronic data into ionic concentrations for processing by the liquid circuits, and then convert the results back into electronic signals for use by other system components.

Microfluidic routing subsystem 4830 acts as the circulatory system of the liquid circuits, dynamically directing the flow of ionic solutions to different computational units. It works closely with action outcome simulation module 1025 and automated planning service module 1030 to optimize the routing of computations based on task requirements and system state. For example, when handling a complex planning task, it might reconfigure the fluid pathways to create temporary specialized processing units optimized for specific subtasks. Computation subsystem 4840 is where the actual processing occurs within the liquid circuits. It leverages the unique properties of ionic computations to perform operations with extreme energy efficiency. This subsystem may interface with model hardware co-design subsystem 3900, allowing for the development of specialized liquid circuit configurations optimized for different types of AI computations. It might, for example, implement matrix operations for neural network layers using ionic interactions, achieving high parallelism and energy efficiency.

Memory subsystem 4850 takes advantage of the liquid circuits' ability to combine computation and memory storage within the same medium. It works in conjunction with multidimensional time series data store 1020 and vector embedding subsystem 3100 to provide rapid, energy-efficient storage and retrieval of data and model parameters. This could enable more efficient processing of large AI models by reducing the need for constant data movement between separate memory and computation units.

Power and thermal manager 4860 ensures the stable and efficient operation of the liquid circuits. It interfaces closely with the Through-Chip Microchannel Cooler 2300 to maintain optimal temperature conditions for the ionic computations. This component might dynamically adjust cooling parameters based on the current computational load, ensuring energy-efficient operation across a wide range of processing intensities. Integration and compatibility layer 4770 serves as the primary interface between the liquid circuit subsystem and other platform components. It works with AI-based operating system (AIOS) 4500 to ensure that liquid circuit resources are efficiently allocated and managed within the broader system context. This layer might provide abstraction mechanisms that allow other system components to leverage liquid circuit capabilities without needing to understand the intricacies of ionic computing.

By integrating these components, liquid circuit subsystem 4700 enables a new paradigm in AI computation within the platform. It allows for extremely energy-efficient processing of certain AI workloads, potentially enabling more complex AI tasks on resource-constrained devices or improving the scalability of large-scale AI operations. The result is a more versatile, energy-efficient, and brain-like AI system that can deliver enhanced performance across a wide range of applications, from edge computing to data center-scale operations, opening up new possibilities for AI applications that require high performance within strict energy constraints.

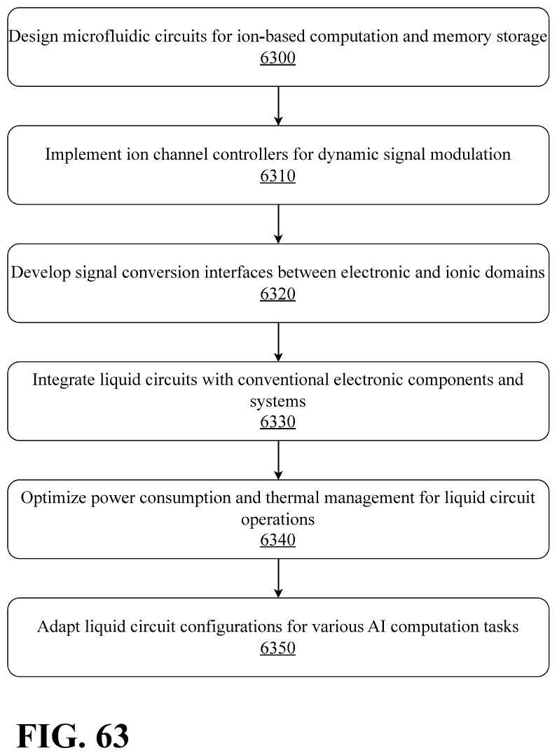

FIG. 63 is a flow diagram illustrating an exemplary method for a distributed generative artificial intelligence reasoning and action platform with an integrated liquid circuit subsystem. In a first step 6300, the system designs microfluidic circuits for ion-based computation and memory storage. This step involves creating intricate networks of microscale channels and chambers that can manipulate and store information using ionic solutions. The design draws inspiration from biological synapses, aiming to mimic their efficiency in information processing and storage. The microfluidic circuits are engineered to perform basic computational operations (like addition or multiplication) and store information through the manipulation of ion concentrations or flows. This design may incorporate advanced materials like hydrogels or specialized polymers that can interact with ionic solutions in controlled ways.

In a step 6310, the system implements ion channel controllers for dynamic signal modulation. This involves developing mechanisms to precisely control the flow of ions through the microfluidic circuits, analogous to how ion channels work in biological neurons. These controllers might use a combination of electrical fields, chemical gradients, and mechanical actuators to modulate ion flow. The implementation ensures fine-grained control over signal strength and timing, allowing for complex computational operations. This step may also involve developing feedback mechanisms to maintain stability and precision in ionic signaling.

In a step 6320, the system develops signal conversion interfaces between electronic and ionic domains. This step bridges the gap between conventional electronic systems and the ionic-based liquid circuits. It involves creating transducers that can efficiently convert electronic signals to ionic concentrations or flows, and vice versa. This might include developing specialized electrodes, chemical sensors, or optical detection systems that can interface with both domains. The conversion process needs to be fast, accurate, and energy-efficient to maintain the advantages of liquid circuit computation.

In a step 6330, the system integrates liquid circuits with conventional electronic components and systems. This step focuses on creating a seamless integration between the novel liquid circuit technology and existing electronic hardware. It involves developing interface protocols, signal synchronization mechanisms, and potentially hybrid computational units that can leverage both electronic and ionic processing. The integration ensures that liquid circuits can be effectively utilized within the broader AI platform, potentially working alongside traditional processors, memory units, and neuromorphic hardware.

In a step 6340, the system optimizes power consumption and thermal management for liquid circuit operations. This involves developing strategies to minimize energy use in ion manipulation and signal conversion processes. The system might implement techniques like reversible computing or adiabatic switching, which are particularly suited to ionic systems. For thermal management, the liquid nature of the circuits presents unique opportunities and challenges. The system might develop active cooling mechanisms that leverage the fluid dynamics of the ionic solutions themselves, potentially integrating with advanced cooling technologies like the through-chip microchannel cooler mentioned in earlier disclosures.

In a step 6350, the system adapts liquid circuit configurations for various AI computation tasks. This final step involves tailoring the liquid circuit architecture and operations for specific AI applications. This might include optimizing circuit layouts for pattern recognition tasks, developing specialized ionic memory structures for efficient data storage and retrieval, or creating liquid circuit implementations of neural network components like attention mechanisms. The adaptation process ensures that the unique properties of liquid circuits, such as their ability to perform parallel computations or store information in a high-density, low-power state, are fully leveraged for AI tasks.

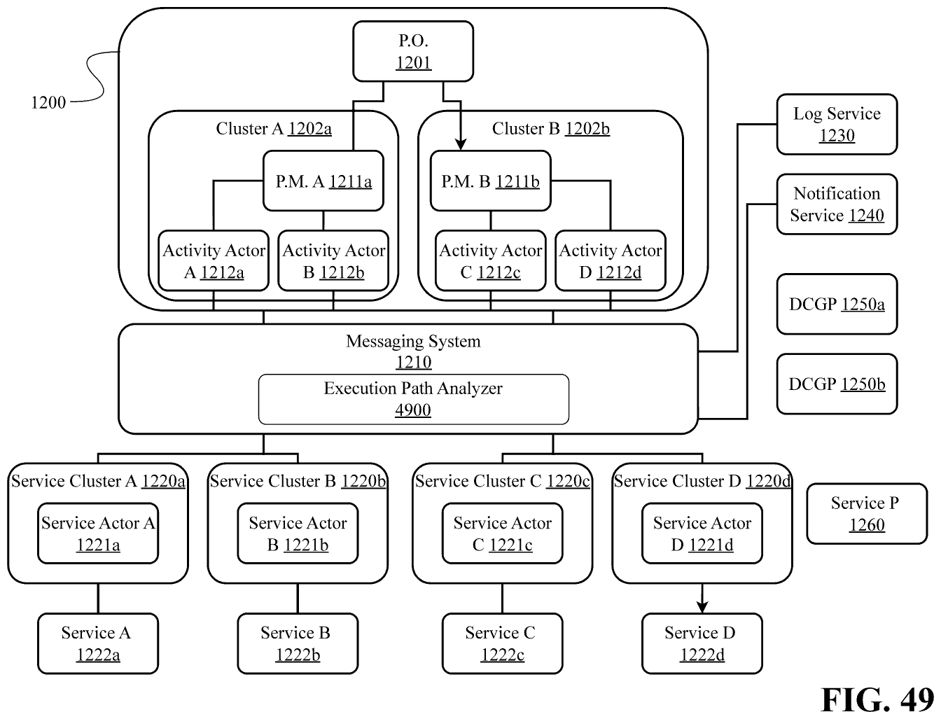

FIG. 49 is a block diagram illustrating an exemplary system architecture for a distributed generative artificial intelligence reasoning and action platform with an integrated execution path analyzer. Execution path analyzer 4900 is an advancement in the distributed generative AI reasoning and action platform, introducing sophisticated capabilities for analyzing, optimizing, and securing computational workflows. This analyzer seamlessly integrates with multiple components of the existing architecture, fundamentally enhancing the platform's ability to understand, optimize, and safeguard its own operations.

Execution path analyzer 4900 establishes a connection with pipeline orchestrator 1201 and individual pipeline managers 1211a and 1211b. It continuously monitors and analyzes the execution paths of various tasks and workflows as they traverse through different clusters and activity actors. By leveraging advanced graph theory techniques, including the identification of Hamiltonian cycles, the analyzer can map out all possible execution paths within the system. This comprehensive understanding allows for more efficient task scheduling, resource allocation, and error detection.

Execution path analyzer 4900 works in close concert with DCG protocols DCGP 1250a, 1250b, enhancing their ability to optimize data flow and task distribution across the distributed computational graph. By providing detailed insights into execution patterns and potential bottlenecks, the analyzer enables more intelligent routing of tasks and data. For instance, when processing a complex AI workflow that involves multiple transformers and data processing stages, the execution path analyzer might identify opportunities for parallel processing or suggest alternative routing to minimize data transfer and improve overall efficiency. Interacting closely with the service clusters 1220a-d and their respective service actors 1221a-d, execution path analyzer 4900 enables more adaptive and efficient service provisioning. It can analyze the interaction patterns between different services and identify opportunities for optimization. For example, it might detect that certain services are frequently used in sequence and suggest pre-emptive data caching or service co-location to reduce latency and improve performance.

Execution path analyzer also establishes a link with log service 1230 and notification service 1240, enhancing the platform's ability to detect and respond to anomalies or potential security threats. By analyzing execution paths in real-time and comparing them against expected patterns, the analyzer can quickly identify unusual behaviors that might indicate errors, inefficiencies, or security breaches. This capability is particularly valuable for maintaining the integrity and performance of the system in dynamic and potentially adversarial environments. In its interaction with the messaging system 1210, execution path analyzer 4900 plays a role in optimizing communication patterns within the platform. It can analyze message flows between different components and suggest improvements to reduce communication overhead or latency. This might involve recommendations for message batching, routing optimizations, or changes to the communication protocols used between different system components.

Execution path analyzer 4900 also interfaces with activity actors 1212a-d within each cluster, providing insights that can help optimize their individual operations. By understanding how each actor fits into broader execution paths, the analyzer can suggest ways to streamline their processes or better coordinate their activities with other system components.

In an embodiment, when a complex AI task is initiated through the client access interface, execution path analyzer 4900 springs into action, mapping out potential execution paths across the system. As the task progresses through various clusters and services, the analyzer continuously monitors its actual path, comparing it against predicted optimal paths and historical data. Throughout the task execution, execution path analyzer 4900 provides real-time insights to other system components. It might, for example, detect that a particular execution path is becoming congested and suggest alternative routes to the pipeline orchestrator. Or it could identify that certain execution patterns are consistently leading to improved performance and recommend these patterns be prioritized in future task allocations.

Execution path analyzer 4900 also plays a role in the platform's security and reliability. By continuously monitoring execution paths, it can quickly detect anomalies that might indicate a security breach or system malfunction. For instance, if it detects an unusual pattern of service accesses or data flows that deviate significantly from expected paths, it can trigger alerts through notification service 1240 and potentially initiate automated response mechanisms.

By integrating execution path analyzer 4900, the platform achieves a new level of self-awareness and optimization capability. It allows for more intelligent task routing, improved resource utilization, and enhanced security monitoring. This results in a more efficient, reliable, and secure AI system that can adapt its operations in real-time based on a deep understanding of its own execution patterns. The execution path analyzer thus becomes a component in enabling the platform to handle increasingly complex and dynamic AI workloads while maintaining optimal performance and security.

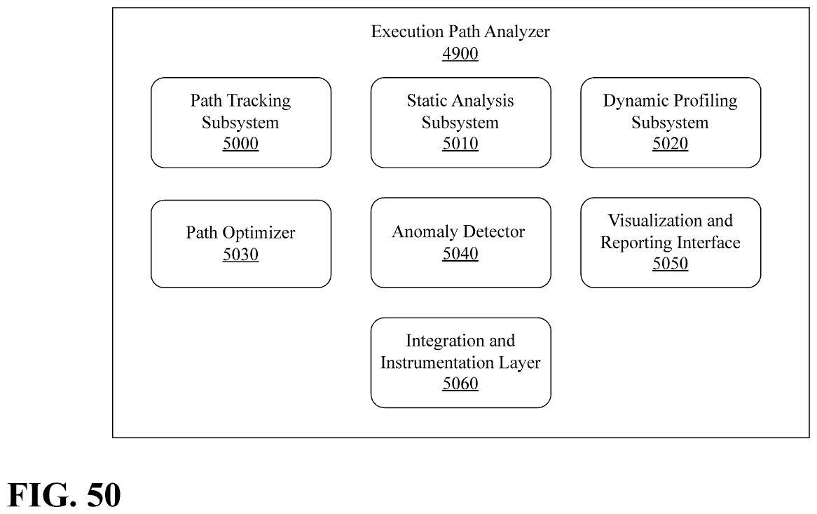

FIG. 50 is a block diagram illustrating an exemplary subsystem architecture for a component of a distributed generative artificial intelligence reasoning and action platform with an integrated execution path analyzer, an execution path analyzer. Execution path analyzer 4900 represents a sophisticated system for monitoring, analyzing, and optimizing the computational workflows within the distributed generative AI reasoning and action platform. This analyzer creates a synergistic relationship between its components and the broader architecture, fundamentally enhancing the platform's ability to understand, optimize, and secure its own operations.

Path tracking subsystem 5000 works in close concert with the pipeline orchestrator 1201 and individual pipeline managers 1211a-b. It continuously monitors and records the actual execution paths of tasks as they flow through the system's clusters and activity actors. Leveraging advanced graph theory techniques, including the identification of Hamiltonian cycles, this subsystem creates a comprehensive map of all possible and actual execution paths. For instance, when processing a complex AI workflow involving multiple transformer models and data processing stages, the path tracking subsystem might record how data and computations flow through various services and actors, providing a detailed audit trail of the task's execution.

Static analysis subsystem 5010 establishes a connection with DCG protocols 1250a-b and distributed computational graph system 1055. It analyzes the structure of computational graphs and potential execution paths before runtime. This subsystem might, for example, identify potential bottlenecks or inefficiencies in the planned execution path of a large language model training task, allowing for preemptive optimizations in task allocation and resource provisioning. Working in tandem with these components, dynamic profiling subsystem 5020 continuously monitors the real-time performance of execution paths. It interfaces closely with the service clusters 1220a-d and their respective service actors 1221a-d, collecting detailed performance metrics as tasks are executed. This subsystem might, for instance, detect that certain service combinations consistently lead to improved performance in specific types of AI workloads, informing future task allocation decisions.

Path optimizer 5030 plays a role in enhancing the efficiency of the platform's operations. It leverages insights from both static analysis and dynamic profiling to suggest improvements in task routing and resource allocation. This component works closely with pipeline orchestrator 1201 and messaging system 1210 to implement these optimizations. For example, it might recommend reorganizing the sequence of operations in a data processing pipeline to minimize data transfer overhead or suggest parallel execution paths for independent subtasks.

Anomaly detector 5040 serves as a vigilant guardian of the system's integrity and performance. It analyzes execution paths in real-time, comparing them against expected patterns and historical data to identify unusual behaviors. This component interfaces with log service 1230 and notification service 1240 to alert system administrators or trigger automated responses to potential issues. For instance, if it detects an unexpected sequence of service accesses that could indicate a security breach, it might immediately isolate the affected components and initiate a security protocol.

Visualization and reporting interface 5050 translates the complex analysis performed by other components into intuitive visual representations and detailed reports. It works with observation and state estimation service 1040 to provide system administrators and developers with clear insights into the platform's operations. This interface might, for example, generate heat maps showing the most frequently used execution paths or produce interactive graphs for exploring the relationships between different system components. Integration and instrumentation layer 5060 serves as the primary means by which the execution path analyzer 4900 interfaces with the broader system architecture. It works with the connector module 1035 and operates across multiple levels of system management, including local operating systems, the federated DCG orchestration layer, and DCG-enabled systems within specific tiers or tessellations. At the local level, it interfaces with traditional operating systems to collect low-level performance metrics and resource utilization data. At the federated DCG orchestration level, it interacts with the AI-enabled distributed operating environment, which manages resources and tasks across the entire federation. Within individual tiers or tessellations, it integrates with DCG-enabled systems to gather execution path data specific to that segment of the distributed architecture. This multi-layered approach allows the integration and instrumentation layer to implement low-overhead instrumentation points throughout the system, collecting necessary data at various levels of abstraction without significantly impacting overall performance. By distinguishing between these operational layers, the system can provide a comprehensive view of execution paths while respecting the hierarchical and distributed nature of the federated DCG architecture.

By integrating these components, execution path analyzer 4900 enables a new level of self-awareness and self-optimization within the platform within a given DCG orchestrator and across the federated network of DCG enabled orchestration systems at multiple tiers or tessellations. It allows for more configurable and intelligent task routing, improved resource utilization, and enhanced privacy controls and security options. This results in a more efficient, reliable, and secure AI system that can adapt its operations in real-time based on a deep understanding of its own execution patterns at local, regional, or global levels with optional total visibility or partial visibility or blind computation distribution options, ultimately enabling the platform to handle increasingly complex and dynamic AI enabled workloads while managing performance and reliability and security or privacy considerations.

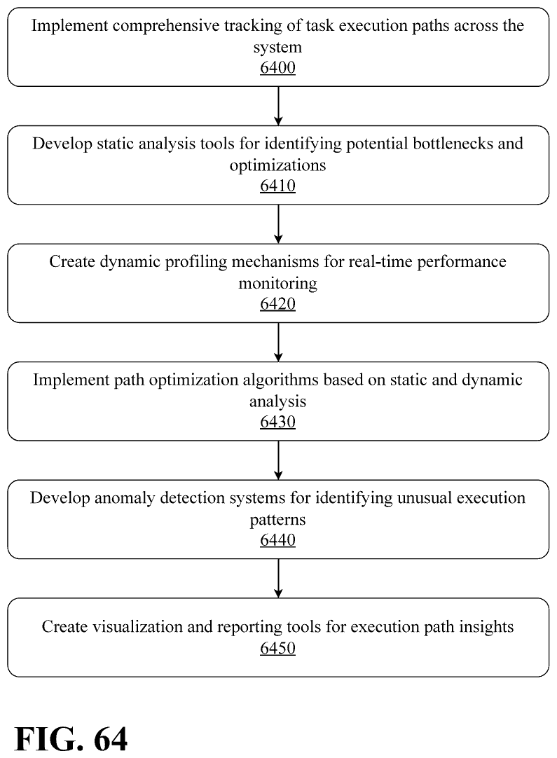

FIG. 64 is a flow diagram illustrating an exemplary method for a distributed generative artificial intelligence reasoning and action platform with an integrated execution path analyzer. In a first step 6400, the system implements comprehensive tracking of task execution paths across the system. This involves developing a robust mechanism to monitor and record the sequence of operations, function calls, and data flows as tasks are executed across the distributed AI platform. The tracking system needs to be lightweight to minimize performance overhead while still capturing detailed information about each step in the execution process. This might involve instrumenting code at key points, using hardware performance counters, or leveraging system-level tracing tools. The tracking should cover various components of the system, including the distributed computational graph, different AI models, and hardware resources.

In a step 6410, the system develops static analysis tools for identifying potential bottlenecks and optimizations. This step focuses on analyzing the structure and code of the AI system without actually running it. The static analysis tools examine aspects like control flow, data dependencies, and resource usage patterns. They might employ techniques from compiler optimization, such as data flow analysis or symbolic execution, to identify potential performance bottlenecks, redundant computations, or opportunities for parallelization. These tools could also leverage recent advancements in graph theory, such as the identification of Hamiltonian cycles in highly connected networks, to optimize the flow of computations.

In a step 6420, the system creates dynamic profiling mechanisms for real-time performance monitoring. This involves implementing tools that can collect and analyze performance data while the system is running. The dynamic profiling might track metrics like execution time, memory usage, cache hits/misses, and inter-component communication patterns. It could use sampling techniques or full instrumentation, depending on the level of detail required and the performance impact. The profiling mechanisms need to be designed to handle the distributed nature of the AI platform, potentially leveraging the distributed computational graph system for efficient data collection across multiple components and hardware resources.

In a step 6430, the system implements path optimization algorithms based on static and dynamic analysis. This step involves developing algorithms that can use the insights gained from both static analysis and dynamic profiling to optimize execution paths. These algorithms might employ techniques from operations research, such as linear programming or genetic algorithms, to find optimal task scheduling and resource allocation strategies. They could also use machine learning approaches, like reinforcement learning, to adaptively improve execution paths over time based on observed performance. The optimization algorithms should be able to handle the complexity of the AI platform's distributed nature and heterogeneous hardware environment.

In a step 6440, the system develops anomaly detection systems for identifying unusual execution patterns. This involves creating mechanisms to detect deviations from expected or typical execution paths. The anomaly detection system might use statistical methods, machine learning models (such as autoencoders or isolation forests), or rule-based systems to identify unusual patterns. These could include unexpected delays, resource usage spikes, or atypical sequences of operations. The anomaly detection is for identifying potential performance issues, bugs, or security threats in real-time.

In a step 6450, the system creates visualization and reporting tools for execution path insights. This final step focuses on developing user-friendly interfaces to present the complex data gathered and analyzed by the execution path analyzer. The visualization tools might include interactive graphs showing execution flows, heat maps of resource usage, or timelines of task progressions. Reporting tools could generate summaries of performance bottlenecks, optimization opportunities, and anomalies detected. These tools should be designed to cater to different user needs, from high-level overviews for system administrators to detailed technical reports for developers and AI researchers.

### Exemplary Computing Environment

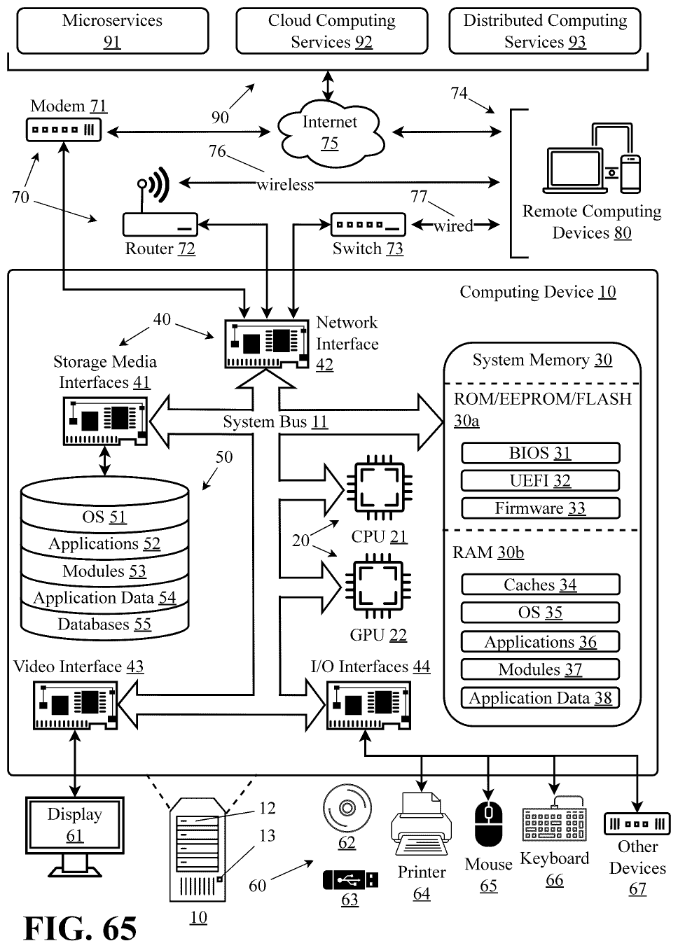

FIG. 65 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Container provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Federated distributed computing services 93 provide large-scale processing using multiple interconnected computers or nodes to solve computational problems or perform tasks collectively. In federated distributed computing, the processing and storage capabilities of multiple machines are leveraged to work together as a unified system, even when different tiers or tessellations may have limited or even no visibility into the resources and processing layer up or downstream. Federated distributed computing services are designed to address problems that cannot be efficiently solved by a single computer or that require large-scale computational power and require dynamism and workload distribution for economic, security or privacy reasons not well supported by canonical distributed computing resources; e.g. most commonly cloud-based computing applications, resources or analytics. Federated DCG coordinated variants of these services enable superior decentralization and further enhance parallel processing, fault tolerance, and scalability by distributing tasks across multiple tiers or tessellations while enabling computing process dependency calculation with varying degrees of visibility, assurance and privacy or security based on constituent computing system, network, workload and user or provider needs and preferences as well as practical legal and regulatory concerns to include but not limited to data localization, national data transfer restrictions, privacy and consumer protections, wiretap/telecommunications monitoring requirements, encryption and data routing and intermediate processing restrictions.

Although described above as a physical device, computing device 10 can be a virtual computing device, in which case the functionality of the physical components herein described, such as processors 20, system memory 30, network interfaces 40, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computing system for a federated distributed graph-based computing platform with hardware management, the computing system comprising:
one or more hardware processors configured for:
integrating a hardware management layer with existing system components of a distributed graph-based computing platform;
configuring and initializing a thermal management system for optimal thermal control across the platform;
establishing real-time monitoring and control of hardware resources distributed throughout the platform;
implementing dynamic resource allocation based on workload demands and thermal conditions;
coordinating with an operating system for intelligent task scheduling and resource optimization;
continuously analyzing platform capabilities and adapting hardware configurations into optimized hardware configurations; and
executing AI tasks using the optimized hardware configurations.

2. The computing system of claim 1, wherein the distributed graph-based computing platform is a federated distributed graph-based computing platform.

3. The computing system of claim 1, wherein dynamically allocating resources comprises adjusting computational resources across hardware components including CPUs, GPUs, and specialized AI hardware such as TPUs.

4. A computer-implemented method executed on a federated distributed graph-based computing platform with hardware management, the computer-implemented method comprising:
integrating a hardware management layer with existing system components of a distributed graph-based computing platform;
configuring and initializing a thermal management system for optimal thermal control across the platform;
establishing real-time monitoring and control of hardware resources distributed throughout the platform;
implementing dynamic resource allocation based on workload demands and thermal conditions;
coordinating with an operating system for intelligent task scheduling and resource optimization;
continuously analyzing platform capabilities and adapting hardware configurations into optimized hardware configurations; and
executing AI tasks using the optimized hardware configurations.

5. The computer implemented method of claim 4, wherein the distributed graph-based computing platform is a federated distributed graph-based computing platform.

6. The computer implemented method of claim 4, wherein dynamically allocating resources comprises adjusting computational resources across hardware components including CPUs, GPUs, and specialized AI hardware such as TPUs.

7. A system for a federated distributed graph-based computing platform with an integrated hardware management layer, comprising one or more computers with executable instructions that, when executed, cause the system to:
integrate a hardware management layer with existing system components of a distributed graph-based computing platform;
configure and initialize a thermal management system for optimal thermal control across the platform;
establish real-time monitoring and control of hardware resources distributed throughout the platform;
implement dynamic resource allocation based on workload demands and thermal conditions;
coordinate with an operating system for intelligent task scheduling and resource optimization;
continuously analyze platform capabilities and adapt hardware configurations into optimized hardware configurations; and
execute AI tasks using the optimized hardware configurations.

8. The system of claim 7, wherein the distributed graph-based computing platform is a federated distributed graph-based computing platform.

9. The system of claim 7, wherein dynamically allocating resources comprises adjusting computational resources across hardware components including CPUs, GPUs, and specialized AI hardware such as TPUs.
